(19) United States
(12) Patent Application Publication
(10) Pub. No.: US 2023/0393717 A1
(43) Pub. Date: Dec. 7, 2023

(54) USER INTERFACES FOR DISPLAYING HANDWRITTEN CONTENT ON AN ELECTRONIC DEVICE

(71) Applicant: Apple Inc., Cupertino, CA (US)

(72) Inventors: Christopher D. SOLI, San Francisco, CA (US); William J. THIMBLEBY, Sunnyvale, CA (US); Grant R. PAUL, San Francisco, CA (US); Aram D. KUDURSHIAN, San Francisco, CA (US); Jennifer P. CHEN, Mountain View, CA (US); Jun R. HATORI, Santa Clara, CA (US); Elizabeth J. BOARD, Campbell, CA (US); Adrien DELAYE, Sunnyvale, CA (US)

(21) Appl. No.: 18/327,757

(22) Filed: Jun. 1, 2023

Related U.S. Application Data
(60) Provisional application No. 63/365,864, filed on Jun. 4, 2022.

(51) Int. Cl. G06F 3/0484; G06F 3/023; G06F 3/04883

(52) U.S. Cl. CPC G06F 3/0484; G06F 3/04883; G06F 3/0233

(57) ABSTRACT

Some embodiments described in this disclosure are directed to electronic devices that provide for entering text into one or more text-entry regions within a document displayed in a user interface. Some embodiments described in this disclosure are directed to electronic devices that provide for presenting a mark with thickness that depends on the direction in which a drawing input is received. Some embodiments described in this disclosure are directed to electronic devices that provide for presenting simulated marks that merge with or overlap other simulated marks. Some embodiments described in this disclosure are directed to electronic devices that provide for scrolling and movement of a content entry palette in a user interface based on movement of input directed to the content entry palette.

### CROSS-REFERENCE TO RELATED APPLICATIONS

This application claims the benefit of U.S. Provisional Application No. 63/365,864, filed Jun. 4, 2022, the content of which is incorporated herein by reference in its entirety for all purposes.

### FIELD OF THE DISCLOSURE

This relates generally to electronic devices that display handwritten content, and user interactions with such devices.

### BACKGROUND

User interaction with electronic devices has increased significantly in recent years. These devices can be devices such as computers, tablet computers, televisions, multimedia devices, mobile devices, and the like.

In some circumstances, users wish to enter text into one or more text-entry regions within a document displayed on an electronic device. In some circumstances, users wish to make simulated marks that vary in width. In some circumstances, users wish to make simulated marks that overlap with or merge with other simulated marks. In some circumstances, users desire to manipulate user interface regions for providing handwritten content on the electronic device. Enhancing these interactions improves the user's experience with the device and decreases user interaction time, which is particularly important where input devices are battery-operated.

### SUMMARY

Some embodiments described in this disclosure are directed to electronic devices that provide for entering text into one or more text-entry regions within a document displayed in a user interface. Some embodiments described in this disclosure are directed to electronic devices that provide for presenting a mark with thickness that depends on the direction in which a drawing input is received. Some embodiments described in this disclosure are directed to electronic devices that provide for presenting simulated marks that merge with or overlap other simulated marks. Some embodiments described in this disclosure are directed to electronic devices that provide for scrolling and movement of a content entry palette in a user interface based on movement of input directed to the content entry palette.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIG. 5I illustrates a block diagram of an exemplary architectures for devices according to some embodiments of the disclosure.

FIGS. 6A-6CC illustrate exemplary ways in which an electronic device facilitates entering text into one more text-entry regions within a document in accordance with some embodiments of the disclosure.

FIGS. 7A-7K is a flow diagram illustrating a method of facilitating entering text into one more text-entry regions within a document in accordance with some embodiments of the disclosure.

FIGS. 8A-8K illustrate exemplary ways of presenting a mark with a thickness that depends on the direction in which a drawing input is received in accordance with some embodiments of the disclosure.

FIGS. 9A-9D is a flow diagram illustrating an exemplary method of presenting a mark with a thickness that depends on the direction in which a drawing input is received in accordance with some embodiments of the disclosure.

FIGS. 10A-10P illustrate exemplary ways of presenting simulated marks that merge with or overlap other simulated marks in accordance with some embodiments of the disclosure.

FIGS. 11A-11K is a flow diagram illustrating a method of presenting simulated marks that merge with or overlap other simulated marks in accordance with some embodiments of the disclosure.

FIGS. 12A-12M illustrate exemplary ways in which an electronic device facilitates scrolling of a content entry palette and movement of the content entry palette within a user interface in accordance with some embodiments of the disclosure.

FIGS. 13A-13F is a flow diagram illustrating a method of facilitating scrolling of a content entry palette and movement of the content entry palette within a user interface in accordance with some embodiments of the disclosure.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods for entering text into one or more text-entry regions within a document displayed in a user interface. In some embodiments, while a content entry mode is active, an electronic device displays a text-entry field at a respective location in the document that is based on a location of a text-entry region in the document in response to detecting a respective gesture. In some embodiments, the text-entry field is selectable to initiate a process to enter text into the text-entry field associated with the text-entry region. Such techniques can reduce the cognitive burden on a user who uses such devices. Further, such techniques can reduce processor and battery power otherwise wasted on redundant user inputs.

There is a need for electronic devices that provide efficient methods for presenting a mark with a thickness that depends on the direction in which a drawing input is received. In some embodiments, in response to detecting an input including movement (e.g., of an input device or another object, such as a finger of the user), the electronic device displays a simulated mark corresponding to the movement. In some embodiments, the thickness of the mark depends on which way the movement was made, with marks along a first dimension being thicker or thinner depending on the direction along the first dimension with which the mark was made and marks along a second dimension having a medium thickness independent from the direction along the second dimension in which the mark was made. Such techniques can reduce the cognitive burden on a user who uses such devices. Further, such techniques can reduce processor and battery power otherwise wasted on redundant user inputs.

There is a need for electronic devices that provide efficient methods for presenting simulated marks that merge with or overlap other simulated marks. In some embodiments, in response to detecting an input for making a mark, the electronic device presents a representation of the mark that merges with marks made by inputs received within a threshold time and/or overlaps with marks made by inputs received more than the threshold time ago. In some embodiments, an overlapping portion of merged marks has the same value for a visual characteristic (e.g., darkness and/or color saturation) as the value for the visual characteristic for non-overlapping portions of the marks. In some embodiments, an overlapping portion of overlapping marks has a different value for the visual characteristic than the value for the visual characteristic for the non-overlapping portions of the marks. Such techniques can reduce the cognitive burden on a user who uses such devices. Further, such techniques can reduce processor and battery power otherwise wasted on redundant user inputs.

There is a need for electronic devices that provide efficient methods for scrolling and moving a content entry palette within a user interface in response to detecting input directed to the content entry palette. In some embodiments, an electronic device scrolls through a plurality of user interface objects within the content entry palette in response to detecting input that includes movement in a first direction. In some embodiments, the electronic device moves the content entry palette within the user interface in response to detecting input that includes movement in a second direction, different from the first direction. Such techniques can reduce the cognitive burden on a user who uses such devices. Further, such techniques can reduce processor and battery power otherwise wasted on redundant user inputs.

Although the following description uses terms “first,” and/or “second,” to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad).

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

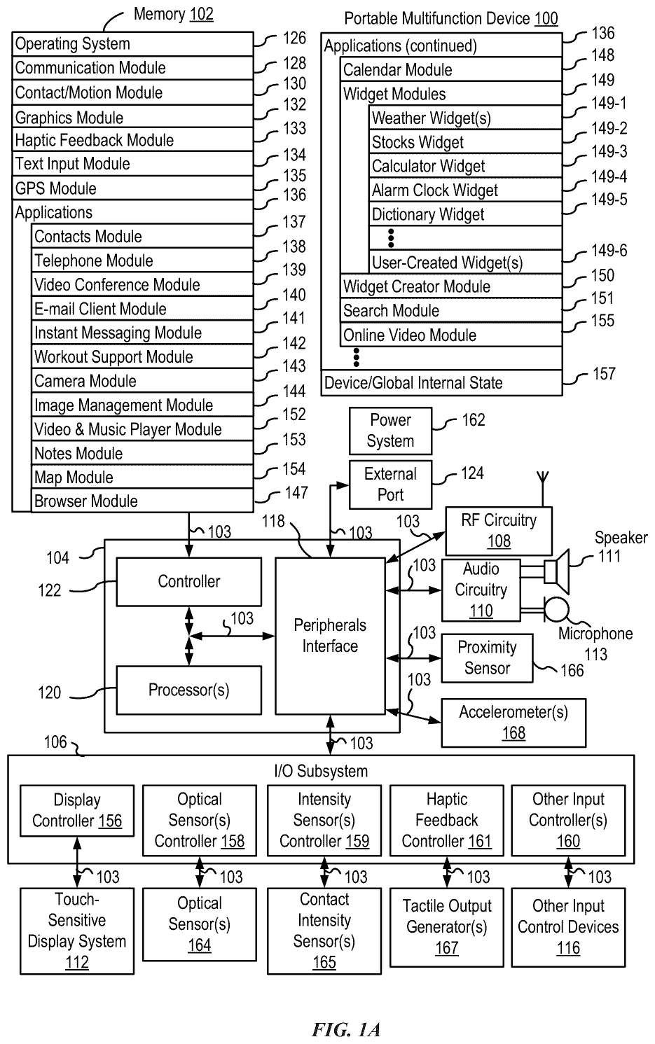

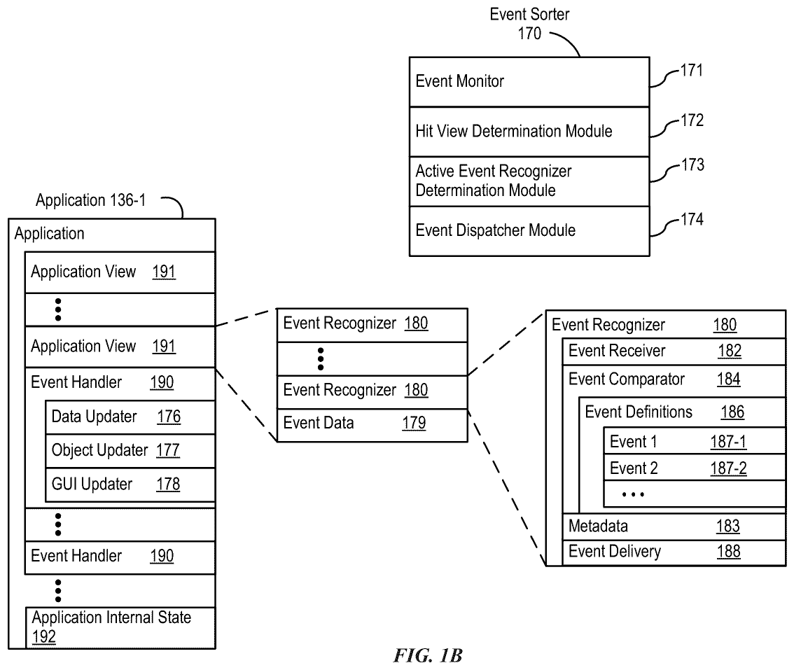

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

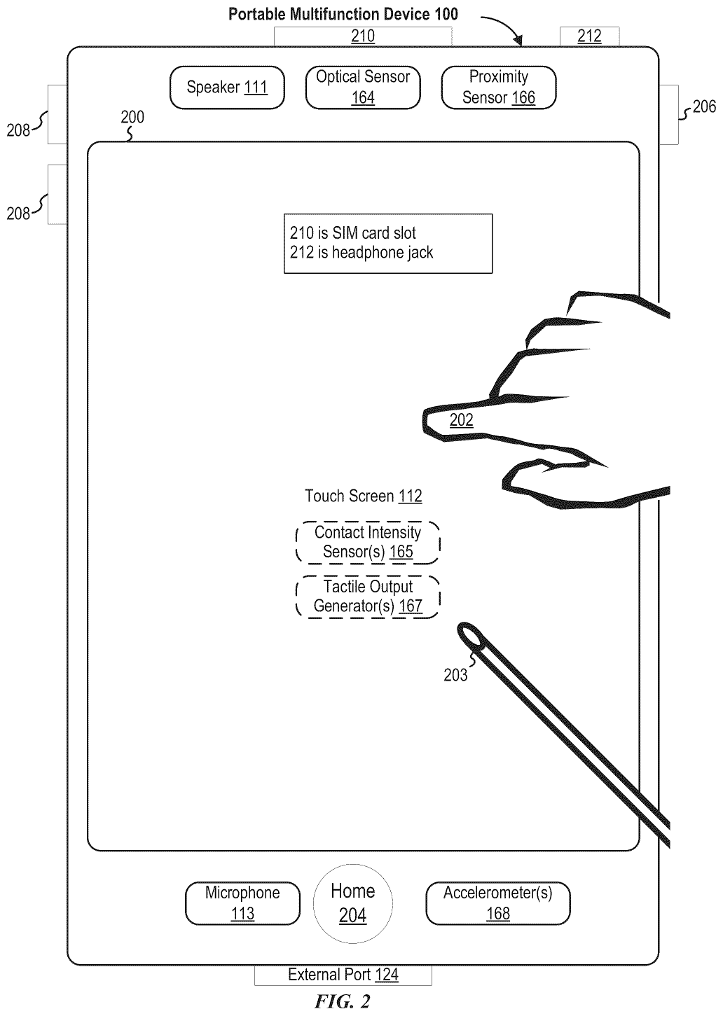

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, and/or rocker buttons), dials, slider switches, joysticks, click wheels, and so forth. In some alternate embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, device 100 is a portable computing system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system (e.g., an integrated display and/or touch screen 112). In some embodiments, the display generation component is separate from the computer system (e.g., an external monitor and/or a projection system). As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

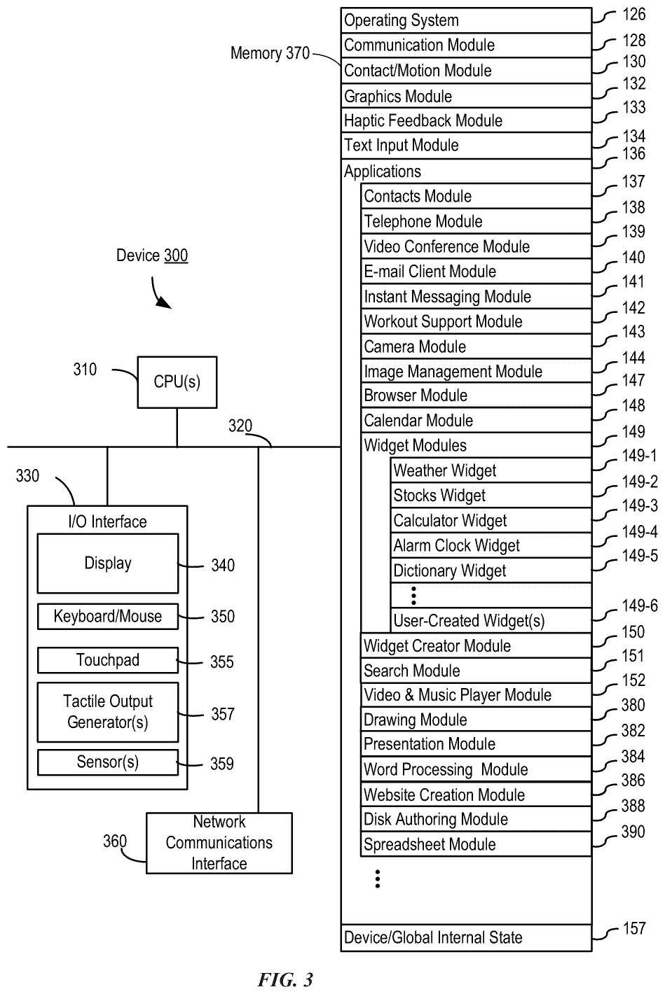

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, and/or power management) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB) and/or FIREWIRE.) is adapted for coupling directly to other devices or indirectly over a network (e.g., the Internet and/or wireless LAN). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications, for example, one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries and/or to-do lists) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, and/or scrolls on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

In some embodiments, stylus 203 is an active device and includes one or more electronic circuitry. For example, stylus 203 includes one or more sensors, and one or more communication circuitry (such as communication module 128 and/or RF circuitry 108). In some embodiments, stylus 203 includes one or more processors and power systems (e.g., similar to power system 162). In some embodiments, stylus 203 includes an accelerometer (such as accelerometer 168), magnetometer, and/or gyroscope that is able to determine the position, angle, location, and/or other physical characteristics of stylus 203 (e.g., such as whether the stylus is placed down, angled toward or away from a device, and/or near or far from a device). In some embodiments, stylus 203 is in communication with an electronic device (e.g., via communication circuitry, over a wireless communication protocol such as Bluetooth) and transmits sensor data to the electronic device. In some embodiments, stylus 203 is able to determine (e.g., via the accelerometer or other sensors) whether the user is holding the device. In some embodiments, stylus 203 can accept tap inputs (e.g., single tap or double tap) on stylus 203 (e.g., received by the accelerometer or other sensors) from the user and interpret the input as a command or request to perform a function or change to a different input mode.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or programs (e.g., sets of instructions) need not be implemented as separate software programs, procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

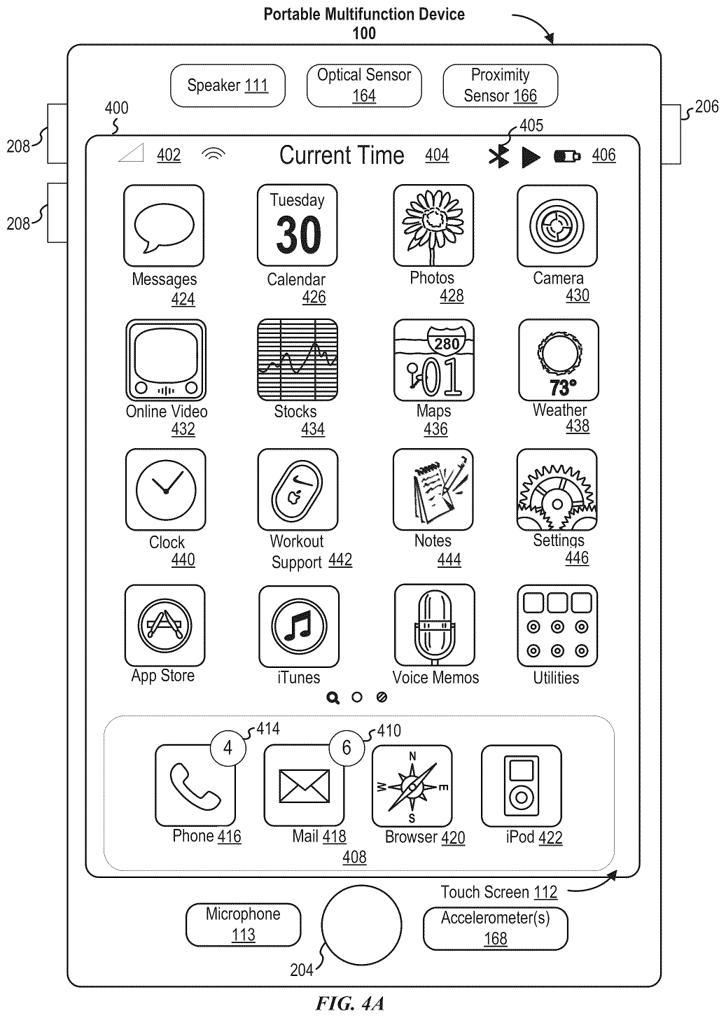

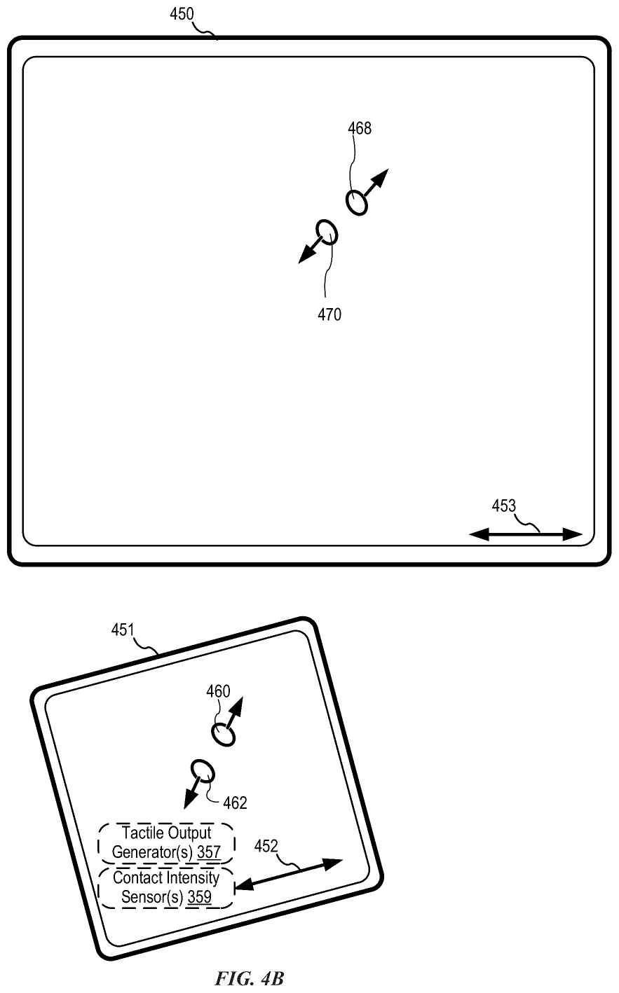

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

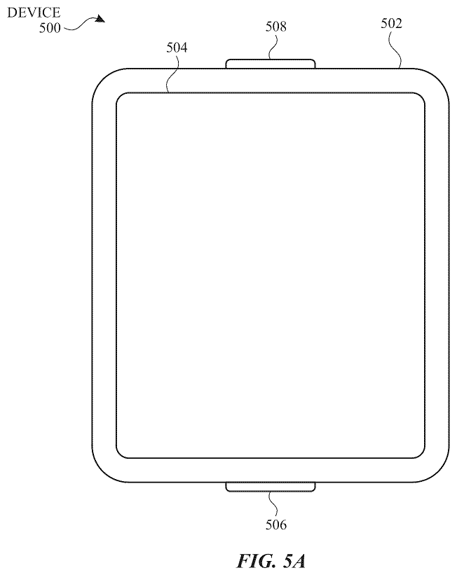

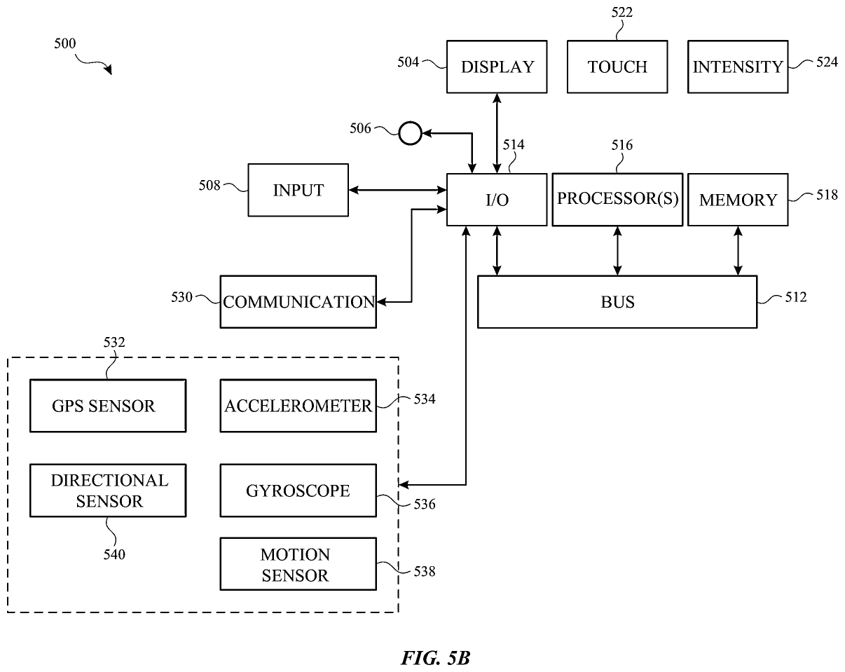

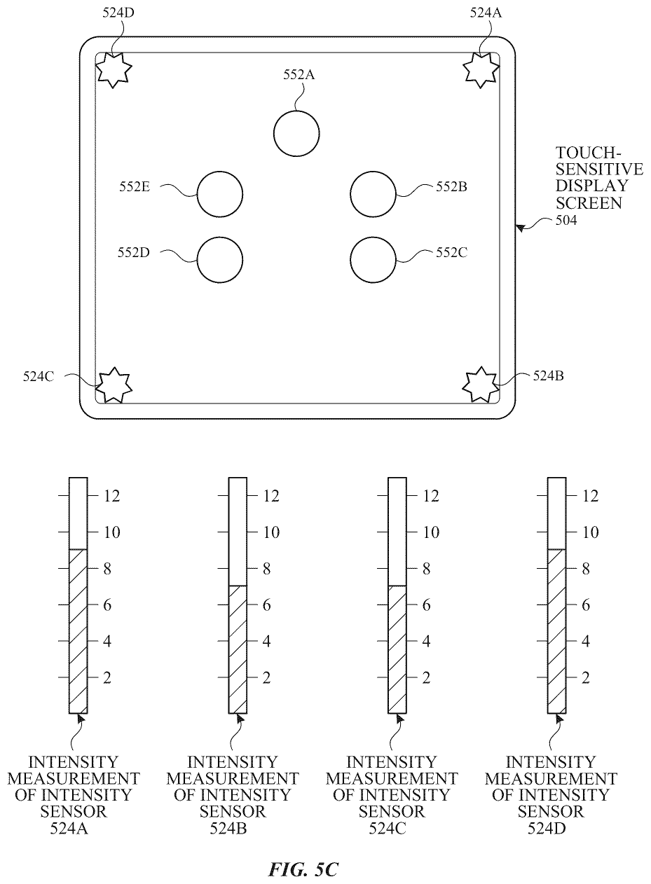

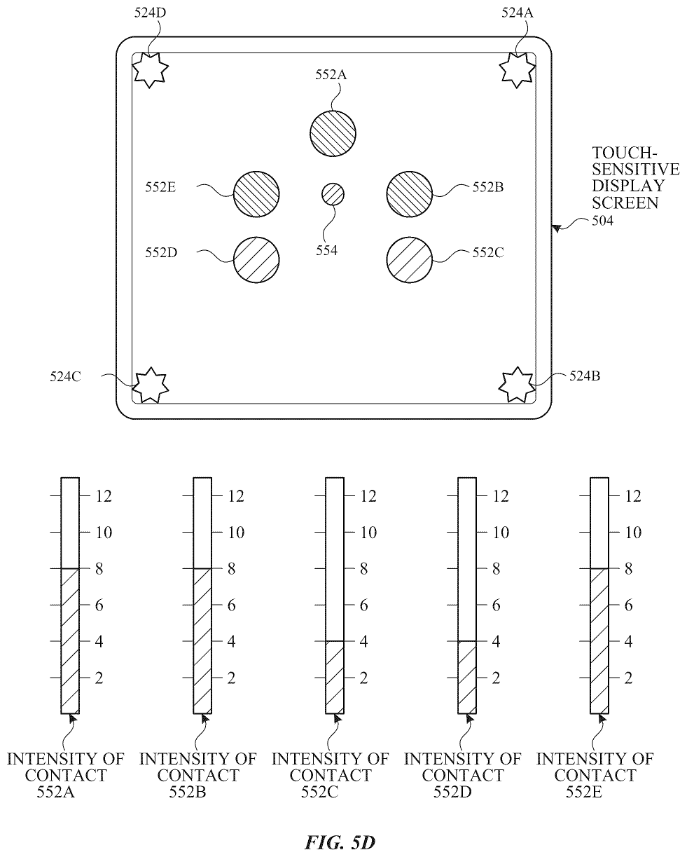

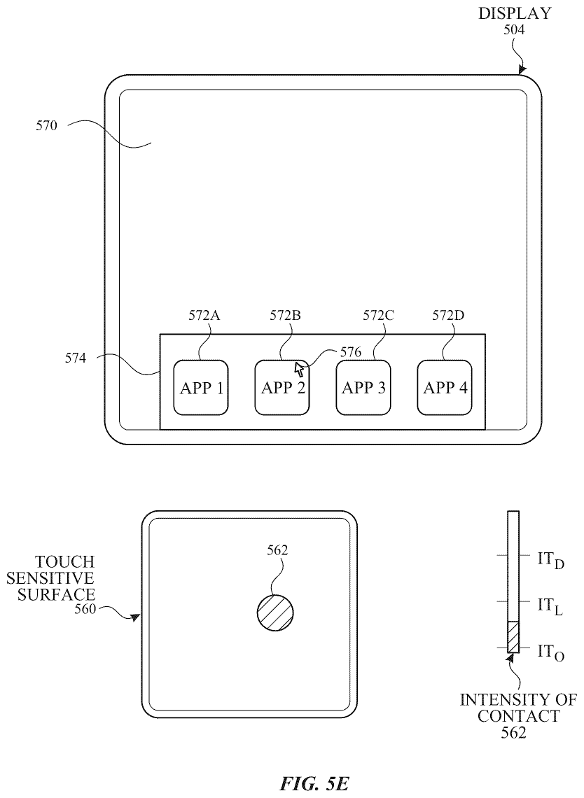

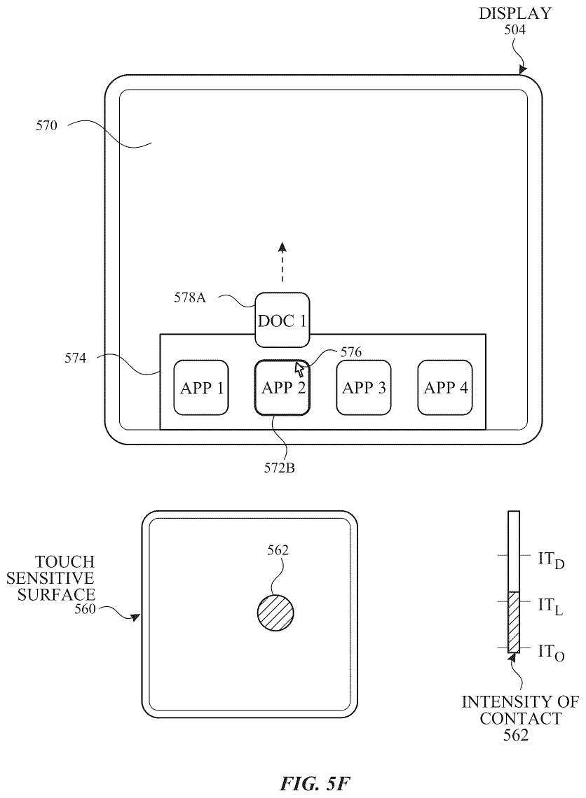

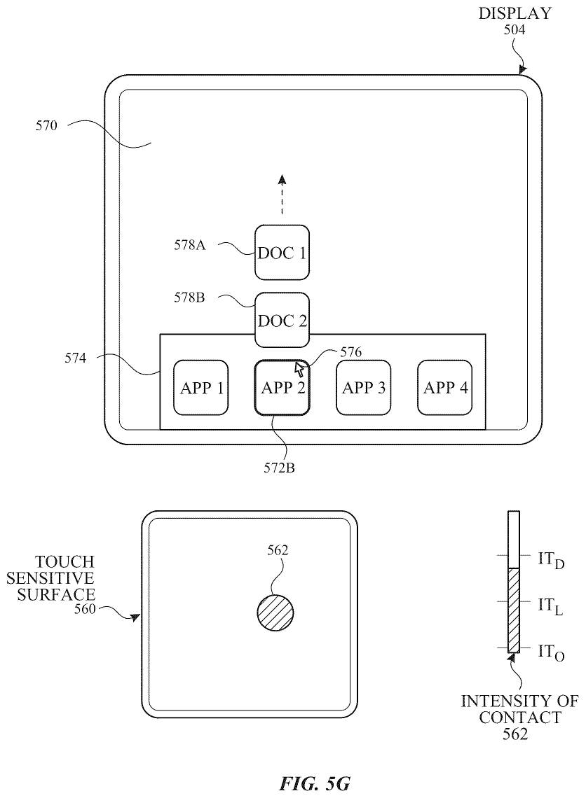

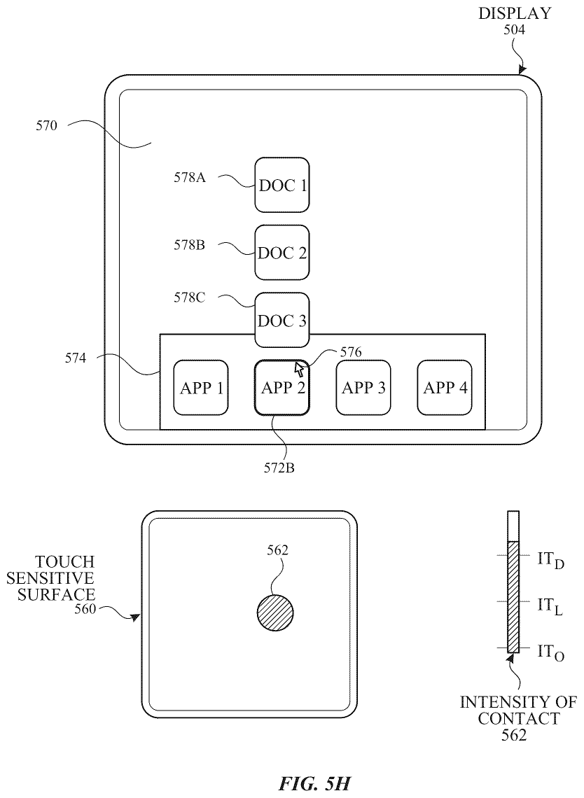

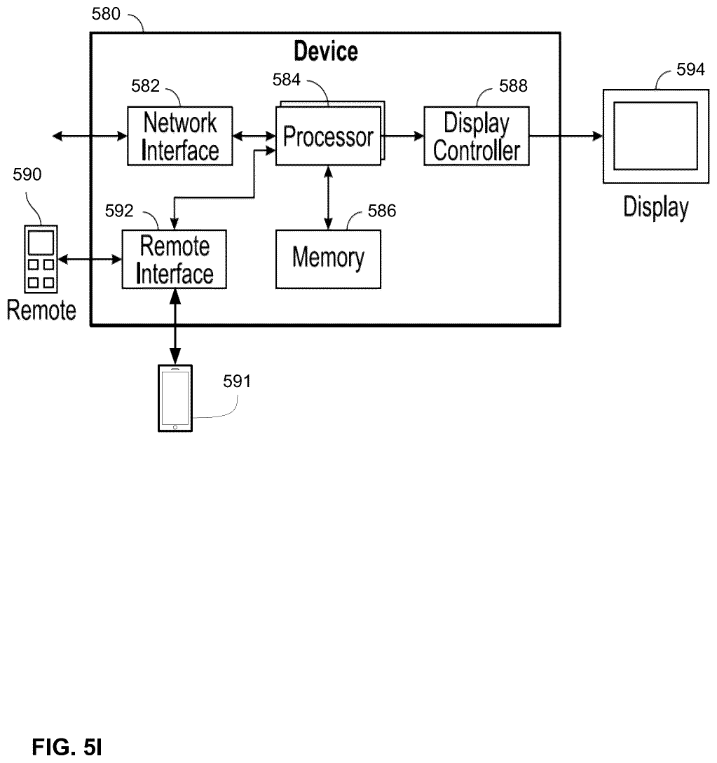

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

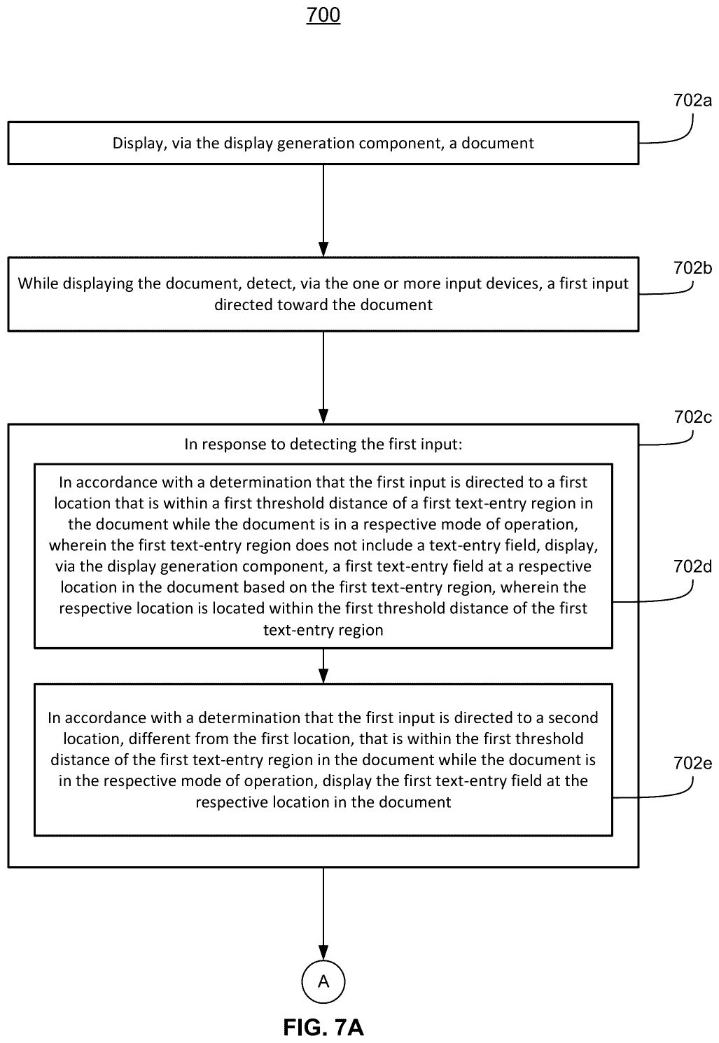

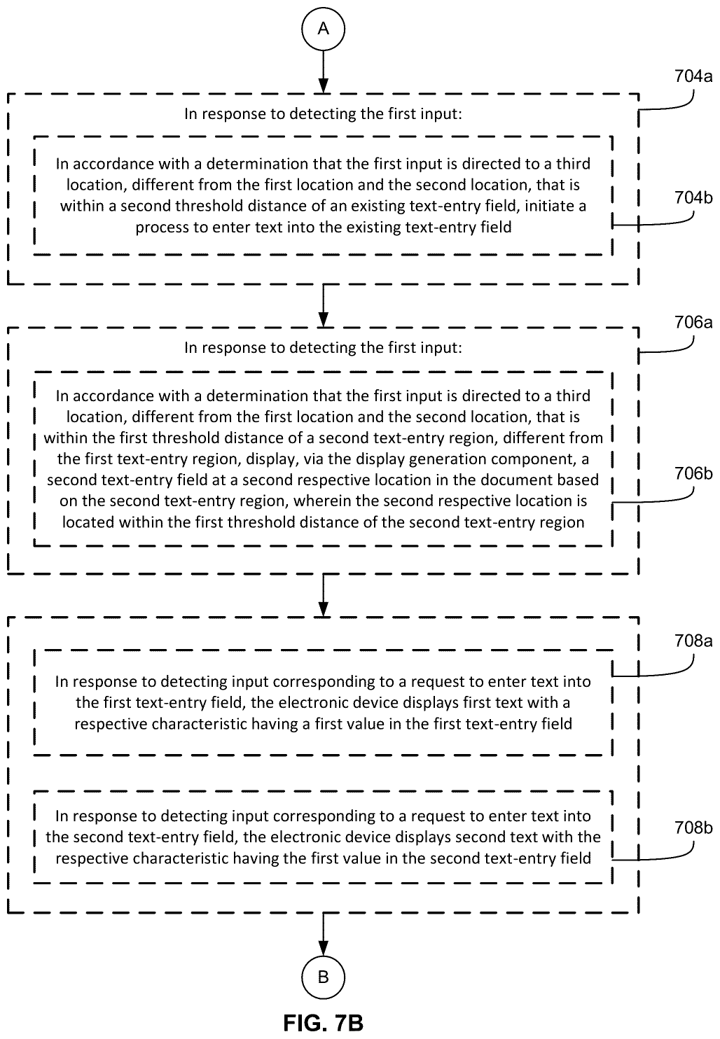

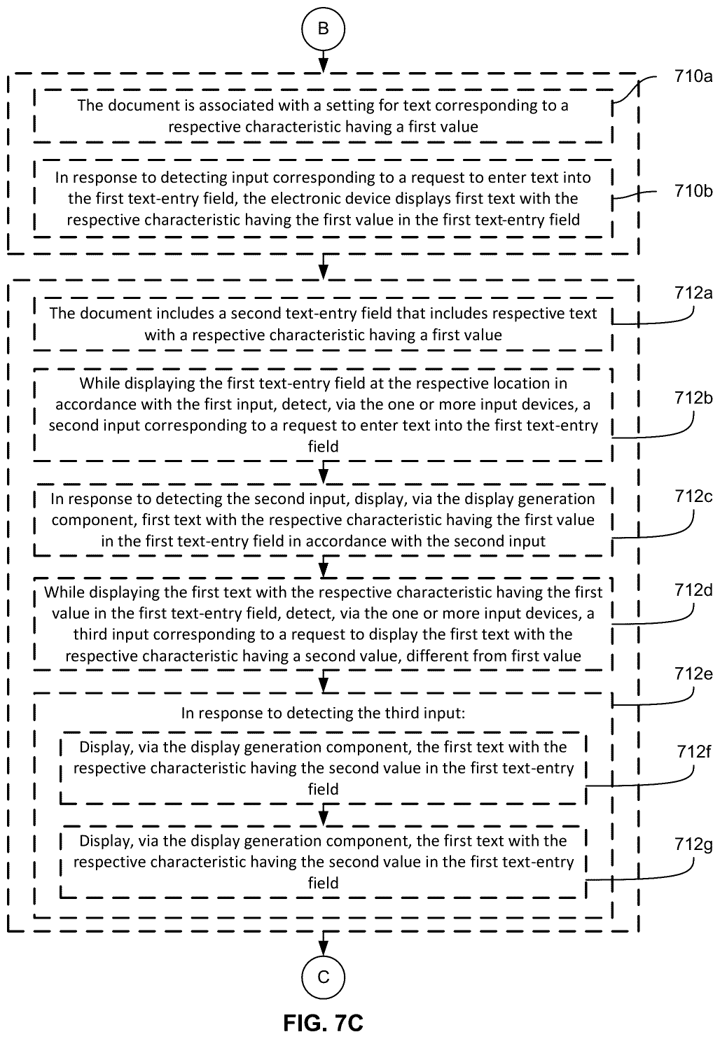

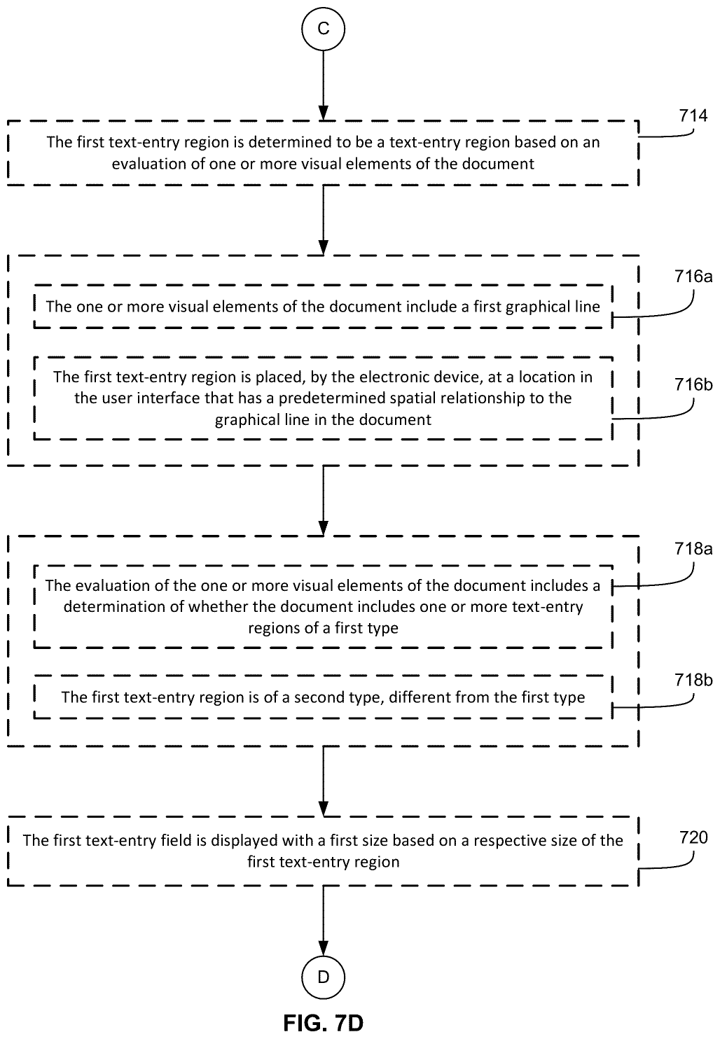

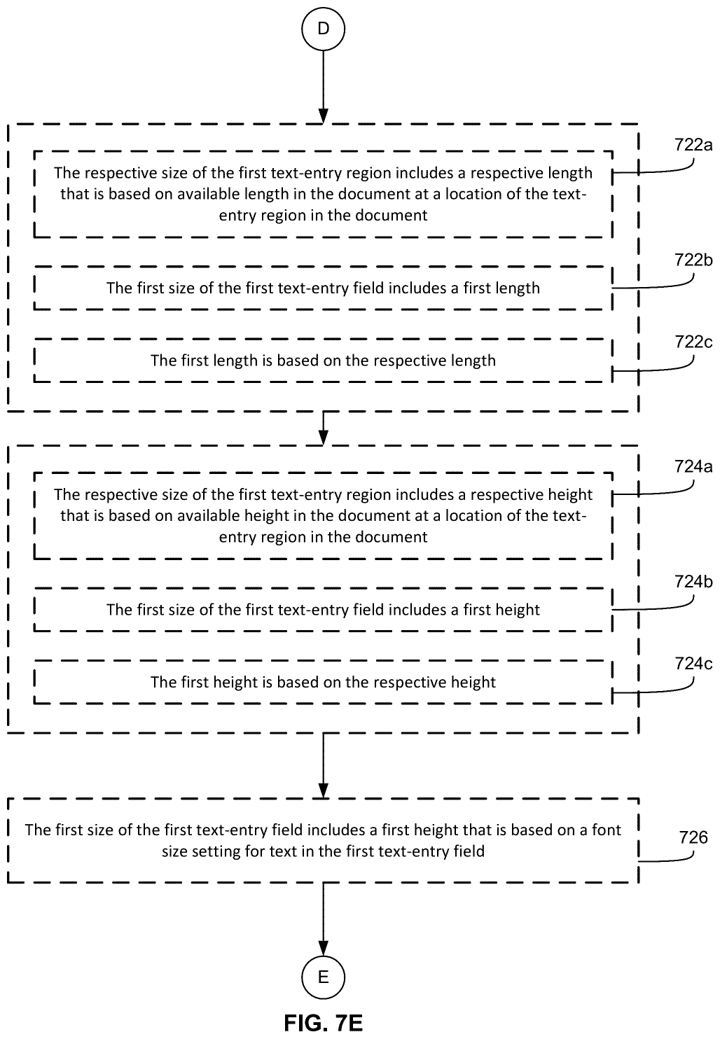

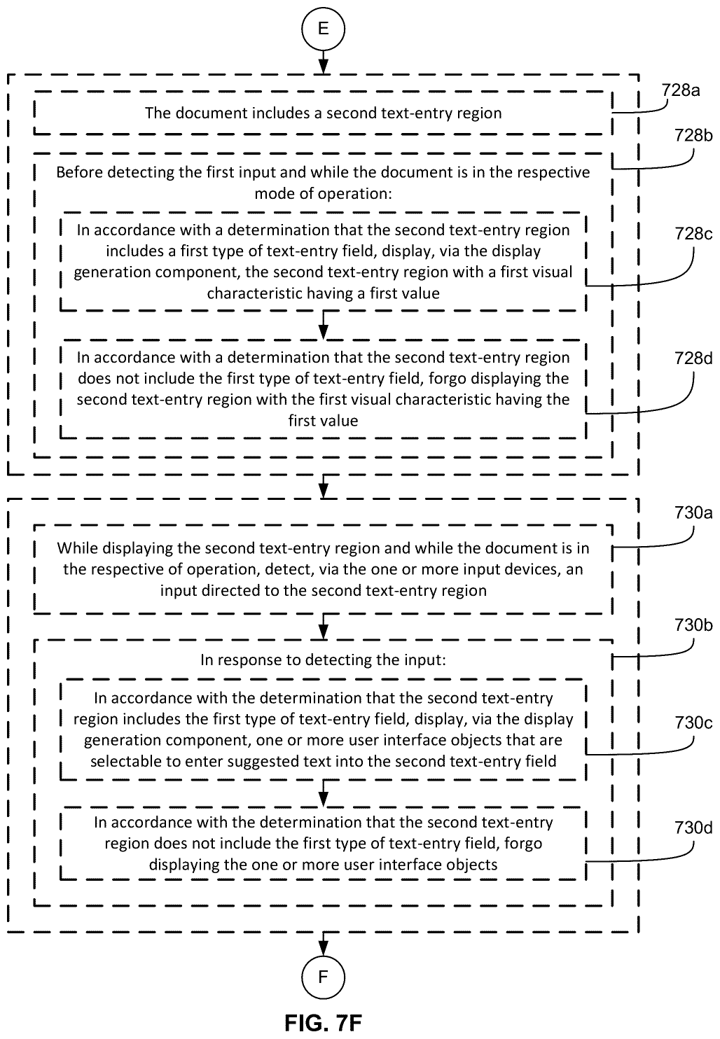

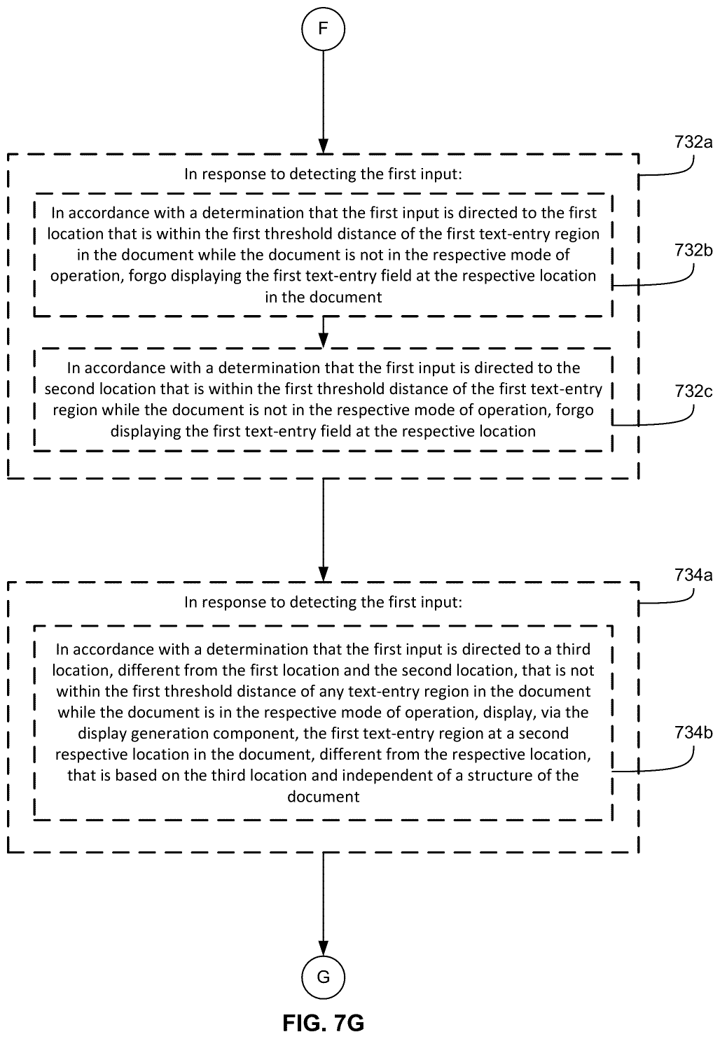

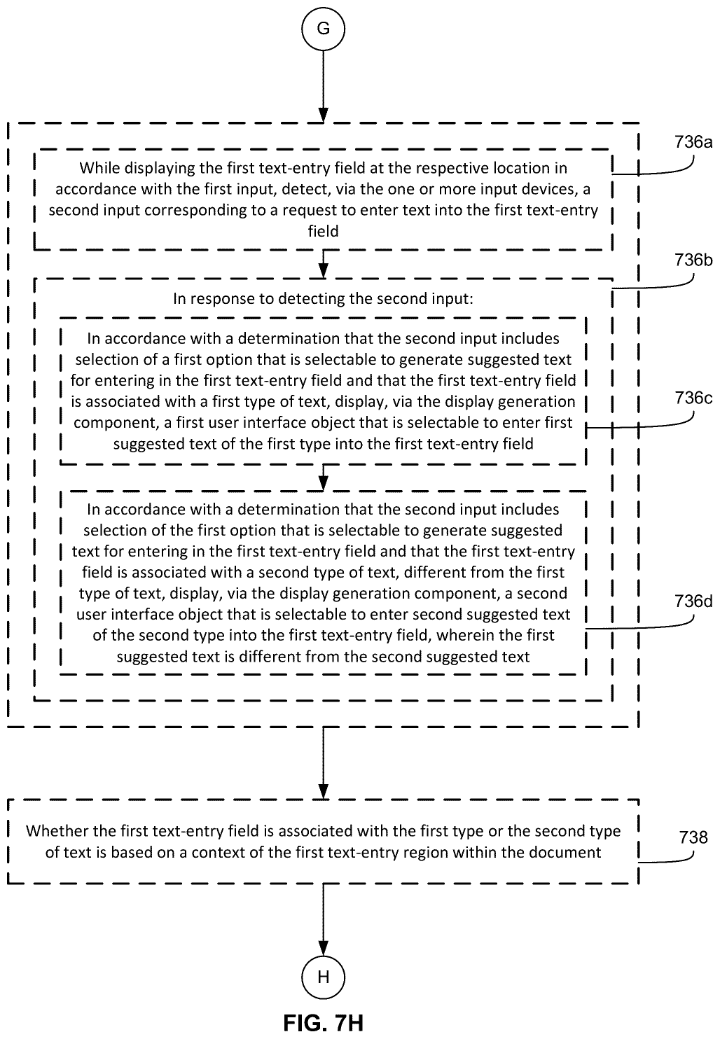

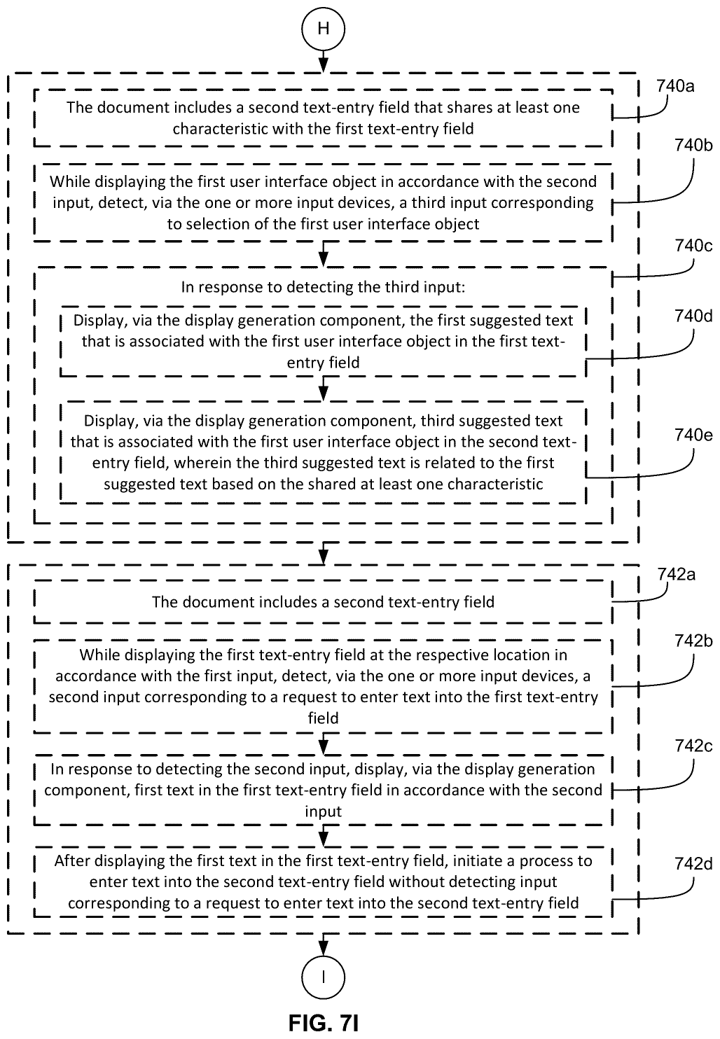

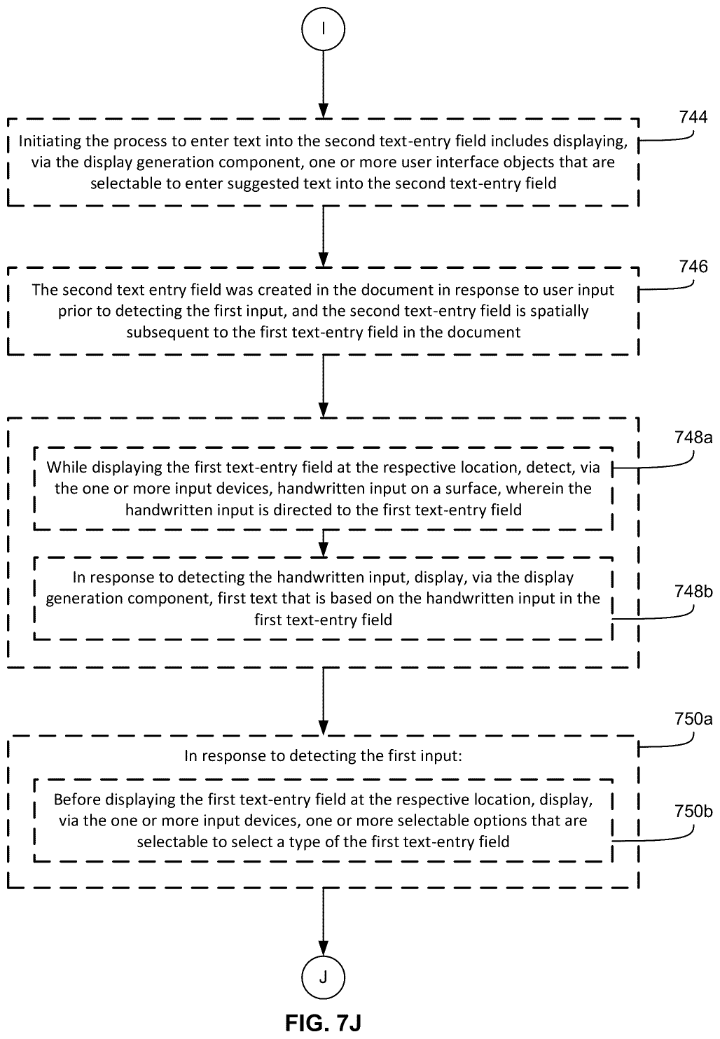

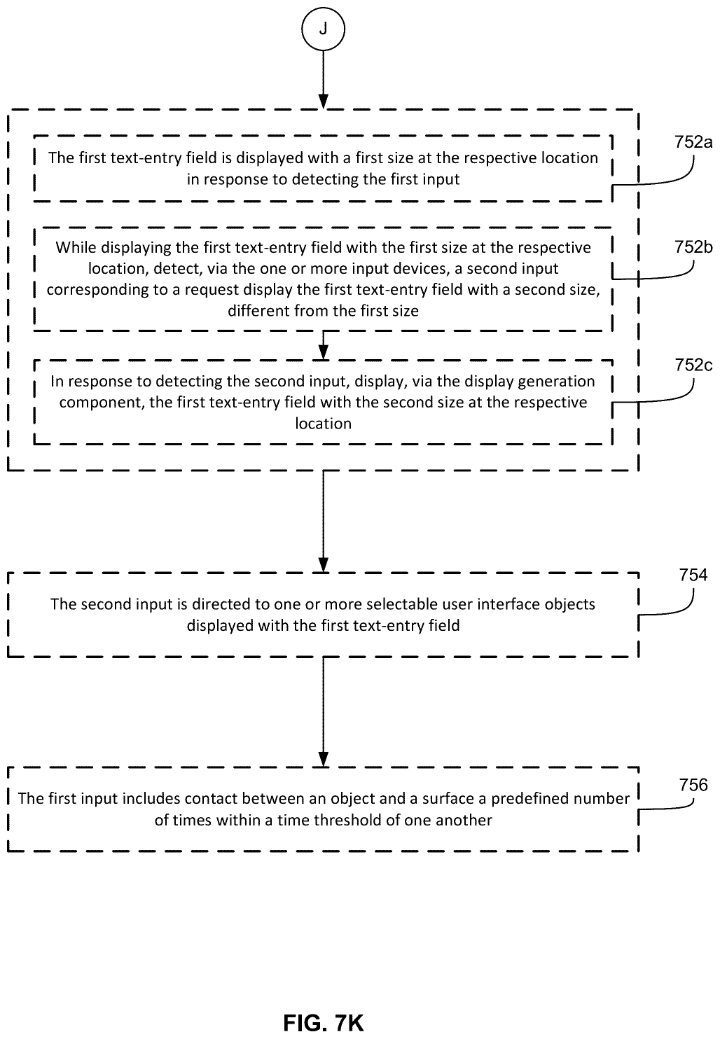

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700, 900, 1100, and/or 1300 (FIGS. 7, 9, 11, and/or 13). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT_{L}”) in FIG. 5E, to an intensity above a deep press intensity threshold (e.g., “IT_{D}”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D}”) during the gesture, reduced-scale representations 578A-578C (e.g., thumbnails) of recently opened documents for App 2 are displayed, as shown in FIGS. 5F-5I. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D}”). In some embodiments, the intensity, on which the progress of the animation is based, is the characteristic intensity of the contact. The operations described with reference to FIGS. 5E-5H can be performed using an electronic device similar or identical to device 100, 300, or 500.

FIG. 5I illustrates a block diagram of an exemplary architecture for the device 580 according to some embodiments of the disclosure. In the embodiment of FIG. 5I, media or other content is optionally received by device 580 via network interface 582, which is optionally a wireless or wired connection. The one or more processors 584 optionally execute any number of programs stored in memory 586 or storage, which optionally includes instructions to perform one or more of the methods and/or processes described herein (e.g., methods 700, 900, 1100 and/or 1300).

In some embodiments, display controller 588 causes the various user interfaces of the disclosure to be displayed on display 594. Further, input to device 580 is optionally provided by remote 590 via remote interface 592, which is optionally a wireless or a wired connection. In some embodiments, input to device 580 is provided by a multifunction device 591 (e.g., a smartphone) on which a remote control application is running that configures the multifunction device to simulate remote control functionality, as will be described in more detail below. In some embodiments, multifunction device 591 corresponds to one or more of device 100 in FIGS. 1A and 2, device 300 in FIG. 3, and device 500 in FIG. 5A. It is understood that the embodiment of FIG. 5I is not meant to limit the features of the device of the disclosure, and that other components to facilitate other features described in the disclosure are optionally included in the architecture of FIG. 5I as well. In some embodiments, device 580 optionally corresponds to one or more of multifunction device 100 in FIGS. 1A and 2, device 300 in FIG. 3, and device 500 in FIG. 5A; network interface 582 optionally corresponds to one or more of RF circuitry 108, external port 124, and peripherals interface 118 in FIGS. 1A and 2, and network communications interface 360 in FIG. 3; processor 584 optionally corresponds to one or more of processor(s) 120 in FIG. 1A and CPU(s) 310 in FIG. 3; display controller 588 optionally corresponds to one or more of display controller 156 in FIG. 1A and I/O interface 330 in FIG. 3; memory 586 optionally corresponds to one or more of memory 102 in FIG. 1A and memory 370 in FIG. 3; remote interface 592 optionally corresponds to one or more of peripherals interface 118, and I/O subsystem 106 (and/or its components) in FIG. 1A, and I/O interface 330 in FIG. 3; remote 590 optionally corresponds to and or includes one or more of speaker 111, touch-sensitive display system 112, microphone 113, optical sensor(s) 164, contact intensity sensor(s) 165, tactile output generator(s) 167, other input control devices 116, accelerometer(s) 168, proximity sensor 166, and I/O subsystem 106 in FIG. 1A, and keyboard/mouse 350, touchpad 355, tactile output generator(s) 357, and contact intensity sensor(s) 359 in FIG. 3, and touch-sensitive surface 451 in FIG. 4; and, display 594 optionally corresponds to one or more of touch-sensitive display system 112 in FIGS. 1A and 2, and display 340 in FIG. 3.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as portable multifunction device 100, device 300, or device 500.

### User Interfaces and Associated Processes

### Document Filling

Users interact with electronic devices in many different manners. In some embodiments, an electronic device presents one or more text-entry regions in a document of a user interface. The embodiments described below provide ways in which, in response to detecting user input, an electronic device facilitates entering text into the one or more text-entry regions depending on one or more characteristics of the one or more text-entry regions. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

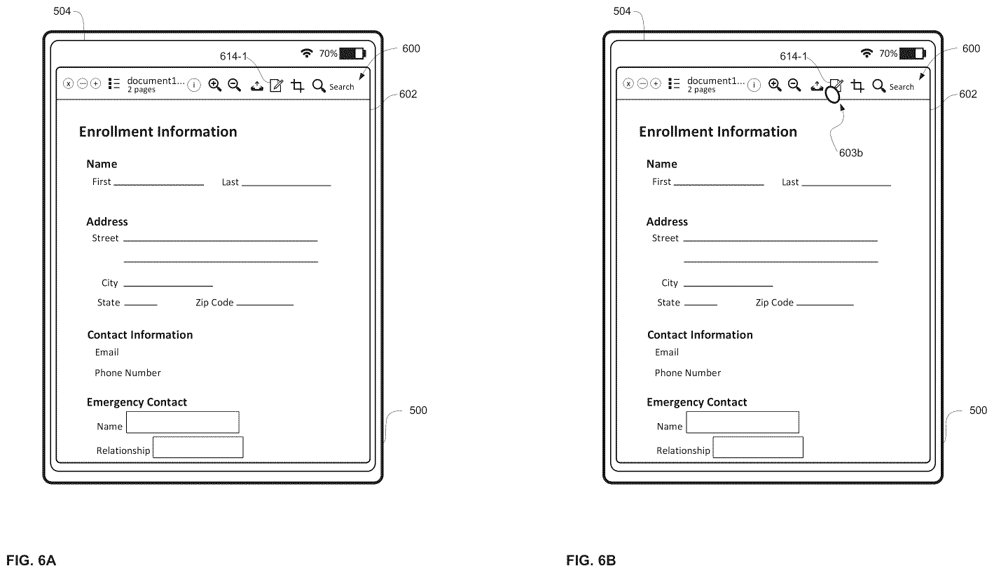

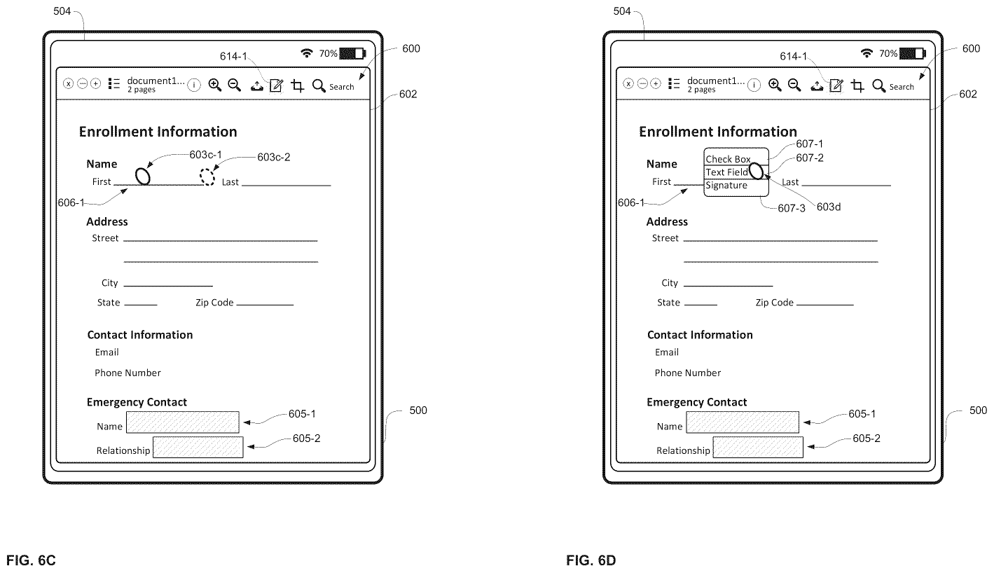

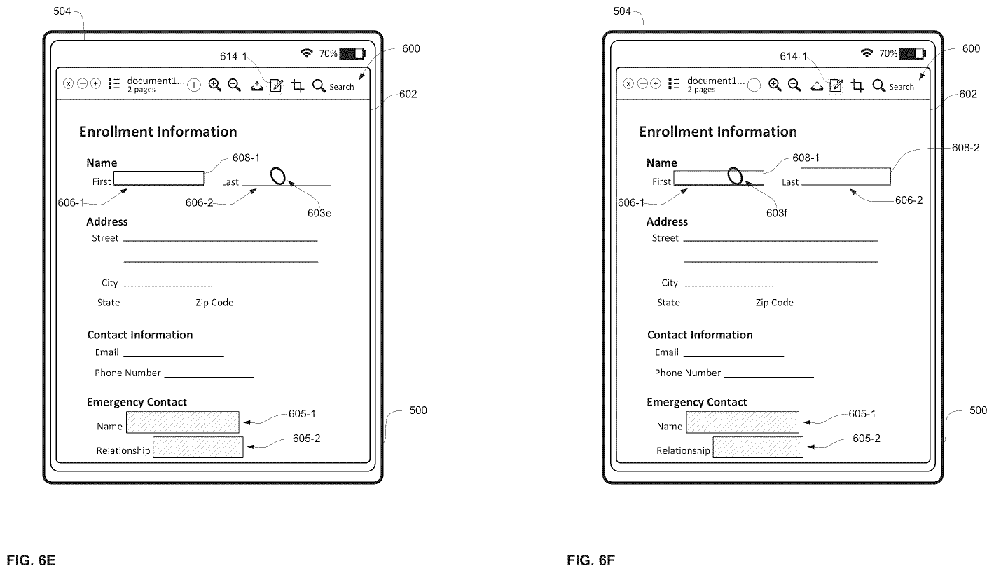

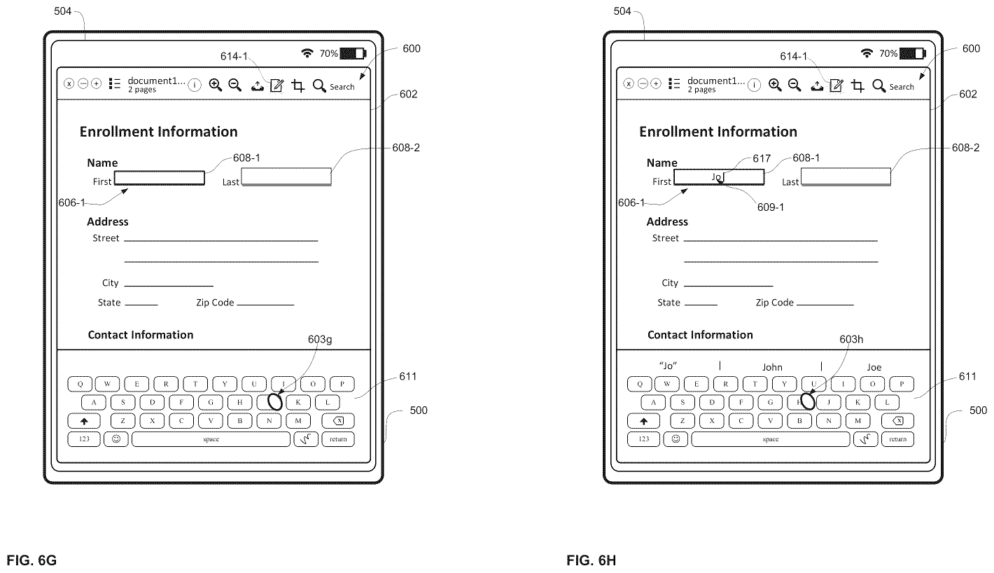

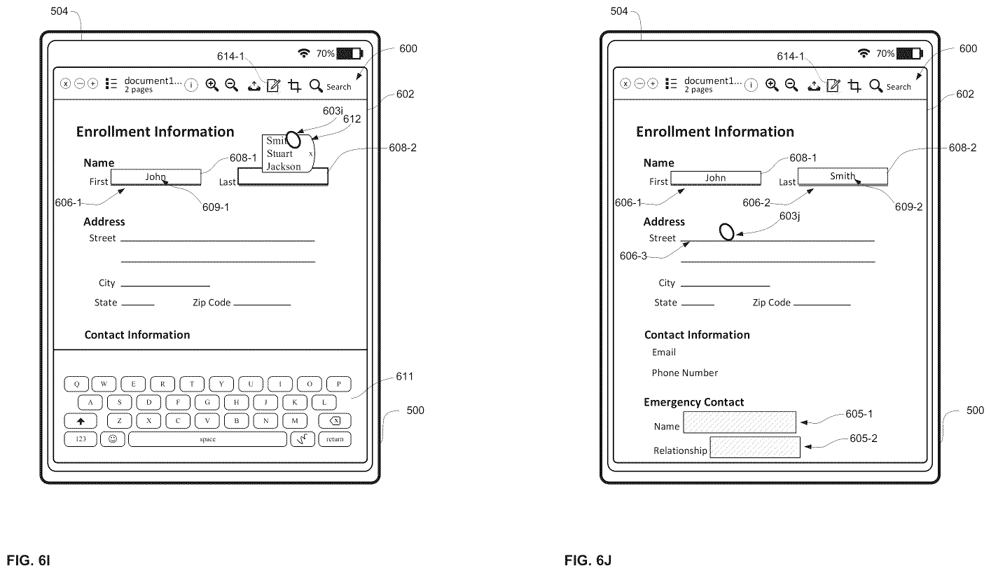

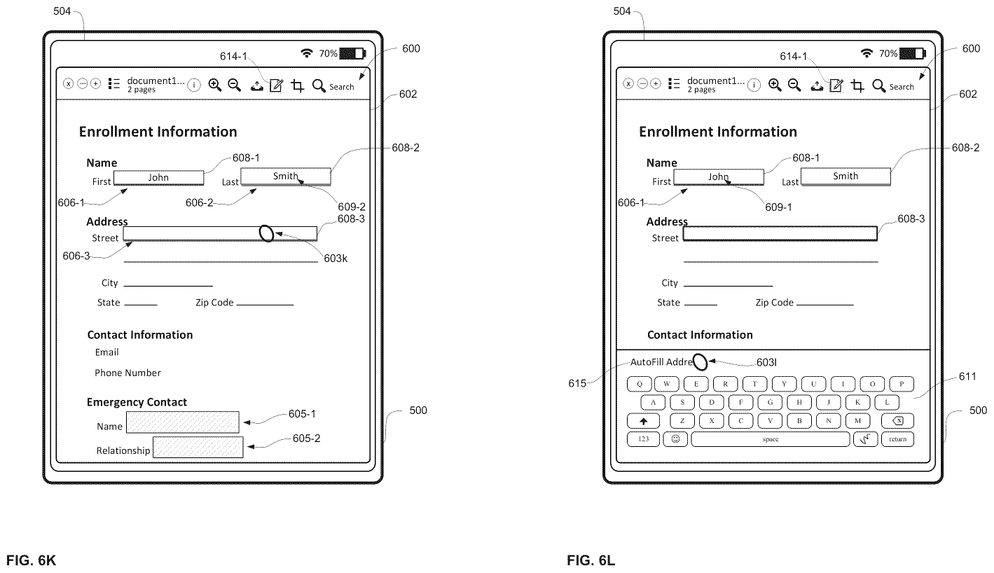

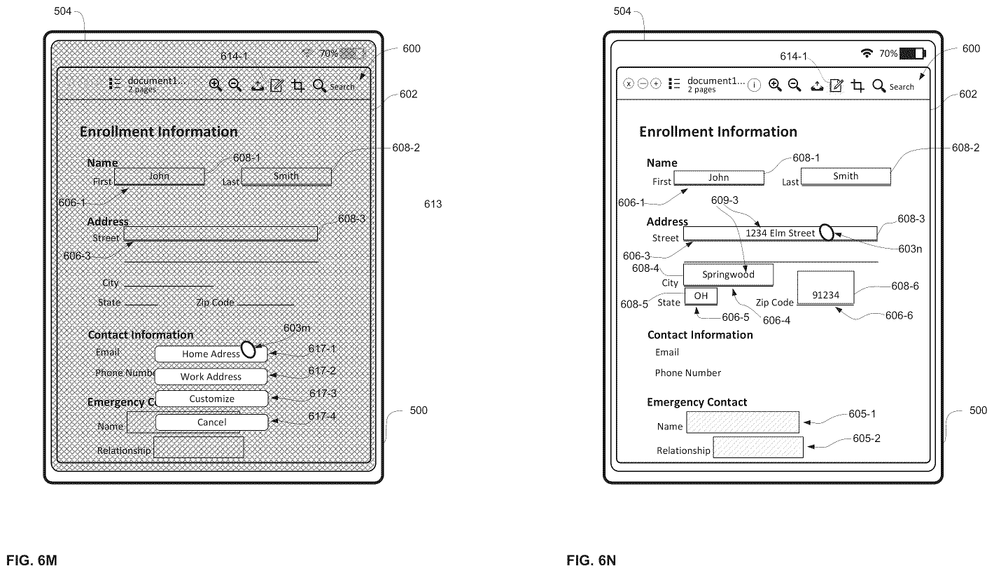

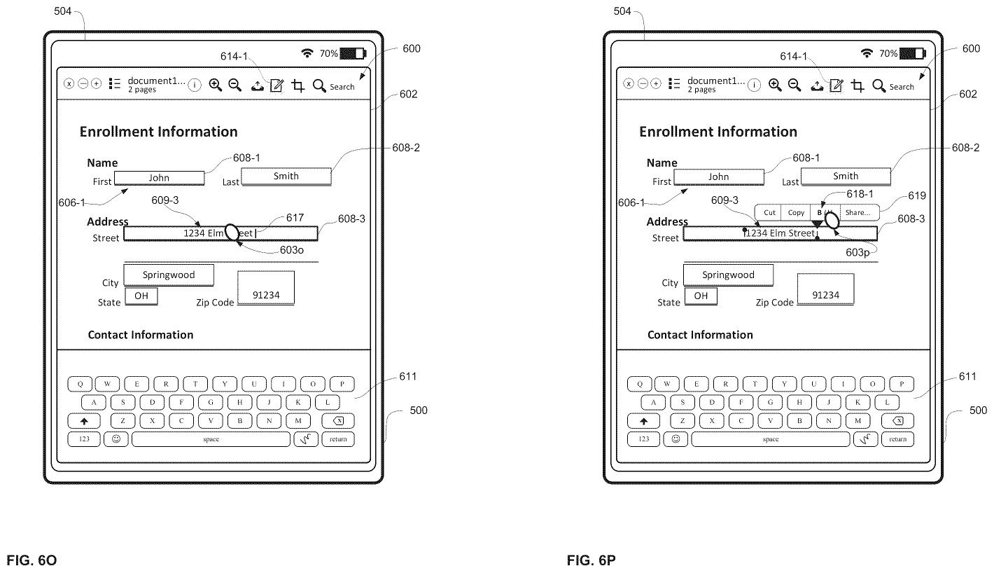

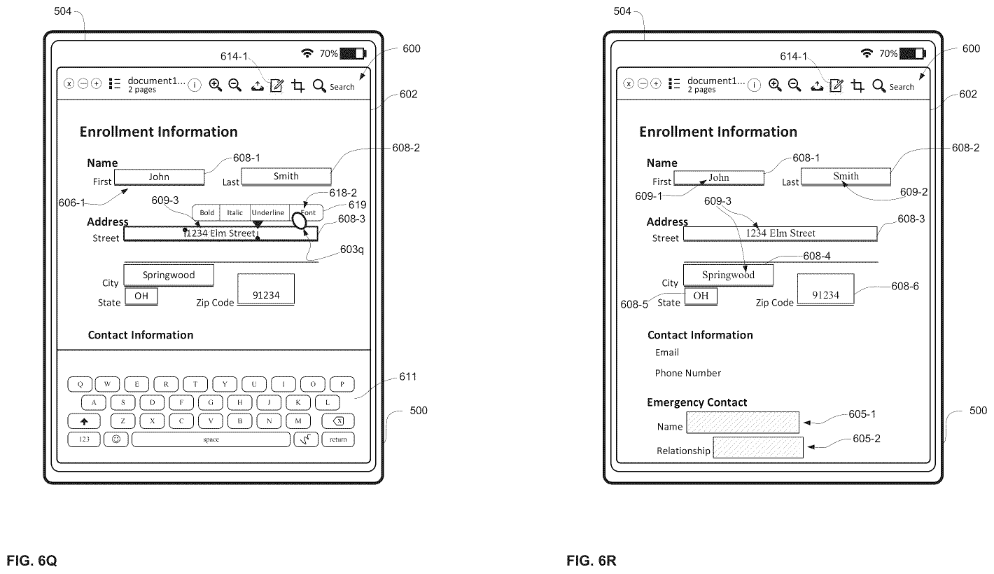

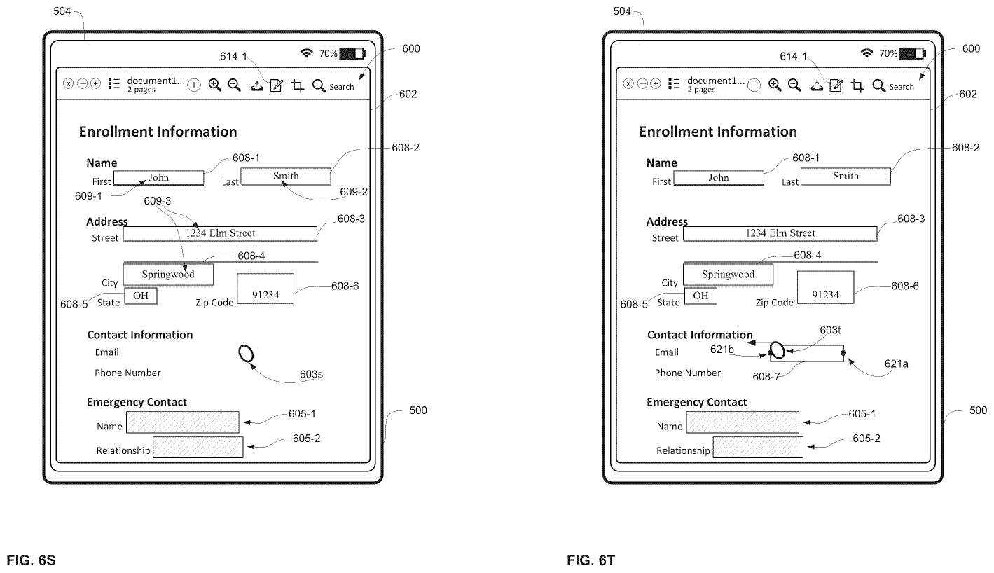

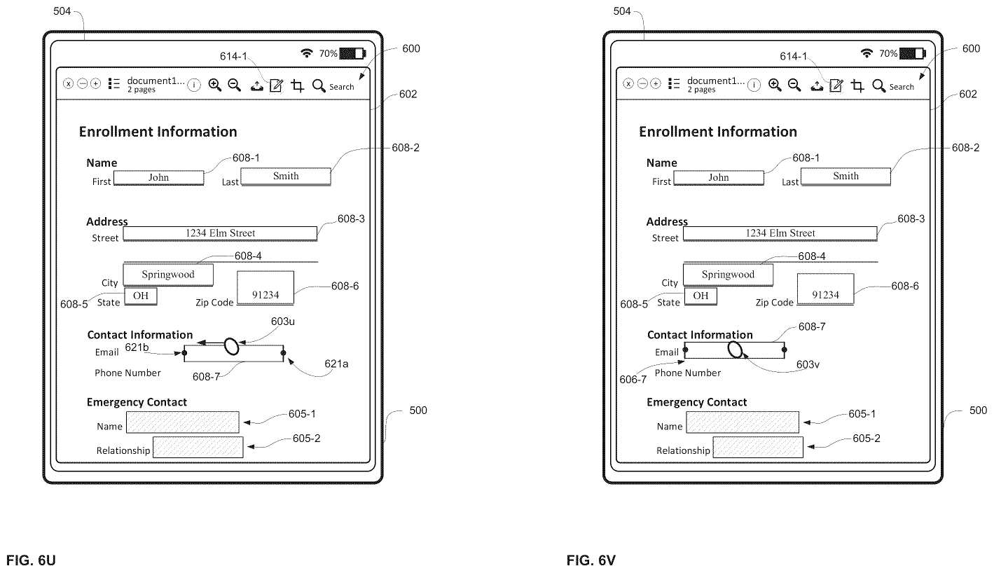

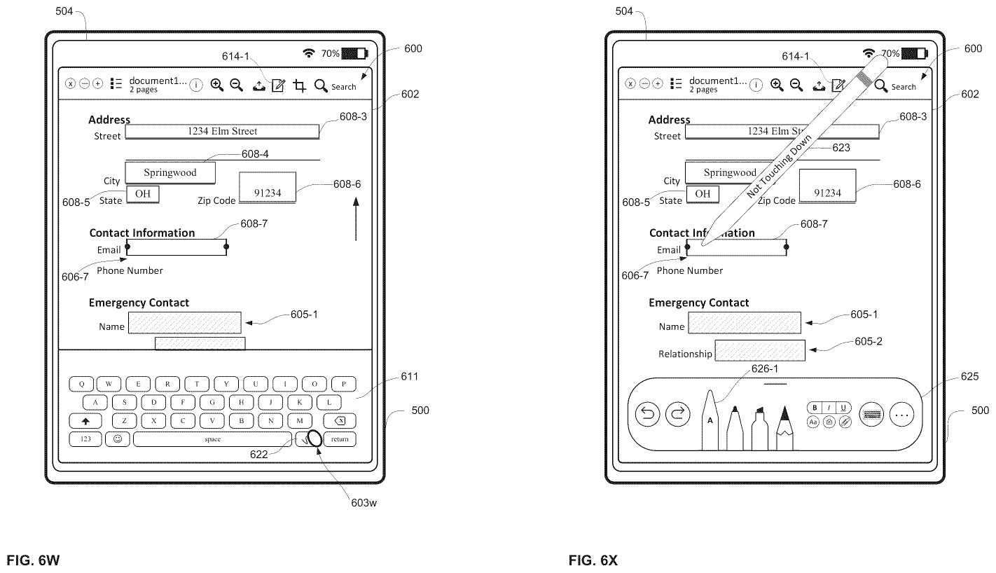

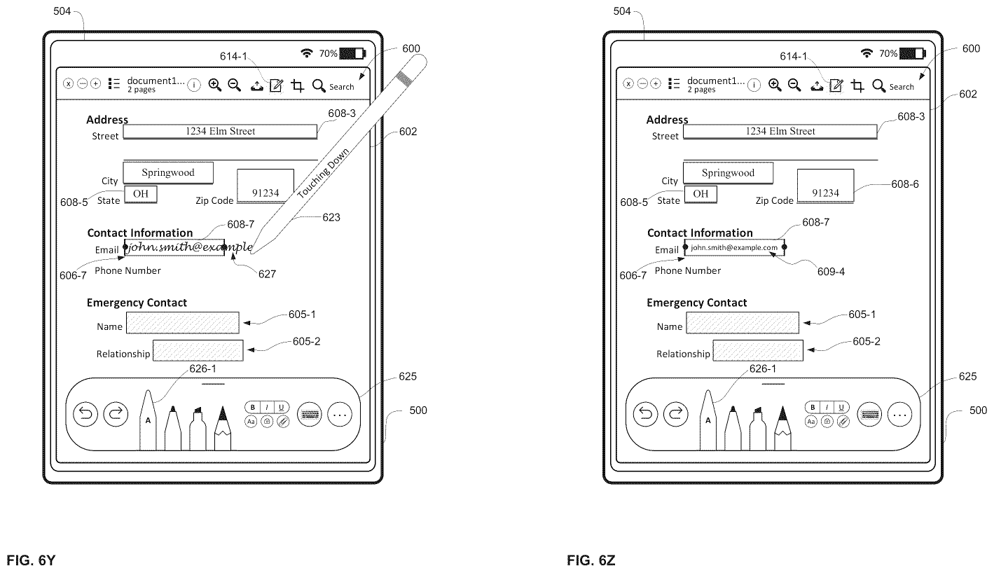

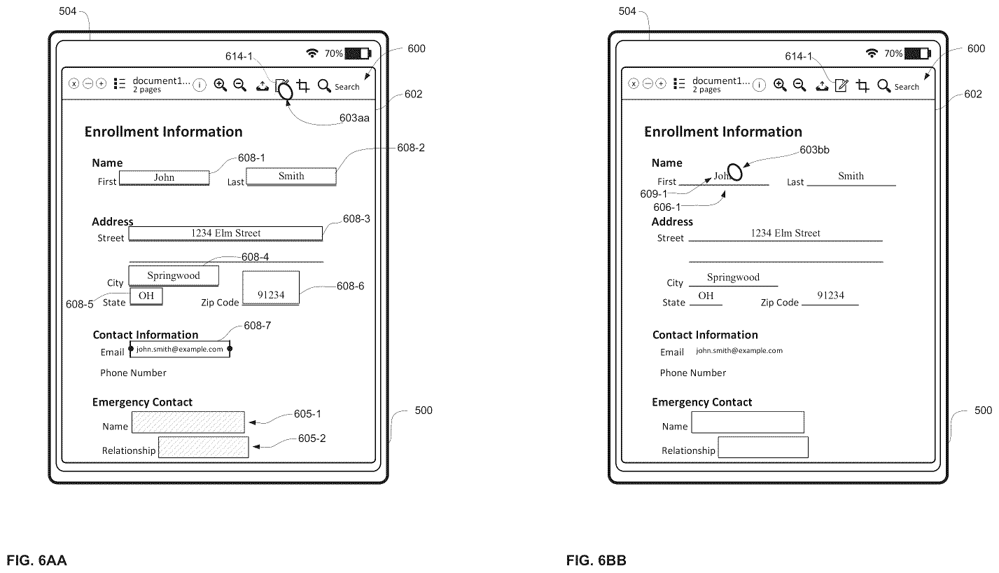

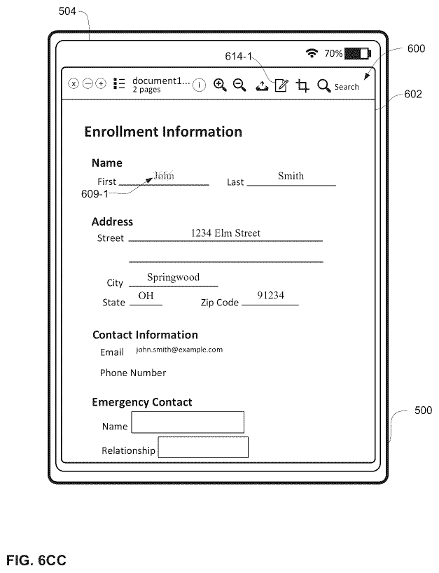

FIGS. 6A-6CC illustrate exemplary ways in which an electronic device facilitates entering text into one more text-entry regions within a document in accordance with some embodiments of the disclosure. The embodiments in these figures are used to illustrate the processes described below, including the processes described with reference to FIGS. 7A-7K.

FIGS. 6A-6CC illustrate operation of the electronic device 500 for entering text into one or more text-entry regions within a document. FIG. 6A illustrates electronic device 500 displaying user interface 600 (e.g., via a display device, via a display generation component, or via a touch screen). In some embodiments, user interface 600 is displayed via a display generation component. In some embodiments, the display generation component is a hardware component (e.g., including electrical components) capable of receiving display data and displaying a user interface. In some embodiments, examples of a display generation component include a touch screen display (such as touch screen 504), a monitor, a television, a projector, an integrated, discrete, or external display device, or any other suitable display device that is in communication with device 500.

In some embodiments, user interface 600 is a user interface of a content creation application. For example, the content creation application is a document viewing application, a notetaking application, and/or a document markup application. In some embodiments, the content creation application is an application installed on device 500.

In FIG. 6A, user interface 600 is displaying a document 602. In some embodiments, user interface 600 includes one or more selectable options associated with the document 602. For example, the user interface 600 includes one or more options for changing a viewing mode of the document 602 (e.g., adding display of bookmarks or table of contents), one or more options for changing a name/title of the document 602 (e.g., changing the name of the document from “document 1”), one or more options for increasing or decreasing a size of the document 602, one or more options for sharing the document 602 (e.g., via email, a message, or other application), one or more options for activating a content entry mode for the document 602, one or more options for changing a size of the document 602, and/or one or more options for searching within the document 602 (e.g., searching for a specified keyword in text of the document 602).

In some embodiments, as similarly mentioned above, selection of selectable option 614-1 causes the electronic device 500 to enter a content entry mode at the electronic device 500. For example, in FIG. 6A, selection of the selectable option 614-1 causes the electronic device 500 to activate a text entry mode for the document 602. In some embodiments, as described herein below, while the text entry mode is active at the electronic device 500, the electronic device 500 provides for entering text (e.g., font-based text) in the document 602 in response to detecting user input directed to the document 602. In some embodiments, as described below, the electronic device 500 provides for entering text in the document 602 by displaying a text-entry field in the document 602 based on user input directed toward the document 602.

In FIG. 6B, the electronic device 500 detects a selection input 603b directed to selectable option 614-1 in the user interface 600. For example, in FIG. 6B, the electronic device 500 detects an object (e.g., a finger of the user or an input device, such as a stylus) provide a tap or touch input on the touch screen 504 directed to the selectable option 614-1. In some embodiments, as shown in FIG. 6C, in response to detecting selection of the selectable option 614-1, the electronic device 500 activates the content entry mode (e.g., text entry mode) for the document 602. For example, in FIG. 6C, the electronic device 500 displays the selectable option 614-1 with a visual effect (e.g., highlighting, bolding, shading, and/or coloring) that indicates that the content entry mode is active for the document 602.

As mentioned above, while the content entry mode is active for the document 602, the electronic device 500 facilitates entering text in the document 602 in response to detecting user input directed to the document 602. In some embodiments, the electronic device 500 facilitates entering text into the document 602 based on a structure of the document 602. For example, in FIG. 6C, when the electronic device 500 activates the content entry mode (e.g., in response to detecting selection of the selectable option 614-1), the electronic device 500 evaluates metadata associated with the document 602 to determine whether the document 602 includes any preset text-entry regions. In some embodiments, if the electronic device 500 determines that the document 602 includes one or more preset text-entry regions, the electronic device 500 displays the one or more preset text-entry regions with a visual effect. For example, in FIG. 6C, the electronic device 500 determines that the document 602 includes preset text-entry regions 605-1 and 605-2. Accordingly, as shown in FIG. 6C, the electronic device 500 optionally highlights, shades, boldens, and/or colors the preset text-entry regions 605-1 and 605-2 indicating that input directed to the text-entry regions 605-1 and/or 605-2 causes the electronic device 500 to facilitate text entry into the text-entry regions 605-1 and/or 605-2. For example, if the electronic device 500 detects an input (e.g., a selection input, such as a tap or touch input) directed to the preset text-entry regions 605-1 and/or 605-2, the electronic device 500 displays a soft keyboard for entering text into the preset text-entry regions 605-1 and/or 605-2, and/or one or more user interface objects that are selectable to enter suggested text into the preset text-entry regions 605-1 and/or 605-2, as similarly described in more detail below.

In FIG. 6C, detects an input directed to a respective portion of the document 602. For example, as shown in FIG. 6C, the electronic device 500 detects a respective gesture (e.g., a double tap or double touch input) 603c-1 or selection input 603c-2 at a location in the document 602 that is near a location of a first text-entry region 606-1. As mentioned above, when the content entry mode is activated for the document 602, the electronic device 500 evaluates the structure of the document 602 for facilitating text entry in the document 602. In some embodiments, the electronic device 500 determines locations of text-entry regions (e.g., different from preset text-entry regions, such as preset text-entry regions 605-1 and 605-2 described above) in the document 602 based on an evaluation of one or more visual elements of the document 602. For example, the electronic device 500 determines locations in the document 602 at which to create text-entry fields configured to display text in response to user input based on graphical and/or textual elements of the document 602. In some embodiments, the electronic device 500 determines a location of the first text-entry region 606-1 in the document based on text label “First” and the graphical line following (e.g., adjacent to) the text label in the document 602.

In some embodiments, in response to detecting the respective gesture (e.g., selection input 603c-1 or 603c-2) at a location that is near the location of the first text-entry region 606-1 (e.g., within a threshold distance of, such as 0.1, 0.25, 0.5, 1, 2, 3, 4, 5, or 10 cm of the first text-entry region 606-1), the electronic device 500 displays a text-entry field at a respective location in the document 602 that is based on the location of the first text-entry region 606-1, as described below. In some embodiments, a type of text-entry field that is displayed at the respective location in the document 602 is able to be selected before the text-entry field is displayed at the respective location. For example, in FIG. 6D, in response to detecting the selection input, the electronic device 500 displays a menu element in the document 602 (e.g., before displaying a text-entry field at the respective location in the document 602). In some embodiments, the menu element includes one or more selectable options that are selectable to select the type of text-entry field to display at the respective location. For example, as shown in FIG. 6D, the menu element includes a selectable option 607-1 that is selectable to display a check mark entry field at the respective location, a selectable option 607-2 that is selectable to display a font-based text entry field at the respective location, and/or a selectable option 607-3 that is selectable to display a signature entry field at the respective location in the document 602.

In FIG. 6D, the electronic device 500 detects a selection input (e.g., a tap or touch input) 603d directed to the selectable option 607-2 in the menu element. In some embodiments, in response to detecting selection of the selectable option 607-2, the electronic device 500 displays a first text-entry field 608-1 at the respective location in the document 602 that is based on the location of the first text-entry region 606-1, as shown in FIG. 6E. For example, as shown in FIG. 6E, the electronic device 500 displays a text box that is selectable to initiate a process for entering text into the text box for display at the first text-entry region 606-1. In some embodiments, the respective location at which the first text-entry region 606-1 is displayed at least partially overlaps with the first text-entry region 606-1. For example, as shown in FIG. 6E, the electronic device 500 displays the first text-entry field 608-1 next to the text label “First” and above the graphical line in the document 602.

In some embodiments, the electronic device 500 displays the first text-entry field 608-1 with a size that is based on a size of the first text-entry region 606-1. For example, as shown in FIG. 6E, the first text-entry field 608-1 includes a first length and a first height. In some embodiments, the electronic device 500 displays the first text-entry field 608-1 with the first length and the first height based on a length and a height, respectively, associated with the first text-entry region 606-1. For example, the length of the first text-entry region 606-1 extends a length of the graphical line, and the height of the first text-entry region 606-1 includes the empty (e.g., white) space above the graphical line and below the text label “Name” in the document 602. Accordingly, as shown in FIG. 6E, the electronic device 500 optionally displays the first text-entry field 608-1 with the first height that occupies the white space between the graphical line and the text label “Name” and displays the text-entry field 608-1 with the first length that extends the length of the graphical line of the first text-entry region 606-1.

In some embodiments, the electronic device 500 displays the first text-entry field 608-1 with a size that is based on a size of the text that is able to be displayed in the first text-entry field 608-1. For example, the document 602 is associated with a font size setting that determines a size of the font in which text is displayed in the first text-entry field 608-1. In some embodiments, the first height of the first text-entry field 608-1 is based on the size of the font determined by the font size setting. For example, the first height of the first text-entry field 608-1 has a value that is greater than or equal to the size (e.g., vertical size) of the font in which text is displayed in the first text-entry field 608-1.

In FIG. 6E, while the content entry mode is active for the document 602, the electronic device 500 detects a respective gesture (e.g., a double tap or double touch input) 603e at a location that is near a second text-entry region 606-2 in the document 602. For example, in FIG. 6E, the electronic device 500 detects the double tap input at a location that is within the threshold distance described above of a location of the second text-entry region 606-2 in the document 602. As similarly described above, the second text-entry region 606-2 is determined by the electronic device 500 based on text label “Last” and the graphical line adjacent to the text label in the document 602.

In some embodiments, in response to detecting the respective gesture near the second text-entry region 606-2, the electronic device 500 displays a second text-entry field 608-2 at a second respective location that is based on the location of the second text-entry region 606-2 in the document 602, as shown in FIG. 6F. For example, as shown in FIG. 6F, the electronic device 500 displays the second text-entry field 608-2 in empty (e.g., white) space adjacent to the text label “Last” and above the graphical line in the document 602. In some embodiments, as similarly described above, the second text-entry field 608-2 is displayed at a size (e.g., a height and/or length) that is determined by the electronic device 500 based on a size of the second text-entry region 606-2.

In FIG. 6F, the electronic device 500 detects a selection input (e.g., a tap or touch input) 603f directed to the first text-entry field 608-1 in the document 602. In some embodiments, in response to detecting selection of the first text-entry field 608-1, the electronic device 500 initiates a process for entering text into the first text-entry field 608-1. For example, as shown in FIG. 6G, the electronic device 500 displays soft keyboard 611 in the user interface 600 for entering text into the first text-entry field 608-1 (e.g., via selection of one or more keys of the keyboard 611). In some embodiments, the electronic device 500 displays the first text-entry field 608-1 with a visual indication of focus (e.g., bolding, highlighting, coloring, shading) indicating that selection of one or more keys of the keyboard 611 will cause the electronic device 500 to display corresponding text in the first text-entry field 608-1.

In FIG. 6G, the electronic device 500 detects a selection input (e.g., a tap or touch input) 603g directed to one or more keys of the keyboard 611 in the user interface 600. In some embodiments, in response to detecting selection of the one or more keys of the keyboard 611, the electronic device 500 displays text 609-1 corresponding to the selected one or more keys in the first text-entry field 608-1, as shown in FIG. 6H. For example, as shown in FIG. 6H, the electronic device 500 displays the font-based text “Jo” at a location of text cursor 617 in the text-entry field 608-1. In some embodiments, the text 609-1 is displayed in a font that is determined based on a font setting associated with the document 602. For example, the text 609-1 is displayed in a font that is a predefined font, selected by the user, and/or based on a font of the text labels in the document 602 (e.g., the text label “First” and/or “Last”).

Additionally, in some embodiments, when the electronic device 500 detects the selection of the one or more keys of the keyboard 611, the electronic device 500 displays one or more user interface objects that are selectable to enter suggested text into the first text-entry field 608-1. For example, as shown in FIG. 6H, the electronic device 500 displays the one or more user interface objects above the keyboard 611 that include text labels (e.g., “Jo,” John, Joe) indicating the suggested text that will be entered into the first text-entry field 608-1 if the one or more user interface objects are selected.

In FIG. 6H, the electronic device 500 detects additional selection input (e.g., tap or touch input) directed to the keys of the keyboard 611. In some embodiments, in response to detecting selection of additional keys of the keyboard 611, the electronic device 500 updates display of the text 609-1 in the first text-entry field 608-1, as shown in FIG. 6I. For example, as shown in FIG. 6I, the electronic device 500 updates the text 609-1 to include the word “John” in accordance with the selected keys of the keyboard 611.

In some embodiments, the electronic device 500 initiates a process to enter text into the second text-entry field 608-2 in response to detecting an end of the input entering text into the first text-entry field 608-1. For example, in FIG. 6I, the electronic device 500 detects an end of the selection of the one or more keys of the keyboard 611, and/or detects selection of a respective key of the keyboard 611 (e.g., “return” key or “tab” key) that causes the electronic device 500 to move the current focus to the second text-entry field 608-2. Accordingly, as shown in FIG. 6I, the electronic device 500 displays the second text-entry field 608-2 with the visual indication of focus and maintains display of the keyboard 611 for entering text into the second text-entry field 608-2 in a similar manner as described above.

In some embodiments, the electronic device 500 initiates the process to enter text into the second text-entry field 608-2 in response to detecting the end of the input entering text into the first text-entry field 608-1 because the second text-entry field 608-2 is spatially subsequent to the first text-entry field 608-1. For example, as shown in FIG. 6I, the second text-entry field 608-2 is located to the right of the first text-entry field 608-1, which is spatially subsequent to the first text-entry field 608-1 (e.g., for a right-to-left language, including English, which is the language in which the text of the document 602 is written). In some embodiments, if the second text-entry field 608-2 were located above the first text-entry field 608-1, for example, the electronic device 500 would initiate a process to enter text into the preset text-entry region 605-1, and not the second text-entry field 608-2, because the preset text-entry region 605-1 would be spatially subsequent to the first text-entry field 608-1 in the document 602.

In some embodiments, the electronic device 500 displays one or more user interface objects 612 that are selectable to enter suggested text into the second text-entry region 608-2, as shown in FIG. 6I. For example, as shown in FIG. 6I, the electronic device 500 displays the one or more user interface objects 612 at the location of the second text-entry field 608-2 after moving the focus from the first text-entry field 608-1 to the second text-entry field 608-2. In some embodiments, the one or more user interface objects 612 include text labels (e.g., “Smith,” “Stuart,” “Jackson”) indicating the suggested text that will be entered into the second text-entry field 608-2 in response to detecting selection of the one or more user interface objects 612. In some embodiments, the suggested text is determined based on a context associated with the second text-entry region 606-2. For example, as mentioned above, the second text-entry region 606-2 includes the text label “Last” and is located next to the first text entry-region 606-1 that includes the text label “First.” Additionally, as described above, the user entered the text “John” into the first text-entry field 608-1 that is associated with the first text-entry region 606-1 in the document 602. In some embodiments, the electronic device 500 uses this context to determine the suggested text that is associated with the one or more user interface objects 612, namely last names that are commonly associated with the first name “John” and/or a known last name at the electronic device 500 (e.g., the last name of the user of the electronic device 500).

In FIG. 6I, the electronic device 500 detects a selection input (e.g., a tap or touch input) 603i directed to a first user interface object of the one or more user interface objects 612. In some embodiments, in response to detecting selection of the first user interface object, the electronic device 500 displays suggested text 609-2 corresponding to the first user interface object in the second text-entry field 608-2, as shown in FIG. 6J. For example, as shown in FIG. 6J, the electronic device 500 displays the text “Smith” corresponding to the first user interface object in the second text-entry field 608-2. In some embodiments, the electronic device 500 ceases display of the keyboard 611 and the visual indication of focus after detecting an end of the input entering text into the second text-entry field 608-2. For example, the electronic device 500 ceases display of the keyboard 611 and the visual indication of focus on the second text-entry field 608-2 in response to detecting selection of a selectable option for ceasing display of the keyboard 611 and/or detecting a swipe gesture (e.g., a downward swipe) directed to the keyboard 611.

In FIG. 6J, while the content entry mode is active and while displaying the first text-entry field 606-1 and the second text-entry field 606-2, the electronic device 500 detects a respective gesture 603j near a third text-entry region 606-3. For example, as similarly described above, the electronic device 500 detects a double tap input at a location that is within the threshold distance described above of the third text-entry region 606-3. In some embodiments, in response to detecting the respective gesture near the third text-entry region 606-3, the electronic device 500 displays a third text-entry field 608-3 at a third respective location in the document 602 that is based on the location of the third text-entry region 606-3, as shown in FIG. 6K. Additionally, as similarly described above, the electronic device 500 optionally displays the third text-entry field 608-3 with a size that is based on the size of the third text-entry region 606-3 in the document 602.

In FIG. 6K, the electronic device 500 detects a selection input (e.g., a tap or touch input) 603k directed to the third text-entry field 608-2 in the document 602. In some embodiments, as similarly described above, in response to detecting selection of the third text-entry field 608-2, the electronic device 500 initiates a process for entering text into the third text-entry field 608-2, as shown in FIG. 6L. For example, as shown in FIG. 6L, the electronic device 500 displays the keyboard 611 and displays the third text-entry field with a visual indication of focus, as similarly described above.

In some embodiments, initiating the process for entering text into the third text-entry field 608-2 includes providing for automatically entering text into one or more text-entry fields in the document 602. For example, as shown in FIG. 6L, the keyboard 611 includes a selectable option 615 that is selectable for initiating a process for automatically entering text into the third text-entry field 608-3. In FIG. 6L, the electronic device 500 detects a selection input (e.g., a tap or touch input) 6031 directed to the selectable option 615.

In some embodiments, in response to detecting selection of the selectable option 615, the electronic device 500 displays one or more selectable options that are selectable for entering automatically-generated text into one or more text-entry fields in the document 602, as shown in FIG. 6M. For example, as shown in FIG. 6M, the electronic device 500 displays selectable option 617-1 that is selectable to enter text corresponding to a home address associated with the user of the electronic device 500 in the third text-entry field 608-3, a selectable option 617-2 that is selectable to enter text corresponding to a work address associated with the user of the electronic device 500 in the third text-entry field 608-3, a selectable option 617-3 that is selectable to customize the text corresponding to addresses associated with the user, and/or a selectable option 617-4 that is selectable to navigate backward (e.g., redisplay the keyboard 611). In some embodiments, the electronic device 500 generates and displays the selectable options 617-1 and 617-2 based on a context of the third text-entry region 606-3. For example, as similarly described above, the electronic device 500 displays the selectable options 6717-1 and 617-2 based on the text labels “Address” and “Street” that are proximate to the third text-entry region 606-3. In some embodiments, the text corresponding to the home address (e.g., associated with selectable option 617-1) and/or the text corresponding to the work address (e.g., associated with selectable option 617-2) are saved in a memory of the electronic device 500 (e.g., in response to previous user action providing and subsequently saving the text). For example, the text corresponding to the home address and the text corresponding to the work address is categorized and saved by the electronic device 500 as text associated with addresses in response to user input categorizing and saving the text for future generation of address-related text via the auto-generation feature associated with selectable option 615. In some embodiments, the selectable options 617-1 and 617-2 include a preview (e.g., a portion) of the text that will be automatically entered into the third text-entry region 608-3 by the electronic device 500 in response to detecting selection of the selectable options 617-1 and 617-2.

In FIG. 6M, the electronic device 500 detects a selection input (e.g., a tap or touch input) 603m directed to selectable option 617-1. In some embodiments, in response to detecting selection of the selectable option 617-1, the electronic device 500 displays text corresponding to the selectable option 617-1 in the third text-entry field 608-3, as shown in FIG. 6N. For example, as shown in FIG. 6N, the electronic device 500 displays the text “1234 Elm Street” corresponding to a home address associated with the user of the electronic device 500.

In some embodiments, the electronic device 500 displays text corresponding to the selectable option 617-1 in multiple text-entry fields in response to detecting selection of the selectable option 617-1. For example, as shown in FIG. 6N, the electronic device 500 displays text corresponding to the home address associated with the user in the third text-entry field 608-3, a fourth text-entry field 608-4, a fifth text-entry field 608-5, and a sixth text-entry field 608-6. In some embodiments, the electronic device 500 automatically generates and displays the text-entry fields 608-4 through 608-6 in response to detecting the selection of the selectable option 617-1. For example, the electronic device 500 displays the fourth text-entry field 608-4 at a location that is based on a location of a fourth text-entry region 606-4, the fifth text-entry field 608-5 at a location that is based on a location of a fifth text-entry region 606-5, and the sixth text-entry field 608-6 at a location that is based on a location of a sixth text-entry region 606-6. As similarly described above, the electronic device 500 displays the text-entry fields 608-4 through 608-6 with respective sizes that are based on sizes of the text-entry regions 606-4 through 606-6, respectively. In some embodiments, the electronic device 500 displays the text-entry fields 608-4 through 608-6 in response to detecting input (e.g., a respective gesture, such as a double tap) at respective locations near (e.g., within the threshold distance described above of) the text-entry regions 606-4 through 606-6) in the document 602. For example, the electronic device 500 displays the text-entry fields 608-4 through 608-6 in response to detecting user input before detecting selection of the selectable option 615 in FIG. 6L.

Further, in some embodiments, a portion of the text corresponding to the home address associated with the user that is displayed in the text-entry fields 608-3 through 608-6 is determined based on a shared context of the text-entry regions 606-3 through 606-6. For example, as similarly discussed above, the electronic device 500 determines that the text-entry regions 606-3 through 606-6 collectively have a context that corresponding to addresses (e.g., based on the text label “Address” in the document 602). Accordingly, in FIG. 6N, in response to detecting selection of the selectable option 617-1, the electronic device 500 displays the text 609-3 in the third text-entry field 608-3 that corresponds to a street address of the home address associated with the user based on the text label “Street” of the third text-entry region 606-3. Additionally, the electronic device 500 displays text (e.g., “Springwood”) in the fourth text-entry field 608-4 that corresponds to a city of the home address associated with the user based on the text label “City” of the fourth text-entry region 608-5. Similarly, in FIG. 6N, the electronic device 500 displays text (e.g., “OH”) in the fifth text-entry field 608-5 that corresponds to a state of the home address associated with the user based on the text label “State” of the fifth text-entry region 606-5, and text (e.g., “91234”) in the sixth text-entry field 608-6 that corresponds to a postal code of the home address associated with the user based on the text label “Zip Code” of the sixth text-entry region 606-6.

In FIG. 6N, the electronic device 500 detects a selection input (e.g., a tap or touch input) 603n directed to the third text-entry field 608-3 while displaying the text 609-3 in the third text-entry field 608-3. In some embodiments, in response to detecting selection of the third text-entry field 608-3, the electronic device 500 initiates a process for modifying the text 609-3 in the third text-entry field 608-3, as shown in FIG. 6O. For example, as shown in FIG. 6O, the electronic device 500 redisplays the keyboard 611 and displays text cursor 617 with the text 609-3 in the third text-entry field 608-3. In FIG. 6O, the electronic device 500 detects a selection input (e.g., a triple tap or touch input) 603o directed to the text 609-3 in the third text-entry field 608-3.

In some embodiments, in response to detecting the selection of the text 609-3, the electronic device 500 selects the text 609-3 in the third text-entry field 608-3. For example, as shown in FIG. 6P, the electronic device 500 displays the text 609-3 with a visual effect (e.g., highlighting, shading, bolding, and/or coloring) that indicates that the text 609-3 is selected. Additionally, as shown in FIG. 6P, the electronic device 500 displays menu element 619 in the user interface 600. For example, in FIG. 6P, the menu element 619 includes one or more selectable options that are selectable to cause the electronic device 500 to perform one or more corresponding operations involving the selected text 609-3, such as cutting the selected text, copying the selected text, changing an appearance of the selected text, and/or sharing the selected text (e.g., in a message or email). In FIG. 6P, the electronic device 500 detects a selection input (e.g., a tap or touch input) 603p directed to selectable option 618-1 in the menu element 619.

In some embodiments, in response to detecting selection of the selectable option 618-1, the electronic device 500 initiates a process for changing the appearance of the selected text 609-3, as shown in FIG. 6Q. For example, as shown in FIG. 6Q, the electronic device 500 displays a subset of selectable options for changing the appearance of the selected text 609-3, such as bolding the selected text, italicizing the selected text, underlining the selected text, and/or changing a font associated with the selected text. In FIG. 6Q, the electronic device 500 detects a selection input (e.g., a tap or touch input) 603q directed to selectable option 618-2 in the menu element 619. In some embodiments, in response to detecting selection of the selectable option 618-2, the electronic device 500 initiates a process for changing the font associated with the selected text 609-3 in the third text-entry field 608-3. For example, the electronic device 500 displays one or more user interface elements for changing the font associated with the selected text from a first font to a second font.

In some embodiments, in response to detecting an input changing the font associated with the selected text 609-3, the electronic device 500 updates display of the text 609-3 in the third text-entry field 608-3 to have a second font (e.g., Times New Roman) in the document 602 in accordance with the input, as shown in FIG. 6R. In some embodiments, when the electronic device 500 changes the font associated with text in one text-entry field in the document 602, the electronic device 500 changes the font associated with all text in all text-entry fields in the document 602. For example, as shown in FIG. 6R, when the electronic device 500 changes the font associated with the text 609-3 in the third text-entry field 608-3, the electronic device 500 also changes the font associated with the text 609-1 in the first text-entry field 608-1, the text 609-2 in the second text-entry field 608-2, and the text in the text-entry fields 608-4 through 608-6.

In FIG. 6S, while the content entry mode is active, the electronic device 500 detects a respective gesture (e.g., a double tap or double touch input) 603s directed to the document 602. In some embodiments, the electronic device 500 detects the respective gesture 603s at a location that is not near any text-entry regions, including preset text-entry regions, in the document 602. For example, the electronic device 500 detects the respective gesture 603s at a location that is outside the threshold distance described above of the nearest text-entry regions (e.g., text-entry region 606-6 in FIG. 6N and/or text-entry region 605-1).

In some embodiments, in response to detecting the respective gesture 603s, the electronic device 500 displays a text-entry field 608-7 at a location in the document 602 that is based on the location at which the respective gesture 603s is detected, as shown in FIG. 6T. For example, in FIG. 6T, a center point of the text-entry field 608-7 is displayed at the location in the document 602 at which the respective gesture 603s is detected. In some embodiments, the electronic device 500 displays the text-entry field 608-7 with a predefined size in the document 602. For example, in FIG. 6T, because the text-entry field 608-7 is not detected near any text-entry regions in the document 602, the electronic device 500 displays the text-entry field 608-7 with a default size (e.g., and not based on a size of any of the text-entry regions in the document 602, as similarly described above).

In some embodiments, the size of the text-entry field 608-7 is able to be changed in the document 602 in response to user input. For example, as shown in FIG. 6T, the electronic device 500 displays the text-entry field 608-7 with one or more resizing handles 621. As shown in FIG. 6T, the text-entry field 608-7 is optionally displayed with a first resizing handle 621a (e.g., on a right end of the text-entry field 608-7) and a second resizing handle 621b (e.g., on a left end of the text-entry field 608-7). In some embodiments, the one or more resizing handles are selectable to initiate a process for changing the size of the text-entry field 608-7 in the document 602.

In some embodiments, the one or more resizing handles 621 are displayed with a text-entry field depending on a type of the text-entry field in the document 602. For example, the electronic device 500 displays the first resizing handle 621a and the second resizing handle 621b for user-created text-entry fields, such as text-entry fields 608-1 through 608-7, and not for preset text-entry regions, such as text-entry regions 605-1 and 605-2. In FIG. 6T, the electronic device 500 detects a selection input (e.g., a tap and hold) 603t directed to the second resizing handle 621b, followed by movement of the second resizing handle 621b in a leftward direction in the user interface 600.

In some embodiments, in response to detecting the input directed to the second resizing handle 621b, the electronic device 500 changes the size of the text-entry field 608-7 in accordance with the movement of the input, as shown in FIG. 6U. For example, as shown in FIG. 6U, the electronic device 500 increases the size (e.g., the length) of the text-entry field 608-7 in the leftward direction and by a respective amount that is based on the movement of the input 603t. In some embodiments, the text-entry field 608-7 is able to be moved within the document 602 in response to user input directed to the text-entry field 608-7. For example, in FIG. 6U, the electronic device 500 detects a selection input (e.g., a tap and hold) 603u directed to a portion of the text-entry field 608-7, followed by movement of the portion of the text-entry field 608-7 in the leftward direction in the user interface 600.

In some embodiments, in response to detecting the input directed to the text-entry field 608-7, the electronic device 500 moves the text-entry field 608-7 to location 606-7 in the document 602 in accordance with the movement of the input, as shown in FIG. 6V. For example, as shown in FIG. 6V, the electronic device 500 moves the text-entry field 608-7 in the leftward direction and by a respective amount that is based on the movement of the input 603u. in FIG. 6V, the electronic device 500 detects a selection input (e.g., a tap or touch input) 603v directed to the text-entry field 608-7 in the document 602.

In some embodiments, in response to detecting selection of the text-entry field 608-7, the electronic device 500 initiates a process for entering text into the text-entry field 608-7, as shown in FIG. 6W. For example, as shown in FIG. 6W, the electronic device 500 shifts the document 602 upward in the user interface 600 and displays the keyboard 611. In some embodiments, the keyboard 611 includes a selectable option 622 that is selectable to display a content entry palette in the user interface 600 for providing handwritten input in the document 602. In FIG. 6W, the electronic device 500 detects a selection input (e.g., a tap or touch input) 603w directed to the selectable option 622 in the keyboard 611.

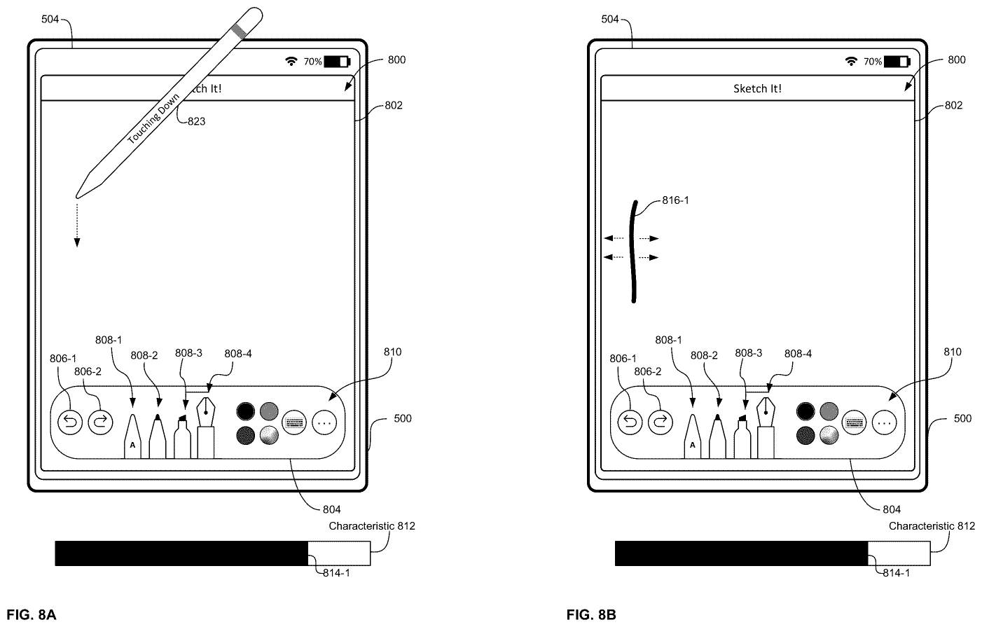

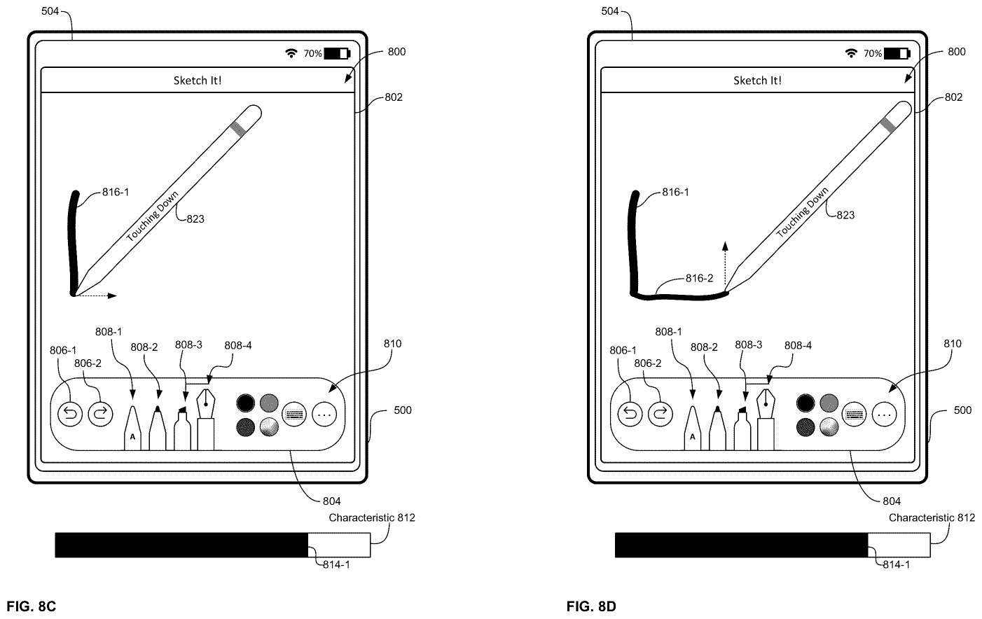

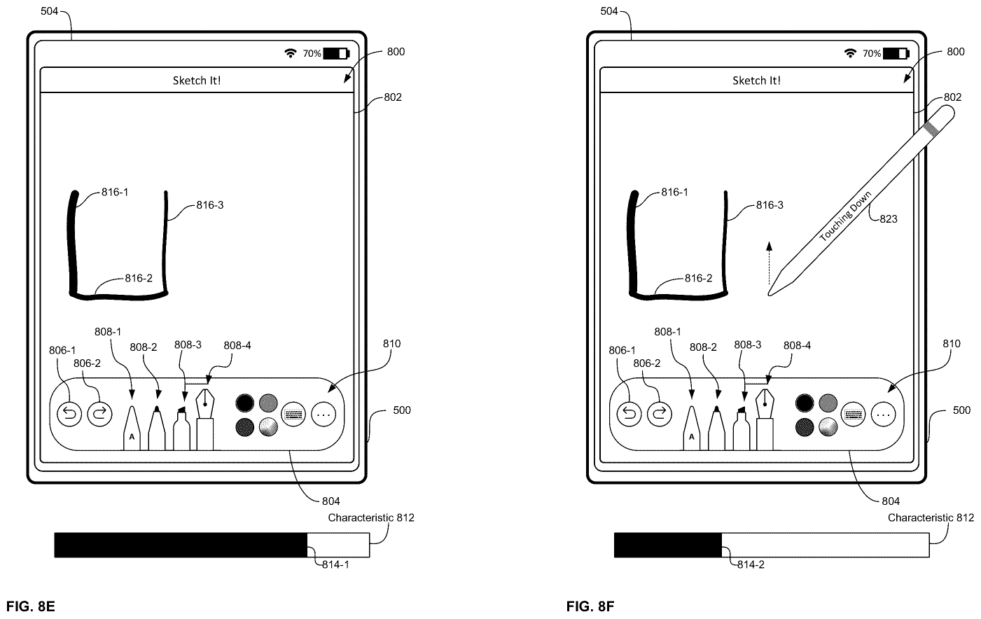

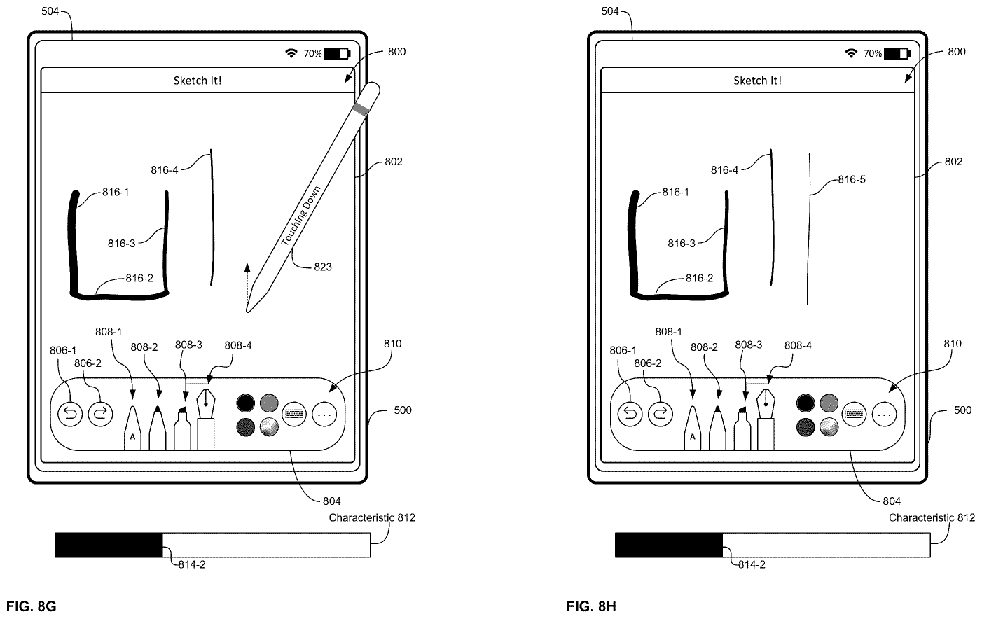

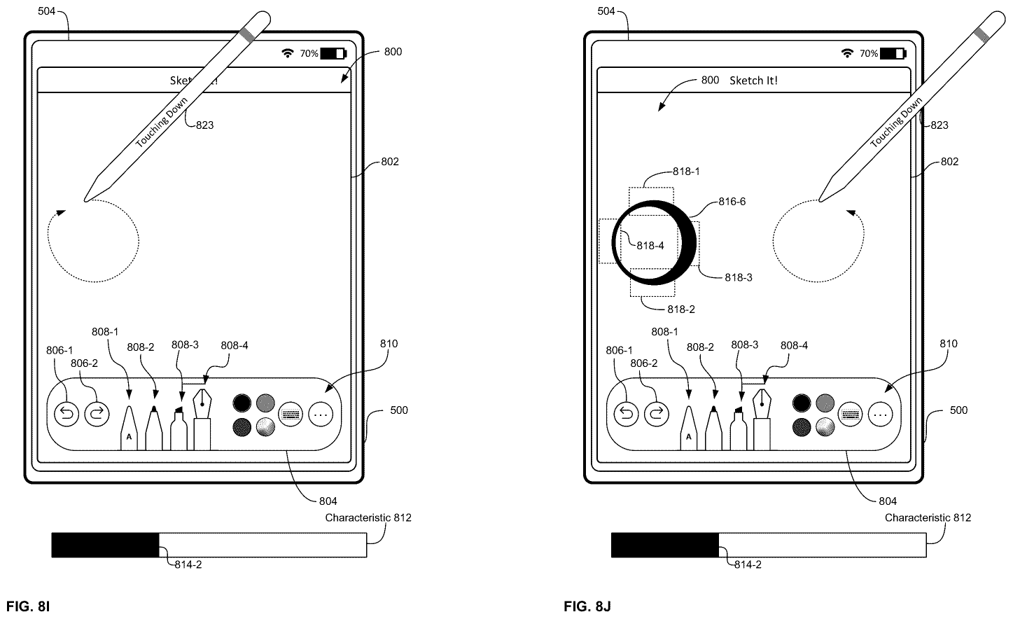

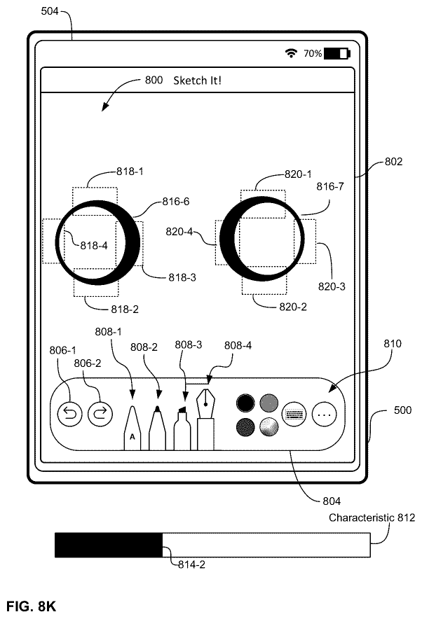

In some embodiments, in response to detecting selection of the selectable option 622, the electronic device 500 displays content entry palette 625 in the user interface 600, as shown in FIG. 6X. In some embodiments, content entry palette 625 is a user interface element that includes one or more selectable options associated with content in the user interface 600. For example, content entry palette 625 includes options for changing a color of content in the content-entry region (e.g., changing the color of existing content or changing the content of future content inserted by the user), options for changing the font of text in the content-entry region (e.g., changing the font of existing text or changing the font of future text inserted by the user), options for attaching or inserting rich objects (e.g., files, images, web-based links), options for selecting the content-entry tool, and/or options for displaying a soft keyboard for inserting font-based text in the content-entry region. In some embodiments, content entry palette 625 corresponds to menu 804 described below with reference to the FIG. 8 series.

In FIG. 6X, text entry tool 626-1 is currently active (e.g., as shown by the representation of text entry tool 626-1 displayed higher than the other entry tools in the content entry palette 625). In some embodiments, while the text entry tool 626-1 is selected, the electronic device 500 activates in a text entry mode in which handwritten inputs (e.g., corresponding to handwritten text) detected by the electronic device 500 are converted to font-based text in the user interface 600. As mentioned above, in some embodiments, the user interface 600 is configured to receive handwritten input (e.g., a drawing and/or handwriting input via a stylus device, such as stylus 623) and display a representation of the handwritten input (e.g., if drawing and/or handwritten input is provided).

In FIG. 6Y, the electronic device 500 has detected a contact with touch screen 504 provided by the stylus 623 (e.g., controlled by the user of the electronic device 500) while the text entry tool 626-1 is active. While the contact is maintained with touch screen 504, the electronic device 500 detects handwriting movement by the stylus 623. In some embodiments, in response to detecting the handwriting movement, the electronic device 500 displays a representation of the handwritten input 627 in the user interface 600, as shown in FIG. 6Y. In some embodiments, a representation of the handwritten input is displayed while the input is being received. In FIG. 6Y, the representation of the handwritten input 627 includes the handwritten text “john.smith@example.” in accordance with the handwriting movement.

In FIG. 6Z, the electronic device 500 has detected an end of the handwritten input provided by the stylus 623. For example, as shown in FIG. 6Z, after detecting the handwriting movement (e.g., corresponding to handwritten text “john.smith@example.com”), the electronic device 500 detects lift-off of the stylus 623 from the touch screen 504. In some embodiments, as shown in FIG. 6Z, in response to detecting the end of the handwritten input, the electronic device 500 converts the representation of handwritten input 627 to font-based text 609-4. For example, as shown in FIG. 6Z, the electronic device 500 displays the text 609-4 in the text-entry field 608-7 in the document 602. In some embodiments, the electronic device 500 displays the text 609-4 with a size that is based on the size of the text-entry field 608-7, as similarly described above. Additionally, as similarly described above, the electronic device 500 optionally displays the text 609-4 using a font that is based on a (e.g., selected or predetermined) font setting associated with the document 602.

In FIG. 6AA, the electronic device 500 detects a selection input (e.g., a tap or touch input) 603aa directed to the selectable option 614-1 in the user interface 600 while the content entry mode is still active for the document 602. As mentioned above, the selectable option 614-1 is selectable to activate the content entry mode (e.g., text entry mode) for the document 602 at the electronic device 500. In some embodiments, in response to detecting selection of the selectable option 614-1 while the content entry mode is active, the electronic device 500 deactivates the content entry mode at the electronic device 500. For example, as shown in FIG. 6BB, the electronic device 500 no longer displays the selectable option 614-1 with the visual effect (e.g., highlighting, shading, bolding, and/or coloring) in the user interface 600. Additionally, in some embodiments, the electronic device 500 ceases display of the text-entry fields 608-1 through 608-7 in the document 602, as shown in FIG. 6BB. Further, as shown in FIG. 6BB, the electronic device 500 optionally maintains display of the text entered into the document 602 using the text-entry fields 608-1 through 608-7.

In FIG. 6BB, the electronic device 500 detects a respective gesture (e.g., a double tap or double touch input) 603bb directed to the document 602 while the content entry mode is not active for the document 602. For example, as shown in FIG. 6BB, the electronic device 500 detects the respective gesture 603bb at a location that is near (e.g., within the threshold distance described above of) the text-entry region 606-1 while the content entry mode is not active. As shown in FIG. 6BB, the location at which the respective gesture 603bb is detected corresponds to a location of the text 609-1 in the document 602.

In some embodiments, in response to detecting the respective gesture, the electronic device 500 selects the text 609-1 in the document 602, as shown in FIG. 6CC. For example, as shown in FIG. 6CC, the electronic device 500 displays the text 609-1 with a visual effect (e.g., highlighting, shading, bolding, and/or coloring) that indicates the text 609-1 is selected. In some embodiments, the electronic device 500 selects the text 609-1 in response to detecting the respective gesture because the content entry mode is not active for the document 602. For example, as previously described above, if the respective gesture was detected while the content entry mode is active, the electronic device 500 would initiate a process for modifying the text 609-1 (e.g., editing the text, adding additional text, changing an appearance of the text, and/or deleting the text) because the text 609-1 would still be displayed in the text-entry field 608-1 (e.g., in FIG. 6AA).

FIGS. 7A-7K is a flow diagram illustrating a method 700 of facilitating entering text into one more text-entry regions within a document in accordance with some embodiments of the disclosure. The method 700 is optionally performed at an electronic device such as device 100, device 300, device 500 as described above with reference to FIGS. 1A-1B, 2-3, 4A-4B and 5A-5H. Some operations in method 700 are, optionally combined and/or order of some operations is, optionally, changed.

As described below, the method 700 provides ways in which an electronic device enters text into one more text-entry regions within a document in accordance with some embodiments of the disclosure. The method reduces the cognitive burden on a user when interaction with a user interface of the device of the disclosure, thereby creating a more efficient human-machine interface. For battery-operated electronic devices, increasing the efficiency of the user's interaction with the user interface conserves power and increases the time between battery charges.

In some embodiments, the method 700 is performed at an electronic device (e.g., 500) in communication with a display generation component (e.g., 504), and one or more input devices. For example, the electronic device is a mobile device (e.g., a tablet, a smartphone, a media player, or a wearable device) including wireless communication circuitry, optionally in communication with one or more of a mouse (e.g., external), trackpad (optionally integrated or external), touchpad (optionally integrated or external), remote control device (e.g., external), another mobile device (e.g., separate from the electronic device), a handheld device (e.g., external), and/or a controller (e.g., external). In some embodiments, the display generation component is a display integrated with the electronic device (optionally a touch screen display), external display such as a monitor, projector, television, or a hardware component (optionally integrated or external) for projecting a user interface or causing a user interface to be visible to one or more users.

In some embodiments, the electronic device displays (702a), via the display generation component, a document (e.g., document 602 in FIG. 6A). For example, the electronic device displays a portable document format (PDF) document or other document type within a document-viewing application operating on the electronic device. In some embodiments the document includes a plurality of text-entry regions. For example, the document includes visual (e.g., lines or boxes) and/or textual indications (e.g., text labels) indicating respective locations in the document at which to enter text (e.g., written text and/or font-based text) or other content. In some embodiments, the plurality of text-entry regions do not include text-entry fields (e.g., a predefined control element that enables a user of the electronic device to directly input text into the document).

In some embodiments, while displaying the document, the electronic device detects (702b), via the one or more input devices, a first input directed toward the document, such as input 603c-1 or 603c-2 as shown in FIG. 6C. For example, the electronic device detects a respective gesture provided by the user of the electronic device. In some embodiments, the respective gesture is provided by a predefined portion of the user (e.g., by a finger of the user). In some embodiments, the respective gesture is provided by a hardware writing tool (e.g., a stylus) in communication with the electronic device. In some embodiments, the respective gesture includes a tap gesture (e.g., a double tap gesture) detected on a touch sensitive surface (e.g., on the touch screen display of the electronic device) or other surface. In some embodiments, the surface with which the first input is interacting is the touch-sensitive surface, such as touch screen 504, a physical surface on which the document is projected, or a simulated surface corresponding to at least a portion of the document.

In some embodiments, in response to detecting the first input (702c), in accordance with a determination that the first input is directed to a first location that is within a first threshold distance (e.g., 0.25, 0.5, 0.75, 1, 1.5, 2, 3, 5, or 10 cm) of a first text-entry region in the document while the document is in a respective mode of operation (e.g., a text-entry, form-filling, or form-creation mode of operation), such as input 603c-1 directed to a location near first text-entry region 606-1 as shown in FIG. 6C, wherein the first text-entry region does not include a text-entry field, the electronic device displays (702d), via the display generation component, a first text-entry field at a respective location in the document based on (e.g., selected automatically by the electronic device) the first text-entry region, such as display of first text-entry field 608-1 as shown in FIG. 6E, wherein the respective location is located within the first threshold distance of the first text-entry region. For example, the electronic device generates a first text-entry field and displays the first text-entry field at a location in the document that is based on the location of the first text-entry region. In some embodiments, the respective location at which the first text-entry field is displayed is different from the first location at which the first input was detected in the document. In some embodiments, the respective location is a predefined location within the first threshold distance of the first text-entry region. For example, the respective location is a single location determined based on a size of the first text-entry region, the location of the first text-entry region in the document, and/or a context of the first text-entry region, as discussed in more detail below. In some embodiments, the electronic device determines the respective location without receiving user input defining the size of the first text-entry region, the location of the first text-entry region, and/or the context of the first text-entry region. In some embodiments, the electronic device displays the first text-entry field with a first size that is based on the first text-entry region (e.g., the size of the first text-entry region and/or the location of the first text-entry region in the document, which is optionally determined by the device based on surrounding content in the document and/or the size of the area/space available between such surrounding content). In some embodiments, the first text-entry field enables the user to directly input text (e.g., written text or font-based text) or other content into the document at the respective location, such as through input directed to the first text-entry field (e.g., input 603f directed to the first text-entry field 608-1 in FIG. 6F). In some embodiments, if the electronic device detects an input at a location in the document that is outside the first threshold distance of the first text-entry region, the electronic device forgoes displaying the first text-entry field at the respective location in the document.

In some embodiments, in accordance with a determination that the first input is directed to a second location, different from the first location, that is within the first threshold distance (e.g., 0.25, 0.5, 0.75, 1, 1.5, 2, 3, 5, or 10 cm) of the first text-entry region in the document while the document is in the respective mode of operation, such as input 603c-2 directed to a location near first text-entry region 606-1 as shown in FIG. 6C, the electronic device displays (702e) the first text-entry field at the respective location in the document, such as display of the first text-entry field 608-1 as shown in FIG. 6E. For example, the electronic device generates the first text-entry field and displays the first text-entry field at the same location in the document that is based on the location of the first text-entry region, irrespective of where the first input was detected, so long as the location of the input is within the first threshold distance of the first text-entry region. In some embodiments, while the electronic device is displaying the first text-entry field at the respective location, user input associated with the text-entry field enables text to be entered into the document at the first text-entry field. For example, an input corresponding to selection of the first text-entry field enables text to be entered into the first text-entry field (e.g., via a keyboard user interface object displayed via the display generation component, such as keyboard 611 in FIG. 6G, and/or an external keyboard device in communication with the electronic device). In some embodiments, the electronic device displays a respective user interface element (e.g., a text insertion cursor, such as text cursor 617 in FIG. 6H) in the first text-entry field after displaying the first text-entry field indicating that text is enterable into the first text-entry field (e.g., using a keyboard as similarly described above). In some embodiments, input corresponding to selection of one or more keys of the keyboard causes the electronic device to display one or more characters corresponding to the selected keys in the first text-entry field, such as display of characters 609-1 in response to detecting selection of one or more keys as shown in FIG. 6H. Displaying a text-entry field based on a location of a text-entry region in a document in response to detecting a respective gesture at a location that is a threshold distance from the location of the text-entry region reduces the number of inputs needed to input text into the document at the text-entry region and/or enables a text-entry field to be displayed automatically, thereby improving user-device interaction.

In some embodiments, in response to detecting the first input (704a), in accordance with a determination that the first input is directed to a third location, different from the first location and the second location, that is within a second threshold distance (e.g., 0.05, 0.1, 0.15, 0.25, 0.5, 0.75, 1, 1.5, 2, 5, or 10 cm) of an existing text-entry field, such as text-entry field 608-2 in FIG. 6I, the electronic device initiates (704b) a process to enter text into the existing text-entry field, such as via display of soft keyboard 611 as shown in FIG. 6I. For example, if the first input described above with reference to steps 702a-702e is directed to the third location, which is optionally the location at which an existing text-entry field is located (e.g., present/integrated in the document and/or created in response to user input prior to detecting the first input, such as user input 603e in FIG. 6E), the electronic device initiates a process to enter text into the text-entry field. In some embodiments, initiating the process to enter text into the text-entry field includes displaying, via the display generation component, a soft keyboard that is associated with the user interface, as similarly described above with reference to steps 702a-702e. In some embodiments, initiating the process to enter text into the text-entry field includes displaying a text cursor in the text-entry field indicating that text will be entered into the text-entry field (e.g., in response to user input (e.g., selection of one or more keys of the soft keyboard, an integrated hardware keyboard, or an external keyboard in communication with the electronic device)). Initiating a process to enter text into an existing text-entry field in a document in response to detecting a respective gesture at a location that is a threshold distance from the location of the existing text-entry field reduces the number of inputs needed to input text into the document at the text-entry field and/or enables text to be entered into the text-entry field automatically, thereby improving user-device interaction.

In some embodiments, in response to detecting the first input (706a), such as input 603e in FIG. 6E, in accordance with a determination that the first input is directed to a third location, different from the first location and the second location, that is within the first threshold distance (e.g., 0.25, 0.5, 0.75, 1, 1.5, 2, 3, 5, or 10 cm) of a second text-entry region, such as second text-entry region 606-2 in FIG. 6E, different from the first text-entry region, the electronic device displays (706b), via the display generation component, a second text-entry field at a second respective location in the document based on (e.g., selected automatically by the electronic device) the second text-entry region, such as display of second text-entry field 608-2 as shown in FIG. 6F, wherein the second respective location is located within the first threshold distance of the second text-entry region. For example, the electronic device generates a text-entry field and displays the text-entry field at a location in the document that is based on the location of the second text-entry region, as similarly described above with reference to steps 702a-702e. Displaying a text-entry field based on a location of a text-entry region in a document in response to detecting a respective gesture at a location that is a threshold distance from the location of the text-entry region reduces the number of inputs needed to input text into the document at the text-entry region and/or enables a text-entry field to be displayed automatically, thereby improving user-device interaction.

In some embodiments, in response to detecting input corresponding to a request to enter text into the first text-entry field, such as input 603g directed to one or more keys of the keyboard 611 in FIG. 6G, the electronic device displays first text with a respective characteristic having a first value in the first text-entry field (708a), such as display of text 609-1 in the first text-entry field 606-1 as shown in FIG. 6H. For example, while displaying the first text-entry field, if the electronic device detects input corresponding to a request to enter text into the first text-entry field (e.g., as similarly described above with reference to steps 702a-702e), the electronic device displays first text in the first text-entry field. In some embodiments, the first text is font-based text displayed using a first font. For example, the first text is displayed in a first value of size, color, and/or weight (e.g., thickness and/or boldness) that is determined by the first font in the document.

In some embodiments, in response to detecting input corresponding to a request to enter text into the second text-entry field, the electronic device displays second text with the respective characteristic having the first value in the second text-entry field (708b), such as display of text 609-2 in the second text-entry field 608-2 as shown in FIG. 6J. For example, while displaying the second text-entry field, if the electronic device detects input corresponding to a request to enter text into the second text-entry field, the electronic device displays second text in the second text-entry field. In some embodiments, the second text is font-based text displayed using the first font described above. For example, the second text has the same value of size, color, and/or weight as that of the first text displayed in the first text-entry field, such as display of text 609-1 and 609-2 with the same font size as shown in FIG. 6J. Displaying first text in a first text-entry field and second text in a second text-entry field that have a same font in a document enables the first text and the second text to have a consistent appearance and/or enables the font to be maintained between different text-entry fields in the document automatically, thereby improving user-device interaction.

In some embodiments, the document is associated with a setting for text corresponding to a respective characteristic having a first value (710a), such as the font of the text 609-1 in the first text-entry field 606-1 in FIG. 6I. For example, the setting for text associated with the document determines a font of the text to-be-entered into text-entry fields of the document. In some embodiments, changing the setting for the text changes the font of the text to-be-entered. In some embodiments, the first value of the font determines a size, color, and/or weight of the text, as similarly described above with reference to steps 708a-708b.

In some embodiments, in response to detecting input corresponding to a request to enter text into the first text-entry field, such as input 603h directed to one or more keys of the keyboard 611 as shown in FIG. 6H, the electronic device displays first text (e.g., text 609-1 in FIG. 6I) with the respective characteristic having the first value in the first text-entry field (710b). For example, if the electronic device detects an input corresponding to a request to enter text into the first text-entry field, the electronic device displays first text in the first text-entry field that is displayed using the font described above. For example, the first text has the same value of size, color, and/or weight as that of the setting. Displaying text in a text-entry field that has a font determined based on a text setting of a document in which the text-entry field is displayed enables text to have a consistent appearance across multiple text-entry fields and/or enables the font to be maintained between different text-entry fields in the document automatically, thereby improving user-device interaction.

In some embodiments, the document includes a second text-entry field (e.g., text-entry field 608-2 in FIG. 6J) that includes respective text (e.g., text 609-2 in FIG. 6J) with a respective characteristic having a first value (712a) (e.g., respective text that is displayed in the second text-entry field using a respective font, as similarly described above with reference to steps 708a-708b). In some embodiments, while displaying the first text-entry field at the respective location in accordance with the first input, such as text-entry field 608-3 in FIG. 6K, the electronic device detects (712b), via the one or more input devices, a second input corresponding to a request to enter text into the first text-entry field, such as selection input 603k directed to the text-entry field 608-3 as shown in FIG. 6K. For example, the electronic device detects input via a soft keyboard (e.g., keyboard 611) associated with the user interface or via an external keyboard in communication with the electronic device directed to the first text-entry field, as similarly described above with reference to steps 702a-702e. In some embodiments, the electronic device detects selection of one or more keys of the keyboard while the first text-entry field has a current focus (e.g., while a text cursor is displayed within the first text-entry field).

In some embodiments, in response to detecting the second input, the electronic device displays (712c), via the display generation component, first text with the respective characteristic having the first value in the first text-entry field in accordance with the second input, such as display of text 609-3 in the text-entry field 608-3 with the same font as the text 609-2 in text-entry field 608-2 as shown in FIG. 6O. For example, the electronic device displays first text comprising one or more characters corresponding to one or more keys selected by the user. In some embodiments, the electronic device displays the first text as font-based text using the respective font of the respective text displayed in the second text-entry field. For example, the first text has the same value of size, color, and/or weight as that of the respective text displayed in the first text-entry field.

In some embodiments, while displaying the first text with the respective characteristic having the first value in the first text-entry field, the electronic device detects (712d), via the one or more input devices, a third input corresponding to a request to display the first text with the respective characteristic having a second value, different from first value, such as inputs 603p and 603q in FIGS. 6P-6Q changing the font of the text 609-3 in the text-entry field 608-3. For example, the electronic device detects an input corresponding to a request to change the font in which the first text is displayed in the first text-entry field. In some embodiments, the electronic device detects selection of the first text, such as via input 603o in FIG. 6O, followed by a sequence of inputs that cause the electronic device to change the font of the first text, such as via inputs 603p and 603q in FIGS. 6P-6Q.

In some embodiments, in response to detecting the third input (712e), the electronic device displays (7120, via the display generation component, the first text with the respective characteristic having the second value in the first text-entry field, such as display of text 609-3 in the text-entry field 608-3 with a different font as shown in FIG. 6R. For example, the electronic device changes the font in which the first text is displayed in accordance with the third input. In some embodiments, the electronic device displays the first text with a different value of size, color, and/or weight determined based on the selected font.

In some embodiments, the electronic device displays (712g), via the display generation component, the respective text with the respective characteristic having the second value in the second text-entry field, such as display of the text 609-2 in the text-entry field 608-2 with the different font as shown in FIG. 6R. For example, the electronic device changes the font in which the respective text is displayed in accordance with the third input. In some embodiments, the respective text has the same value of size, color, and/or weight as that of the first text after the third input is detected. Accordingly, changing a font of text in one text-entry field in the document causes the electronic device to change the font of text in multiple (e.g., all) text-entry fields that contain text in the document, such as the text in text-entry fields 608-1 through 608-6 as shown in FIG. 6R. Changing a font of second text in a second text-entry field and first text in a first text-entry field in a document in response to detecting an input changing the font of the first text in the first text-entry field enables the font of the first text and the second text to have maintain a consistent appearance and/or enables the font of text in different text-entry fields to be changed in the document automatically, thereby improving user-device interaction.

In some embodiments, the first text-entry region (e.g., text-entry region 608-1 in FIG. 6C) is determined to be a text-entry region based on (e.g., selected automatically by the electronic device) an evaluation of one or more visual elements of the document (714) (e.g., document 602 in FIG. 6A). For example, while the document is in the respective mode of operation (e.g., after detecting selection of selectable option 614-1 as shown in FIG. 6B), the electronic device evaluates one or more visual elements of the document to determine the presence of text-entry regions and/or predefined text-entry fields in the document. In some embodiments, as similarly described below with reference to steps 716a-720, the electronic device evaluates graphical elements, textual elements, and/or spatial elements (e.g., white/empty space) to determine the presence of text-entry regions and/or predefined text-entry fields in the document. Determining a text-entry region in a document based on an evaluation of visual elements of the document reduces the number of inputs needed to create a text-entry field at a location based on the text-entry region in the document and/or enables the text-entry field to be created at a location based on the text-entry region in the document automatically, thereby improving user-device interaction.

In some embodiments, the one or more visual elements of the document include a first graphical line (716a), such as horizontal line in text-entry region 606-1 in FIG. 6C. For example, the document includes a horizontal line with empty space above the horizontal line at which handwritten text would be written if the document were a physical document (e.g. printed on paper) and handwritten input were provided above the horizontal line.

In some embodiments, the first text-entry region is placed, by the electronic device, at a location in the user interface that has a predetermined spatial relationship to the graphical line in the document (716b), such as placement of text-entry region 606-1 above the horizontal line in FIG. 6C. For example, the electronic device places the first text-entry region is located in (e.g., a portion of) the empty space above the horizontal line in the document. Accordingly, when the electronic device displays the first text-entry field at the respective location in accordance with the first input, the first text-entry field is displayed (e.g., at least partially) in the empty space above the horizontal line in the document. Determining a text-entry region in a document based on a location of a graphical line in the document reduces the number of inputs needed to create a text-entry field at a location based on the location of the graphical line in the document and/or enables the text-entry field to be created at a location based on the location of the graphical line in the document automatically, thereby improving user-device interaction.

In some embodiments, the evaluation of the one or more visual elements of the document includes a determination of whether the document includes one or more text-entry regions of a first type (718a), such as preset text-entry regions 605-1 and 605-2 in FIG. 6C. For example, the electronic device determines whether the document includes any preset/predefined text-entry regions in the document. In some embodiments, text-entry regions of the first type are selectable to initiate a process to enter text into a respective text-entry region without first having to create a text-entry field at a location that is based on a location of the respective text-entry region. In some embodiments, the electronic device determines that the document includes a text-entry region of the first type based on metadata associated with the document and/or visual characteristics of the text-entry region (e.g., if the text-entry region includes a box/rectangle).

In some embodiments, the first text-entry region (e.g., text-entry region 606-1 in FIG. 6C) is of a second type, different from the first type (718b). For example, because the electronic device created the first text-entry field in response to the first input (e.g., in response to user input 603c-1 or 603c-2 in FIG. 6C), as described above with reference to steps 702a-702e, the first text-entry region is not a preset/predefined text-entry region. Accordingly, while the document is in the respective mode of operation, text-entry regions of the second type (e.g., text-entry region 606-1 and/or 606-2 in FIG. 6E) are selectable to create a text-entry field (e.g., text-entry field 608-1 and/or 608-2 in FIG. 6F) at a location that is based on the location of the text-entry region, and text-entry region of the first type are selectable to enter text into the text-entry region. Determining locations of preset text-entry regions in a document based on an evaluation of the visual elements of the document reduces the number of inputs needed to enter text at the preset text-entry region in the document and/or enables text to be entered into the preset text-entry region automatically, thereby improving user-device interaction.

In some embodiments, the first text-entry field is displayed with a first size based on (e.g., selected automatically by the electronic device) a respective size of the first text-entry region (720), such as display of the first text-entry field 606-1 with a size that is based on the size of the first text-entry region 606-1 as shown in FIG. 6E. For example, when the electronic device displays the first text-entry field at the respective location in the document, a size (e.g., dimensions, such as length and/or height) of the first text-entry field are determined based on a detected size of the first text-entry region with which the first text-entry field is associated. In some embodiments, the size of the first text-entry field is equal to the size of the first text-entry region. In some embodiments, the size of the first text-entry field is different from the size of the first text-entry region. In some embodiments, if the document includes a second text-entry region, separate from the first text-entry region, the electronic device displays a text-entry field that is at a location based on the second text-entry region with a size that is based on a size of the second text-entry region, such as display of text-entry field 608-3 as shown in FIG. 6K. For example, if the second text-entry region (e.g., text-entry region 606-3 in FIG. 6K) is larger (e.g., in dimension) than the first text-entry region, the electronic device displays the text-entry field at the second text-entry region with a second size, larger than the first size of the first text-entry field, such as display of text-entry field 608-3 with a size that is larger than that of the first text-entry field 608-1 as shown in FIG. 6K. Similarly, if the second text-entry region is smaller than the first text-entry region, the electronic device displays the text-entry field at the second text-entry region with the second size that is smaller than the first size of the first text-entry field. Displaying a text-entry field with a size in a document that is based on a size of a text-entry region with which the text-entry field is associated enables text entered into the text-entry field to remain proximate to the text-entry region and/or enables the text-entry field to be displayed without requiring selection of the size of the text-entry field, thereby improving user-device interaction.

In some embodiments, the respective size of the first text-entry region includes a respective length that is based on (e.g., selected automatically by the electronic device) available length in the document at a location of the text-entry region in the document (722a), such as a length of the horizontal graphical line of the first text-entry region 606-3 in FIG. 6C. For example, if the first text-entry region includes a visual element, such as a graphical line or a graphical box, the respective length of the first text-entry region is based on the length of the graphical line or the graphical box. In some embodiments, if the first text-entry region includes empty space within the document, the respective length of the first text-entry region is based on an amount of the empty space. In some embodiments, the first size of the first text-entry field includes a first length (722b), such as the length of the first text-entry field 608-1 in FIG. 6E. For example, the first text-entry field extends the first length in the document while the first text-entry field is displayed.

In some embodiments, the first length is based on (e.g., selected automatically by the electronic device) the respective length (722c), such as display of the first text-entry field 608-1 with a length that extends the length of the horizontal graphical line of the first text-entry region 606-1. For example, the first length of the first text-entry field is equal to the respective length of the text-entry region, as similarly shown for the text-entry field 606-1 in FIG. 6E. In some embodiments, the first length of the first text-entry field is different from (e.g., but proportional to) the respective length of the text-entry region. In some embodiments, if the document includes a second text-entry region, separate from the first text-entry region, the electronic device displays a text-entry field that is at a location based on the second text-entry region with a length that is based on a length of the second text-entry region. For example, if the second text-entry region is larger (e.g., has a longer length) than the first text-entry region, the electronic device displays the text-entry field at the second text-entry region with a second length, larger than the first length of the first text-entry field, such as display of text-entry field 608-3 with a length that is longer than that of the first text-entry field 608-1 as shown in FIG. 6K. Similarly, if the second text-entry region is smaller than the first text-entry region, the electronic device displays the text-entry field at the second text-entry region with the second length that is smaller than the first length of the first text-entry field. Displaying a text-entry field with a length in a document that is based on a length of a text-entry region with which the text-entry field is associated enables text entered into the text-entry field to remain proximate to the text-entry region and/or enables the text-entry field to be displayed without requiring selection of the length of the text-entry field, thereby improving user-device interaction.

In some embodiments, the respective size of the first text-entry region includes a respective height that is based on (e.g., selected automatically by the electronic device) available height in the document at a location of the text-entry region in the document (724a), such as an amount of the empty space above the horizontal graphical line in the first text-entry region 606-1 in FIG. 6C. For example, if the first text-entry region includes a visual element, such as a vertical graphical line or a graphical box, the respective height of the first text-entry region is based on the height of the vertical graphical line or the graphical box. In some embodiments, if the first text-entry region includes empty space within the document, the respective height of the first text-entry region is based on an amount of the empty space. For example, the height of the first text-entry region is based on an amount of empty space that is between lines of text or visual elements surrounding the first text-entry region. In some embodiments, the first size of the first text-entry field includes a first height (724b), such as a height of the first text-entry field 608-1 in FIG. 6E. For example, the first text-entry field has the first height in the document while the first text-entry field is displayed.

In some embodiments, the first height is based on (e.g., selected automatically by the electronic device) the respective height (724c), such as display of the first text-entry field 608-1 with a height that occupies the empty space above the graphical horizontal line of the first text-entry field 606-1 as shown in FIG. 6E. For example, the first height of the first text-entry field is equal to the respective height of the text-entry region. In some embodiments, the first height of the first text-entry field is different from (e.g., but proportional to) the respective height of the text-entry region. In some embodiments, if the document includes a second text-entry region (e.g., text-entry region 606-2 in FIG. 6F), separate from the first text-entry region, the electronic device displays a text-entry field that is at a location based on the second text-entry region with a size that is based on a size of the second text-entry region, such as text-entry field 608-2 in FIG. 6F. For example, if the second text-entry region is larger (e.g., has a larger height) than the first text-entry region, the electronic device displays the text-entry field at the second text-entry region with a second height, larger than the first height of the first text-entry field, such as display of the text-entry field 608-2 with a height that is larger than that of the first text-entry field 608-1 as shown in FIG. 6F. Similarly, if the second text-entry region is smaller than the first text-entry region, the electronic device displays the text-entry field at the second text-entry region with the second height that is smaller than the first height of the first text-entry field. Displaying a text-entry field with a height in a document that is based on a height of a text-entry region with which the text-entry field is associated enables text entered into the text-entry field to remain proximate to the text-entry region and/or enables the text-entry field to be displayed without requiring selection of the height of the text-entry field, thereby improving user-device interaction.

In some embodiments, the first size of the first text-entry field includes a first height that is based on (e.g., selected automatically by the electronic device) a font size setting for text in the first text-entry field (726), such as the size of the font used to display text 609-1 in FIG. 6H. For example, as similarly described above with reference to steps 710a-710b, the font size setting for text determines a font of text to-be-entered into the first text-entry field in the document. In some embodiments, the font size setting for text in the first text-entry field is a predefined (e.g., a default) value, a value selected by the user of the electronic device, and/or a value determined based on the size of other text in the document (e.g., text displayed in other text-entry fields and/or text-entry regions). In some embodiments, the first height of the first text-entry field is equal to a height of font determined by the font size setting. In some embodiments, the first height of the first text-entry field is different from (e.g., but proportional to) the height of font determined by the font size setting, such as the height of the first text-entry field 608-1 being greater than the font size of the text 609-1 as shown in FIG. 6H. In some embodiments, if the font size setting for text in the first text-entry field is changed (e.g., from a first value to a second, different, value), the electronic device changes the first height of the first text-entry field to a second height, different from the first height. Displaying a text-entry field with a height in a document that is based on a font size setting for text in the text-entry field enables text with the font size to be entered into the text-entry field without clipping or obscuring the text and/or enables the text-entry field to be displayed without requiring selection of the height of the text-entry field, thereby improving user-device interaction.

In some embodiments, the document includes a second text-entry region (728a) (e.g., separate from the first text-entry region), such as text-entry region 605-1 in FIG. 6B. In some embodiments, before detecting the first input and while the document is in the respective mode of operation (728b), in accordance with a determination that the second text-entry region includes a first type of text-entry field, the electronic device displays (728c), via the display generation component, the second text-entry region with a first visual characteristic having a first value, such as display of the preset text-entry region 605-1 with a visual effect (e.g., highlighting) as shown in FIG. 6C. For example, while the respective mode of operation of the document is active at the electronic device, if the electronic device determines that the second text-entry region includes a preset/predefined text-entry field, the electronic device displays the second text-entry region with the first visual characteristic having the first value. In some embodiments, displaying the second text-entry region with the first visual characteristic having the first value includes highlighting the text-entry region by a first magnitude, shading the text-entry region by a first magnitude, boldening the text-entry region by a first magnitude, and/or changing a color of the text-entry region while the document is in the respective mode of operation. In some embodiments, the text-entry field is a preset/predefined text-entry field if the text-entry field is included in the document without user input creating the text-entry field, such as display of text-entry regions 605-1 and 605-2 in FIG. 6C without user input. For example, the electronic device determines the second text-entry region includes the preset/predefined text-entry field based on metadata associated with the document and/or visual elements, such as boxes/rectangles, that are selectable to enter text into the text-entry field.

In some embodiments, in accordance with a determination that the second text-entry region does not include the first type of text-entry field, the electronic device forgoes (728d) displaying the second text-entry region with the first visual characteristic having the first value, such as forgoing displaying the text-entry field 608-2 with the visual effect as shown in FIG. 6F. For example, if the electronic device determines that the second text-entry region does not include a preset/predefined text-entry field, the electronic device does not display the second text-entry region with the first visual characteristic having the first value. In some embodiments, the electronic device does not highlight, shade, bolden, and/or change a color of the second text-entry region because the second text-entry region does not include a preset/predefined text-entry field. For example, the electronic device does not alter display of the second text-entry region in the document. Displaying a text-entry region with a respective visual characteristic in accordance with a determination that the text-entry region includes a preset text-entry field facilitates discovery that the text-entry region includes a present text-entry field and/or facilitates user input for entering text into the text-entry region without displaying additional controls, thereby improving user-device interaction.

In some embodiments, while displaying the second text-entry region and while the document is in the respective of operation, the electronic device detects (730a), via the one or more input devices, an input directed to the second text-entry region, such as a selection of the text-entry region 605-1. For example, the electronic device detects selection (e.g., a tap or touch input) directed to the second text-entry region. In some embodiments, the electronic device detects the selection via an external input device in communication with the electronic device (e.g., a click or selection via a key/button of an external keyboard, mouse, or trackpad).

In some embodiments, in response to detecting the input (730b), in accordance with the determination that the second text-entry region includes the first type of text-entry field (e.g., a preset/predefined text-entry field), the electronic device displays (730c), via the display generation component, one or more user interface objects that are selectable to enter suggested text into the second text-entry field, such as user interface objects 612 in FIG. 6I. For example, the electronic device displays the one or more user interface objects with a soft keyboard associated with the user interface. In some embodiments, the electronic device displays the one or more user interface objects in a portion of the second text-entry region, as similarly shown in FIG. 6I. In some embodiments, the one or more user interface objects include text labels (e.g., “Smith,” “Stuart,” and/or “Jackson” in FIG. 6I) indicating the suggested text that will be entered into the second text-entry field if the one or more user interface objects are selected. In some embodiments, as similarly described with reference to steps 736a-736d, the electronic device generates the suggested text based on a context of the second text-entry region.

In some embodiments, in accordance with the determination that the second text-entry region does not include the first type of text-entry field (e.g., the second text-entry region does not include a preset/predefined text-entry field, and/or no user input has been received for creating a text-entry field at the second text-entry region), the electronic device forgoes (730d) displaying the one or more user interface objects (e.g., and displays a text-entry field, such as text-entry field 608-2 in FIG. 6G, in the document 602). For example, the electronic device does not display the one or more user interface object. In some embodiments, the electronic device performs a different operation in accordance with the input. For example, the electronic device creates a text-entry field at a location that is based on the location of the second text-entry region in the document. Displaying user interface objects that are selectable to enter suggested text into a preset text-entry field in response to detecting input directed to a text-entry region with which the preset text-entry field is associated reduces the number of inputs needed to enter text in the text-entry region and/or enables the text to be entered into the text-entry region automatically, thereby improving user-device interaction.

In some embodiments, in response to detecting the first input (732a), in accordance with a determination that the first input is directed to the first location that is within the first threshold distance (e.g., 0.25, 0.5, 0.75, 1, 1.5, 2, 3, 5, or 10 cm) of the first text-entry region in the document while the document is not in the respective mode of operation, such as input 603bb in FIG. 6BB, the electronic device forgoes (732b) displaying the first text-entry field at the respective location in the document, such as forgoing display a text-entry field at the text-entry region 606-1 as shown in FIG. 6CC. In some embodiments, in accordance with a determination that the first input is directed to the second location that is within the first threshold distance of the first text-entry region while the document is not in the respective mode of operation, the electronic device forgoes (732c) displaying the first text-entry field at the respective location. For example, the document operates in the respective mode of operation after a selectable option associated with the document-viewing application that is displaying the document is selected. In some embodiments, if the selectable option that is selectable to activate the respective mode is not selected when the first input is detected, the electronic device does not display the first text-entry field at the respective location, irrespective of whether the first input is detected at a location that is within the first threshold distance of the first text-entry region. For example, the electronic device performs a different operation in accordance with the first input. In some embodiments, the electronic device selects (e.g., highlights) a portion of text at the first location or the second location at which the first input is directed, such as selection of the text 609-1 at text-entry region 606-1 as shown in FIG. 6CC. In some embodiments, the electronic device activates a selectable option (e.g., a hyperlink) at the first location or the second location at which the first input is directed. Forgoing displaying a text-entry field in a document in response to detecting a respective gesture directed to the document while a respective mode of operation is not active avoids unintentional creation of text-entry fields in the document and/or enables different operations involving the document to be performed in accordance with the respective gesture, thereby improving user-device interaction.

In some embodiments, in response to detecting the first input (734a), in accordance with a determination that the first input is directed to a third location, different from the first location and the second location, that is not within the first threshold distance (e.g., 0.25, 0.5, 0.75, 1, 1.5, 2, 3, 5, or 10 cm) of any text-entry region in the document while the document is in the respective mode of operation, such as input 603s in FIG. 6S, the electronic device displays (734b), via the display generation component, the first text-entry region at a second respective location in the document, different from the respective location, that is based on (e.g., selected automatically by the electronic device) the third location and independent of a structure of the document, such as display of text-entry field 608-7 at a location in the document 602 that is based on the location at which the input 603s is detected as shown in FIG. 6T. For example, if the respective gesture of the first input is detected away from any text-entry regions in the document, the electronic device creates the first text-entry field at a location that is based on the third location at which the first input is detected. In some embodiments, the second respective location in the document is the same as or overlaps with the third location at which the first input is detected. In some embodiments, the first text-entry field is displayed at the second respective location independent of the structure of the document (e.g., independent of visual elements (e.g., lines, text labels, and/or boxes) included in the document). Displaying a text-entry field based on a location at which a respective gesture is detected that is outside of a threshold distance from a location of a text-entry region in a document reduces the number of inputs needed to input text into the document and/or enables a text-entry field to be displayed at a location of the respective gesture automatically, thereby improving user-device interaction.

In some embodiments, while displaying the first text-entry field (e.g., text-entry field 608-3 in FIG. 6K) at the respective location in accordance with the first input, the electronic device detects (736a), via the one or more input devices, a second input corresponding to a request to enter text into the first text-entry field, such as input 603k in FIG. 6K. For example, the electronic device detects selection (e.g., a tap or touch input) directed to the first text-entry field. In some embodiments, the electronic device detects the selection via an external input device in communication with the electronic device (e.g., a click or selection via a key/button of an external keyboard, mouse, or trackpad).

In some embodiments, in response to detecting the second input (736b), in accordance with a determination that the second input includes selection of a first option (e.g., option 615 displayed in keyboard 611 in FIG. 6L) that is selectable to generate suggested text for entering in the first text-entry field and that the first text-entry field is associated with a first type of text, the electronic device displays (736c), via the display generation component, a first user interface object that is selectable to enter first suggested text of the first type into the first text-entry field, such as display of user interface object 617-1 as shown in FIG. 6M. In some embodiments, in response to detecting the second input, the electronic device displays a first option for generating suggested text. For example, in response to detecting selection of the first option, if the first text-entry field is associated with the first type of text, the electronic device displays a first user interface object that is selectable to enter first suggested text of the first type into the first text-entry field. As discussed below with reference to step 738, the first type of text is determined based on a context of the first text-entry region with which the first text-entry field is associated. In some embodiments, the first user interface object includes a text label (e.g., “Home Address” in FIG. 6M) indicating the first suggested text that will be entered into the first text-entry field if the first user interface object is selected. In some embodiments, the first text-entry field is displayed with text corresponding to a hint for the first text-entry field. For example, the text corresponding to the hint is based on the first type of text, and selection of the first text-entry field causes the text corresponding to the hint to no longer be displayed.

In some embodiments, in accordance with a determination that the second input includes selection of the first option (e.g., option 615) that is selectable to generate suggested text for entering in the first text-entry field and that the first text-entry field is associated with a second type of text, different from the first type of text, the electronic device displays (736d), via the display generation component, a second user interface object that is selectable to enter second suggested text of the second type into the first text-entry field, such as display of user interface object 617-2 as shown in FIG. 6M, wherein the first suggested text is different from the second suggested text. For example, in response to detecting selection of the first option, if the first text-entry field is associated with the second type of text, the electronic device displays a second user interface object that is selectable to enter second suggested text of the second type into the first text-entry field. As discussed below with reference to claim 19, the second type of text is determined based on a context of the first text-entry region with which the first text-entry field is associated. In some embodiments, the second user interface object includes a text label (e.g., “Work Address” in FIG. 6M) indicating the second suggested text that will be entered into the first text-entry field if the second user interface object is selected. Displaying a user interface object that is selectable to enter a particular type of suggested text into a text-entry field in response to detecting an input corresponding to a request to enter text into the text-entry field reduces the number of inputs needed to enter text into the text-entry field and/or enables the particular type of text to be entered into the text-entry field automatically, thereby improving user-device interaction.

In some embodiments, whether the first text-entry field (e.g., text-entry field 608-3 in FIG. 6K) is associated with the first type or the second type of text is based on (e.g., selected automatically by the electronic device) a context of the first text-entry region (e.g., text-entry region 606-3 in FIG. 6K) within the document (738). For example, the electronic device determines the type of suggested text to suggest based on the context of the first text-entry region with which the first text-entry field is associated. In some embodiments, as similarly described above with reference to step 714, the document includes one or more visual elements that are evaluated to determine the presence of text-entry regions in the document. One such visual element includes text labels that optionally identify text-entry regions in the document. For example, a first type of text label (e.g., a “Name” text label or an “Address” text label, as similarly shown in FIG. 6K) causes the electronic device to determine the first text-entry field is associated with the first type of text. Accordingly, the first suggested text that is entered into the first text-entry field in response to selection of the first user interface object is text of the first type (e.g., text corresponding to suggested name(s) or suggested address(es)). Alternatively, for example, a second type of text label (e.g., a “Phone” text label or an “Email” text label) causes the electronic device to determine the first text-entry field is associated with the second type of text. Accordingly, the second suggested text that is entered into the first text-entry field in response to selection of the second user interface object is text of the second type (e.g., text corresponding to suggested telephone number(s) or suggested email address(es)). Displaying a user interface object that is selectable to enter suggested text that is based on a context of a text-entry region reduces the number of inputs needed to enter a particular type of text into the text-entry field and/or enables the particular type of text to be entered into the text-entry field automatically, thereby improving user-device interaction.

In some embodiments, the document includes a second text-entry field (e.g., text-entry field 608-4 in FIG. 6N) that shares at least one characteristic with the first text-entry field (e.g., text-entry field 608-3 in FIG. 6L) (740a) (e.g., the first text-entry field and the second text-entry field are associated with a first type of text). In some embodiments, while displaying the first user interface object (e.g., user interface object 617-1 in FIG. 6M) in accordance with the second input, the electronic device detects (740b), via the one or more input devices, a third input corresponding to selection of the first user interface object, such as input 603m in FIG. 6M. For example, the electronic device detects a tap or touch input directed to the first user interface object. In some embodiments, the electronic device detects the selection via an external input device in communication with the electronic device (e.g., a click or selection via a key/button of an external keyboard, mouse, or trackpad).

In some embodiments, in response to detecting the third input (740c), the electronic device displays (740d), via the display generation component, the first suggested text that is associated with the first user interface object in the first text-entry field, such as display of text 609-3 in the text-entry field 608-3 as shown in FIG. 6N. For example, the first suggested text corresponds to the text label (e.g., described above with reference to steps 736a-736d) indicated by the first user interface object. In some embodiments, the first suggested text includes a first portion of text of the text label indicated by the first user interface object, such as the street name “1234 Elm Street” as shown in FIG. 6N.

In some embodiments, the electronic device displays (740e), via the display generation component, third suggested text that is associated with the first user interface object in the second text-entry field, such as display of text 609-3 in the text-entry field 608-4 as shown in FIG. 6N, wherein the third suggested text is related to the first suggested text based on (e.g., selected automatically by the electronic device) the shared at least one characteristic. For example, the third suggested text includes a second portion, different from the first portion, of the text of the text label indicated by the first user interface object. In some embodiments, the first suggested text and the third suggested text are the first type of text. For example, if the first type of text corresponds to a home address of the user, as similarly shown in FIG. 6N, the first suggested text includes a first portion of the home address and the third suggested text includes a second portion of the home address (e.g., display of the city “Springwood” as shown in FIG. 6N). If the first type of text corresponds to a name of the user, the first suggested text optionally includes a first name and the third suggested text optionally includes a last name of the user. Entering suggested text into a first text-entry field and a second text-entry field in a document in response to detecting selection of a user interface object for entering suggested text into the first text-entry field reduces the number of inputs needed to enter a particular type of text into the first and the second text-entry fields and/or enables the particular type of text to be entered into the first and the second text-entry fields automatically, thereby improving user-device interaction.

In some embodiments, the document includes a second text-entry field (742a) (e.g., separate from the first text-entry field), such as second text-entry field 608-2 in FIG. 6F. In some embodiments, while displaying the first text-entry field (e.g., first text-entry field 608-1 in FIG. 6F) at the respective location in accordance with the first input, the electronic device detects (742b), via the one or more input devices, a second input corresponding to a request to enter text into the first text-entry field, such as selection input 603f in FIG. 6F. For example, the electronic device detects input via a soft keyboard (e.g., keyboard 611 in FIG. 6G) associated with the user interface or via an external keyboard in communication with the electronic device directed to the first text-entry field, as similarly described above with reference to steps 702a-702e. In some embodiments, the electronic device detects selection of one or more keys of the keyboard while the first text-entry field has a current focus (e.g., while a text cursor is displayed within the first text-entry field), such as input 603g in FIG. 6G.

In some embodiments, in response to detecting the second input, the electronic device displays (742c), via the display generation component, first text in the first text-entry field in accordance with the second input, such as display of text 609-1 in the first text-entry field 608-1 as shown in FIG. 6H. For example, the electronic device displays first text comprising one or more characters corresponding to one or more keys selected by the user. In some embodiments, the electronic device displays the first text as font-based text in the first text-entry field in the document.

In some embodiments, after displaying the first text in the first text-entry field (e.g., text 609-1 in FIG. 6I), the electronic device initiates (742d) a process to enter text into the second text-entry field without detecting input corresponding to a request to enter text into the second text-entry field, such as automatically displaying user interface objects 612 that are selectable to enter suggested text into the second text-entry field 608-2 as shown in FIG. 6I. For example, after the electronic device detects an end of the second input, the electronic device moves the current focus to the second text-entry field in the document, such as display of the second text-entry field 608-2 with the indication of focus as shown in FIG. 6I. In some embodiments, detecting the end of the second input includes detecting selection of a respective key of the keyboard (e.g., a Tab key or Enter key in keyboard 611 in FIG. 6H). In some embodiments, detecting the end of the second input includes determining a threshold amount of time (e.g., 0.1, 0.25. 0.4, 0.5, 1, 1.5, 2, 3, 4, 5, or 10 seconds) has elapsed since displaying the first text in the first text-entry field (e.g., after detecting an end of the selection of keys of the keyboard). In some embodiments, the electronic device initiates the process to enter text into the second text-entry field without detecting an input directed to the second text-entry field (e.g., a selection of the text-entry field corresponding to a request to enter text into the second text-entry field). Initiating a process to enter text in a second text-entry field in a document after entering text in a first text-entry field in the document reduces the number of inputs needed to enter text into the second text-entry field after entering text into the first text-entry field and/or enables text to be entered into the second text-entry field after entering text into the first text-entry field automatically, thereby improving user-device interaction.

In some embodiments, initiating the process to enter text into the second text-entry field includes displaying, via the display generation component, one or more user interface objects (e.g., user interface objects 612 in FIG. 6I) that are selectable to enter suggested text into the second text-entry field (744). For example, when the current focus shifts to the second text-entry field after displaying the first text in the first text-entry field, the electronic device displays one or more user interface objects that are selectable to enter suggested text into the second text-entry field. In some embodiments, as similarly described above with reference to steps 736a-736d, the one or more user interface objects include textual labels (e.g., “Smith,” “Stuart,” and/or “Jackson” in FIG. 6I) corresponding to the suggested text that will be entered into the second text-entry field if the one or more user interface objects are selected. Displaying user interface objects that are selectable to enter text in a second text-entry field in a document after entering text in a first text-entry field in the document reduces the number of inputs needed to enter text into the second text-entry field after entering text into the first text-entry field and/or enables text to be entered into the second text-entry field after entering text into the first text-entry field automatically, thereby improving user-device interaction.

In some embodiments, the second text entry field was created in the document in response to user input (e.g., input 603e in FIG. 6E) prior to detecting the first input, and the second text-entry field is spatially subsequent to the first text-entry field in the document (746) (e.g., the second text-entry field 608-2 is spatially located adjacent to the first text-entry field 608-1 in FIG. 6F). For example, a chronological order in which the electronic device initiates a process to enter text into a respective text-entry field is based on a spatial order of the text-entry fields in the document, and not a sequence in which the user created the text-entry fields. In some embodiments, even though the second text-entry field was created in response to user input before detecting the first input that created the first text-entry field, the electronic device initiates the process to enter text into the second text-entry field because the second text-entry field is spatially arranged after the first text-entry field in the document. For example, the second text-entry field is displayed adjacent (and/or to the right of the first text entry field, for a left-to-right language, or to the left of the first text entry field for a right-to-left language) to the first text-entry field, as similarly shown in FIG. 6F, and/or below (e.g., for a top-to-bottom language, or above the first text-entry field for a bottom-to-top language) the first text-entry field in the document. Automatically initiating a process to enter text in a second text-entry field in a document based on a spatial arrangement of the second text-entry field relative to a first text-entry field reduces the number of inputs needed to enter text into the second text-entry field after entering text into the first text-entry field and/or enables text to be entered into the second text-entry field after entering text into the first text-entry field automatically, thereby improving user-device interaction.

In some embodiments, while displaying the first text-entry field at the respective location, the electronic device detects (748a), via the one or more input devices, handwritten input on a surface (e.g., a touch screen surface of the electronic device, or a touch-sensitive surface of an input device in communication with the electronic device), such as handwritten input provided by stylus 623 on the touch screen 504 as shown in FIG. 6Y, wherein the handwritten input is directed to the first text-entry field (e.g., text-entry field 608-7 in FIG. 6Y). For example, the electronic device detects an object (e.g., a finger or an input device, such as a stylus) contact the surface and provide handwriting corresponding to handwritten text. In some embodiments, while detecting the handwritten input, the electronic device displays a representation of the handwritten input (e.g., handwritten letters, numbers, and/or special characters) in the first text-entry field in accordance with the handwritten input, such as representation of the handwritten input 627 in FIG. 6Y.

In some embodiments, in response to detecting the handwritten input, the electronic device displays (748b), via the display generation component, first text that is based on (e.g., selected automatically by the electronic device) the handwritten input in the first text-entry field, such as display of text 609-4 in the text-entry field 608-7 as shown in FIG. 6Z. For example, the electronic device converts the representation of handwritten input (e.g., representation 627 in FIG. 6Y) to font-based text that is displayed in the first text-entry field. In some embodiments, the electronic device determines the font-based text to display in the first text-entry field based on characteristics of the representation of handwritten input (e.g., shape, size, and/or weight of the handwritten characters). In some embodiments, the electronic device detects the handwritten input while a content entry mode is active at the electronic device (e.g., in response to detecting selection of option 622 as shown in FIG. 6W), such as a handwriting entry mode that causes handwriting input to be converted to font-based text in the document. Displaying text in a text-entry field in a document in response to detecting handwritten input directed to the text-entry field reduces the number of inputs needed to enter text into the text-entry field and/or enables handwritten input to be entered as text in the text-entry field automatically, thereby improving user-device interaction.

In some embodiments, in response to detecting the first input (750a), such as input 603c-1 or 603c-2 in FIG. 6C, before displaying the first text-entry field (e.g., text-entry field 608-1 in FIG. 6E) at the respective location, the electronic device displays (750b), via the one or more input devices, one or more selectable options that are selectable to select a type of the first text-entry field, such as display of selectable options 607-1 through 607-3 as shown in FIG. 6D. For example, before the electronic device displays the first text-entry field in response to detecting the first input and while the document is in the respective mode of operation, the electronic device displays one or more selectable options in the document for selecting a type of the first text-entry field. In some embodiments, the one or more selectable options are displayed in a menu element in the document. In some embodiments, the one or more selectable options include an option that is selectable to cause the first text-entry field to correspond to a check box (e.g., selectable option 607-1 in FIG. 6D), a text-entry box (e.g., selectable option 607-2 in FIG. 6D), and/or a signature-entry box (e.g., selectable option 607-3 in FIG. 6D). In some embodiments, the first text-entry field (e.g., 608-1 in FIG. 6E) is displayed at the respective location after the electronic device detects selection of one of the one or more selectable options, such as selection provided by input 603d in FIG. 6D. Displaying one or more selectable options that are selectable to select a type of a text-entry field in a document before the text-entry field is displayed reduces the number of inputs needed to select the type of the text-entry field and/or enables the type of the text-entry field to be selected automatically, thereby improving user-device interaction.

In some embodiments, the first text-entry field (e.g., text-entry field 608-7 in FIG. 6T) is displayed with a first size (e.g., an initial size, a predetermined size, and/or a selected size) at the respective location in response to detecting the first input (752a). In some embodiments, while displaying the first text-entry field with the first size at the respective location, the electronic device detects (752b), via the one or more input devices, a second input corresponding to a request display the first text-entry field with a second size, different from the first size, such as input 603t in FIG. 6T. For example, the electronic device an input directed to a portion of the first text-entry field that is selectable to initiate a process to change the size of the first text-entry field from the first size to the second size. In some embodiments, as described below with reference to steps 752a-752c, the electronic device detects the second input directed to one or more resizing elements (e.g., 621a and 621b in FIG. 6T) displayed with the first text-entry field in the document.

In some embodiments, in response to detecting the second input, the electronic device displays (752c), via the display generation component, the first text-entry field with the second size at the respective location, such as increasing the size of the text-entry field 608-7 as shown in FIG. 6U. For example, the electronic device increases or decreases the size of the first text-entry field at the respective location in the document. In some embodiments, changing the size of the first text-entry field is in accordance with a determination that the first text-entry field is not a predefined text-entry field in the document (e.g., integrated with the document), such as preset text-entry region 605-1 in FIG. 6T. For example, if the second input is directed to a second text-entry field in the document that is a predefined text-entry field, the electronic device forgoes changing the size of the second text-entry field in the document. Changing a size of a text-entry field in a document in response to detecting input corresponding to a request to change the size of the text-entry field reduces the number of inputs needed to change the size of the text-entry field and/or enables a larger or smaller amount of text to be entered into the text-entry field, thereby improving user-device interaction.

In some embodiments, the second input is directed to one or more selectable user interface objects displayed with the first text-entry field (754), such as resizing handles 621a and 621b in FIG. 6T. For example, the first text-entry field is displayed with one or more resizing elements that are selectable to initiate a process to change the size of the first text-entry field in the document. In some embodiments, the one or more resizing elements are movable in the document for causing the electronic device to change the size of the first text-entry field. For example, displaying the first text-entry field with the second size is based on a magnitude and direction of the movement of the one or more resizing elements. In some embodiments, the one or more resizing elements include a first resizing element (e.g., resizing handle 621b) displayed at a first end (e.g., a left side) of the first text-entry field, and a second resizing element (e.g., resizing handle 621a) displayed at a second end of the second text-entry field. In some embodiments, if the second input includes movement of the first resizing element in a first direction (e.g., a leftward direction) with a respective magnitude, such as movement of the resizing handle 621b leftward as shown in FIG. 6T, the electronic device increases the size of the first text-entry field, such as increasing the size of the text-entry field 608-7 as shown in FIG. 6U. If the second input includes movement of the first resizing element in a second direction (e.g., a rightward direction) with the respective magnitude, the electronic device decreases the size of the first text-entry field. Similarly, if the second input includes movement of the second resizing element in the first direction with the respective magnitude, the electronic device decreases the size of the first text-entry field in the document. If the second input includes movement of the second resizing element in the second direction with the respective magnitude, the electronic device increases the size of the first text-entry field. In some embodiments, the one or more selectable user interface objects are not displayed for predefined text-entry fields, such as preset text-entry region 605-1 in FIG. 6T. For example, as described above with reference to steps 752a-752c, if the document includes a second text-entry field that is a predefined text-entry field, the electronic device does not display the one or more selectable user interface objects with the second text-entry field, such as forgoing display of the preset text-entry regions 605-1 and 605-2 with the resizing handles 621a and 621b as shown in FIG. 6T. Changing a size of a text-entry field in a document in response to detecting input directed to one or more resizing elements displayed with the text-entry field reduces the number of inputs needed to change the size of the text-entry field and/or enables a more or less text to be entered into the text-entry field, thereby improving user-device interaction.

In some embodiments, the first input includes contact between an object (e.g., a finger of the user and/or an external input device, such as a stylus) and a surface (e.g., touch screen 504) a predefined number (e.g., one, two, or three) of times within a time threshold (e.g., 0.025, 0.1, 0.15, 0.25, 0.5, 0.75, 1, 1.5, 2, or 3 seconds) of one another (756). For example, the electronic device detects a double tap gesture detected on a touch sensitive surface (e.g., on the touch screen display of the electronic device) or other surface, as similarly described above with reference to steps 702a-702e. Displaying a text-entry field based on a location of a text-entry region in a document in response to detecting a double tap gesture at a location that is a threshold distance from the location of the text-entry region reduces the number of inputs needed to input text into the document at the text-entry region and/or enables a text-entry field to be displayed automatically, thereby improving user-device interaction.

It should be understood that the particular order in which the operations in FIGS. 7A-7K have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 900, 1100, and/or 1300) are also applicable in an analogous manner to method 700 described above with respect to FIGS. 7A-7K. For example, the operation of the electronic device entering text into one or more text-entry regions within a document, described above with reference to method 700, optionally has one or more of the characteristics of presenting marks with widths depending on the direction of movement of the input to make the marks, presenting marks that merge or overlap with other marks, and/or scrolling and moving a content entry palette in a user interface in response to user input (e.g., methods 900, 1100, and/or 1300). For brevity, these details are not repeated here.

The operations in the information processing methods described above are, optionally, implemented by running one or more functional modules in an information processing apparatus such as general purpose processors (e.g., as described with respect to FIGS. 1A-1B, 3, 5A-5I) or application specific chips. Further, the operations described above with reference to FIGS. 7A-7K are, optionally, implemented by components depicted in FIGS. 1A-1B. For example, displaying operations 702a, 702d, 702e, 706b, 712c, 712f, 712g, 728c, 730c, 734b, 736c, 736d, 740d, 740e, 742c, 748b, 750b, and 752c, and detecting operations 702b, 712b, 712d, 730a, 736a, 740b, 742b, 748a, and 752b, are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

### Simulated Calligraphy

Users interact with electronic devices in many different manners. In some embodiments, an electronic device presents marks in a content entry region in response to detecting drawing inputs provided by the user. The embodiments described below provide ways in which a computer system displays marks with varying thicknesses depending on the direction in which the marks were drawn. For example, displaying marks with varying thickness in this manner creates a simulated calligraphy effect. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

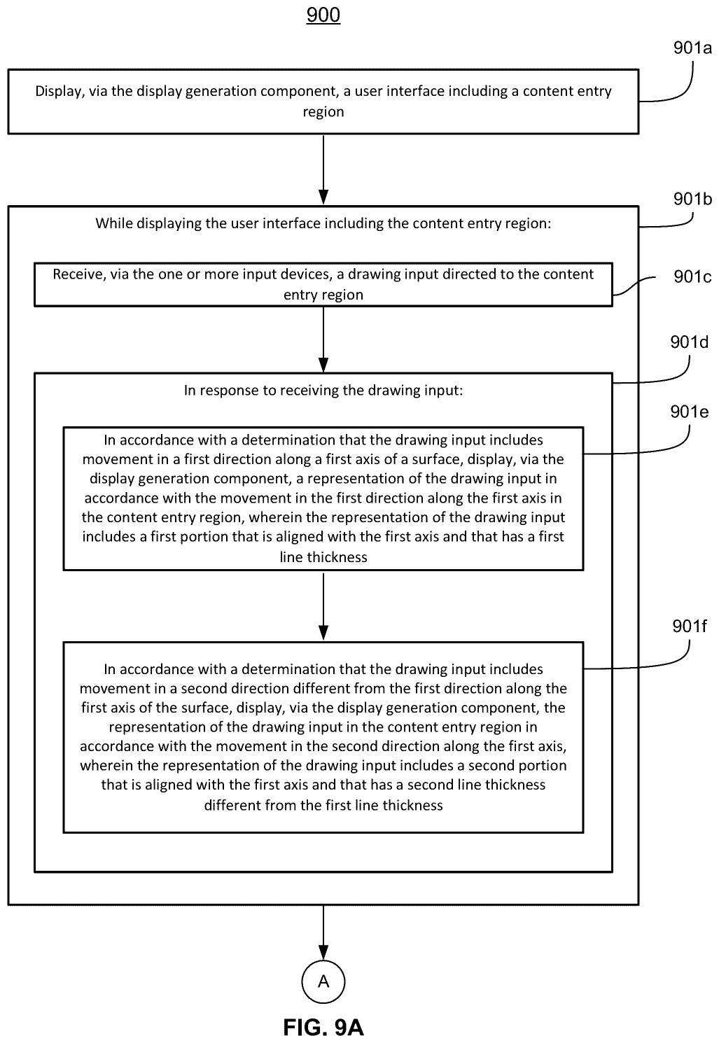

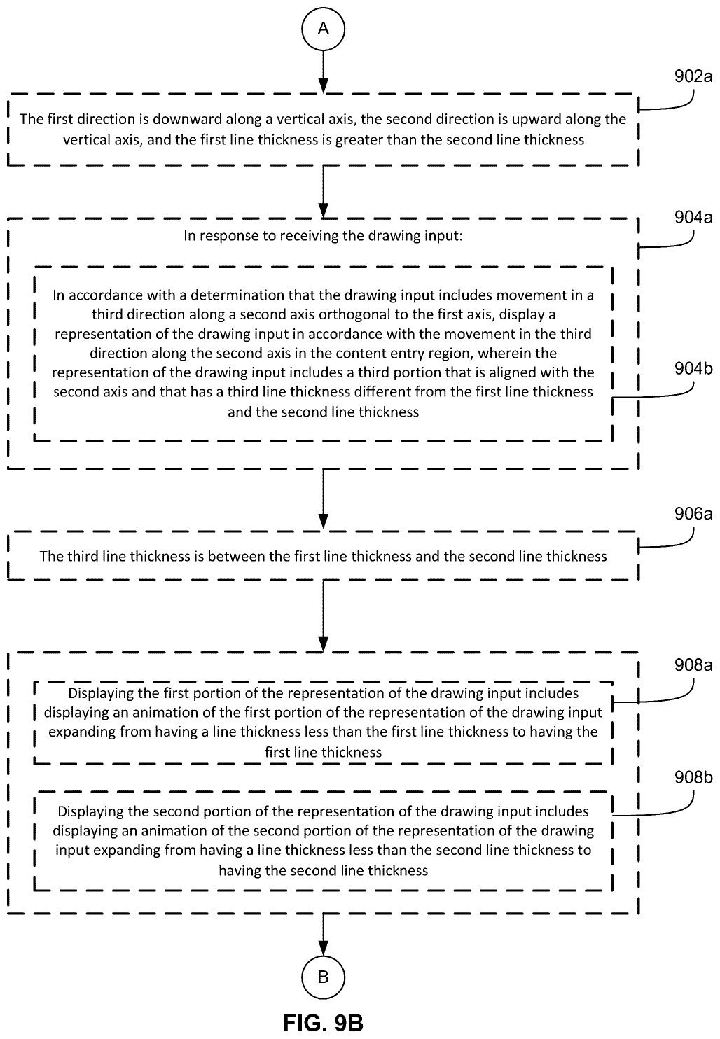

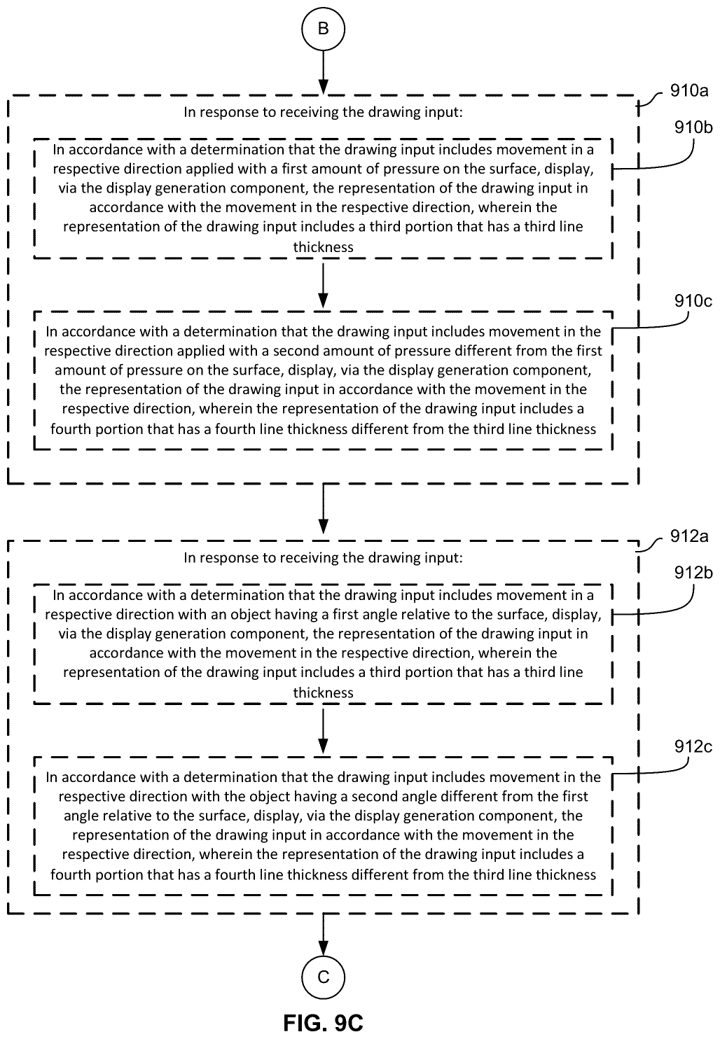

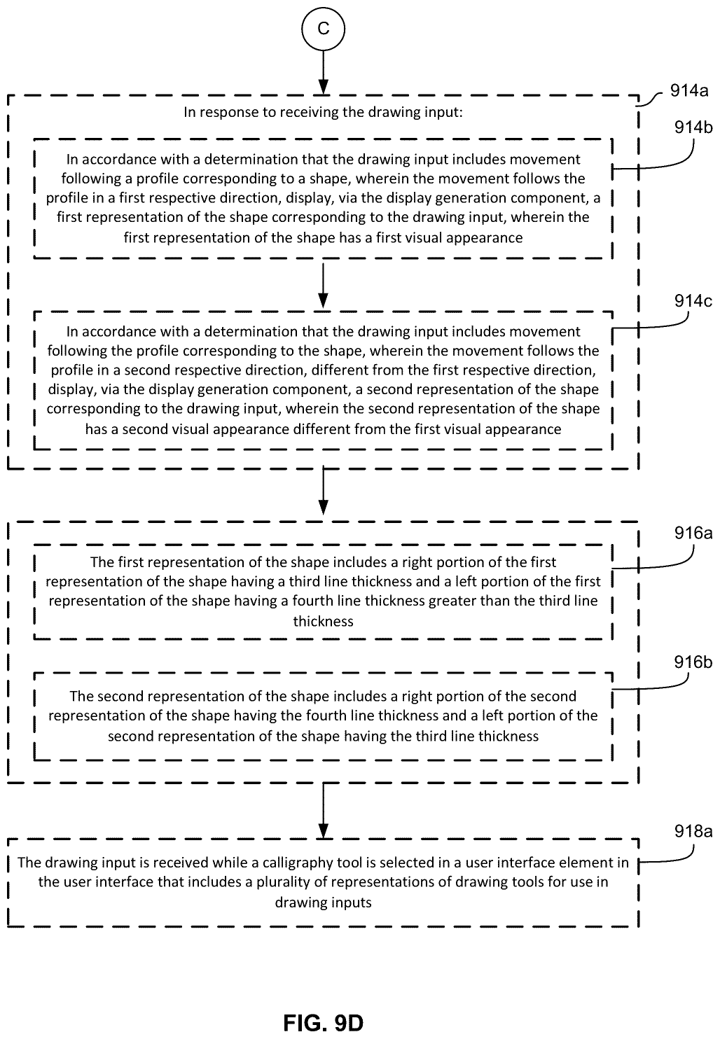

FIGS. 8A-8K illustrate exemplary ways of presenting a mark with a thickness that depends on the direction in which a drawing input is received in accordance with some embodiments of the disclosure. The embodiments in these figures are used to illustrate the processes described below, including the processes described with reference to FIGS. 9A-9D.

FIG. 8A illustrates the electronic device 500 displaying a user interface 800 of a content creation application. For example, the content creation application is a drawing application, a notetaking application, and/or a document markup application. The user interface 800 includes a content entry region 802. In some embodiments, in response to detecting inputs directed to content entry region 802, the electronic device 500 displays marks in accordance with the inputs, thus enabling the user to create content including, for example, handwriting and/or drawings in the content entry region 802 by providing inputs.

In some embodiments, the electronic device 500 detects inputs provided via input device 823. In some embodiments, input device 823 is a stylus, such as a passive stylus or an active stylus. In some embodiments, the electronic device 500 includes one or more sensors (e.g., included in touch screen 504) to detect the location of a portion (e.g., the tip) of the input device 823 while the portion of the input device 823 is in contact with or within a threshold distance of a surface (e.g., of touch screen 504). Example threshold distances are provided below in the description of method 900.

The user interface 800 further includes a menu 804 for defining settings for marks created in response to detecting inputs provided by the input device 823. Menu 804 optionally has one or more characteristics in common with the menu described below with reference to method 1300. For example, menu 804 includes an undo option 806-1, a redo option 806-2, a plurality of tool options 808-1, 808-2, 808-3, and 808-4, a keyboard option 811a, and an option 811a to display an additional menu. In some embodiments, in response to detecting selection of the undo option 806-1, the electronic device 500 ceases display of the mark corresponding to the most-recently received input from the input device 823. In some embodiments, in response to detecting selection of the redo option 806-2, the electronic device 500 displays the mark that was most recently removed by selection of the undo option 806-1. In some embodiments, in response to detection selection of a text tool 808-1, the electronic device 500 converts handwriting provided by the input device 823 to typed text, including one or more steps of method 700 described above. In some embodiments, in response to detecting selection of the pen tool 808-2, the electronic device 500 displays simulated pen marks in response to inputs provided by the input device 823. In some embodiments, in response to detecting selection of the marker tool 808-3, the electronic device 500 displays simulated marker marks in response to inputs provided by the input device 823, including one or more steps of method 1100 described below. In some embodiments, in response to detecting selection of the calligraphy tool 808-4, the electronic device 500 displays simulated calligraphy marks in response to inputs provided by the input device 823, as described with reference to FIGS. 8A-8H and method 900. In some embodiments, in response to detecting selection of one of the color options 810a-810d, the electronic device 500 changes the color of the marks displayed in response to detecting inputs received from input device 823. In some embodiments, in response to detecting selection of keyboard option 811a, the electronic device 500 displays a soft keyboard, which causes the electronic device 500 to insert text to content entry region 802 in response to one or more inputs directed the soft keyboard. In some embodiments, in response to detecting selection of menu option 811b, the electronic device 500 displays a menu with additional content creation options.

As shown in FIG. 8A, the calligraphy tool 808-4 is selected in the user interface 800. Thus, in response to detecting one or more inputs provided by input device 823, the electronic device 500 displays calligraphy marks. For example, the calligraphy marks have thicknesses that depend on the direction in which the mark was drawn with the input device 823. In some embodiments, the thickness of the marks further depends on an angle of the input device 823 relative to the drawing/writing surface and an additional characteristic 812. In some embodiments, characteristic 812 is pressure and/or speed with which the input is provided with input device 823. In FIG. 8A, the electronic device 500 detects movement of the input device 823 while the input device 823 is touching the drawing/writing surface (e.g., the surface of touch screen 504), while the calligraphy tool 808-4 is selected, while the input device 823 is at a first angle relative to the writing/drawing surface, and while characteristic 812 has a first value 814-1. As shown in FIG. 8A, the movement of the input device 823 is downward movement along the writing/drawing surface. In response to the input illustrated in FIG. 8A, the electronic device 500 presents a mark in the content entry region 802, as shown in FIGS. 8B-8C.

In some embodiments, in response to the input illustrated in FIG. 8A, the electronic device 500 presents an animation of ink spreading in the content entry region 802 along a portion of the content entry region 802 over which the input device 823 moved while providing the input, as shown in FIG. 8B. In FIG. 8B, the electronic device 500 displays mark 816-1 with an animation of the width of mark 816-1 expanding. In some embodiments, the electronic device 500 displays expansion of the mark 816-1 to reach a thickness shown in FIG. 8C.

In FIG. 8C, the electronic device 500 displays mark 816-1 at its final thickness, which depends on the direction of movement of the input device 823 during the input shown in FIG. 8A, the angle of the input device 823 relative to the writing/drawing surface, and the value of characteristic 812. In some embodiments, the electronic device 500 displays the thickest marks in response to receiving an input including downward movement of the input device 823, compared to marks in other directions with the same value for characteristic 812 and the same angle of the input device 823 relative to the drawing/writing surface.

In FIG. 8C, the electronic device 500 detects another input that includes movement of the input device 823 while the input device 823 is touching down on the writing/drawing surface with the same angle as the angle at which mark 816-1 was drawn and the same value 814-1 for characteristic 812 as the value 814-1 of characteristic 812 while mark 816-1 was drawn. As shown in FIG. 8C, the input includes horizontal movement of the input device 823 along the writing/drawing surface. In response to the input illustrated in FIG. 8C, the electronic device 500 displays a mark with less thickness than the thickness of mark 816-1, as shown in FIG. 8D.

FIG. 8D illustrates the electronic device 500 displaying the mark 816-2 in response to the input illustrated in FIG. 8C. In some embodiments, the electronic device 500 displays an animation of the mark 816-2 expanding in response to the input similar to the animation described above with reference to FIG. 8B, with the final thickness of the mark 816-2 being shown in FIG. 8D. As described above, the angle of the input device 823 relative to the drawing/writing surface and the value 814-1 of characteristic 812 are the same for mark 816-1 and mark 816-2, but, because the directions of marks 816-1 and 816-2 are different, the thicknesses of marks 816-1 and 816-2 are different. As shown in FIG. 8D, mark 816-1, which was drawn with a downward motion, is thicker than mark 816-2, which was drawn with a horizontal motion. In some embodiments, the thickness of mark 816-2 would be the same regardless of whether the input for drawing mark 816-2 included motion from left to right or motion from right to left.

In FIG. 8D, the electronic device 500 detects another input that includes movement of the input device 823 while the input device 823 is touching down on the writing/drawing surface with the same angle as the angle at which marks 816-1 and 816-2 were drawn and the same value 814-1 for characteristic 812 as the value 814-1 of characteristic 812 while marks 816-1 and 816-2 were drawn. As shown in FIG. 8D, the input includes upward vertical movement of the input device 823 along the writing/drawing surface. In response to the input illustrated in FIG. 8D, the electronic device 500 displays a mark with less thickness than the thickness of mark 816-2, as shown in FIG. 8E.

FIG. 8E illustrates the electronic device 500 displaying the mark 816-3 in response to the input illustrated in FIG. 8D. In some embodiments, the electronic device 500 displays an animation of the mark 816-3 expanding in response to the input similar to the animation described above with reference to FIG. 8B, with the final thickness of the mark 816-3 being shown in FIG. 8E. As described above, the angle of the input device 823 relative to the drawing/writing surface and the value 814-1 of characteristic 812 are the same for mark 816-1, mark 816-2, and mark 816-3 but, because the directions of marks 816-1, 816-2, and 816-3 are different, the thicknesses of marks 816-1, 816-2, and 816-3 are different. As shown in FIG. 8E, mark 816-1, which was drawn with a downward motion, is thicker than mark 816-2, which was drawn with a horizontal motion and marks 816-1 and 816-2 are thicker than mark 816-3, which was drawn with an upward motion.

In some embodiments, in response to an input that includes curved motion of the input device 823 along the writing/drawing surface, the electronic device 500 presents a mark that has a thickness that varies along segments of the mark depending on the direction of motion of the input device 823 while drawing each respective segment, as described in more detail below with reference to FIGS. 8I-8K. In some embodiments, in response to inputs that include diagonal movement of the input device 823 along the writing/drawing surface, the electronic device 500 presents a mark that has a thickness that depends on a vertical component of the movement. For example, mark drawn with diagonal downward motion would be thicker than a mark drawn with diagonal upward motion if the angles of the input device 823 and the values of characteristic 812 were the same for both marks. As another example, a mark drawn with diagonal downward motion with more downward motion than horizontal motion would be thicker than a mark drawn with diagonal downward motion with more horizontal motion than downward motion if the angles of the input device 823 and the values of characteristic 812 were the same for both marks.

In some embodiments, the electronic device 500 displays the thickest marks in response to upward movement of the input device 823 along the writing/drawing surface and the thinnest marks in response to downward movement of the input device 823 along the writing/drawing surface. In some embodiments, the electronic device 500 displays marks with the same width in response to downward or upward movement of the input device 823 along the writing/drawing surface, and changes the thickness of horizontal marks depending on whether the marks were drawn with motion of the input device 823 along the writing/drawing surface from left to right or motion from right to left.

As described above, in some embodiments, the thickness of the marks displayed by the electronic device 500 depends on the value of characteristic 812. FIG. 8F illustrates the electronic device 500 displaying marks 816-1, 816-2, and 816-3 that were drawn while the characteristic 812 had the value 814-1 illustrated in FIGS. 8A-8E. In FIG. 8F, the electronic device 500 receives an input including upward movement of input device 823 while characteristic 812 has the value 814-2 and the angle of the input device 823 relative to the writing/drawing surface has the same angle as the angles of the input device 823 while creating marks 816-1, 816-2, and 816-3. In response to the input illustrated in FIG. 8F, the electronic device 500 displays a mark with less thickness than mark 816-3, as shown in FIG. 8G.

FIG. 8G illustrates the electronic device 500 displaying mark 816-4 in response to the input illustrated in FIG. 8F. Mark 816-3 and mark 816-4 were both drawn with upward movement of the input device 823 along the writing/drawing surface with the same angle of the input device 823 relative to the writing/drawing surface, but mark 816-4 is thinner than mark 816-3 because characteristic 812 had value 814-2 while mark 816-4 was drawn, which is less than the value 814-1 of characteristic 812 while mark 816-3 was drawn. Thus, in some embodiments, the thickness of marks displayed by the electronic device 500 depends on the value of characteristic 812.

As shown in FIG. 8G, the electronic device 500 receives an input including upward movement of the input device 823 while characteristic 812 has the same value 814-2 as the value 814-2 of characteristic 812 while mark 816-4 was drawn, and while the angle of the input device 823 relative to the writing/drawing surface is more vertical than the angle of the input device 823 relative to the writing/drawing surface while drawing mark 816-4. In response to the input illustrated in FIG. 8G, the electronic device 500 displays the mark shown in FIG. 8H.

FIG. 8H illustrates the electronic device 500 displaying mark 816-5 in response to the input illustrated in FIG. 8G. Mark 816-4 and mark 816-5 were both drawn with upward movement of the input device 823 along the writing/drawing surface with the value 814-2 for characteristic 812, but mark 816-5 is thinner than mark 816-4 because the angle of the input device 823 relative to the writing/drawing surface was more vertical while mark 816-5 was drawn than the angle while mark 816-4 was drawn. Thus, in some embodiments, the thickness of marks displayed by the electronic device 500 depends on the angle of the input device 823 relative to the writing/drawing surface.

In some embodiments, the thickness of marks displayed by the electronic device 500 depends on the direction of movement of the input device 823, the value of characteristic 812, and the angle of the input device 823 relative to the writing/drawing surface while the marks were drawn. In some embodiments, these characteristics influence the thickness of the marks as shown in table 1 below:

TABLE 1

| Relatively thin marks | Relatively moderate marks | Relatively thick marks |
|---|---|---|
| Upward movement | Horizontal movement | Downward movement |
| Low value for | Medium value for | High value for |
| characteristic 812 | characteristic 812 | characteristic 812 |
| More vertical input | Moderate input | More horizonal input |
| device 823 angle | device 823 angle | device 823 angle |

Because the thickness of a mark depends on a plurality of characteristics of the input that caused display of the mark, in some situations, the relative thicknesses of two marks may not correspond to the relative values for one of the characteristics, if one or more other characteristics correspond to a different relative thickness of the two marks. For example, a first upward mark may have more thickness than a second downward mark if the upward mark is drawn with a high value for characteristic 812 and/or a relatively horizontal angle of the input device 823 and the downward mark is drawn with a low value for characteristic 812 and/or a relatively vertical angle of the input device 823. As another example, a first mark drawn with a relatively low value for characteristic 812 may be thicker than a second mark drawn with a relatively high value for characteristic 812 if the first mark is drawn with downward movement and/or a relatively horizontal angle of input device 823 and the second mark is drawn with upward movement and/or a relatively vertical angle of input device 823. As another example, a first mark drawn with a relatively vertical angle of input device 823 may be thicker than a second mark drawn with a relatively horizontal angle of input device 823 if the first mark is drawn with downward movement and/or a relatively high value for characteristic 812 and the second mark is drawn with upward movement and/or a relatively low value for characteristic 812.

In some embodiments, because the thickness of a mark depends on the direction in which the mark was drawn, it is possible for two marks with the same shape to have different thickness profiles if they were drawn in different directions. For example, a shape drawn clockwise would have a different thickness profile than a shape drawn counterclockwise, as described with reference to FIGS. 8I-8K.

In FIG. 8I, the electronic device 500 receives an input including clockwise movement of the input device 823 along the writing/drawing surface while characteristic 812 has value 814-2. In some embodiments, the input device 823 starts and ends at the same location, creating a closed circle shape. In response to the input illustrated in FIG. 8I, the electronic device 500 displays the shape shown in FIG. 8J.

FIG. 8J illustrates the electronic device 500 displaying a shape 816-6 in response to the input illustrated in FIG. 8I. Shape 816-6 includes a relatively thick segment 818-3 drawn while the input device 823 was moving downward, a relatively thin segment 818-4 drawn while the input device 823 was moving upward, and moderate segments 818-1 and 818-2 drawn while the input device 823 was moving horizontally. As shown in FIG. 8J, the thickness of shape 816-6 varies between segments 818-1, 818-2, 818-3, and 818-4 depending on the proportions of the vertical and horizontal components of movement of the input device 823 and whether the vertical portions were drawn upward or downward while the various locations of shape 816-6 were being drawn.

As shown in FIG. 8J, the electronic device 500 receives an input including counterclockwise movement of the input device 823 along the writing/drawing surface while the angle of the input device 823 and the value 814-2 of the characteristic 812 are the same as those while shape 816-6 was drawn. In some embodiments, the input device 823 starts and ends at the same location, creating a closed circle shape. In some embodiments, the contours of the movement of the input device 823 in FIG. 8J are the same as those of the input device 823 while drawing shape 816-6, but the movement of the input device 823 is in the opposite direction (e.g., counterclockwise, as opposed to clockwise). In response to the input shown in FIG. 8J, the electronic device 500 displays the shape shown in FIG. 8K.

FIG. 8K illustrates the electronic device 500 displaying a shape 816-7 in response to the input illustrated in FIG. 8J. Shape 816-7 includes a relatively thick segment 820-4 drawn while the input device 823 was moving downward, a relatively thin segment 820-3 drawn while the input device 823 was moving upward, and moderate segments 820-1 and 820-2 drawn while the input device 823 was moving horizontally. As shown in FIG. 8K, the thickness of shape 816-7 varies between segments 820-1, 820-2, 820-3, and 820-4 depending on the proportions of the vertical and horizontal components of movement of the input device 823 and whether the vertical portions were drawn upward or downward while the various locations of shape 816-6 were being drawn.

As shown in FIG. 8K, although shapes 816-6 and 816-7 have the same contours, the thicknesses of the outlines of shapes 816-6 and 816-7 are different because shapes 816-6 and 816-7 were drawn in different directions. For example, shape 816-6 has thick portion 818-3 on the right, whereas shape 816-7 has thick portion 820-4 on the left because shape 816-6 was drawn in a clockwise direction, with downward movement on the right, whereas shape 816-7 was drawn in a counterclockwise direction, with downward movement on the left. As another example, shape 816-6 has thin portion 818-3 on the left, whereas shape 816-7 has thin portion 820-4 on the right because shape 816-6 was drawn in a clockwise direction, with upward movement on the left, whereas shape 816-7 was drawn in a counterclockwise direction, with upward movement on the right.

FIGS. 9A-9D is a flow diagram illustrating an exemplary method of presenting a mark with a thickness that depends on the direction in which a drawing input is received in accordance with some embodiments of the disclosure. The method 900 is optionally performed at an electronic device such as device 100, device 300, device 500, device 501, device 510, and device 591 as described above with reference to FIGS. 1A-1B, 2-3, 4A-4B and 5A-5I. Some operations in method 900 are, optionally combined and/or order of some operations is, optionally, changed.

As described below, the method 900 provides for interaction with simulated marks, including modifying the width of the simulated marks in accordance with the direction in which the simulated marks were drawn. The method reduces the cognitive burden on a user when interacting with a user interface of the device of the disclosure, thereby creating a more efficient human-machine interface. For battery-operated electronic devices, increasing the efficiency of the user's interaction with the user interface conserves power and increases the time between battery charges.

In some embodiments, method 900 is performed at an electronic device (e.g., 500) in communication with a display generation component (e.g., 504) and one or more input devices (e.g., 504 and/or 823), such as in FIG. 8A. For example, the electronic device is the electronic device described above with reference to method 700. In some embodiments, the display generation component is the display generation component described above with reference to method 700.

In some embodiments, the electronic device (e.g., 500) displays (901a), via the display generation component (e.g., 504), a user interface (e.g., 800) including a content entry region (e.g., 802) (e.g., canvas region), such as in FIG. 8A. In some embodiments, the user interface is the user interface described with respect to method(s) 1100 and/or 1300. In some embodiments, the content entry region is a region of the user interface in which the computer system displays drawings and/or handwriting in response to drawing and/or handwriting inputs detected using the one or more input devices. For example, the computer system detects drawing and/or handwriting using a stylus, electronic pencil, or similar input device and/or a touch sensitive surface, such as a trackpad, tablet, or touch screen directed to the content entry region. In some embodiments, the content entry region has a simulated paper background, such as a blank background, a lined background, a dotted background, or a grid background. For example, the user interface is a user interface of a notetaking application or a drawing application. In some embodiments, the content entry region is a document including text, images, tables and/or charts. For example, the user interface is the user interface of a document reading and/or editing application and the handwriting and/or drawing is markup on the document.

In some embodiments, while displaying the user interface (e.g., 800) including the content entry region (e.g., 802) (901b), the electronic device (e.g., 500) receives (902c), via the one or more input devices, a drawing input directed to the content entry region (e.g., 802), such as in FIG. 8A. In some embodiments, such as in FIG. 8A, the drawing input is provided by an object, such as a stylus (e.g., 823), digital pen, or similar input device or a portion of the user's body (e.g., finger). In some embodiments, the electronic device detects the location of the object or a portion of the object (e.g., the tip of the stylus) using an input device, such as a touch sensitive surface or other surface, including one of the touch sensitive surfaces described above. In some embodiments, detecting the drawing input includes detecting movement of the object while the object is in contact with or within a threshold distance (e.g., 0.05, 0.1, 0.2, 0.3, 0.5, 1, 2, 3, or 5 centimeters) of a touch sensitive surface or other surface. In some embodiments, the surface with which the object is interacting and/or contacting as part of the drawing input is the touch-sensitive surface, a physical surface on which the user interface is projected, or a virtual surface corresponding to at least a portion of the user interface.

In some embodiments, while displaying the user interface (e.g., 800) including the content entry region (e.g., 802) (901b), in response to receiving the drawing input (901d), in accordance with a determination that the drawing input includes movement in a first direction along a first axis of a surface (e.g., a display, a touch-sensitive display, or a touch-sensitive surface), such as in FIG. 8A, the electronic device (e.g., 500) displays (901e), via the display generation component (e.g., 504), a representation (e.g., 816-1) of the drawing input in accordance with the movement in the first direction along the first axis in the content entry region (e.g., 802), wherein the representation (e.g., 816-1) of the drawing input includes a first portion that is aligned with the first axis and that has a first line thickness, such as in FIG. 8C. In some embodiments, the representation of the drawing input includes markings at locations at which a portion the first input device moved during the movement of the first input device. For example, the representation of the drawing input includes markings at locations on a touch screen at which the tip of a stylus moved while the electronic device detected the drawing input. In some embodiments, the movement of the object includes movement in the first direction and movement in another direction that is orthogonal to the first axis. For example, the first axis is vertical and the other direction is right or left. As another example, the first axis is horizontal and the other direction is up or down.

In some embodiments, while displaying the user interface (e.g., 800) including the content entry region (e.g., 802) (901b), in response to receiving the drawing input (901d), in accordance with a determination that the drawing input includes movement in a second direction different from the first direction along the first axis of the surface (e.g., 504), such as in FIG. 8D, the electronic device (e.g., 500) displays (9010, via the display generation component (e.g., 504), the representation (e.g., 816-3) of the drawing input in the content entry region (e.g., 802) in accordance with the movement in the second direction along the first axis, wherein the representation (e.g., 816-3) of the drawing input includes a second portion that is aligned with the first axis and that has a second line thickness different from the first line thickness. In some embodiments, the first direction is up, the second direction is down, and the axis is a vertical axis. In some embodiments, the first direction is left, the second direction is right, and the axis is a horizontal axis. In some embodiments, the movement of the input device includes movement in the second direction and movement in another direction that is orthogonal to the first axis in a manner similar to the manner described above. In some embodiments, the representation of the drawing input includes a portion drawn in the first direction that has the first line thickness and a portion drawn in the second direction that has the second line thickness. In some embodiments, the first line thickness is greater than the second line thickness. In some embodiments, the second line thickness is greater than the first line thickness. In some embodiments, the drawing input has one or more additional characteristics that impact the width of the representation of the drawing input, such as force, speed, and/or thickness and/or type of simulated pen tip selected while the drawing input was received. In some embodiments, in response to receiving a first drawing input having the one or more additional characteristics with first values that includes movement of the first input device in the first direction, the electronic device displays the representation of the drawing input with a first portion having the first line thickness. In some embodiments, in response to receiving a second drawing input having the one or more additional characteristics with the first values that includes movement of the first input device in the second direction, the electronic device displays the representation of the drawing input with a second portion having the second line thickness. In some embodiments, if the one or more additional characteristics of the first drawing input and the second drawing input have the same values, but the first drawing input includes the movement in the first direction and the second drawing input includes the movement in the second direction, the representation of the first drawing input and the representation of the second drawing input have different thicknesses because they include movement in the first direction or second direction, respectively.

Displaying the representation of the drawing input with a different line thickness depending on the direction in which the drawing was drawn enhances user interactions with the computer system by providing an efficient way of creating drawings and/or handwriting with varying line thicknesses with fewer drawing strokes and, thus, inputs.

In some embodiments, such as in FIG. 8E, the first direction is downward along a vertical axis, the second direction is upward along the vertical axis, and the first line thickness is greater than the second line thickness (902a). In some embodiments, the electronic device receives one or more drawing inputs that include movement components in both the vertical axis and the horizontal axis, such as diagonal movement. In some embodiments, in response to receiving a drawing input that includes diagonal movement, the electronic device displays a representation of the drawing input with a line thickness corresponding to the movement components. For example, a representation of a drawing input that includes downward diagonal movement is thicker than a representation of a drawing input that includes upward diagonal movement. Displaying vertical lines drawn with downward movement thicker than vertical lines drawn with upward movement enhances user interactions with the electronic device by reducing the number of inputs needed to create a simulated calligraphy effect.

In some embodiments, in response to receiving the drawing input (904a), in accordance with a determination that the drawing input includes movement in a third direction along a second axis orthogonal to the first axis, such as in FIG. 8C, the electronic device (e.g., 500) displays (904b) a representation (e.g., 816-2) of the drawing input in accordance with the movement in the third direction along the second axis in the content entry region, wherein the representation (e.g., 816-2) of the drawing input includes a third portion that is aligned with the second axis and that has a third line thickness different from the first line thickness and the second line thickness. In some embodiments, the first axis is the vertical axis and the second axis is the horizontal axis. In some embodiments, in response to receiving a drawing input that includes diagonal movement, the electronic device displays a representation of the drawing input with a line thickness corresponding to the movement components, as described above at least with reference to step 904a. For example, a representation of a drawing input that includes downward diagonal movement that is more vertical than horizontal is thicker than a representation of a drawing input that includes downward diagonal movement that is more horizontal than vertical. In some embodiments, the first axis is the horizontal axis and the second axis is the vertical axis. Displaying a representation of a drawing input including movement along the second axis with the third thickness enhances user interactions with the electronic device by reducing the inputs needed to create a simulated calligraphy effect.

In some embodiments, such as in FIG. 8E, the third line thickness is between the first line thickness and the second line thickness (906a). In some embodiments, in response to receiving a drawing input that includes diagonal movement, the electronic device displays a representation of the drawing input with a line thickness corresponding to the movement components, as described above at least with reference to step 904a. For example, a representation of a drawing input that includes downward diagonal movement that is more vertical than horizontal is thicker than a representation of a drawing input that includes downward diagonal movement that is more horizontal than vertical, which is thicker than a representation of a drawing input that includes upward diagonal movement. Displaying a representation of a drawing input including movement along the second axis with the third thickness between the first and second thicknesses enhances user interactions with the electronic device by reducing the inputs needed to create a simulated calligraphy effect.

In some embodiments, displaying the first portion of the representation (e.g., 816-1) of the drawing input, such as in FIG. 8C, includes displaying an animation of the first portion (e.g., 816-1) of the representation of the drawing input expanding from having a line thickness less than the first line thickness to having the first line thickness (908a), such as in FIG. 8B. In some embodiments, the animation begins while the drawing input is still being detected. For example, the electronic device displays the animated expansion of a portion of the representation of the drawing input corresponding to a portion of the drawing input already received while a second portion of the drawing input is still being received. In some embodiments, the electronic device displays the first portion of the representation of the drawing input at the first line thickness while still displaying the animation of the second portion of the representation of the first drawing input.

In some embodiments, displaying the second portion of the representation (e.g., 816-3) of the drawing input, such as in FIG. 8E, includes displaying an animation of the second portion of the representation (e.g., 816-3) of the drawing input expanding from having a line thickness less than the second line thickness to having the second line thickness (908b). In some embodiments, the thickness of the first portion of the representation at the start of the animation is the same as the thickness of the second portion of the representation at the start of the animation, even though the first and second line thicknesses are different. In some embodiments, if the first line thickness is greater than the second line thickness, the thickness of the first portion of the representation at the start of the animation is greater than the thickness of the second portion of the representation at the start of the animation. In some embodiments, if the first line thickness is less than the second line thickness, the first portion of the representation at the start of the animation is less than the thickness of the second portion of the representation at the start of the animation.

Animating the line thickness of the representation of the drawing input increase over time enhances user interactions with the computer system by providing enhanced visual feedback to the user.

In some embodiments, in response to receiving the drawing input (910a), in accordance with a determination that the drawing input includes movement in a respective direction applied with a first amount (e.g., 814-1) of pressure (e.g., characteristic 812) on the surface (e.g., 504), such as in FIG. 8D, the electronic device (e.g., 500) displays (910b), via the display generation component (e.g., 504), the representation (e.g., 816-3) of the drawing input in accordance with the movement in the respective direction, wherein the representation (e.g., 816-3) of the drawing input includes a third portion that has a third line thickness, such as in FIG. 8E. In some embodiments, the electronic device detects the pressure of the drawing input using one or more sensors of a touch sensitive surface and/or one or more sensors of a stylus or other input device with which the user “draws.”

In some embodiments, in response to receiving the drawing input (910a), in accordance with a determination that the drawing input includes movement in the respective direction applied with a second amount (e.g., 814-2) of pressure (e.g., characteristic 812) different from the first amount of pressure on the surface (e.g., 504), such as in FIG. 8F, the electronic device (e.g., 500) displays (910c), via the display generation component (e.g., 504), the representation (816-4) of the drawing input in accordance with the movement in the respective direction, wherein the representation (e.g., 816-4) of the drawing input includes a fourth portion that has a fourth line thickness different from the third line thickness, such as in FIG. 8G. In some embodiments, if the second amount of pressure is greater than the first amount of pressure, the fourth line thickness is greater than the third line thickness. In some embodiments, if the second amount of pressure is greater than the first amount of pressure, the fourth line thickness is less than the third line thickness. In some embodiments, the line thickness of a representation of a drawing input depends on the pressure included in the drawing input and the direction of movement included in the drawing input. For example, in response to detecting a drawing in input including movement in the first direction with first pressure, the line thickness is the first line thickness; in response to detecting a drawing in input including movement in the first direction with second pressure greater than the first pressure, the line thickness is thicker than the first line thickness; and in response to detecting a drawing in input including movement in the first direction with third pressure less than the first pressure, the line thickness is less than the first line thickness. As another example, in response to detecting a drawing in input including movement in the second direction with first pressure, the line thickness is the second line thickness; in response to detecting a drawing in input including movement in the second direction with second pressure greater than the first pressure, the line thickness is thicker than the second line thickness; and in response to detecting a drawing in input including movement in the second direction with third pressure less than the first pressure, the line thickness is less than the second line thickness. Changing the line thickness of a representation of a drawing input in accordance with the pressure of the drawing input enhances user interactions with the computer system by providing additional controls for changing the thickness of a representation of the drawing input without interacting with displayed options.

In some embodiments, in response to receiving the drawing input (912a), in accordance with a determination that the drawing input includes movement in a respective direction with an object (e.g., 823) having a first angle relative to the surface (e.g., 504), such as in FIG. 8F, the electronic device (e.g., 500) displays (912b), via the display generation component (e.g., 504), the representation (e.g., 816-4) of the drawing input in accordance with the movement in the respective direction, wherein the representation (e.g., 816-4) of the drawing input includes a third portion that has a third line thickness, such as in FIG. 8G. In some embodiments, the electronic device detects the angle of the object using one or more sensors in a touch-sensitive surface, one or more cameras, and/or one or more sensors included in the object (e.g., a stylus). For example, such as in FIG. 8F, the angle is an angle between a stylus (e.g., 823) the user is using to write/draw and the surface (e.g., 504) is the writing/drawing surface.

In some embodiments, in response to receiving the drawing input (912a), in accordance with a determination that the drawing input includes movement in the respective direction with the object (e.g., 823) having a second angle different from the first angle relative to the surface (e.g., 504), such as in FIG. 8G, the electronic device (e.g., 500) displays (912c), via the display generation component (e.g., 504), the representation (e.g., 816-5) of the drawing input in accordance with the movement in the respective direction, wherein the representation (e.g., 816-5) of the drawing input includes a fourth portion that has a fourth line thickness different from the third line thickness, such as in FIG. 8H. In some embodiments, if the first angle is greater than the second angle, the third line thickness is thinner than the fourth line thickness. In some embodiments, if the first angle is greater than the second angle, the third line thickness is thicker than the fourth line thickness. For example, in response to detecting a drawing in input including movement in the first direction while the object has the first angle, the line thickness is the first line thickness; in response to detecting a drawing in input including movement in the first direction with an angle less than the first angle, the line thickness is thicker than the first line thickness; and in response to detecting a drawing input including movement in the first direction while the object is at an angle greater than the first angle, the line thickness is less than the first line thickness. As another example, in response to detecting a drawing input including movement in the second direction with the object at a second angle, the line thickness is the second line thickness; in response to detecting a drawing in input including movement in the second direction while the object is at an angle less than the second angle, the line thickness is thicker than the second line thickness; and in response to detecting a drawing in input including movement in the second direction while the angle of the object is greater than the second angle, the line thickness is less than the second line thickness. Changing the line thickness of a representation of a drawing input in accordance with the angle of an object during the drawing input enhances user interactions with the computer system by providing additional controls for changing the thickness of a representation of the drawing input without interacting with displayed options.

In some embodiments, in response to receiving the drawing input (914a), in accordance with a determination that the drawing input includes movement following a profile corresponding to a shape (e.g., with first speed, pressure, and angle between object and surface), wherein the movement follows the profile in a first respective direction, such as in FIG. 8I, the electronic device (e.g., 500) displays (914b), via the display generation component (e.g., 504), a first representation (e.g., 816-6) of the shape corresponding to the drawing input, wherein the first representation (e.g., 816-6) of the shape has a first visual appearance, such as in FIG. 8J. In some embodiments, the visual appearance includes how the line thickness of the representation changes as location along the representation changes. For example, the first visual appearance for representation 816-6 in FIG. 8K includes a thick portion 818-3 along the right side of the representation 816-6 and a thin portion 813-4 along the left side of the representation 816-6 connected by medium portions 818-1 and 818-2 along the top and bottom of the representation 816-6, respectively. In some embodiments, the shape is a circle, oval, square, triangle, or star. In some embodiments, the shape includes curved lines. In some embodiments, the shape includes straight lines. In some embodiments, the first respective direction is clockwise or counterclockwise.

In some embodiments, in response to receiving the drawing input (914a), in accordance with a determination that the drawing input includes movement following the profile corresponding to the shape, wherein the movement follows the profile in a second respective direction, different from the first respective direction (e.g., with the first speed, pressure, and angle between the object and surface), such as in FIG. 8J, the electronic device (e.g., 500) displays (914c), via the display generation component (e.g., 504), a second representation (e.g., 816-7) of the shape corresponding to the drawing input, wherein the second representation (e.g., 816-7) of the shape has a second visual appearance different from the first visual appearance, such as in FIG. 8K. For example, the second visual appearance for representation 816-7 in FIG. 8K includes a thin portion 820-3 along the right side of the representation 816-7 and a thick portion 820-4 along the left side of the representation 816-7 connected by medium portions 820-1 and 820-2 along the top and bottom of the representation 816-7, respectively. In some embodiments, portions of the shape drawn in the first direction have the first line thickness and portions of the shape drawn in the second direction have the second line thickness, so if the shape is drawn clockwise, different portions will have the first and second thicknesses, respectively, that would be the case if the shape is drawn counterclockwise. In some embodiments, the first respective direction is clockwise or counterclockwise. Displaying the representation of the drawing input with a different visual appearances depending on the direction in which the shape was drawn enhances user interactions with the computer system by reducing the inputs needed to create a simulated calligraphy effect.

In some embodiments, such as in FIG. 8K, the first representation (e.g., 816-6) of the shape includes a right portion (e.g., 818-3) of the first representation of the shape having a third line thickness and a left portion (e.g., 818-4) of the first representation (e.g., 816-6) of the shape having a fourth line thickness greater than the third line thickness (916a). For example, representation 816-7 in FIG. 8K has the line thickness profile described above with reference to step 916c. In some embodiments, the shape is a circle and the right portion includes a portion of the circle that has a vertical line on the right side of the circle and the left portion includes a portion of the circle that has a vertical line on the left side of the circle.

In some embodiments, such as in FIG. 8K, the second representation (e.g., 816-7) of the shape includes a right portion (e.g., 820-3) of the second representation (e.g., 816-7) of the shape having the fourth line thickness and a left portion (e.g., 820-4) of the second representation (e.g., 816-7) of the shape having the third line thickness (916b). For example, representation 816-6 in FIG. 8K has the line thickness profile described above with reference to step 916b. In some embodiments, the shape is a circle and the right portion includes a portion of the circle that has a vertical line on the right side of the circle and the left portion includes a portion of the circle that has a vertical line on the left side of the circle. Displaying the representation of the drawing input with a different line thickness profile depending on the direction in which the shape was drawn enhances user interactions with the computer system by reducing the inputs needed to create a simulated calligraphy effect.

In some embodiments, such as in FIG. 8A, the drawing input is received while a calligraphy tool (e.g., 808-4) is selected in a user interface element (e.g., 810) in the user interface (e.g., 800) that includes a plurality of representations (e.g., 808-1 through 808-4) of drawing tools for use in drawing inputs (918a). In some embodiments, the user interface element has one or more characteristics described below with reference to method 1300. In some embodiments, the user interface element includes a plurality of drawing tools, including the drawing tools described with reference to method(s) 700, 1100, and/or 1300. In some embodiments, in response to detecting selection of a different drawing tool that does not include displaying representations of drawing inputs with different line thicknesses depending on the direction of movement included in the drawing input, the electronic device displays a representation of a subsequent drawing input with a line thickness independent of the direction of movement included in the drawing input. For example, the line thickness would be the same regardless of whether the movement along the first axis is in the first direction or the second directions if a drawing tool other than the calligraphy tool is selected while the drawing input is received. Providing the simulated calligraphy effect in response to the calligraphy tool being selected in the user interface element enhances user interactions with the computer system by reducing the inputs needed to create a simulated calligraphy effect and providing an efficient way to cease creating the simulated calligraphy effect.

It should be understood that the particular order in which the operations in FIGS. 9A-9D have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method(s) 700, 1100, and/or 1300) are also applicable in an analogous manner to method 900 described above with respect to FIGS. 9A-9D. For example, the operation of the electronic device displaying marks with varying widths described above with reference to method 900 optionally has one or more of the characteristics of entering text into text entry regions, displaying merging and overlapping marks, and/or manipulating a content entry palette described herein with reference to other methods described herein (e.g., method(s) 700, 1100, and/or 1300). For brevity, these details are not repeated here.

The operations in the information processing methods described above are, optionally, implemented by running one or more functional modules in an information processing apparatus such as general purpose processors (e.g., as described with respect to FIGS. 1A-1B, 3, 5A-5I) or application specific chips. Further, the operations described above with reference to FIGS. 9A-9D are, optionally, implemented by components depicted in FIGS. 1A-1B. For example, displaying operations 901a, 901e, and/or 901f and/or receiving operation 901c are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

### Merging and Overlapping Simulated Marks

Users interact with electronic devices in many different manners. In some embodiments, an electronic device presents marks in a content entry region in response to detecting drawing inputs provided by the user. The embodiments described below provide ways in which a computer system displays marks that merge with or overlap with existing marks, depending on how much time passes between the inputs corresponding to the marks are received. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

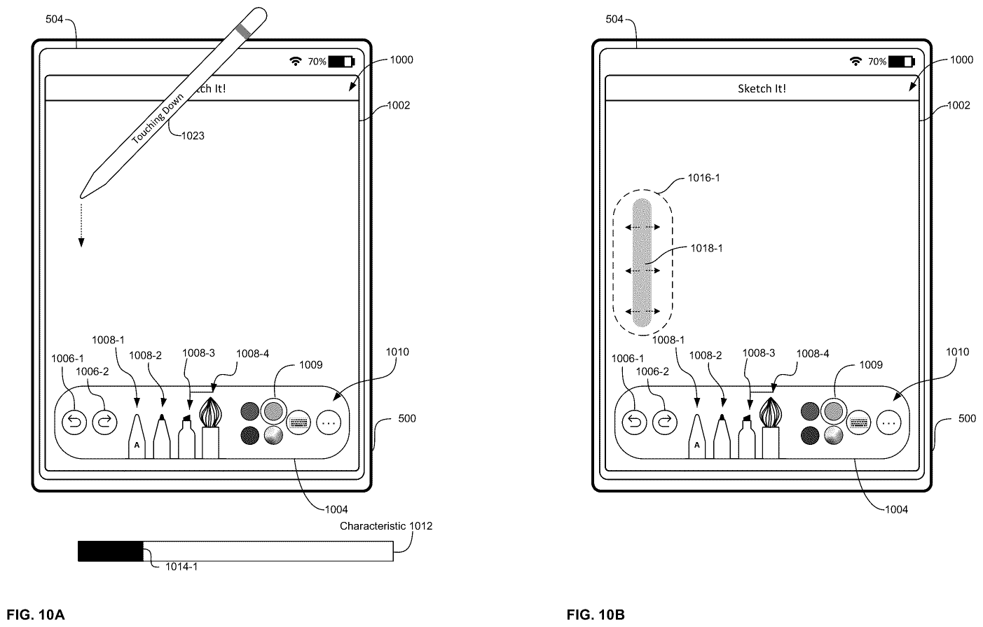

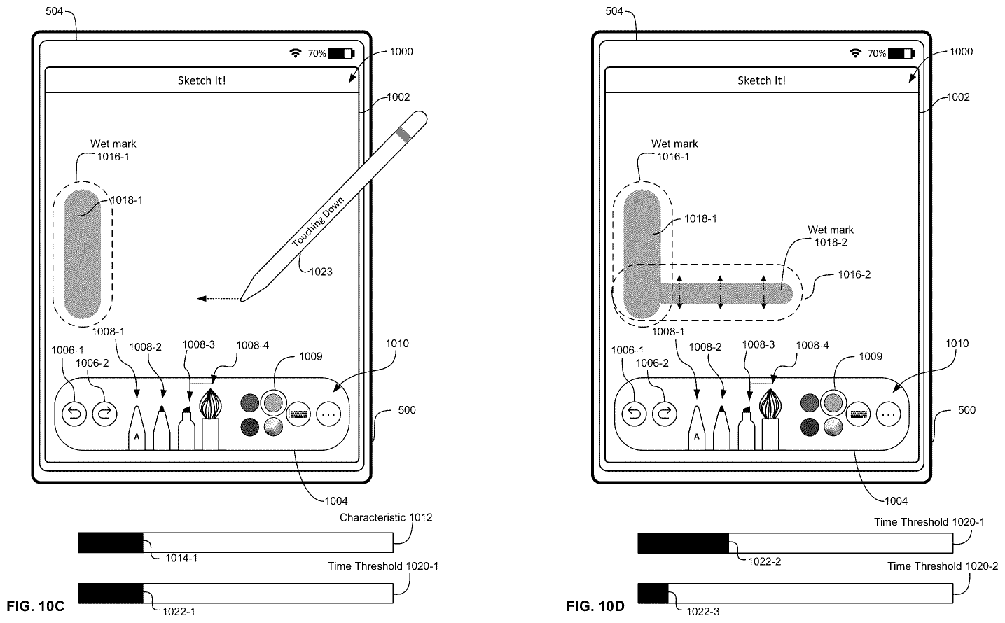

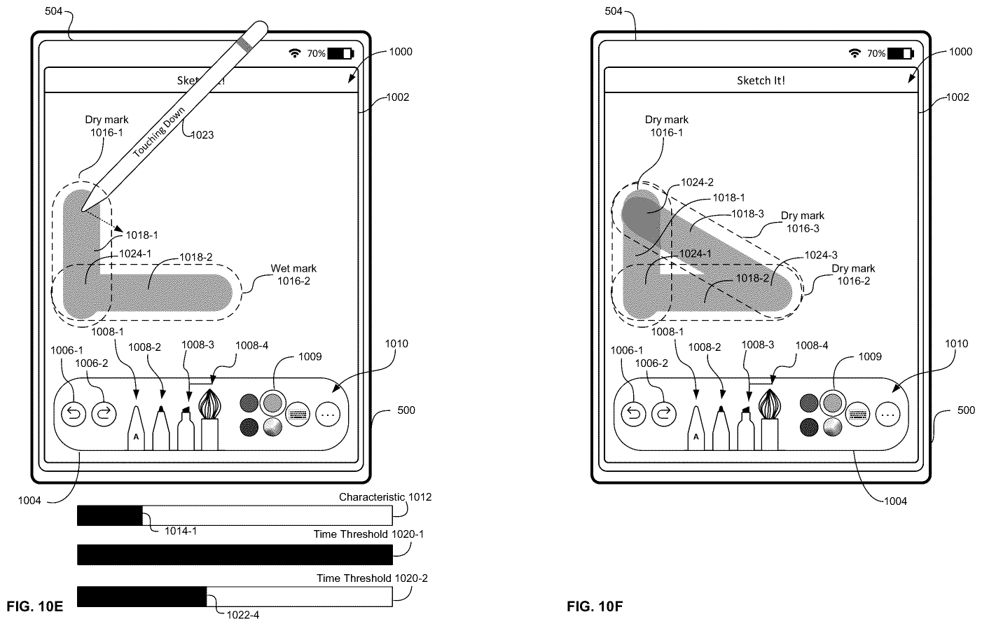

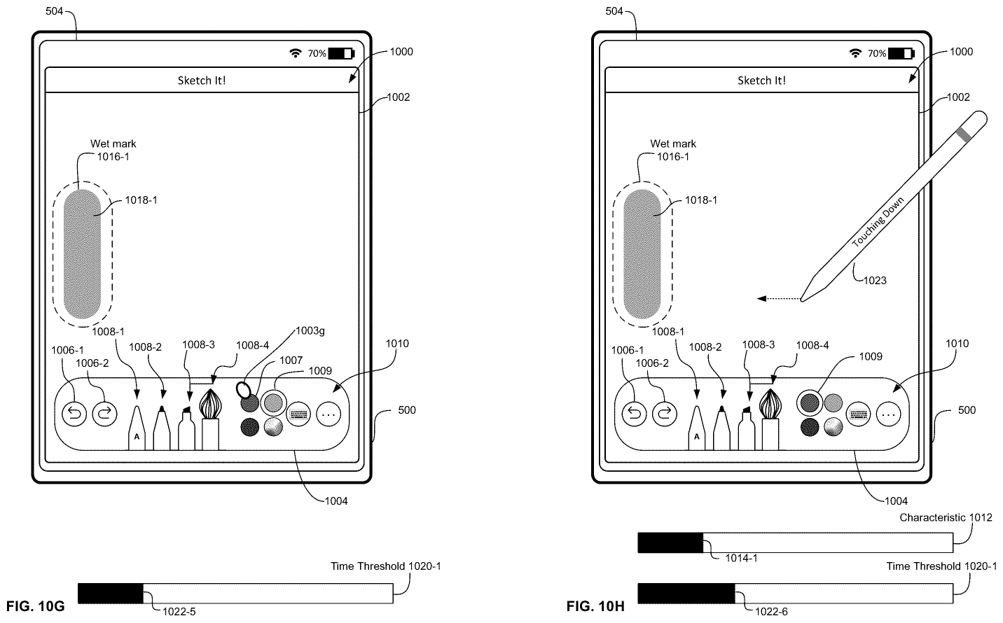

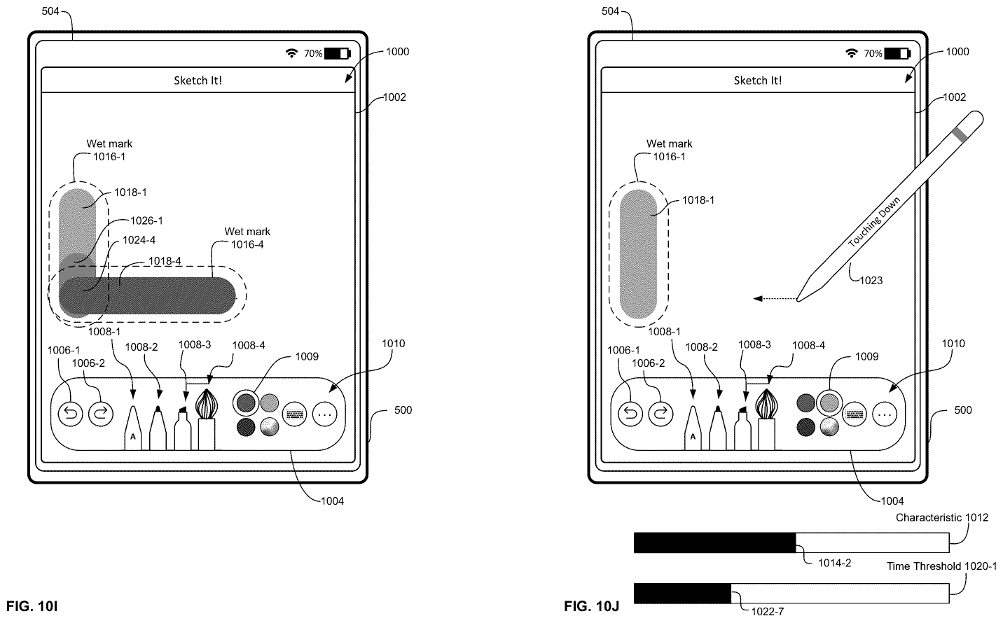

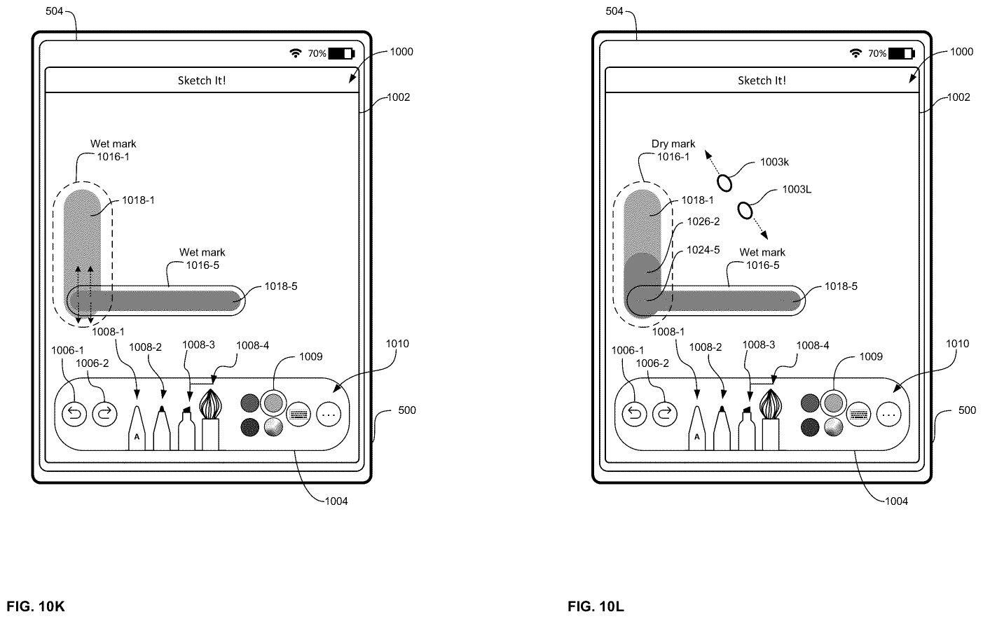

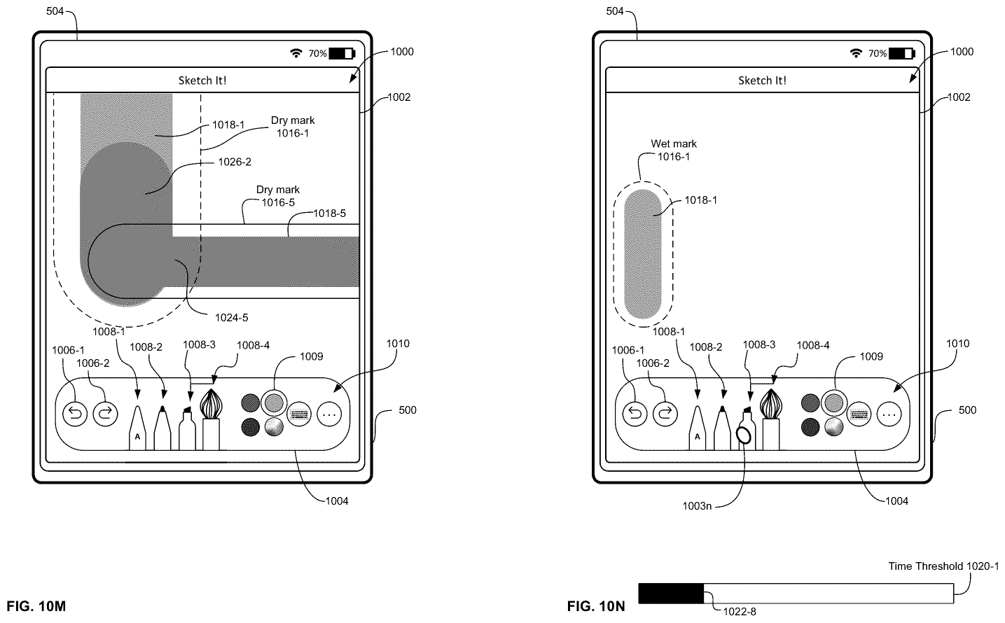

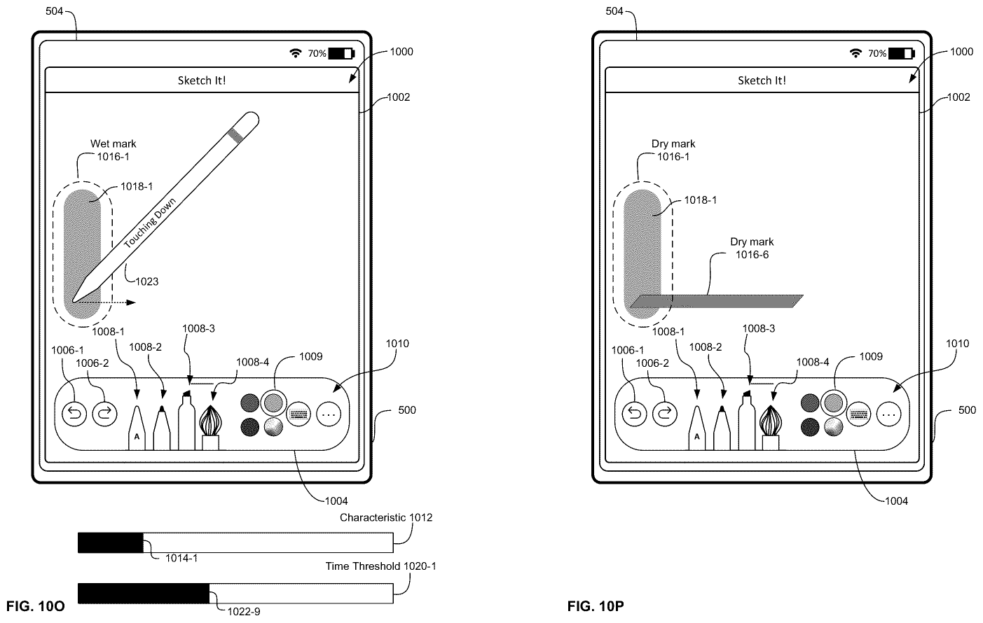

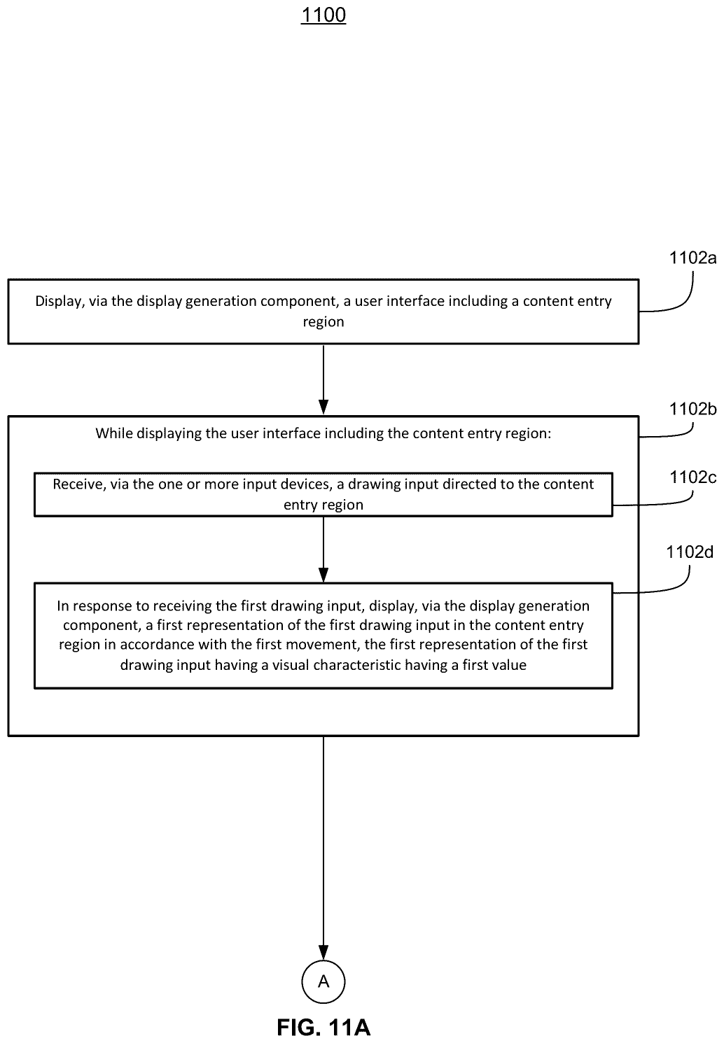

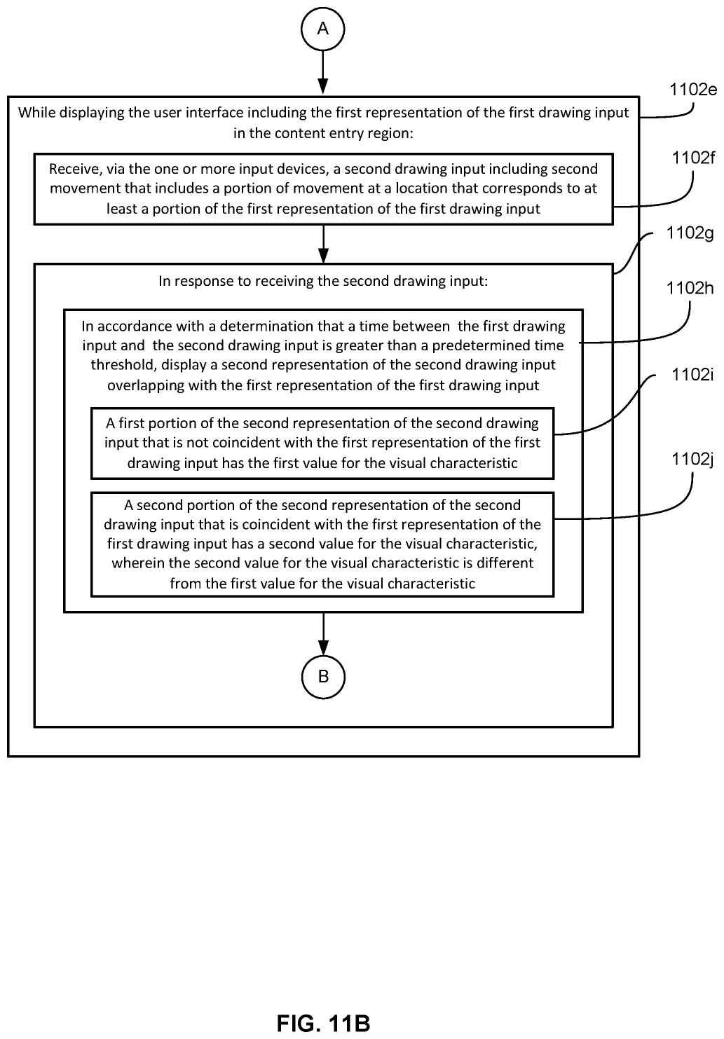

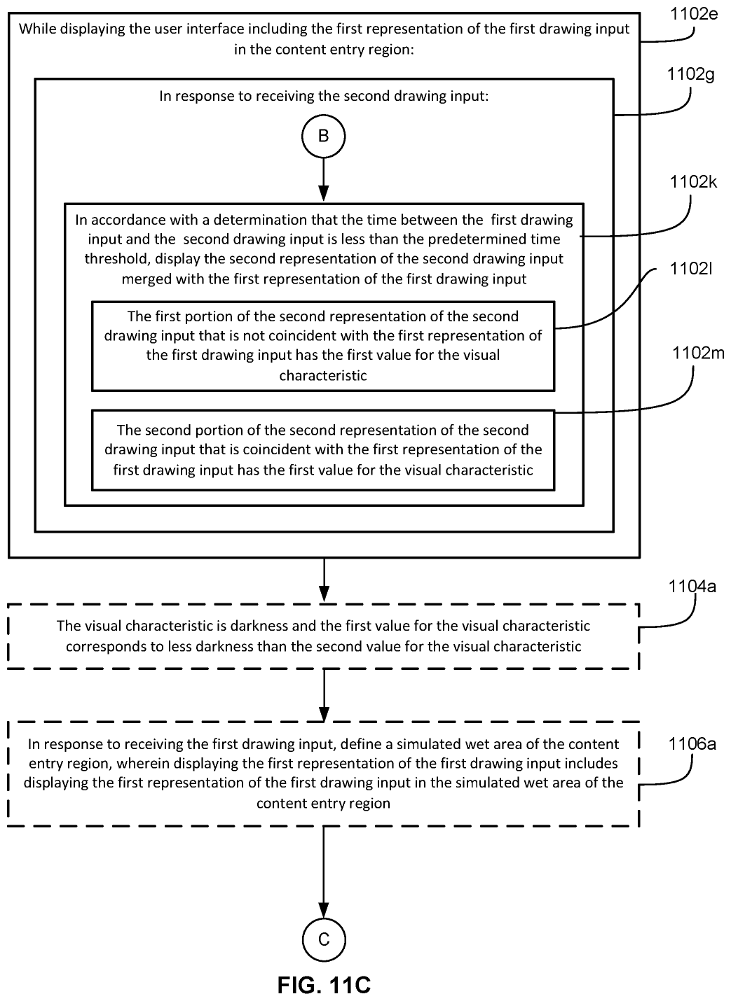

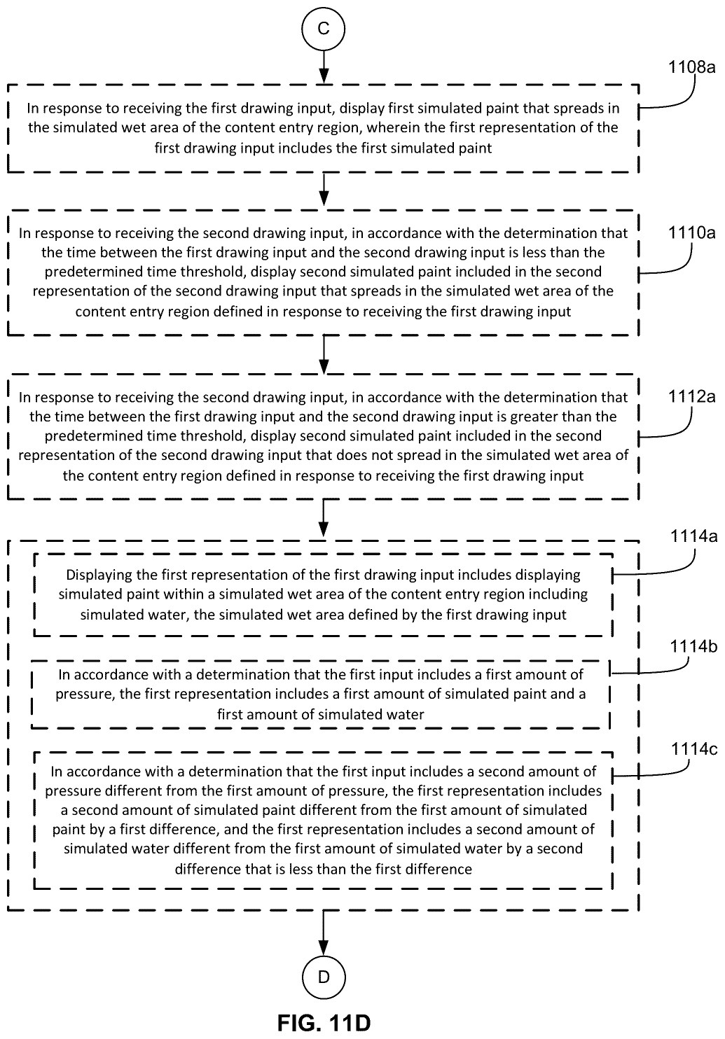

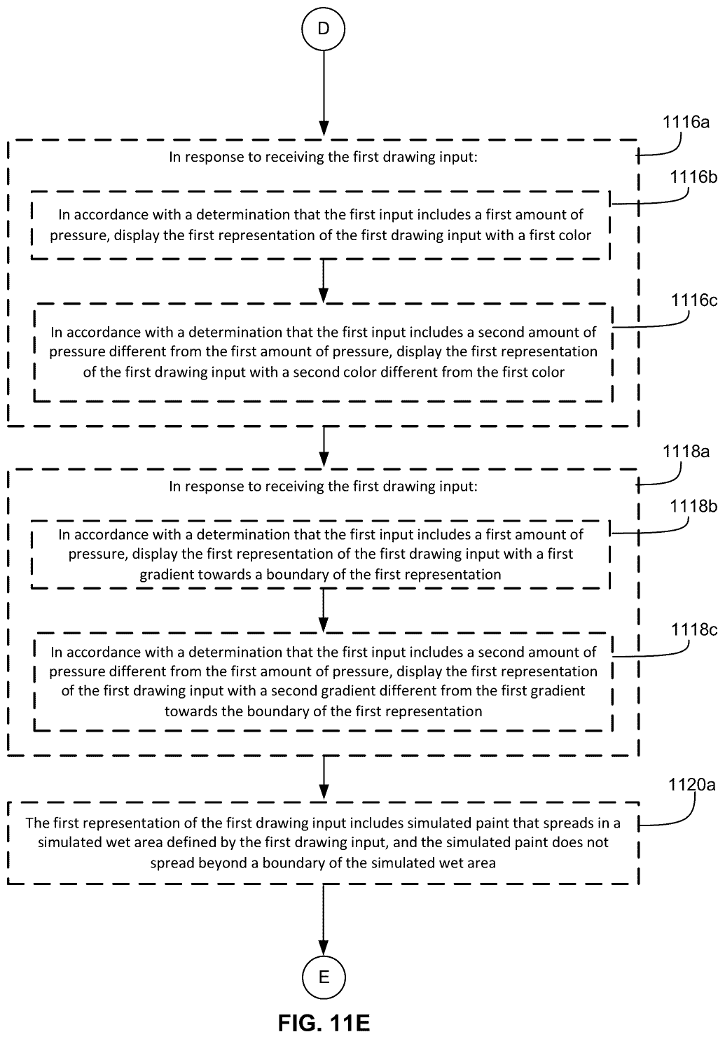

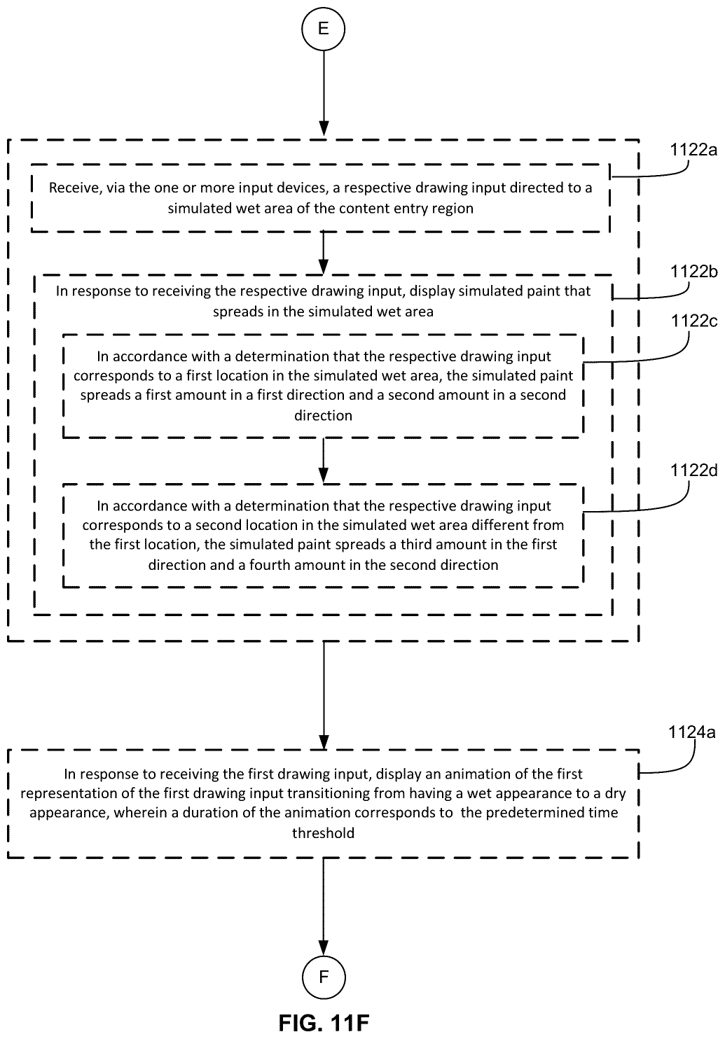

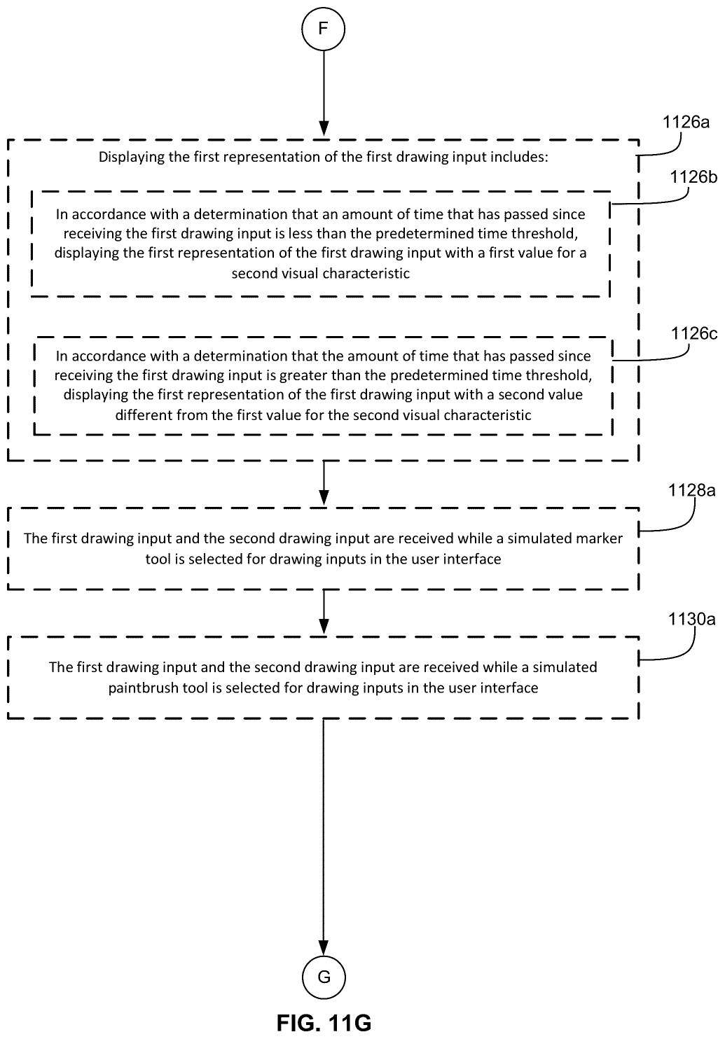

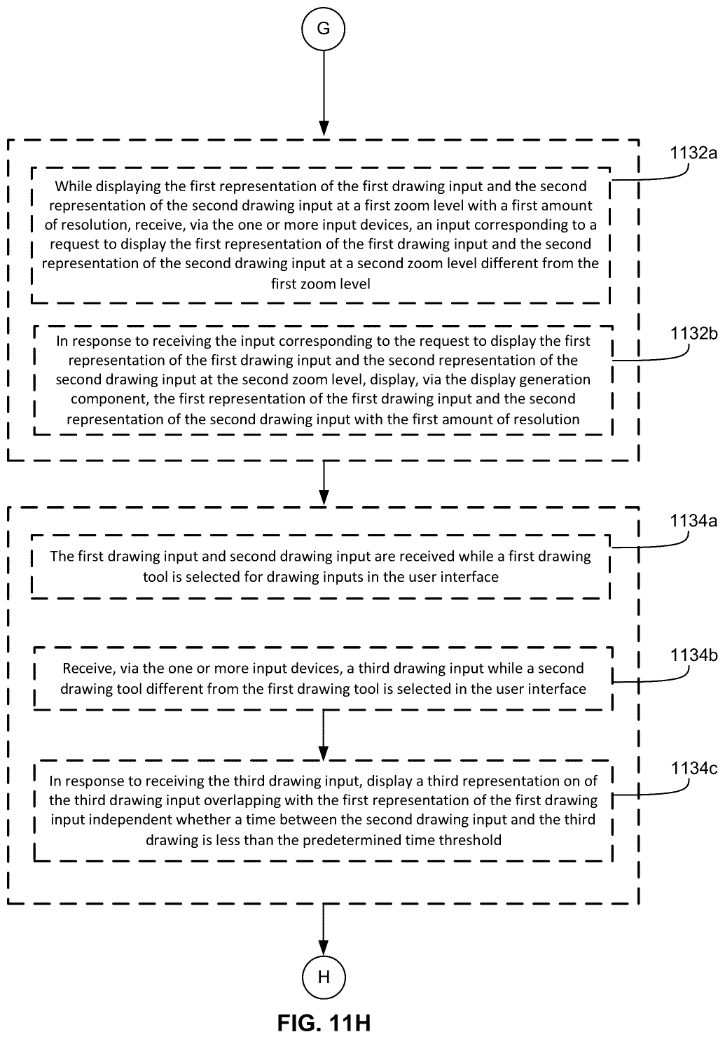

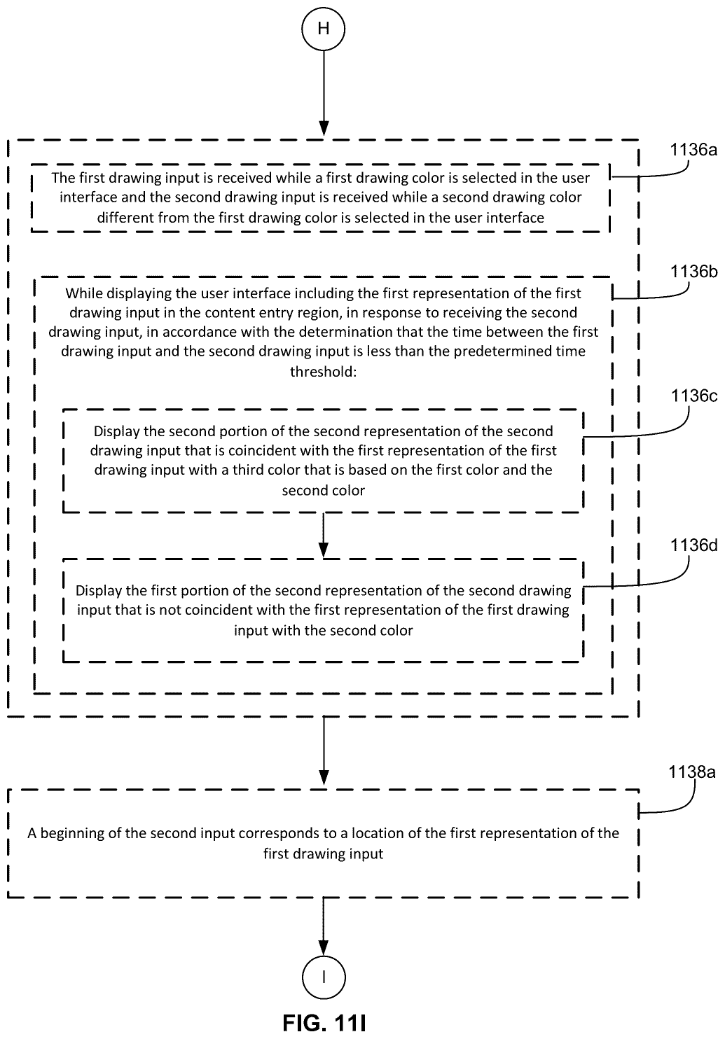

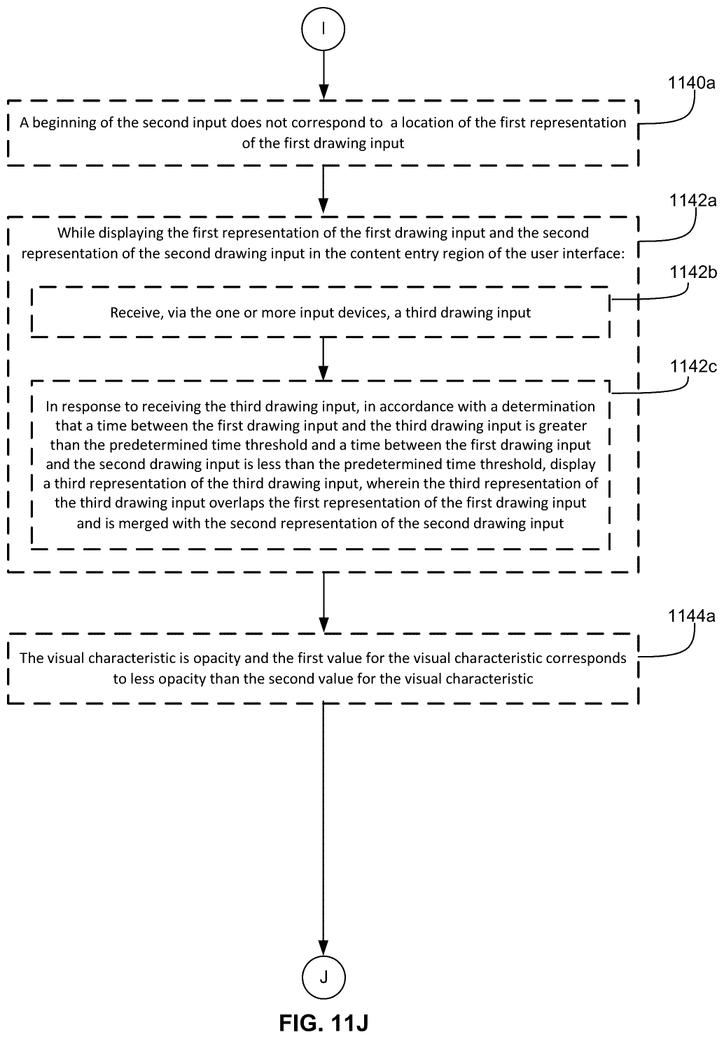

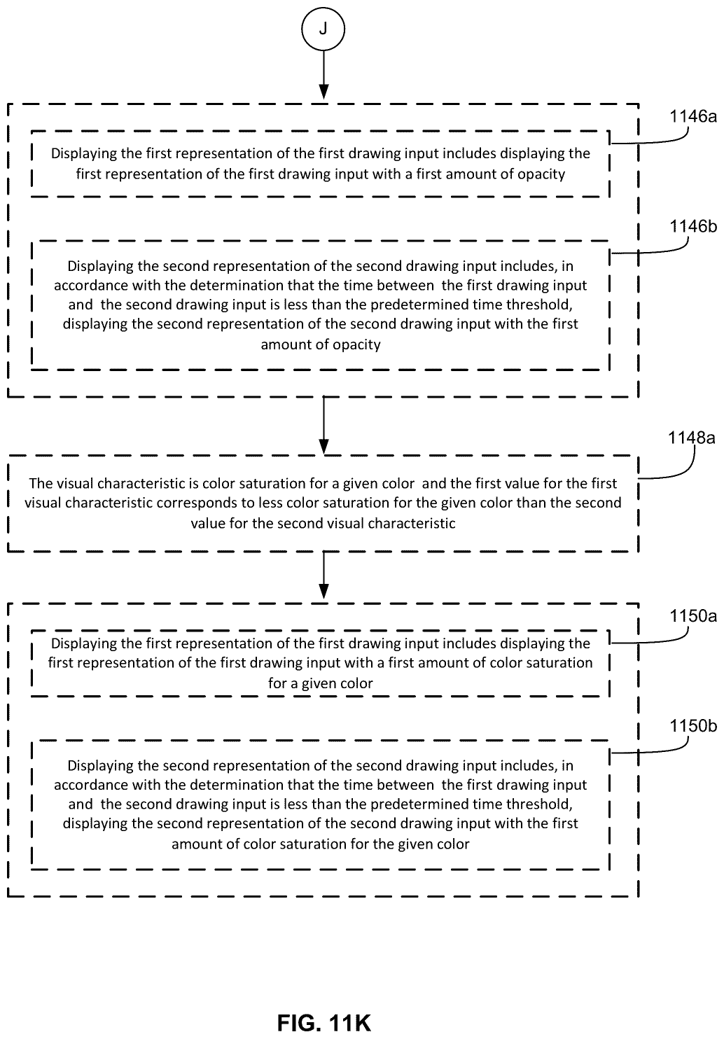

FIGS. 10A-10P illustrate exemplary ways of presenting simulated marks that merge with or overlap other simulated marks in accordance with some embodiments of the disclosure. The embodiments in these figures are used to illustrate the processes described below, including the processes described with reference to FIGS. 11A-11K.

FIG. 10A illustrates the electronic device 500 displaying a user interface 1000 of a content creation application that includes a content entry region 1002 and menu 1004. In some embodiments, the content creation application and user interface 1000 are similar to the content creation application and user interface described above with reference to method 900. In some embodiments, the input device 1023 is similar to the input device described above with reference to methods 900 and/or 1100.

The menu 1004 of user interface 1000 includes options for defining settings for marks created in response to detecting inputs provided by the input device 1023. Menu 1004 optionally has one or more characteristics in common with the menu described with reference to method(s) 700, 900, and/or 1300. For example, menu 1004 includes an undo option 1006-1, a redo option 1006-2, a plurality of tool options 1008-1, 1008-2, 1008-3, and 1008-4, a keyboard option 1011a, and an option 1011a to display an additional menu. In some embodiments, these options function similarly to the options described above with reference to method 900.

As shown in FIG. 10A, a brush tool 1008-4 is active in the content creation application. In some embodiments, in response to receiving an input including movement of input device 1023 along a surface (e.g., the surface of touch screen 504), the electronic device 500 displays simulated watercolor brush marks. In some embodiments, the watercolor brush marks include simulated water and simulated paint that spreads within the region of content entry region 1002 that has a simulated “wet” property (herein referred to as being “wet” with the simulated water). In some embodiments, the amount of simulated water and simulated ink displayed in response to an input depends on the value of a characteristic 1012, such as speed or pressure applied by the input device 1023 while the input is detected.

In FIG. 10A, the electronic device 500 detects an input including movement of the input device 1023 along the writing/drawing surface while the brush tool 1008-4 is selected and while characteristic 1012 has value 1014-1. In response to the input illustrated in FIG. 10A, the electronic device 500 presents the mark illustrated in FIGS. 10B-10C.

FIG. 10B illustrates an animation of simulated paint 1018-1 spreading in mark 1016-1 in response to the input illustrated in FIG. 10B. In some embodiments, the electronic device 500 displays simulated water up to the boundaries of mark 1016-1 and simulated paint 1018-1 in a portion of the area within boundaries of mark 1016-1 while the brush tool 1008-4 is active. In some embodiments, while the time 1022-0 that has passed since the input in FIG. 10A was received is less than a threshold time 1020, the electronic device 500 displays an animation indicating that the mark 1016-1 is “wet”, such as a shining or shimmering appearance. Example time thresholds are provided below in the description of method 1100. IN some embodiments, the amount of time 1022-0 is the amount of time since detecting liftoff of the input device 1023 from the writing/drawing surface at the end of the input illustrated in FIG. 10A. In some embodiments, the electronic device 500 presents an animation of the simulated paint 1018-1 spreading within mark 1016-1, as shown in FIG. 10B. In some embodiments, the animation concludes as shown in FIG. 10C.

FIG. 10C illustrates the electronic device 500 displaying mark 1016-1 in response to the input illustrated in FIG. 10A at the conclusion of the animation of the animation illustrated in FIG. 10B. As shown in FIG. 10C, the simulated paint 1018-1 does not reach the boundary of simulated mark 1016-1. In some embodiments, the simulated water reaches the boundary of the mark 1016-1. In some embodiments, there is a gradient of simulated paint 1018-1 within mark 1016-1, with more ink towards the center of mark 1018-1 and less ink towards the boundary of mark 1016-1. In some embodiments, areas of mark 1018-1 that have more ink have darker, brighter, and/or more saturated color than areas of mark 1018-1 that have less ink.

In some embodiments, while the amount of time 1022-1 that passed since receiving the input illustrated in FIG. 10A is less than the threshold time 1020-1, the mark 1016-1 is still “wet”. While mark 1016-1 is “wet”, additional marks in the same area of the content entry region 1002 as mark 1016-1 will merge with mark. In some embodiments, once the threshold time 1020-1 has passed since receiving the input illustrated in FIG. 10A, the mark 1016-1 will have a simulated dry property that (herein referred to as being “dry”), and additional marks in the same area of the content entry region 1002 as mark 1016-1 will overlap mark 1016-1. In some embodiments, whether a mark in the same area of the content region 1002 as an existing mark overlaps or merges with the existing mark depends on the time between the inputs creating the marks, and is independent from the distance between the existing mark and the area of the content entry region 1002 at which the input for the next mark begins.

For example, in FIG. 10C, while mark 1016-1 is “wet” because the time 1022-1 that passed since receiving the input to create mark 1016-1 is less than the threshold time 1020-1, the electronic device 500 receives an input provided by input device 1023. The input includes movement of the input device 1023 along the writing/drawing surface while characteristic 1012 has the same value 1014-1 as the value 1014-1 of characteristic 1012 in FIG. 10A. In some embodiments, the movement of the input device 1023 includes movement to a location that is the same as the location of mark 1016-1. In response to the input in FIG. 10C, the electronic device 500 displays another simulated paint mark shown in FIGS. 10D-10E.

FIG. 10D illustrates the electronic device 500 displaying an animation of simulated paint 1018-2 expanding within mark 1016-2. As described above, in some embodiments, the mark 1016-2 includes simulated water within the boundaries of mark 1016-2 and simulated paint 1018-2 that does not reach the boundaries of the mark 1016-2. The electronic device 500 displays the animation shown in FIG. 10D when a first amount 1022-2 of time has passed since receiving the input to display mark 1016-1 and a second amount 1022-3 of time has passed since receiving the input to display mark 1016-2. In some embodiments, time 1022-2 is less than the time threshold 1020-1 after receiving the input to display mark 1016-1, so mark 1016-1 is “wet”. In some embodiments, time 1022-3 is less than time threshold 1020-2 after receiving the input to display mark 1016-2, so mark 1016-2 is “wet”. In some embodiments, time thresholds 1020-1 and 1020-2 have the same value. In some embodiments, the animation illustrated in FIG. 10D continues until the simulated paint 1018-2 expands to the size shown in FIG. 10E.

FIG. 10E illustrates the electronic device 500 displaying mark 1016-2 at the conclusion of the animation shown in FIG. 10D. As shown in FIG. 10E, the simulated paint 1018-2 of mark 1016-2 does not spread to the boundary of mark 1016-2, as described above with reference to FIG. 10C for mark 1016-1. In some embodiments, mark 1016-2 is displayed with a gradient of paint within the mark 1016-2, as also described above with reference to FIG. 10C for mark 1016-1. Because mark 1016-1 was “wet” when the input to display mark 1016-2 was received in FIG. 10C, the electronic device 500 merges marks 1016-1 and 1016-2. In some embodiments, merging the marks 1016-1 and 1016-2 includes displaying a portion 1024-1 of the marks that are in the same region of the content entry region 1002 with the same color as the regions of marks 1016-1 and 1016-2 that are in distinct areas of the content entry region 1002. In some embodiments, simulated paint 1018-2 of mark 1016-2 is able to spread within the wet area of mark 1016-1 and mark 1016-2 because mark 1016-1 was “wet” when the input to display mark 1016-2 was received.

In FIG. 10E, mark 1016-1 is “dry” because at least the threshold amount of time 1020-1 has passed since the electronic device 500 received the input to display mark 1016-1 and mark 1016-2 is “wet” because the amount of time 1022-4 that passed since the electronic device 500 received the input to display mark 1016-2 is less than the time threshold 1020-2. In some embodiments, the electronic device 500 displays mark 1016-2 with an animation that indicates that mark 1016-2 is “wet” and displays mark 1016-1 without the animation because mark 1016-1 is “dry”. While mark 1016-1 is “dry” and mark 1016-2 is “wet”, the electronic device 500 receives an input drawing a mark with the brush tool 1008-4 that includes portions at locations of mark 1016-1 and mark 1016-2 in the content entry region 1002. In some embodiments, the input includes movement of the input device 1023 along the writing/drawing surface while the characteristic 1012 has the same value 1014-1 as the value 1014-1 of the characteristic 1012 while the inputs to display mark 1016-1 and mark 1016-2 were received. In response to the input illustrated in FIG. 10E, the electronic device 500 displays the mark illustrated in FIG. 10F.

FIG. 10F illustrates the electronic device 500 displaying mark 1016-3 in response to the input illustrated in FIG. 10E. In some embodiments, the electronic device 500 presents an animation of the ink 1018-3 of mark 1016-3 expanding in response to the input illustrated in FIG. 10E, similar to the animations described above with reference to FIGS. 10B and 10D. Mark 1016-3 includes simulated paint 1018-3 within the boundary of mark 1016-3 that does not reach the boundary of mark 1016-3. In some embodiments, mark 1016-3 includes a gradient of the amount of simulated paint 1018-3 decreasing towards the boundary of mark 1016-3.

As shown in FIG. 10F, because mark 1016-2 was “wet” when the input to display mark 1016-3 was received, mark 1016-2 and mark 1016-3 are merged, with the portion 1024-3 of mark 1016-2 and mark 1016-3 in the same region of the content entry region 1002 having the same color as the portions of marks 1016-2 and 1016-3 that are in distinct regions from other marks. Because mark 1016-1 was “dry” when the input to display mark 1016-3 was received, mark 1016-3 overlaps mark 1016-2, with the portion 1024-2 of mark 1016-2 and mark 1016-3 in the same region of the content entry region 1002 having a different color from the portions of marks 1016-1 and 1016-3 that are in distinct regions from other marks. In some embodiments, portion 1024-2 is darker and/or more saturated than portions of the marks 1016-1, 1016-2, and 1016-3 outside of portion 1024-2.

In some embodiments, when the electronic device 500 merges two marks that are different colors, the electronic device 500 blends the colors and/or displays a gradient between the two colors, as shown in FIGS. 10G-10I. In FIG. 10G, the electronic device 500 displays “wet” mark 1016-1 after a time 1022-5 less than the time threshold 1020-1 has passed since receiving the input to display the mark 1016-1. In some embodiments, the electronic device 500 displays mark 1016-1 in response to the input illustrated in FIG. 10A. As shown in FIG. 10G, the electronic device 500 receives an input (e.g., including contact 1003g) corresponding to selection of an option 1007 to change the color of the simulated paint of marks displayed in response to inputs received with input device 1023 from the color currently displayed with indication 1009 to the color corresponding to the option 1007. In response to the input illustrated in FIG. 10G, the electronic device 500 updates the menu 1004 to display the selected color with indication 1009, as shown in FIG. 10H.

FIG. 10H illustrates the electronic device 500 displaying the menu 1004 updated to display the indication 1009 around the color selected in the input illustrated in FIG. 10G. As shown in FIG. 10H, the electronic device 500 receives an input including movement of the input device 1023 along the writing/drawing surface while mark 1016-1 is “wet”. In some embodiments, the movement includes movement to a region of the content entry region 1002 at which mark 1016-1 is displayed. In some embodiments, the input has value 1014-1 for characteristic 1012 that is the same as the value 1014-1 of characteristic 1012 of the input that caused the electronic device 500 to display mark 1016-1. In response to the input illustrated in FIG. 10I, the electronic device 500 displays the mark shown in FIG. 10I.

FIG. 10I illustrates the electronic device 500 displaying mark 1016-4 in response to the input illustrated in FIG. 10J. In some embodiments, in response to the input, the electronic device 500 displays an animation of the simulated paint 1018-4 of mark 1016-4 expanding towards the boundary of mark 1016-4, similar to the animations described above with reference to FIGS. 10B and 10D. As shown in FIG. 10I, mark 1016-1 and mark 1018-4 have simulated paint with different colors because different colors were selected when the inputs to display the marks were received. In some embodiments, because mark 1016-1 was “wet” when the input to display mark 1016-4 was received, the electronic device 500 merges mark 1016-4 and mark 1016-1. Because the marks 1016-4 and 1016-1 have different colors, the electronic device 500 displays a portion 1026-1 of the marks that blends the colors together. In some embodiments, the electronic device 500 displays a gradient between portions of mark 1016-4 with a first color and portions of mark 1016-1 with a second color. In some embodiments, the simulated paint from mark 1016-4 blends beyond the boundary of mark 1016-4 into the simulated water included in mark 1016-1 because mark 1016-1 was “wet” when the input to display mark 1016-4 was received.

As previously described, in some embodiments, marks drawn while the brush tool 1008-4 is active include simulated water and simulated paint. In some embodiments, the amount of simulated paint and simulated water applied in response to an input depends on the value of characteristic 1012. For example, the greater the value of characteristic 1012 during an input, the more simulated paint and/or simulated water will be applied in response to the input. In some embodiments, the amount of simulated paint increases more than the amount of simulated water in response to an increase in the value of characteristic 1012.

For example, in FIG. 10J, the electronic device 500 detects an input including movement of the input device 1023 along the writing/drawing surface. In some embodiments, the input is provided with characteristic 1012 having a value 1014-2 that is greater than the value 1014-1 of characteristic 1012 of the input in FIG. 10A that caused the electronic device 500 to display mark 1016-1. In some embodiments, the selected color and angle of the input device 1023 are the same for the input in FIG. 10A as the input in FIG. 10J. In some embodiments, the input in FIG. 10J is detected while the amount of time 1022-7 that passed since receiving the input to display the mark 1016-1 is less than the threshold amount of time 1020-1. In some embodiments, in response to the input illustrated in FIG. 10J, the electronic device 500 displays the mark shown in FIGS. 10K-10L.

FIG. 10K illustrates the electronic device 500 displaying an animation of mark 1016-5 in response to the input illustrated in FIG. 10J. In some embodiments, mark 1016-5 includes simulated paint 1018-5 within the boundary of mark 1016-5 and simulated water that extends to the boundary of mark 1016-5. In some embodiments, because mark 1016-5 was drawn with characteristic 1012 having a value 1014-2 shown in FIG. 10J that is greater than the value 1014-1 of characteristic 1012 with which mark 1016-1 was drawn in FIG. 10A, the electronic device 500 displays mark 1016-5 with less space between the boundary of simulated paint 1018-5 and the boundary of the mark 1016-5 and with color that is darker and/or more saturated than the color of mark 1016-1. In some embodiments, because mark 1016-1 was “wet” when the input to display mark 1016-5 was received in FIG. 10J, the electronic device 500 displays an animation of the simulated paint 1018-5 from mark 1016-5 blending into the simulated water of mark 1016-1 as shown in FIG. 10K, with the result shown in FIG. 10L.

FIG. 10L illustrates the electronic device 500 displaying mark 1016-5 in response to the input illustrated in FIG. 10J at the conclusion of the animation illustrated in FIG. 10K. As shown in FIG. 10L, mark 1018-5 includes a portion 1026-2 of simulated paint 1018-5 that extends beyond the boundary of mark 1016-5 into mark 1016-1, which was “wet” when the input to display mark 1018-5 was received. As shown in FIG. 10L, because there is more space between mark 1016-5 and the boundary of mark 1016-1 above mark 1016-5 than there is below mark 1016-5, the simulated ink 1018-5 blends further in the upward direction into mark 1016-1 than it does in the downward direction into mark 1016-1. In some embodiments, mark 1016-1 and mark 1016-5 were drawn with the same color of simulated paint, but mark 1016-5 has greater darkness and/or saturation because mark 1016-5 was drawn with a greater value for characteristic 1012 than the value of characteristic 1012 with which mark 1016-1 was drawn. In some embodiments, the electronic device 500 blends marks 1016-1 and 1016-5 with a gradient between the darkness and/or saturation of mark 1016-1 and the darkness and/or saturation of mark 1016-5.

In some embodiments, the electronic device 500 displays the marks in the content creation user interface 1000 as vector drawings. In some embodiments, in response to receiving an input to zoom in on the content region 1002 (e.g., including movement of contacts 1003k and 1003L), the electronic device 500 zooms in on the content entry region 1002, as shown in FIG. 10M.

FIG. 10M illustrates the electronic device 500 displaying portions of marks 1016-1 and 1016-5 in the content entry region 1002 at a higher level of zoom in response to the input illustrated in FIG. 10L. In some embodiments, because the marks 1016-1 and 1016-5 are vector objects, the electronic device 500 displays the marks 1016-1 and 1016-5 with the same degree of clarity at the zoom level in FIG. 10M as the degree of clarity of marks 1016-1 and 1016-5 at the zoom level in FIG. 10L.

In some embodiments, the content application includes a number of drawing tools with which the electronic device 500 simulates drawing with the input device 1023. In some embodiments, the content application includes a marker tool 1008-3. In some embodiments, the electronic device 500 merges or overlaps marks made with the marker tool 1008-3 depending on the time between receiving inputs to display marks in the same or a similar manner to the manner in which the electronic device 500 merges or overlaps marks created with the brush tool 1008-4. In some embodiments, the electronic device 500 does not merge marks made with different tools even if the input to display one of the marks is received while the other mark is still “wet”.

For example, in FIG. 10N, the electronic device 500 displays mark 1016-1 that was created while the brush tool 1008-4 was selected, as shown in FIG. 10A. In some embodiments, while mark 1016-1 is still “wet”, the electronic device 500 receives an input (e.g., including contact 1003n) to select the marker tool 1008-3. In response to the input in FIG. 10N, the electronic device 500 displays the marker tool 1008-3 as being selected for use with the content application and is configured to create simulated marks with the marker tool 1008-3, as shown in FIG. 10O.

In FIG. 10O, the electronic device 500 displays the content application user interface 1000 with the marker tool 1008-3 currently selected. In some embodiments, while the marker tool 1008-3 is selected and while mark 1016-1 is “wet”, the electronic device 500 receives an input including movement of input device 1023 along the writing/drawing surface. In some embodiments, the input has the same value 1014-1 for characteristic 1012 as the value 1014-1 of characteristic 1012 of the input to display mark 1016-1 in FIG. 10A. In some embodiments, in response to the input illustrated in FIG. 10O, the electronic device 500 displays the mark shown in FIG. 10P.

FIG. 10P illustrates the electronic device 500 displaying mark 1016-6 in response to the input illustrated in FIG. 10O. In some embodiments, even though the input in FIG. 10O was received while mark 1016-1 was “wet”, mark 1016-6 is not merged with mark 1016-1 because mark 1016-6 and mark 1016-1 were drawn with different tools selected. In some embodiments, mark 1016-6 includes simulated ink that extends to the boundary of mark 1016-6 because mark 1016-6 was drawn with the marker tool 1008-3.

FIGS. 11A-11K is a flow diagram illustrating a method of presenting simulated marks that merge with or overlap other simulated marks in accordance with some embodiments of the disclosure. The method 1100 is optionally performed at an electronic device such as device 100, device 300, device 500, device 501, device 510, and device 591 as described above with reference to FIGS. 1A-1B, 2-3, 4A-4B and 5A-5I. Some operations in method 1100 are, optionally combined and/or order of some operations is, optionally, changed.

As described below, the method 1100 provides for interaction with simulated marks, including overlapping and merging marks. The method reduces the cognitive burden on a user when interacting with a user interface of the device of the disclosure, thereby creating a more efficient human-machine interface. For battery-operated electronic devices, increasing the efficiency of the user's interaction with the user interface conserves power and increases the time between battery charges.

In some embodiments, such as in FIG. 10A, method 1100 is performed at an electronic device (e.g., 500) in communication with a display generation component (e.g., 504) and one or more input devices (e.g., 504 and/or 1023). For example, the electronic device is the electronic device described above with reference to one or more of method(s) 700 and/or 900. In some embodiments, the display generation component is the display generation component described above with reference to method(s) 700 and/or 900.

In some embodiments, such as in FIG. 10A, the electronic device (e.g., 500) displays (1102a), via the display generation component (e.g., 504), a user interface (e.g., 1000) including a content entry region (e.g., 1002) (e.g., a canvas region). In some embodiments, such as in FIG. 10A, the content entry region (e.g., 1002) is a region of the user interface (e.g., 1000) in which the electronic device (e.g., 500) displays drawings and/or handwriting in response to drawing and/or handwriting inputs detected using the one or more input devices. For example, the electronic device detects drawing and/or handwriting using a stylus, electronic pencil, or similar input device and/or a touch sensitive surface, such as a trackpad, tablet, or touch screen. In some embodiments, the content entry region has a simulated paper background, such as a blank background, a lined background, a dotted background, or a grid background. For example, the user interface is a user interface of a notetaking application. In some embodiments, the content entry region is a document including text, images, tables and/or charts. For example, the user interface is the user interface of a document reading and/or editing application and the handwriting and/or drawing is markup on the document.

In some embodiments, while displaying the user interface (e.g., 1000) including the content entry region (e.g., 1002) (1102b), the electronic device (e.g., 500) receives (1102c), via the one or more input devices, a first drawing input directed to the content entry region (e.g., 1002) including first movement detected by the one or more input devices (e.g., 504 and/or 1023), such as in FIG. 10A. In some embodiments, the movement is movement of an object, such as a stylus, digital pen, or similar input device or a portion of the body of the user (e.g., a finger). In some embodiments, the electronic device detects the location of the object or a portion of object (e.g., the tip of a stylus) using an input device, such as a touch sensitive surface or other surface, including one of the touch sensitive surfaces described above. In some embodiments, detecting the first drawing input includes detecting movement of the object while the object is in contact with or within a threshold distance (e.g., 0.05, 0.1, 0.2, 0.3, 0.5, 1, 2, 3, or 5 centimeters) of a touch sensitive surface. In some embodiments, the surface with which the object is interacting and/or contacting as part of the drawing input is the touch-sensitive surface, a physical surface on which the user interface is projected, or a virtual surface corresponding to at least a portion of the user interface.

In some embodiments, while displaying the user interface (e.g., 1000) including the content entry region (e.g., 1002) (1102b), in response to receiving the first drawing input, the electronic device (e.g., 500) displays (1102d), via the display generation component (e.g., 504), a first representation (e.g., 1016-1) of the first drawing input in the content entry region (e.g., 1002) in accordance with the first movement, the first representation (e.g., 1016-1) of the first drawing input having a visual characteristic having a first value, such as in FIG. 10C. In some embodiments, such as in FIG. 10C, the first representation (e.g., 1016-1) of the first drawing input includes markings at locations at which a portion the object (e.g., 1023) moved during the movement of the first drawing input. For example, the first representation of the first drawing input includes markings at locations on a touch screen at which the tip of a stylus moved while the electronic device detected the drawing input. In some embodiments, the visual characteristic is opacity, color, brightness, tone, saturation, and/or darkness.

In some embodiments, while displaying the user interface (e.g., 1000) including the first representation (e.g., 1016-1) of the first drawing input in the content entry region (e.g., 1002) (1102e), the electronic device (e.g., 500) receives (11020, via the one or more input devices, a second drawing input including second movement that includes a portion of movement at a location that corresponds to at least a portion of the first representation (e.g., 1016-1) of the first drawing input, such as in FIG. 10C. In some embodiments, detecting the second drawing input is similar to detecting the first drawing input as described at least above with reference to step 1102c. In some embodiments, detecting the portion of movement coincident with the first representation of the first drawing input includes detecting the object move over a portion of the first representation of the first drawing input. For example, the display generation component is a touch screen and the second drawing includes movement of the object over a portion of the touch screen at which the first representation of the first drawing input is displayed. As another example, the electronic device detects movement of the object over a portion of a surface corresponding to a portion of the first representation of the first drawing input.

In some embodiments, while displaying the user interface (e.g., 1000) including the first representation (e.g., 1016-1) of the first drawing input in the content entry region (e.g., 1002) (1102e), in response to receiving the second drawing input (1102g), in accordance with a determination that a time between (e.g., an end of) the first drawing input and (e.g., a beginning of) the second drawing input is greater than a predetermined time threshold (e.g., 1020-1) (e.g., 0.05, 0.2, 0.3, 0.5, 1, 2, 3, 5, 10, 20 or 30 seconds), such as in FIG. 10E, the electronic device (e.g., 500) displays (1102h) a second representation (e.g., 1016-3) of the second drawing input overlapping with the first representation (e.g., 1016-1) of the first drawing input. In some embodiments, such as in FIG. 10F, a first portion of the second representation (e.g., 1016-3) of the second drawing input that is not coincident with the first representation (e.g., 1016-1) of the first drawing input has the first value for the visual characteristic (1102i). In some embodiments, such as in FIG. 10F, a second portion of the second representation (e.g., 1016-3) of the second drawing input that is coincident with the first representation (e.g., 1016-1) of the first drawing input has a second value for the visual characteristic, wherein the second value for the visual characteristic is different from the first value for the visual characteristic (1102j). In some embodiments, the time between the first drawing input and the second drawing input is time between the end of the first drawing input and the beginning of the second drawing input. In some embodiments, the end of the first drawing input is liftoff of the portion of the first input device from the surface. For example, liftoff is when the portion of the object transitions from being in contact with or within the threshold distance described above from the surface to being more than the threshold distance from the surface. In some embodiments, the beginning of the second drawing input is touchdown or contact of the object on the surface. For example, touchdown is when the object transitions from being more than the threshold distance described above from the surface to being less than the threshold distance from the surface. In some embodiments, the portion of the second drawing not coincident with the first drawing has the same opacity and/or color brightness, tone, saturation, and/or darkness as the portion of the first drawing not coincident with the second drawing. In some embodiments, the portion of the second drawing coincident with the first drawing has a different opacity and/or color brightness, tone, saturation, and/or darkness than the portion of the second drawing not coincident with the first drawing and the portion of the first drawing not coincident with the second drawing. For example, the overlapping portion of the first and second drawings has greater opacity, less brightness, more (e.g., color) saturation, and/or more darkness than the non-overlapping portions of the first and second drawings. In some embodiments, if the time between the end of the first drawing input and the beginning of the second drawing input is greater than the time threshold, the computer system displays the first drawing and second drawing as overlapping one another with a different visual characteristic for the portion of the drawings that overlaps than the portions of the drawings that do not overlap.

In some embodiments, while displaying the user interface (e.g., 1000) including the first representation (e.g., 1016-1) of the first drawing input in the content entry region (e.g., 1002) (1102e), in response to receiving the second drawing input (1102g), in accordance with a determination that the time (e.g., 1022-1) between the (e.g., end of the) first drawing input and the (e.g., beginning of the) second drawing input is less than the predetermined time threshold (e.g., 1020-1), such as in FIG. 10C, the electronic device (e.g., 500) displays (1102j) the second representation (e.g., 1018-2) of the second drawing input merged with the first representation (e.g., 1016-1) of the first drawing input, such as in FIG. 10E. In some embodiments, such as in FIG. 10E, the first portion of the second representation (e.g., 1016-2) of the second drawing input that is not coincident with the first representation (e.g., 1016-1) of the first drawing input has the first value for the visual characteristic (1102k). In some embodiments, such as in FIG. 10E, the second portion of the second representation (e.g., 1016-2) of the second drawing input that is coincident with the first representation (e.g., 1016-1) of the first drawing input has the first value for the visual characteristic (11021). In some embodiments, the electronic device maintains display of the portion of the first representation of the first drawing input that is coincident with the second representation of the second drawing input with the visual characteristic having the first value. In some embodiments, if the time between the end of the first drawing input and the beginning of the second drawing input is less than the time threshold, the computer system displays the first drawing and second drawing as merged with one another with the same visual characteristic for the portion(s) of the drawings that overlaps and the portion(s) of the drawings that do not overlap. Displaying the first representation of the first drawing input and the second representation of the second drawing input with the first value for the visual characteristic without displaying the overlapping portion with the second value for the visual characteristic in response to detecting the second drawing input within the threshold time of detecting the first drawing input enhances user interactions with the computer system by providing a mechanism to add to the first drawing with the second drawing input without the need to provide separate input for doing so, enabling the user to revise the first drawing quickly and efficiently.

In some embodiments, such as in FIG. 10F, the visual characteristic is darkness and the first value for the visual characteristic corresponds to less darkness than the second value for the visual characteristic (1104a). In some embodiments, such as in FIG. 10F, the overlapping portion of the representation (e.g., 1016-1) of the first drawing input and the representation (e.g., 1016-3) of the second drawing input is darker than non-overlapping portions of the representation (e.g., 1016-1) of the first drawing input and the representation (e.g., 1016-3) of the second drawing input. In some embodiments, the representations of the first and second drawing inputs are partially translucent. In some embodiments, overlapping portions of representations of drawing inputs have less translucency than non-overlapping portions of representations of drawing inputs. Displaying the overlapping portion of the representation of the first drawing input and the representation of the second drawing input darker than non-overlapping portions of the representations of the drawing inputs enhances user interactions with the computer system by providing an efficient way of darkening representations of drawing inputs without interacting with displayed options.

In some embodiments, such as in FIG. 10C, in response to receiving the first drawing input, the electronic device (e.g., 500) defines (1106a) a simulated wet area of the content entry region (e.g., 1002), wherein displaying the first representation (e.g., 1016-1) of the first drawing input includes displaying the first representation (e.g., 1016-1) of the first drawing input in the simulated wet area of the content entry region (e.g., 1002). In some embodiments, the representation of the first drawing input includes simulated water that defines the simulated wet area and simulated paint that spreads in the simulated wet area. In some embodiments, the representation of the first drawing input takes the threshold time described above with reference at least to step 1102g to “dry”. Defining a simulated wet area of the content entry region in response to the first drawing input enhances user interactions with the electronic device by reducing the number of inputs needed to create a simulated watercolor effect.

In some embodiments, such as in FIG. 10B, in response to receiving the first drawing input, the electronic device (e.g., 500) displays (1108a) first simulated paint (e.g., 1018-1) that spreads in the simulated wet area of the content entry region (e.g., 1002), wherein the first representation (e.g., 1016-1) of the first drawing input includes the first simulated paint. In some embodiments, such as in FIG. 10B, the electronic device (e.g., 500) displays an animation of the simulated paint (e.g., 1018-1) spreading from a first thickness to a larger thickness within the wet area in response to a drawing input. In some embodiments, the simulated paint of the first representation of the first drawing input spreads within the simulated wet area of the first representation of the first drawing input and does not spread beyond the simulated wet area of the first representation of the first drawing input. In some embodiments, if the first drawing input overlaps a simulated wet area of the representation of a previously-received drawing input, the simulated paint of the first drawing input spreads in the simulated wet area of the first representation of the first drawing input and the simulated wet area of the representation of the previously-received drawing input. In some embodiments, the simulated paint spreads with a gradient that includes more paint (e.g., darker and/or more saturated color) further from the edge of the simulated wet area and less paint (e.g., lighter and/or less saturated color) closer to the edge of the simulated wet area, with the gradient between. In some embodiments, in response to the first drawing input, the electronic device displays an animation of the simulated paint spreading in the simulated wet area defined by the first drawing input. Displaying the first representation of the first drawing input with simulated paint that spreads in a simulated wet area of the first representation of the first drawing input enhances user interactions with the computer system by creating a simulated watercolor effect with fewer inputs.

In some embodiments, in response to receiving the second drawing input, in accordance with the determination that the time (e.g., 1022-6) between the first drawing input and the second drawing input is less than the predetermined time threshold (e.g., 1020-1) (e.g., the time threshold described above at least with reference to step 1102g), such as in FIG. 10H, the electronic device (e.g., 500) displays (1110a) second simulated paint (e.g., 1018-4) included in the second representation (e.g., 1016-4) of the second drawing input that spreads in the simulated wet area of the content entry region (e.g., 1002) defined in response to receiving the first drawing input, such as in FIG. 10I. In some embodiments, while the simulated wet area of the first representation (e.g., 1016-1) of the first drawing input is “wet” (e.g., before the threshold time has passed), such as in FIG. 10I, simulated paint (e.g., 1018-4) included in the representation (e.g., 1016-4) of the second drawing input spreads in the simulated wet area of the representation (e.g., 1016-1) of the first drawing input, such as in FIG. 10I. In some embodiments, displaying the second representation of the second drawing input includes displaying a second simulated wet area defined by the second drawing input in which the simulated paint of the second drawing input spreads. In some embodiments, if the first representation of the first drawing input is “wet” (e.g., less than the threshold time has passed) while the second drawing input is detected, simulated paint from the first drawing input spreads in the second simulated wet area. In some embodiments, if the first representation of the first drawing input is “wet” (e.g., less than the threshold time has passed) while the second drawing input is detected, simulated paint from the first drawing input does not spread in the second simulated wet area. Displaying the simulated paint from the second representation of the second drawing input spreading in the simulated wet area of the first representation of the first drawing input enhances user interactions with the computer system by creating a simulated watercolor effect with fewer inputs.

In some embodiments, in response to receiving the second drawing input, in accordance with the determination that the time (e.g., 1020-1) between the first drawing input and the second drawing input is greater than the predetermined time threshold (e.g., 1020-1) (e.g., the time threshold described above at least with reference to step 1102g), such as in FIG. 10E, the electronic device (e.g., 500) displays (1112a) second simulated paint (e.g., 1018-3) included in the second representation (e.g., 1016-3) of the second drawing input that does not spread in the simulated wet area of the content entry region (e.g., 1002) defined in response to receiving the first drawing input, such as in FIG. 10F. In some embodiments, once the simulated wet area of the first representation of the first drawing input is “dry” (e.g., after the threshold time has passed), simulated paint included in the representation of the second drawing input does not spread in the simulated wet area of the representation of the first drawing input. Displaying the simulated paint from the second representation of the second drawing input not spreading in the simulated wet area of the first representation of the first drawing input once the threshold time passed since receiving the first drawing input enhances user interactions with the computer system by creating a simulated watercolor effect with fewer inputs.

In some embodiments, such as in FIG. 10C, displaying the first representation (e.g., 1016-1) of the first drawing input includes displaying simulated paint (e.g., 1018-1) within a simulated wet area of the content entry region (e.g., 1002) including simulated water, the simulated wet area defined by the first drawing input (1114a). In some embodiments, the simulated paint and the simulated wet area have one or more of the characteristics described above with reference at least to steps 1106a, 1108a, 1110a, and/or 1112a.

In some embodiments, in accordance with a determination that the first input includes a first amount (e.g., 1014-1) of pressure (e.g., characteristic 1012) (e.g., on a surface (e.g., 504)), such as in FIG. 10A, the first representation (e.g., 1016-1) includes a first amount of simulated paint (e.g., 1018-1) and a first amount of simulated water (1114b), such as in FIG. 10C. In some embodiments, the electronic device measures the amount of pressure of the drawing inputs as described above with reference to one or more steps of method 900.

In some embodiments, in accordance with a determination that the first input includes a second amount (e.g., 1014-2) of pressure (e.g., characteristic 1012) different from the first amount of pressure (e.g., on the surface (e.g., 504)), such as in FIG. 10J, the first representation (e.g., 1016-5) includes a second amount of simulated paint (e.g., 1018-5) different from the first amount of simulated paint by a first difference, and the first representation (e.g., 1016-5) includes a second amount of simulated water different from the first amount of simulated water by a second difference that is less than the first difference (1114c). In some embodiments, if the second amount of pressure is greater than the first amount of pressure, the second amounts of simulated paint and simulated water are greater than the first amounts of simulated paint and simulated water. In some embodiments, if the second amount of pressure is greater than the first amount of pressure, the second amounts of simulated paint and simulated water are less than the first amounts of simulated paint and simulated water. In some embodiments, the amount of simulated paint varies more with pressure than the amount of simulated water varies with pressure. In some embodiments, the amount of simulated water corresponds to the size (e.g., thickness) of the representation of the drawing input, with more water corresponding to a larger (e.g., thicker) representation. In some embodiments, the amount of simulated paint corresponds to one or more of color darkness, color saturation, and/or width of simulated paint within the representation of the drawing input, with more paint corresponding to greater amounts of these characteristics. Varying the amounts of simulated paint and simulated water included in the first representation of the first drawing input depending on the amount of pressure applied during the first drawing input enhances user interactions with the computer system by enabling the user to control the amount of simulated paint and simulated water without interacting with displayed options.

In some embodiments, in response to receiving the first drawing input (1116a), in accordance with a determination that the first input includes a first amount (e.g., 1014-1) of pressure (e.g., 1012) (e.g., on a surface (e.g., 504)), such as in FIG. 10A, the electronic device (e.g., 500) displays (1116b) the first representation (e.g., 1016-1) of the first drawing input with a first color. In some embodiments, the electronic device measures the amount of pressure of the first drawing input as described with reference to one or more steps of method 900.

In some embodiments, in response to receiving the first drawing input (1116a), in accordance with a determination that the first input includes a second amount (e.g., 1014-2) of pressure (e.g., 1012) different from the first amount of pressure (e.g., on the surface), such as in FIG. 10J, the electronic device (e.g., 500) displays (1116c) the first representation (e.g., 1016-5) of the first drawing input with a second color different from the first color, such as in FIG. 10K. In some embodiments, such as in FIG. 10K, the second color is darker and/or more saturated than the first color. In some embodiments, such as in FIG. 10K, the more pressure included in the first drawing input, the darker and/or more saturated the color of the first representation of the first drawing input will be. In some embodiments, the less pressure included in the first drawing input, the darker and/or more saturated the color of the first representation of the first drawing input will be. In some embodiments, the hues of the first and second colors are the same. For example, the second color is dark, more saturated red and the first color is light, less saturated red. In some embodiments, the hues of the first and second colors are different. For example, the first color is yellow and the second color is orange. Displaying the first representation of the first drawing input with a color that depends on the pressure included in the first drawing input enhances user interactions with the computer system by enabling the user to control the color of the first representation of the first drawing input without interacting with displayed options.

In some embodiments, in response to receiving the first drawing input (1118a), in accordance with a determination that the first input includes a first amount (e.g., 1014-1) of pressure (e.g., 1012) (e.g., on a surface (e.g., 504)), such as in FIG. 10A, the electronic device (e.g., 500) displays (1118b) the first representation (e.g., 1016-1) of the first drawing input with a first gradient towards a boundary of the first representation (e.g., 1016-1), such as in FIG. 10C. In some embodiments, the gradient with which the simulated paint spreads in the simulated wet area is described in more detail above at least with reference to step 1108a.

In some embodiments, in response to receiving the first drawing input (1118a), in accordance with a determination that the first input includes a second amount (e.g., 1014-2) of pressure (e.g., 1012) different from the first amount of pressure (e.g., on the surface), such as in FIG. 10J, the electronic device (e.g., 500) displays (1118c) the first representation (e.g., 1016-5) of the first drawing input with a second gradient different from the first gradient towards the boundary of the first representation (e.g., 1016-5), such as in FIG. 10K. In some embodiments, if the second amount of pressure is greater than the first amount of pressure, the second gradient is more rapid than the first gradient (e.g., the edge of the first representation is higher-contrast and/or has less softness). In some embodiments, if the second amount of pressure is greater than the first amount of pressure, the second gradient is less rapid than the first gradient (e.g., the edge of the first representation is lower-contrast and/or has greater softness). Displaying the first representation with a gradient towards the boundary of the first representation that depends on the pressure included in the first drawing input enhances user interactions with the computer system by enabling the user to control the appearance of the boundary of the representations of drawing inputs without interacting with displayed options.

In some embodiments, such as in FIG. 10C, the first representation (e.g., 1016-1) of the first drawing input includes simulated paint (e.g., 1018-1) that spreads in a simulated wet area defined by the first drawing input, and the simulated paint (e.g., 1018-1) does not spread beyond a boundary of the simulated wet area (1120a). In some embodiments, the boundary of the simulated wet area is the boundary of the first representation of the first drawing input. In some embodiments, the simulated wet area has one or more characteristics described above at least with reference to steps 1106a, 1108a, 1110a, 1112a, and/or 1114a-1114c. In some embodiments, the simulated paint has one or more characteristics described above at least with reference to steps 1108a, 1110a, 1112a, 1114a-1114c, and/or 1116a-1116c. Displaying the first representation with simulated paint that spreads within a boundary of a simulated wet area enhances user interactions with the computer system by creating a simulated watercolor effect with fewer inputs.

In some embodiments, the electronic device (e.g., 500) receives (1122a), via the one or more input devices (e.g., 504 and/or 1023), a respective drawing input directed to a simulated wet area of the content entry region (e.g., 1002), such as in FIG. 10H. In some embodiments, the simulated wet area is the wet area corresponding to the first drawing input. In some embodiments, the simulated wet area has one or more characteristics described above at least with reference to steps 1106a, 1108a, 1110a, 1112a, 1114a-1114c, and/or 1120a. In some embodiments, the simulated paint has one or more characteristics described above at least with reference to steps 1108a, 1110a, 1112a, 1114a-1114c, 1116a-1116c, and/or 1120a.

In some embodiments, in response to receiving the respective drawing input (e.g., within the threshold time from detecting the drawing input corresponding to the wet area), the electronic device (e.g., 500) displays (1122b) simulated paint (e.g., 1018-4) that spreads in the simulated wet area, such as in FIG. 10I.

In some embodiments, in accordance with a determination that the respective drawing input corresponds to a first location in the simulated wet area, the simulated paint (e.g., 1018-4) spreads a first amount in a first direction and a second amount in a second direction (1122c), such as in FIG. 10I.

In some embodiments, in accordance with a determination that the respective drawing input corresponds to a second location in the simulated wet area different from the first location, the simulated paint spreads a third amount in the first direction and a fourth amount in the second direction (1122d), such as the simulated paint 1018-4 spreading differently in FIG. 10I if the input in FIG. 10H was at a different location along mark 1016-1. In some embodiments, the simulated paint spreads in the simulated wet area as described above at least with reference to step 1110a. In some embodiments, if the respective drawing input overlaps with a portion of the simulated wet area that is not in the center of the simulated wet area, the simulated paint will spread different amounts in different directions because the simulated paint spreads within the boundary of the simulated wet area and there is more space between the location of the respective drawing input and the boundary of the simulated wet area on one side than the other if the respective input overlaps away from the center of the simulated wet area. For example, if the respective drawing input overlaps with a portion of the simulated wet area that is below the center of the simulated wet area, the simulated paint will spread further in the upwards direction than the downwards direction because there is more space above the location of the respective drawing input within the simulated wet area than there is below the location of the respective drawing input within the simulated wet area. Displaying the simulated paint of the respective drawing input spreading in the simulated wet area enhances user interactions with the computer system by creating a simulated watercolor effect with fewer inputs.

In some embodiments, in response to receiving the first drawing input, the electronic device (e.g., 500) displays (1124a) an animation of the first representation (e.g., 1016-1) of the first drawing input transitioning from having a wet appearance, such as in FIG. 10D, to a dry appearance, such as in FIG. 10E, wherein a duration of the animation corresponds to (e.g., is) the predetermined time threshold (e.g., 1020-1) (e.g., the time threshold described above at least with reference to step 1102g). In some embodiments, the first representation includes a simulated wet area described above at least with reference to steps 1106a, 1108a, 1110a, 1112a, 1114a-1114c, 1120a, and/or 1122a-d. In some embodiments, the simulated wet area remains “wet” for the threshold period of time and is “dry” when the threshold period of time is reached. In some embodiments, the electronic device displays the first representation with different colors depending on whether or not the first representation is “dry” and displays an animation of the color gradually changing (e.g., from darker to lighter and/or from more saturated to less saturated) as the first representation dries. Displaying the animation of the first representation transiting from “wet” to “dry” enhances user interactions with the computer system by providing improved visual feedback to the user.

In some embodiments, displaying the first representation (e.g., 1016-1) of the first drawing input includes (1126a), in accordance with a determination that an amount (e.g., 1022-2) of time that has passed since receiving the first drawing input is less than the predetermined time threshold (e.g., 1020-1) (e.g., the time threshold described above at least with reference to step 1102g), displaying the first representation (e.g., 1016-1) of the first drawing input with a first value for a second visual characteristic (1126b), such as in FIG. 10D. In some embodiments, the second visual characteristic is the same as the visual characteristic described above with reference at least to steps 1102c and/or 1102g-11021. In some embodiments, the second visual characteristic is different from the visual characteristic described above with reference at least to steps 1102c and/or 1102g-11021. In some embodiments, displaying the first representation with the first value for the second visual characteristic corresponds to displaying the first representation with a wet appearance. In some embodiments, displaying the first representation with the wet appearance includes displaying the first representation with a visual characteristic and/or animation that indicates that the first representation is “wet”. For example, the first representation is displayed with a shimmering animation and/or visual effect while the first representation is “wet”.

In some embodiments, displaying the first representation (e.g., 1016-1) of the first drawing input includes (1126a), in accordance with a determination that the amount (e.g., 1020-1) of time that has passed since receiving the first drawing input is greater than the predetermined time threshold (e.g., 1020-1), displaying the first representation (e.g., 1016-1) of the first drawing input with a second value different from the first value for the second visual characteristic (1126c), such as in FIG. 10E. In some embodiments, displaying the first representation with the second value for the second visual characteristic corresponds to displaying the first representation with a dry appearance. In some embodiments, displaying the first representation with the dry appearance includes displaying the first representation with a visual characteristic and/or animation that indicates that the first representation is “dry”. Displaying the first representation with a visual characteristic that indicates whether the first representation is “wet” or “dry” enhances user interactions with the computer system by providing improved visual feedback to the user.

In some embodiments, such as in FIG. 10P, the first drawing input and the second drawing input are received while a simulated marker tool (e.g., 1008-3) is selected for drawing inputs in the user interface (e.g., 1000) (1128a). In some embodiments, such as in FIG. 10A, the simulated marker tool (e.g., 1008-3) is selected in a user interface element (e.g., 1010) displayed in accordance with one or more steps of method 1300 described below. In some embodiments, marks made with the simulated marker tool are slightly translucent, so layering marks made with the marker tool on top of other marks made with the marker tool in an overlapping manner (e.g., after the predetermined threshold time passes), causes the overlapping portion to be displayed with less translucency and/or with more darkness and/or color saturation. In some embodiments, the user interface element includes additional drawing tools that do not differentiate overlapping and merged marks based on time between drawing inputs being received. Displaying representations of drawing inputs as merged or overlapping depending on time between drawing inputs while a simulated marker tool is selected enhances user interactions with the computer system by enabling the user to efficiently select characteristics for the representations of drawing inputs.

In some embodiments, such as in FIG. 10A, the first drawing input and the second drawing input are received while a simulated paintbrush tool (e.g., 1008-4) is selected for drawing inputs in the user interface (e.g., 1000) (1130a). In some embodiments, such as in FIG. 10A, the simulated paintbrush tool (e.g., 1008-4) is selected in a user interface element (e.g., 1010) displayed in accordance with one or more steps of method 1300 described below. In some embodiments, marks made with the simulated paintbrush tool are slightly translucent, so layering marks made with the marker tool on top of other marks made with the marker tool in an overlapping manner (e.g., after the predetermined threshold time passes), causes the overlapping portion to be displayed with less translucency and/or with more darkness and/or color saturation. In some embodiments, the user interface element includes additional drawing tools that do not differentiate overlapping and merged marks based on time between drawing inputs being received. In some embodiments, using the simulated paintbrush tool causes representations of drawing inputs to include simulated wet areas as described above at least with reference to steps 1106a, 1108a, 1110a, 1112a, 1114a-1114c, 1120a, 1122a-d, and/or 1124a and simulated paint as described above at least with reference to steps 1108a, 1110a, 1112a, 1114a-1114c, 1116a-1116c, and/or 1120a. Displaying representations of drawing inputs as merged or overlapping depending on time between drawing inputs while a simulated paintbrush tool is selected enhances user interactions with the computer system by enabling the user to efficiently select characteristics for the representations of drawing inputs.

In some embodiments, such as in FIG. 10L, while displaying the first representation (e.g., 1016-1) of the first drawing input and the second representation (e.g., 1016-5) of the second drawing input at a first zoom level with a first amount of resolution, the electronic device (e.g., 500) receives (1132a), via the one or more input devices (e.g., 504), an input (e.g., including movement of contacts 1003k and 1003L) corresponding to a request to display the first representation (e.g., 1016-1) of the first drawing input and the second representation (e.g., 1016-5) of the second drawing input at a second zoom level different from the first zoom level. In some embodiments, such as in FIG. 10L, displaying the first representation (e.g., 1016-1) and the second representation (e.g., 1016-5) with the first zoom level includes displaying the first representation (e.g., 1016-1) and the second representation (e.g., 1016-5) at a first size. In some embodiments, the input is a request to zoom the content entry region in or out. In some embodiments, the amount of resolution corresponds to smoothness and/or crispness of the edges of the first representation and second representation.

In some embodiments, such as in FIG. 10M, in response to receiving the input corresponding to the request to display the first representation (e.g., 1016-1) of the first drawing input and the second representation (e.g., 1016-5) of the second drawing input at the second zoom level, the electronic device (e.g., 500) displays (1132b), via the display generation component (e.g., 504), the first representation (e.g., 1016-1) of the first drawing input and the second representation (e.g., 1016-5) of the second drawing input with the first amount of resolution. In some embodiments, such as in FIG. 10M, displaying the first representation (e.g., 1016-1) and the second representation (e.g., 1016-5) with the second zoom level includes displaying the first representation (e.g., 1016-1) and the second representation (e.g., 1016-5) at a second size different from the first size at the first zoom level. In some embodiments, if the input is a request to zoom in, such as in FIG. 10L, the second size is larger than the first size, such as in FIG. 10M. In some embodiments, if the input is a request to zoom out, the second size is smaller than the first size. In some embodiments, the resolution is the same at the first and second levels of zoom and the smoothness and/or crispness of the edges of the first representation and second representation are the same at the first and second levels of zoom. In some embodiments, the first and second representations are vectorized representations. Displaying the first and second representations with the same resolutions at different levels of zoom enhances user interactions with the computer system by reducing the number of inputs needed to change the size of the representations of drawing inputs without changing the resolution of the representations.

In some embodiments, such as in FIGS. 10A and 10C, the first drawing input and second drawing input are received while a first drawing tool (e.g., 1008-4) is selected for drawing inputs in the user interface (1134a). In some embodiments, such as in FIG. 10A, the first drawing tool (e.g., 1008-4) is selected in a user interface element (e.g., 1010) displayed in accordance with one or more steps of method 1300 described below. In some embodiments, the first drawing tool is a simulated marker described above at least with reference to step 1128a or a simulated paintbrush described above at least with reference to step 1130a.

In some embodiments, such as in FIG. 10O, the electronic device (e.g., 500) receives (1134b), via the one or more input devices, a third drawing input while a second drawing tool (e.g., 1008-3) different from the first drawing tool (e.g., 1008-4) is selected in the user interface (e.g., 1000). In some embodiments, prior to receiving the third drawing input, the electronic device (e.g., 500) receives an input (e.g., including contact 1003n) selecting the second drawing tool (e.g., 1008-3), such as in FIG. 10N. For example, the second drawing tool is selected in the user interface element described according to one or more steps of method 1300 below. In some embodiments, the first drawing tool is a simulated marker and the second drawing tool is a simulated paintbrush. In some embodiments, the first drawing tool is a simulated paintbrush and the second drawing tool is a simulated marker.

In some embodiments, in response to receiving the third drawing input, the electronic device (e.g., 500) displays (1134c) a third representation (e.g., 1016-6) of the third drawing input overlapping with the first representation (e.g., 1016-1) of the first drawing input, such as in FIG. 10P, independent whether a time between the second drawing input and the third drawing is less than the predetermined time threshold (e.g., 1020-1 in FIG. 10O). In some embodiments, the electronic device displays the third representation overlapping the first representation irrespective of the amount of time that passes between the first drawing input and the second drawing input. In some embodiments, a portion of the third representation that overlaps the first representation is displayed with the second value for the visual characteristic and the portion of the third representation that does not overlap the first representation with the first value for the visual characteristic. In some embodiments, the entire third representation is displayed with the first value for the visual characteristic. In some embodiments, the visual characteristic is described above with reference at least to steps 1102c, 1102h, 1102i, 1102k and/or 11021. Forgoing merging representations of drawing inputs received while different drawing tools were selected enhances user interactions with the computer system by reducing the time and inputs needed to display the representations overlapping one another.

In some embodiments, such as in FIG. 10A, the first drawing input is received while a first drawing color is selected in the user interface (e.g., 1000) and the second drawing input is received while a second drawing color different from the first drawing color is selected in the user interface (e.g., 1010) (1136a), such as in FIG. 10H. In some embodiments, such as in FIG. 10A, the electronic device (e.g., 500) displays one or more options for changing the color of representations of drawing inputs in the user interface element (e.g., 1010) described below with reference to method 1300. In some embodiments, the electronic device displays the representation of the first drawing input received while the first color is selected in the first color. In some embodiments, the electronic device displays the representation of the second drawing input received while the second color is selected in the second color.

In some embodiments, while displaying the user interface (e.g., 1000) including the first representation (e.g., 1016-1) of the first drawing input in the content entry region (e.g., 1002), in response to receiving the second drawing input, in accordance with the determination that the time (e.g., 1022-6) between the first drawing input and the second drawing input is less than the predetermined time threshold (e.g., 1020-1) (1136b), such as in FIG. 10H, the electronic device (e.g., 500) displays (1136c) the second portion of the second representation (e.g., 1016-4) of the second drawing input that is coincident with the first representation (e.g., 1016-1) of the first drawing input with a third color that is based on the first color and the second color, such as in FIG. 10I.

In some embodiments, while displaying the user interface (e.g., 1000) including the first representation (e.g., 1016-1) of the first drawing input in the content entry region (e.g., 1002), in response to receiving the second drawing input, in accordance with the determination that the time (e.g., 1022-6) between the first drawing input and the second drawing input is less than the predetermined time threshold (e.g., 1020-1) (1136b), such as in FIG. 10H, the electronic device (e.g., 500) displays (1136d) the first portion of the second representation of the second drawing input that is not coincident with the first representation of the first drawing input with the second color, such as in FIG. 10I. In some embodiments, the third color is a mix of the first color and the second color. For example, the first color is yellow, the second color is red, and the third color is orange. In some embodiments, the second and/or third color spreads from a simulated wet area of the second input to a simulated wet area of the first input and/or the first color and/or third color spreads from a simulated wet area of the first input to the simulated wet area of the second input. In some embodiments, one or more portions of the first drawing input not coincident with the second drawing input are the first color. In some embodiments, the third color spreads to part(s) of the first representation and/or second representation not coincident with the other representation (e.g., due to simulated paint spreading in simulated water). In some embodiments, the third color is automatically selected by the electronic device in accordance with the first color and the second color. Displaying the second portion of the second representation of the second drawing input that is coincident with the first representation of the first drawing input in the third color enhances user interactions with the computer system by creating a simulated watercolor effect with fewer inputs.

In some embodiments, such as in FIG. 10E, a beginning of the second input corresponds to a location of the first representation (e.g., 1016-1) of the first drawing input (1138a). In some embodiments, the electronic device selectively merges or overlaps representations of drawing inputs depending on a duration of time between the drawing inputs when the second input begins at a location corresponding to the first representation of the first drawing input is displayed. In some embodiments, the location corresponding to the first representation of the first drawing input (e.g., the location at which the second drawing input begins) is coincident with, or less than a threshold distance (e.g., 0.1, 0.2, 0.3, 0.5, 1, 2, 3, 5, or 10 centimeters) from the first representation of the first drawing input. Selectively overlapping or merging the second representation of the second drawing input with the first representation of the first drawing input depending on the duration of time between the drawing inputs when the second drawing input begins at a location corresponding to the first representation enhances user interaction with the computer system by reducing the number of inputs needed to create a simulated watercolor effect.

In some embodiments, such as in FIG. 10C, a beginning of the second input does not correspond to (e.g., is away from) a location of the first representation of the first drawing input (1140a). In some embodiments, the electronic device selectively merges or overlaps representations of drawing inputs depending on a duration of time between the drawing inputs when the second input begins at a location not corresponding to the first representation of the first drawing input is displayed. In some embodiments, the location not corresponding to the first representation of the first drawing input (e.g., the location at which the second drawing input begins) is greater than a threshold distance (e.g., 0.1, 0.2, 0.3, 0.5, 1, 2, 3, 5, or 10 centimeters) from the first representation of the first drawing input. Selectively overlapping or merging the second representation of the second drawing input with the first representation of the first drawing input depending on the duration of time between the drawing inputs when the second drawing input begins at a location not corresponding to the first representation enhances user interaction with the computer system by reducing the number of inputs needed to create a simulated watercolor effect.

In some embodiments, while displaying the first representation (e.g., 1016-1) of the first drawing input and the second representation (e.g., 1016-2) of the second drawing input in the content entry region (e.g., 1002) of the user interface (e.g., 1000) (1142a), such as in FIG. 10E, the electronic device (e.g., 500) receives (1142b), via the one or more input devices (e.g., 1023 and/or 504), a third drawing input. In some embodiments, the third drawing input is similar to the first drawing input described above at least with reference to step 1102c and/or the second drawing input described above at least with reference to step 1102e.

In some embodiments, while displaying the first representation (e.g., 1016-1) of the first drawing input and the second representation (e.g., 1016-2) of the second drawing input in the content entry region (e.g., 1002) of the user interface (e.g., 1000) (1142a), in response to receiving the third drawing input, in accordance with a determination that a time (e.g., 1020-1) between the first drawing input and the third drawing input is greater than the predetermined time threshold (e.g., 1020-1) (e.g., the time threshold described above at least with reference to step 1102g) and a time (e.g., 1022-4) between the first drawing input and the second drawing input is less than the predetermined time threshold (e.g., 1020-2), such as in FIG. 10E, the electronic device (e.g., 500) displays (1142c) a third representation (e.g., 1016-3) of the third drawing input, wherein the third representation (e.g., 1016-3) of the third drawing input overlaps the first representation (e.g., 1016-1) of the first drawing input and is merged with the second representation (e.g., 1016-2) of the second drawing input. In some embodiments, such as in FIG. 10F, a portion of the third representation that merges with the second representation is displayed with the first value for the visual characteristic and the portion of the third representation that overlaps the first representation is displayed with the second value for the visual characteristic. In some embodiments, the third representation overlaps the first representation and merges with the second representation irrespective of whether the first and second representations are merged or overlapping. In some embodiments, in response to receiving the third drawing input, in accordance with a determination that the time between the first drawing input and the third drawing input is greater than the predetermined time threshold and the time between the second drawing input and the third drawing input is greater than the predetermined time threshold, the third representation of the third drawing input overlaps the first representation of the first drawing input and the second representation of the second drawing input. In some embodiments, in response to receiving the third drawing input, in accordance with a determination that the time between the first drawing input and the third drawing input is less than the predetermined time threshold and the time between the second drawing input and the third drawing input is less than the predetermined time threshold, the third representation of the third drawing input merges with the first representation of the first drawing input and the second representation of the second drawing input. Displaying the third representation overlapping the first representation and merged with the second representation enhances user interactions with the electronic device enhances user interactions with the computer system by creating a simulated watercolor effect with fewer user inputs.

In some embodiments, such as in FIG. 10F, the visual characteristic is opacity and the first value for the visual characteristic corresponds to less opacity than the second value for the visual characteristic (1144a). In some embodiments, such as in FIG. 10F, overlapping portions of representations (e.g., 1016-1 and 1016-3) of drawing inputs have more opacity than non-overlapping portions of representations of drawing inputs. In some embodiments, in response to detecting further drawing inputs that cause the electronic device to display additional representations of drawing inputs overlaid on existing representations of drawing inputs, the electronic device increases the opacity of the overlapping portion. For example, a portion of a representation that overlaps two other representations has more opacity than a portion of a representation that overlaps one other representation. Displaying overlapping portions of representations of drawing inputs that overlap representations of other drawing inputs with increased opacity compared to portions of representations of drawing inputs that do not overlap representations of other drawing inputs enhances user interactions with the electronic device by creating a simulated watercolor effect with fewer user inputs.

In some embodiments, such as in FIG. 10C, displaying (1146a) the first representation (e.g., 1016-1) of the first drawing input includes displaying the first representation (e.g., 1016-1) of the first drawing input with a first amount of opacity.

In some embodiments, displaying (1146b) the second representation (e.g., 1016-2) of the second drawing input includes, in accordance with the determination that the time (e.g., 1022-1) between (e.g., the end of) the first drawing input and (e.g., the beginning of) the second drawing input is less than the predetermined time threshold (e.g., 1020-1), such as in FIG. 10C, displaying the second representation (e.g., 1016-2) of the second drawing input with the first amount of opacity, such as in FIG. 10E. In some embodiments, the portion of the second representation that is coincident with the first representation is displayed with the same opacity as the portion of the second representation that is not coincident with the first representation in response to receiving the second drawing input within the threshold time of the first drawing input. Displaying the second representation with the first amount of opacity in response to detecting the second drawing input within the time threshold of the first drawing input enhances user interactions with the computer system by creating a simulated watercolor effect with fewer inputs.

In some embodiments, such as in FIG. 10F, the visual characteristic is color saturation for a given color (e.g., the color defined for the currently selected drawing tool) and the first value for the first visual characteristic corresponds to less color saturation for the given color than the second value for the second visual characteristic (1148a). In some embodiments, such as in FIG. 10F, overlapping portions of representations (e.g., 1016-1 and 1016-3) of drawing inputs have more color saturation than non-overlapping portions of representations (e.g., 1016-1 and 1016-3) of drawing inputs. In some embodiments, in response to detecting further drawing inputs that cause the electronic device to display additional representations of drawing inputs overlaid on existing representations of drawing inputs, the electronic device increases the color saturation of the overlapping portion. For example, a portion of a representation that overlaps two other representations has more color saturation than a portion of a representation that overlaps one other representation. Displaying overlapping portions of representations of drawing inputs that overlap representations of other drawing inputs with increased color saturation compared to portions of representations of drawing inputs that do not overlap representations of other drawing inputs enhances user interactions with the electronic device by creating a simulated watercolor effect with fewer user inputs.

In some embodiments, such as in FIG. 10C, displaying the first representation (e.g., 1016-1) of the first drawing input includes displaying the first representation (e.g., 1016-1) of the first drawing input with a first amount of color saturation for a given color (1150a) (e.g., the color defined for the currently selected drawing tool).

In some embodiments, displaying the second representation (e.g., 1016-2) of the second drawing input includes, in accordance with the determination that the time (e.g., 1022-1) between (e.g., the end of) the first drawing input and (e.g., the beginning of) the second drawing input is less than the predetermined time threshold (e.g., 1020-1), such as in FIG. 10C, the electronic device (e.g., 500) displays the second representation (e.g., 1016-2) of the second drawing input with the first amount of color saturation for the given color (1150b), such as in FIG. 10E. In some embodiments, the portion of the second representation that is coincident with the first representation is displayed with the same color saturation as the portion of the second representation that is not coincident with the first representation in response to receiving the second drawing input within the threshold time of the first drawing input. Displaying the second representation with the first amount of color saturation in response to detecting the second drawing input within the time threshold of receiving the first drawing input enhances user interactions with the computer system by creating a simulated watercolor effect with fewer inputs.

It should be understood that the particular order in which the operations in FIGS. 11A-11K have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method(s) 700, 900, and/or 1300) are also applicable in an analogous manner to method 1100 described above with respect to FIGS. 11A-11K. For example, the operation of the electronic device displaying merging and/or overlapping marks described above with reference to method 1100 optionally has one or more of the characteristics of entering text into text entry regions, displaying marks with varying widths, and/or manipulating a content entry palette described herein with reference to other methods described herein (e.g., method(s) 700, 900, and/or 1300). For brevity, these details are not repeated here.

The operations in the information processing methods described above are, optionally, implemented by running one or more functional modules in an information processing apparatus such as general purpose processors (e.g., as described with respect to FIGS. 1A-1B, 3, 5A-5I) or application specific chips. Further, the operations described above with reference to FIGS. 11A-11K are, optionally, implemented by components depicted in FIGS. 1A-1B. For example, displaying operations 1102a, 1102h, and/or 1102j and/or receiving operations 1102c, 1102f, and/or 1122a are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

### Palette Scrolling and Movement

Users interact with electronic devices in many different manners. In some embodiments, an electronic device presents a content entry palette in a content entry region of a user interface. The embodiments described below provide ways in which, in response to detecting user input, an electronic device scrolls the content entry palette and/or moves the content entry palette depending on a direction of movement of the user input. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

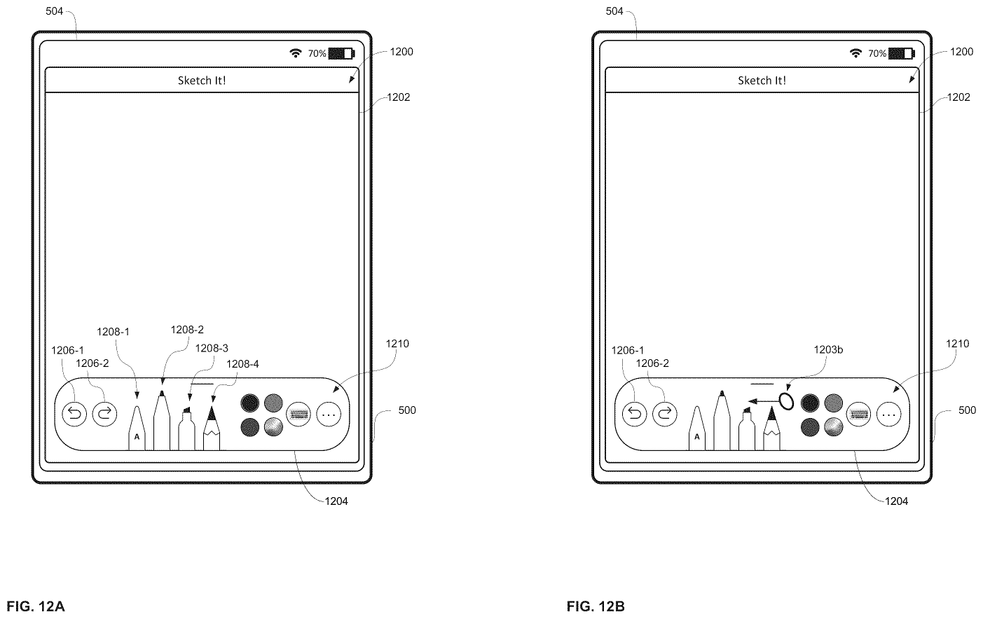

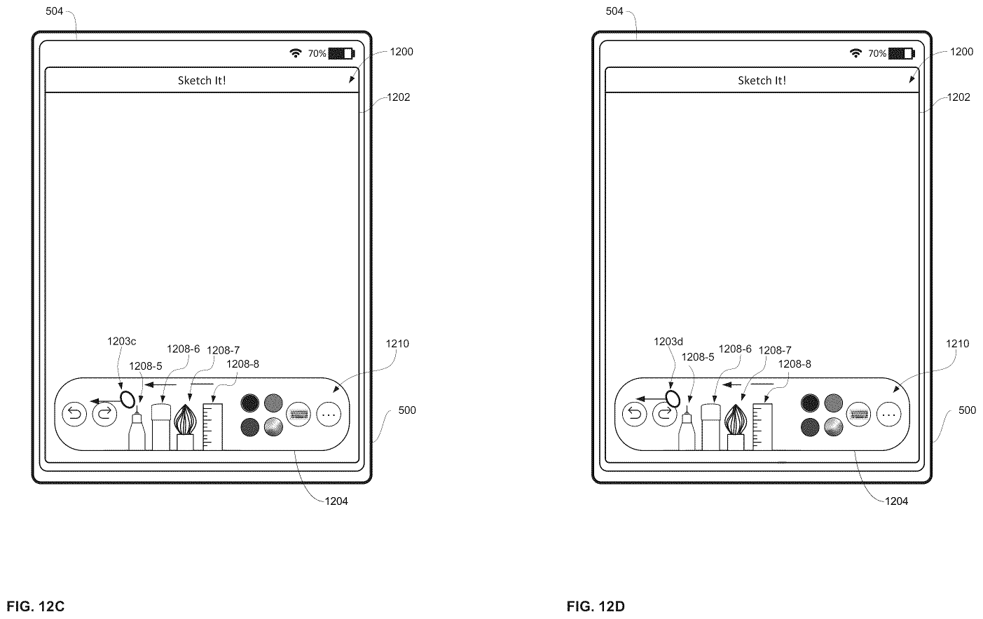

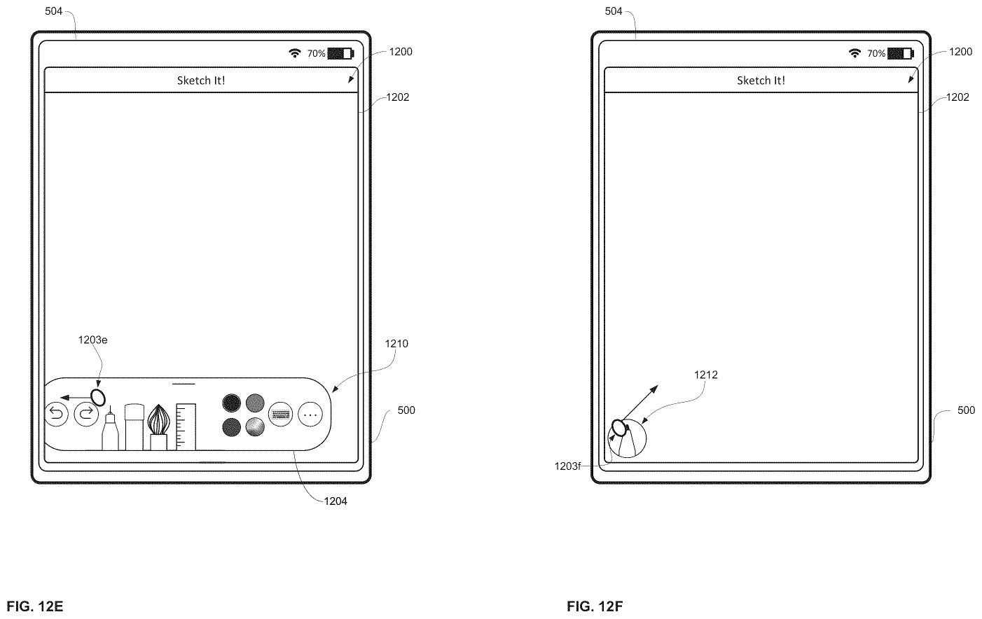

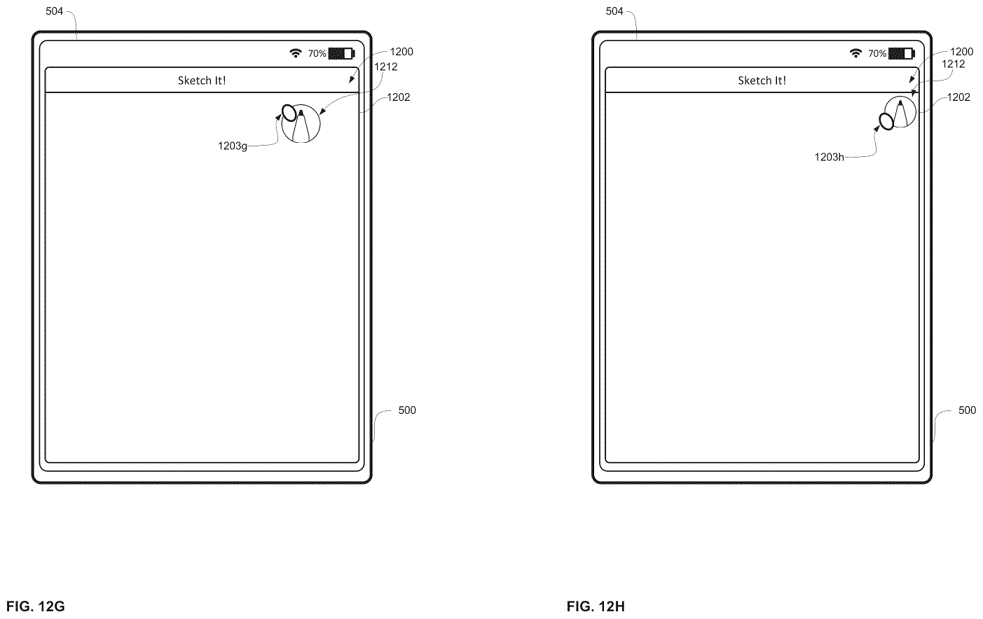

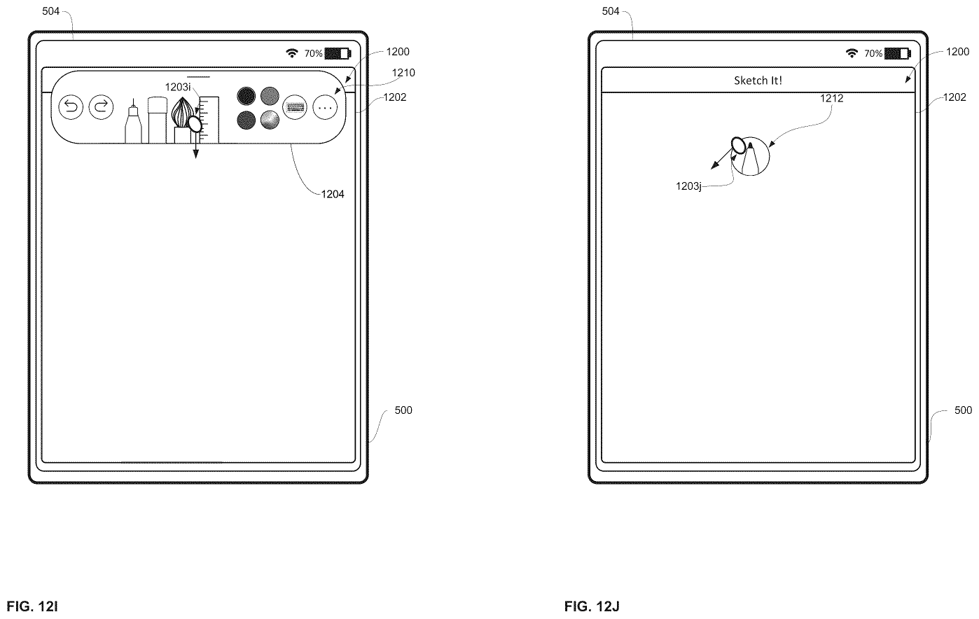

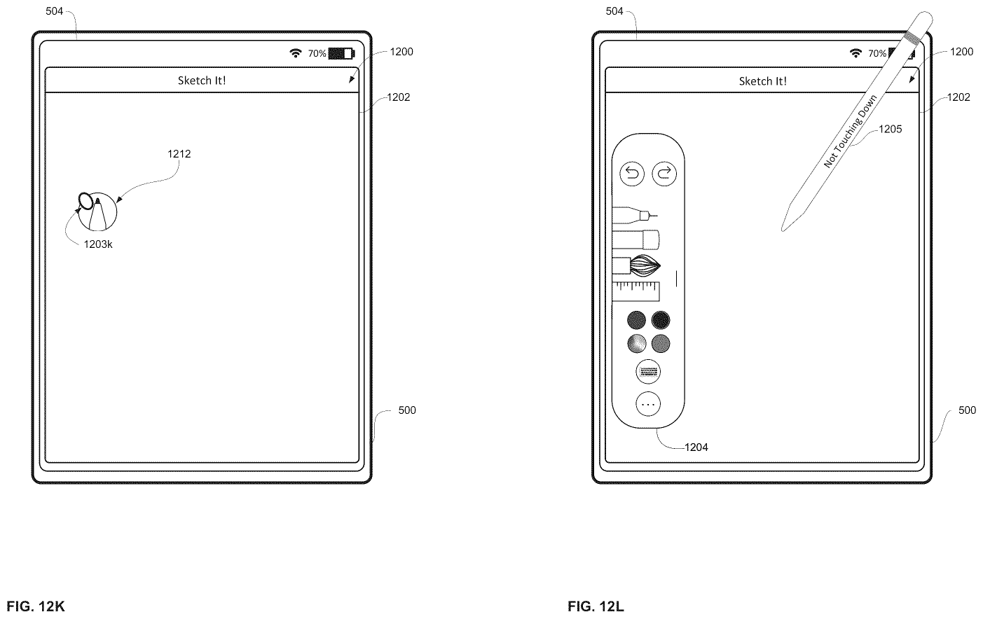

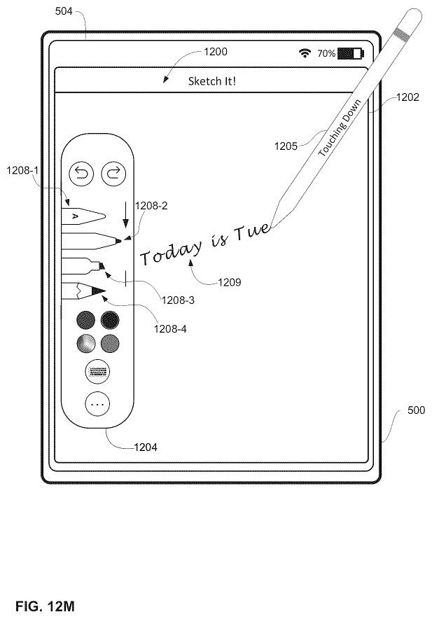

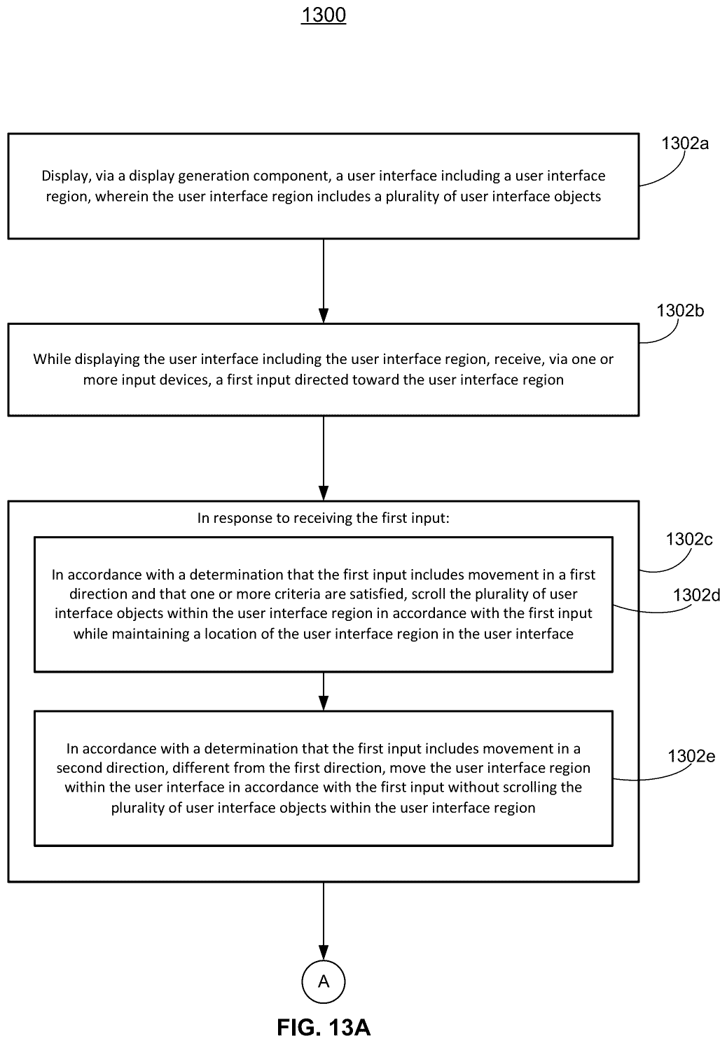

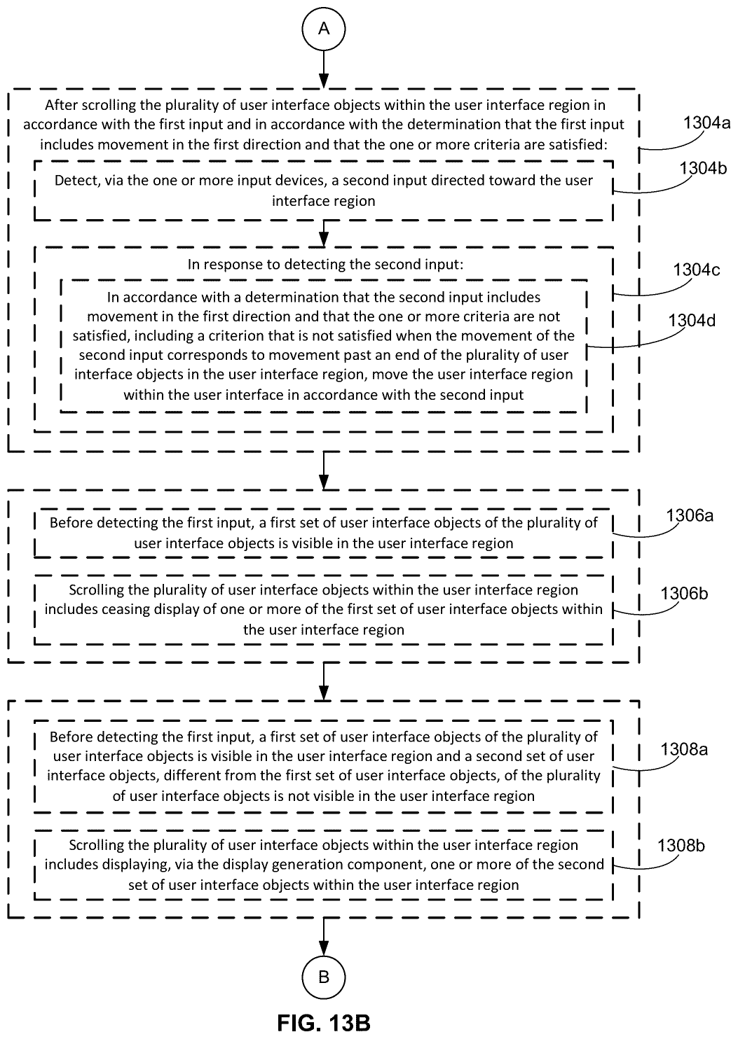

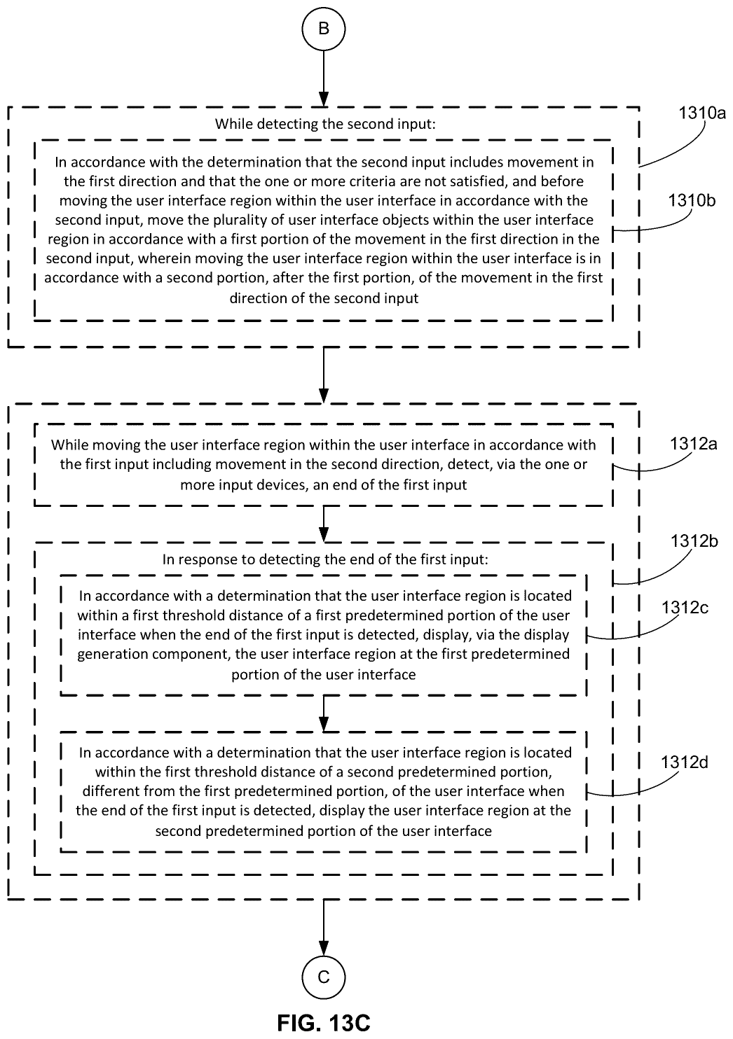

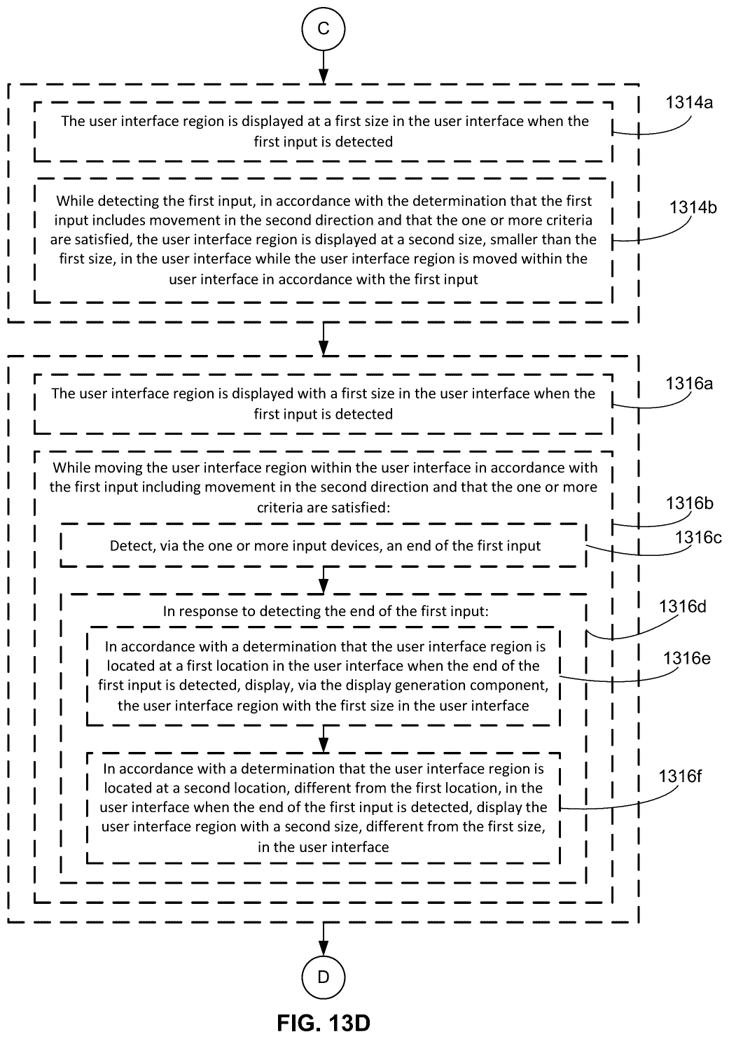

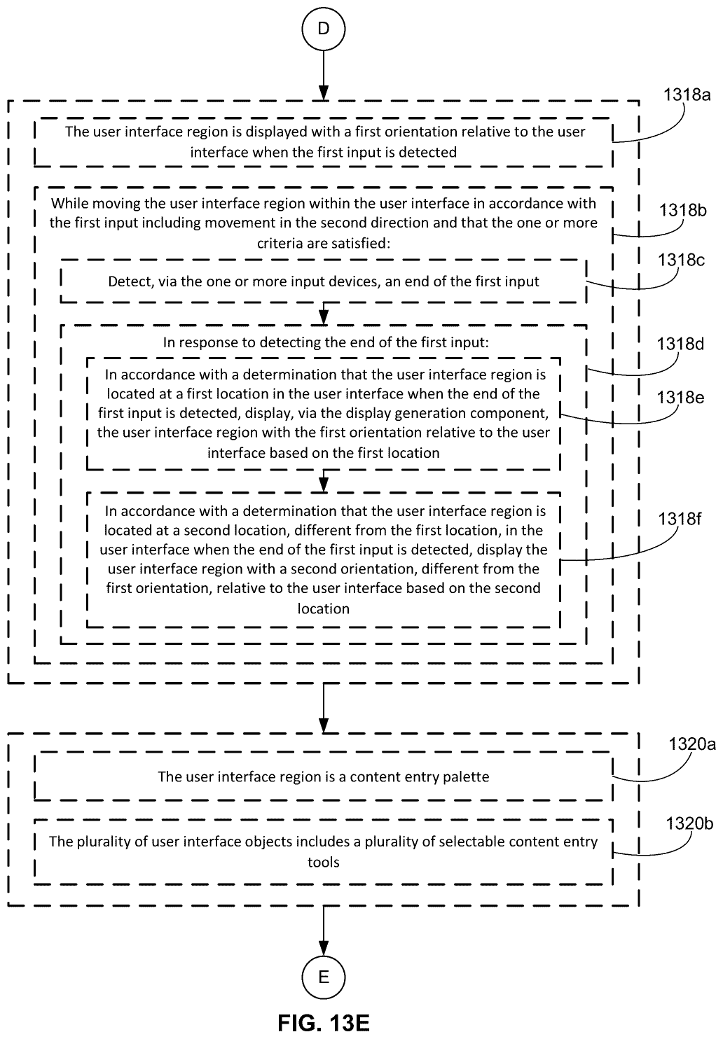

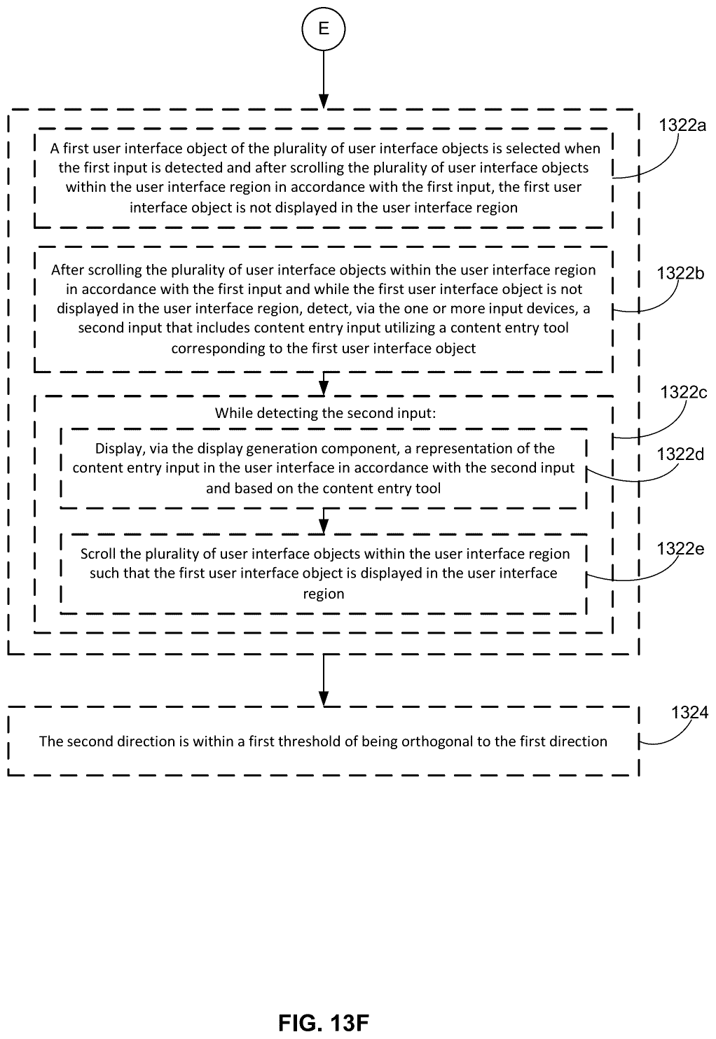

FIGS. 12A-12M illustrate exemplary ways in which an electronic device facilitates scrolling of a content entry palette and movement of the content entry palette within a user interface in accordance with some embodiments of the disclosure. The embodiments in these figures are used to illustrate the processes described below, including the processes described with reference to FIGS. 13A-13F.

FIGS. 12A-12M illustrate operation of the electronic device 500 for scrolling of a content entry palette and movement of the content entry palette within a user interface. FIG. 12A illustrates electronic device 500 displaying user interface 1200 (e.g., via a display device, via a display generation component, or via a touch screen). In some embodiments, user interface 1200 is displayed via a display generation component. In some embodiments, the display generation component is a hardware component (e.g., including electrical components) capable of receiving display data and displaying a user interface. In some embodiments, examples of a display generation component include a touch screen display (such as touch screen 504), a monitor, a television, a projector, an integrated, discrete, or external display device, or any other suitable display device that is in communication with device 500.

In some embodiments, user interface 1200 is a user interface of a content creation application. For example, the content creation application is a drawing application, a notetaking application, and/or a document markup application. In some embodiments, the content creation application is an application installed on device 500. In some embodiments, user interface 1200 corresponds to user interface 800 described above with reference to the FIG. 8 series.

In FIG. 12A, user interface 1200 includes content-entry region 1202. In some embodiments, content-entry region 1202 is configured to receive handwritten input (e.g., a drawing and/or handwriting input via a stylus device) and display a representation of the handwritten input (e.g., if drawing and/or handwritten input is provided) and/or display font-based text (e.g., if font-based text input is provided). In some embodiments, the content-entry region 1202 corresponds to content-entry region 802 described above with reference to the FIG. 8 series. In FIG. 12A, user interface 1200 includes content-entry palette 1204. In some embodiments, content entry palette 1204 is a user interface element that includes one or more selectable options associated with content in the content-entry region 1202. For example, content entry palette 1204 includes options for changing a color of content in the content-entry region (e.g., changing the color of existing content or changing the content of future content inserted by the user), options for changing the font of text in the content-entry region (e.g., changing the font of existing text or changing the font of future text inserted by the user), options for attaching or inserting rich objects (e.g., files, images, web-based links), options for selecting the content-entry tool, and/or options for displaying a soft keyboard for inserting font-based text in the content-entry region. In some embodiments, content entry palette 1204 corresponds to menu 804 described above with reference to the FIG. 8 series.

As shown in FIG. 12A, content entry palette 1204 includes undo option 1206-1 and redo option 1206-2. In some embodiments, undo option 1206-1 is selectable to undo the most recent action (e.g., content entry-related action) and redo option 1206-2 is selectable to perform the most recent action again (e.g., content entry-related action). In some embodiments, content entry palette 1204 includes text entry tool 1208-1, pen entry tool 1208-2, highlighter entry tool 1208-3, and pencil entry tool 1208-4. In some embodiments, content entry palette 1204 includes other options 1210 that are selectable to perform other functions (e.g., display a font-based keyboard) or change one or more settings with respect to content in content entry region 802.

In some embodiments, selection of text entry tool 1208-1 causes the device to enter into a text entry mode in which handwritten inputs (e.g., corresponding to handwritten text) detected by the electronic device 500 are converted to font-based text in the content-entry region 1202. In some embodiments, selection of pen entry tool 1208-2 causes the device to enter into a pen entry mode in which handwritten inputs drawn in the content-entry region 1202 are stylized as if drawn by a pen (e.g., without converting them to font-based text). In some embodiments, selection of highlighter entry tool 1208-3 causes the device to enter into a highlighter entry mode in which handwritten inputs drawn in the content entry region are stylized as if drawn by a highlighter (e.g., without converting them to font-based text). In some embodiments, selection of pencil entry tool 1208-4 causes the device to enter into a pencil entry mode in which handwritten inputs drawn in the content-entry region 1202 are stylized as if drawn by a pencil (e.g., without converting them to font-based text). In some embodiments, content entry tools other than text entry tool 1208-1 are referred to as drawing tools (e.g., because the tools allow a user to draw in the content-entry region and without the drawn content being converted into font-based text). In FIG. 12A, pen entry tool 1208-2 is currently active (e.g., as shown by the representation of pen entry tool 1208-2 displayed higher than the other entry tools in the content entry palette 1204).

In some embodiments, the electronic device 500 scrolls the content entry palette 1204 in the content-entry region 1202 in response to detecting user input corresponding to movement in a first direction. In FIG. 12B, the electronic device 500 detects an input 1203b on touch screen 504 directed to the content-entry palette 1204. For example, as shown in FIG. 12B, the electronic device 500 detects a selection input (e.g., a tap and hold) provided by an object (e.g., a finger of the user or an input device, such as a stylus) on the touch screen 504, followed by movement of the object over the tools of the content entry palette 1204 in a leftward direction (a first direction).

In FIG. 12C, in response to detecting the interaction input directed to the content entry palette 1204, the electronic device 500 scrolls the tools of the content entry palette 1204 in accordance with the movement of the object on the touch screen 504. For example, as shown in FIG. 12C, the electronic device 500 displays additional tools in the content entry palette 1204 (e.g., tools not previously displayed and/or visible in the content entry palette 1204). The additional tools include a fine line pen entry tool 1208-5, an eraser tool 1208-6, a watercolor entry tool 1208-7, and a measurement tool 1208-8.

In some embodiments, selection of fine line pen entry tool 1208-5 causes the device to enter into a fine line pen entry mode in which handwritten inputs drawn in the content-entry region 1202 are stylized as if drawn by a monoline pen (e.g., without converting them to font-based text). In some embodiments, selection of eraser tool 1208-6 causes the device to enter into an eraser mode in which inputs directed to handwritten inputs drawn in the content-entry region 1202 cause the device to cease display of the handwritten inputs. In some embodiments, selection of watercolor entry tool 1208-7 causes the device to enter into a watercolor entry mode in which handwritten inputs drawn in the content entry region are stylized as if drawn by a watercolor paint brush (e.g., without converting them to font-based text), as described in detail in method 1100. In some embodiments, selection of measurement tool 1208-8 causes the device to enter into a measurement mode in which a representation of a measurement tool (e.g., a ruler) is displayed in the content-entry region 1202 for providing measurement reference (e.g., in inches, centimeters, meters). In FIG. 12C, pen entry tool 1208-2 is still active despite not currently being displayed/visible in the content entry palette 1204.

In some embodiments, an amount that the electronic device 500 scrolls the content entry palette 1204 is based on a magnitude of the movement input directed to the tools of the content entry palette 1204. For example, the magnitude of the movement of the interaction input 1203b detected in FIG. 12B causes the electronic device 500 to scroll the tools of the content entry palette 1204 by an amount that is proportional to the movement. For example, a smaller magnitude of movement than that detected in FIG. 12B would cause the electronic device 500 to scroll through the tools by a smaller amount than that shown in FIG. 12C, which would optionally cause fewer additional tools to be displayed in the content entry palette 1204 (e.g., one or more of the tools in FIG. 12A would still be displayed/visible in the content entry palette 1204). In some embodiments, a larger magnitude of movement than that detected in FIG. 12B would cause the electronic device 500 to scroll through the tools by a larger amount than that shown in FIG. 12C and/or would cause the electronic device 500 to resist the scrolling of the tools 1208-5-1208-8 shown in FIG. 12C. For example, in FIG. 12C, the electronic device 500 detects an interaction input 1203c corresponding to further movement of the tools in the content entry palette 1204 in the leftward direction (e.g., while the object providing the interaction input 1203c remains in contact with the touch screen 504).

In FIG. 12D, in response to detecting the interaction input 1203c, the electronic device 500 resists additional scrolling of the tools 1208-5 through 1208-8 within the content entry palette 1204. For example, the content entry palette 1204 has no further additional tools than those displayed in FIG. 12C. Accordingly, in response to detecting the interaction input 1203c, rather than scrolling the content entry palette 1204 to reveal further additional tools, the electronic device 500 resists the scrolling of the content entry palette 1204 in the direction of the movement of the interaction input 1203c, as shown in FIG. 12D. For example, the electronic device 500 allows a small amount (e.g., a threshold amount of movement, such as less than 0.25, 0.5, 1, 2, 3, or 5 cm of movement) of movement of the tools 1208-5 through 1208-8 within the content entry palette 1204 and resists further movement of the tools 1208-5 through 1208-8 according to the movement of the interaction input 1203c (e.g., while the object providing the interaction input 1203c remains in contact with the touch screen 504). In some embodiments, if the electronic device 500 detects a termination (e.g., lift-off) of the contact between the object providing the interaction input 1203c and the touch screen 504, the electronic device 500 reverses at least a portion of the amount of movement of the tools 1208-5 through 1208-8 within the content entry palette 1204 shown in FIG. 12D. For example, the electronic device 500 would move the tools 1208-5 through 1208-8 in a direction that is opposite the movement of the input 1203c (e.g., a rightward direction) within the content entry palette 1204.

In some embodiments, in response to detecting movement input corresponding to further scrolling of the content entry palette 1204 beyond a scrolling limit, the electronic device 500 moves the content entry palette 1204 in accordance with the movement input. For example, in FIG. 12D, the electronic device 500 detects, while the object that provided the interaction input 1203c in FIG. 12C remains in contact with the touch screen 504, an interaction input 1203d corresponding to further scrolling of the content entry palette 1204. As described above, the content entry palette 1204 optionally has no further tools beyond those shown in FIG. 12D. Additionally, as described above, when the interaction input 1203d is detected in FIG. 12D, the electronic device 500 has scrolled through the tools 1208-5 through 1208-8 to the scrolling limit (e.g., has scrolled through the tools 1208-5 through 1208-8 the threshold amount discussed above). Accordingly, as shown in FIG. 12E, in response to detecting the interaction input 1203d that includes movement in the leftward direction beyond the scrolling limit, the electronic device 500 moves the content entry palette 1204 within the content entry region 1202 in accordance with the movement. For example, as shown in FIG. 12E, the electronic device 500 moves the content entry palette 1204 leftward in the content entry region 1202 without scrolling through the tools of the content entry palette 1204.

In some embodiments, the electronic device 500 changes a size and/or appearance of the content entry palette 1204 while moving the content entry palette 1204 within the content-entry region 1202. For example, in FIG. 12D, the electronic device 500 displays the content entry palette 1204 with a firsts size in the content-entry region 1202 when the input 1203d is detected. In some embodiments, in response to detecting subsequent movement input 1203e directed to the content entry palette 1204 (e.g., while the object that provided the input 1203d in FIG. 12D remains in contact with the touch screen 504), the electronic device 500 displays the content entry palette 1204 with a second size, smaller than the first size, in the content entry region 1202 while moving the content entry palette 1204 in accordance with the input 1203e, as shown in FIG. 12F.

Additionally, as mentioned above, in FIG. 12F, the electronic device 500 optionally changes the appearance of the content entry palette 1204 in the content entry region 1202 when the electronic device 500 moves the content entry palette 1204. For example, as shown in FIG. 12F, the electronic device 500 displays the content entry palette 1204 as user interface element 1212. As shown in FIG. 12F, the user interface element 1212 includes the content-entry tool that is currently selected (e.g., the pen-entry tool 1208-2 in FIG. 12A) but does not include the other content-entry tools and selectable options (e.g., selectable options 1210) that were displayed in the content entry palette when the input 1203e was detected in FIG. 12E. In some embodiments, the user interface element 1212 is selectable (e.g., via a touch and hold input) to initiate movement of the user interface element 1212 in the content entry region 1202.

In FIG. 12F, the electronic device 500 detects interaction input 1203f directed to the user interface element 1212 in the content entry region 1202. For example, as shown in FIG. 12F, the electronic device 500 detects selection (e.g., a tap and hold) of the user interface element 1212, followed by movement in a diagonally rightward direction relative to the content entry region 1202. In some embodiments, in response to detecting the movement directed to the user interface element 1212, as shown in FIG. 12G, the electronic device 500 moves the user interface element 1212 within the content-entry region 1202 in accordance with the movement. For example, as shown in FIG. 12G, the electronic device 500 moves the user interface element 1212 in the diagonally rightward direction in the content-entry region 1202.

In some embodiments, in response to detecting an end of the movement input directed to the user interface element 1212, the electronic device 500 displays the user interface element 1212 at a location of the content-entry region 1202 that is based on a location of the user interface element 1212 when the end of the movement input is detected. For example, in FIG. 12G, the electronic device 500 detects a release of the movement of the user interface element 1212 (e.g., detects lift-off of the object providing the movement input from the surface of the touch screen 504). In some embodiments, in response to detecting the release 1203g, the electronic device 500 displays the user interface element 1212 at a first location of the content-entry region 1202, as shown in FIG. 12H. For example, in FIG. 12G, when the electronic device 500 detects the end of the movement input, the user interface element 1212 is located near (e.g., within a first threshold distance, such as 0.5, 0.75, 1, 1.5, 1.75, 2, or 3 cm, of) a first predetermined portion (e.g., the top right corner) of the content-entry region 1202. Accordingly, as shown in FIG. 12H, the electronic device 500 displays the user interface element 1212 at a second location based on the first predetermined portion (e.g., at the top right corner).

Additionally, in some embodiments, as shown in FIG. 12H, the electronic device 500 changes a size of the user interface element 1212 based on the location at which the user interface element 1212 is displayed. For example, in FIGS. 12F-12G, during the movement of the user interface element 1212, the electronic device 500 displays the user interface element 1212 with a first size in the content-entry region 1202. In FIG. 12H, when the electronic device 500 displays the user interface element 1212 at the second location (e.g., the top right corner) of the content-entry region 1202 in response to detecting the end of the movement, the electronic device 500 displays the user interface element 1212 with a second size, optionally smaller than the first size, in the content-entry region 1202.

In some embodiments, the electronic device 500 redisplays the user interface element 1212 as content entry palette 1204 in response to detecting selection of the user interface element 1212. For example, in FIG. 12H, the electronic device 500 detects a selection input (e.g., a tap or touch) 1203h directed to the user interface element 1212 in the content-entry region 1202. In some embodiments, in response to detecting the selection input 1203h, the electronic device 500 replaces display of the user interface element 1212 with the content entry palette 1204, as shown in FIG. 12I. For example, as shown in FIG. 12I, the electronic device 500 redisplays the content entry palette 1204 including the content entry tools (e.g., 1208-5 through 1208-8 in FIG. 12D) and selectable options 1210.

In some embodiments, the electronic device 500 displays the content entry palette 1204 at a location in the user interface 1200 that is based on the location at which the user interface element 1212 was displayed when the selection input 1203h was detected. For example, in FIG. 12H, the electronic device 500 detects the selection input 1203h while the user interface element 1212 is displayed in the top right corner of the content-entry region 1202. Accordingly, as shown in FIG. 12I, the electronic device 500 displays the content entry palette 1204 at a location of the user interface 1200 that is at a top region of the user interface 1200. Additionally, as shown in FIG. 12I, the electronic device 500 displays the content entry palette 1204 with an orientation that is based on the location at which the user interface element 1212 was displayed when the selection input 1203h was detected. For example, because an orientation associated with the top region of the user interface 1200 is a horizontal orientation, the electronic device 500 displays the content entry palette 1204 with the horizontal orientation relative to the user interface 1200, as shown in FIG. 12I. As shown in FIG. 12I, the content entry tools and selectable options 1210 are displayed upright within the content entry palette 1204 relative to the user interface 1200 in accordance with the orientation of the content entry palette 1204.

In some embodiments, the electronic device 500 moves the content entry palette 1204 in response to detecting an interaction input that includes movement directed to the content entry palette 1204 in a second direction, different from the first direction described above with reference to FIG. 12B. In FIG. 12I, the electronic device 500 detects movement input 1203i directed to the plurality of tools displayed within the content entry palette 1204. For example, as shown in FIG. 12I, the electronic device 500 detects a tap or touch of an object (e.g., a finger or input device) directed to the plurality of tools within the content entry palette 1204, followed by movement of the object in a downward direction relative to the user interface 1200. In some embodiments, because the movement input 1203i includes movement in the second direction, different from the first direction (e.g., orthogonal to the first direction), the electronic device 500 moves the content entry palette 1204 in the user interface 1200, as shown in FIG. 12J. In some embodiments, the electronic device 500 moves the content entry palette 1204 in accordance with the movement input because the movement input includes movement in a direction that is different from (e.g., orthogonal to) the orientation of the content entry palette 1204, as shown in FIG. 12I. In some embodiments, the electronic device 500 moves the content entry palette 1204 in accordance with the movement input without scrolling the plurality of content entry tools within the content entry palette 1204.

In some embodiments, as similarly described above, when the electronic device moves the content entry palette 1204 in accordance with the movement input 1203i, the electronic device 500 changes the size of the content entry palette 1204. For example, as shown in FIG. 12J, the electronic device 500 displays the content entry palette 1204 as the user interface element 1212 having a smaller size than that of the content entry palette 1204 in FIG. 12I. In FIG. 12J, the electronic device 500 detects additional movement input 1203j directed to the user interface element 1212. For example, as shown in FIG. 12J, the electronic device 500 detects an object (e.g., a finger or input device) maintain contact with the user interface element 1212 on the touch screen 504 and move in a downward and leftward direction relative to the user interface 1200. In some embodiments, the electronic device 500 moves the user interface element 1212 within the content-entry region 1202 in accordance with the movement input 1203j, as shown in FIG. 12K. For example, as shown in FIG. 12K, the electronic device 500 moves the user interface element 1212 downward and leftward in the content-entry region 1202 relative to the user interface 1200.

In FIG. 12K, the electronic device 500 detects an end of the movement input 1203k. For example, as shown in FIG. 12K, the electronic device 500 detects release (e.g., lift-off) of the object (e.g., a finger or input device) providing the movement input from the touch screen 504. In some embodiments, in response to detecting the release of the movement input, the electronic device 500 displays the content entry palette 1204 at a location in the user interface 1200 that is based on the location at which the release of the movement input is detected, as shown in FIG. 12L. For example, in FIG. 12K, the electronic device 500 detects the end of the movement input 1203k at a location that is near (e.g., within a threshold distance of, such as 0.1, 0.25, 0.5, 1, 2, 3, 5, 10, 15, or cm of) a left side edge of the user interface 1200. As shown in FIG. 12L, the electronic device 500 displays the content entry palette 1204 along the left side edge of the user interface 1200 after detecting the end of the movement input 1203k in FIG. 12K.

In some embodiments, the electronic device 500 displays the content entry palette 1204 with an orientation that is based on the location in the user interface 1200 at which the end of the movement input 1203k is detected in FIG. 12K. As mentioned above, the end of the movement input 1203k is detected in FIG. 12K near the left side edge of the user interface 1200. In some embodiments, the left side edge of the user interface is associated with a first orientation (e.g., a vertical orientation). Accordingly, in FIG. 12L, when the electronic device 500 displays the content entry palette 1204 along the left side edge of the user interface 1200, the electronic device displays the content entry palette 1204 with the first orientation. In some embodiments, if the electronic device 500 had detected the end of the movement input at a different location of the user interface 1200, the electronic device 500 would display the content entry palette with a second orientation different from the first orientation. For example, if the electronic device 500 had detected the end of the movement input in FIG. 12J (e.g., in which the user interface element 1212 is located near a top region of the user interface 1200), the electronic device 500 would display the content entry palette 1204 at a top edge of the user interface 1200 with the orientation shown in FIG. 12I.

In some embodiments, the content entry tools of the content entry palette 1204 are displayed with an orientation that aligns to the orientation of the content entry palette 1204. For example, as shown in FIG. 12L, when the electronic device 500 displays the content entry palette 1204 along the left side edge of the user interface 1200, the electronic device 500 displays the content entry tools of the content entry palette 1204 with the first orientation (e.g., along a vertical direction) described above. On the other hand, if the electronic device 500 were to display the content entry palette 1204 with the second orientation (e.g., as similarly shown in FIG. 12I), the electronic device would display the content entry tools of the content entry palette 1204 with the second orientation (e.g., along a horizontal direction).

As described above, in some embodiments, the content-entry region 1202 is configured to receive handwritten input (e.g., a drawing and/or handwriting input via a stylus device, such as stylus 1205) and display a representation of the handwritten input (e.g., if drawing and/or handwritten input is provided). In some embodiments, the representation of the handwritten input has a visual appearance that is based on the content entry tool that is currently selected in the content entry palette 1204, as discussed previously above. As described above with reference to FIG. 12A, the pen entry tool (e.g., 1208-2) is currently active at the electronic device 500. In FIG. 12L, the pen entry tool is currently not displayed in the content entry palette 1204 (e.g., as a result of the scrolling operation performed in FIG. 12C).

In FIG. 12M, the electronic device 500 has detected a contact with touch screen 504 provided by the stylus 1205 (e.g., controlled by the user of the electronic device 500) while the pen entry tool 1208-2 is active. While the contact is maintained with touch screen 504, the electronic device 500 detects handwriting movement by the stylus 1205. In some embodiments, in response to detecting the handwriting movement, the electronic device 500 displays a representation of the handwritten input 1209 in the content-entry region 1202, as shown in FIG. 12M. In some embodiments, a representation of the handwritten input is displayed while the input is being received. As shown in FIG. 12M, the representation of the handwritten input 1209 has a visual appearance that is based on the pen entry tool selected in FIG. 12A.

In some embodiments, if the selected content entry tool is not displayed in the content entry palette 1204 when the handwritten input provided by the stylus 1205 is detected, the electronic device redisplays the selected content entry tool in the content entry palette 1204. For example, as mentioned above, the pen entry tool 1208-2 is not visible in the content entry palette 1204 when the handwritten input is detected. As shown in FIG. 12M, while detecting the handwritten input provided by the stylus 1205 on the touch screen 504, the electronic device 500 redisplays the pen entry tool 1208-2 in the content entry palette 1204. In some embodiments, redisplaying the pen entry tool 1208-2 in the content entry palette 1204 includes scrolling the plurality of content entry tools to bring the pen entry tool 1208-2 back into view within the content entry palette 1204, as shown in FIG. 12M. For example, the content entry tools that are located adjacent to the pen entry tool 1208-2, such as the text entry tool 1208-1 and/or the highlighter entry tool 1208-3, are also brought back into view within the content entry palette 1204 when the electronic device 500 scrolls the content entry palette 1204.

FIGS. 13A-13F is a flow diagram illustrating a method 1300 of facilitating scrolling of a content entry palette and movement of the content entry palette within a user interface in accordance with some embodiments of the disclosure. The method 1300 is optionally performed at an electronic device such as device 100, device 300, device 500 as described above with reference to FIGS. 1A-1B, 2-3, 4A-4B and 5A-5H. Some operations in method 1300 are, optionally combined and/or order of some operations is, optionally, changed.

As described below, the method 1300 provides ways in which an electronic device scrolls a content entry palette and moves the content entry palette within a user interface. The method reduces the cognitive burden on a user when interaction with a user interface of the device of the disclosure, thereby creating a more efficient human-machine interface. For battery-operated electronic devices, increasing the efficiency of the user's interaction with the user interface conserves power and increases the time between battery charges.

In some embodiments, the method 1300 is performed at an electronic device (e.g., 500) in communication with a display generation component (e.g., 504), and one or more input devices. For example, the electronic device is a mobile device (e.g., a tablet, a smartphone, a media player, or a wearable device). In some embodiments, the electronic device has one or more characteristics of the electronic device in methods 700, 900, and/or 1100. In some embodiments, the display generation component has one or more characteristics of the display generation component in methods 700, 900, and/or 1100. In some embodiments, the one or more input devices have one or more characteristics of the one or more input devices in methods 700, 900, and/or 1100.

In some embodiments, the electronic device displays (1302a), via the display generation component, a user interface (e.g., user interface 1200 in FIG. 12A) including a user interface region (e.g., content entry palette 1204 in FIG. 12A), wherein the user interface region includes a plurality of user interface objects, such as content entry tools 1208-1 through 1208-4 in FIG. 12A. For example, the electronic device displays a user interface associated with a content creation application on the electronic device. In some embodiments, the content creation application includes a note-taking application, a drawing application, a journaling application, and/or a design application. In some embodiments, the user interface region is displayed in a predefined portion of the user interface (e.g., at a bottom, top, or side region of the user interface). In some embodiments, the user interface region is a toolbar element or content entry palette that includes a plurality of user interface objects. In some embodiments, the plurality of user interface objects includes a plurality of writing tools (e.g., that define a form and appearance of handwritten strokes provided in the user interface) and/or a plurality of controls associated with the plurality of writing tools, such as color controls, thickness controls, text-insertion controls, text-editing controls, and/or selection controls, similar to selectable options 1210 in FIG. 12A. In some embodiments, a subset of the plurality of user interface objects are visible in the user interface region at a given moment in time (e.g., the user interface region is scrollable (e.g., horizontally scrollable) to reveal additional user interface objects of the plurality of user interface objects). In some embodiments, the user interface region has one or more characteristics of user interface(s) and/or region(s) in methods 900 and/or 1100.

In some embodiments, while displaying the user interface including the user interface region, the electronic device receives (1302b), via the one or more input devices, a first input directed toward the user interface region, such as user input 1203b directed toward the content entry palette 1204 as shown in FIG. 12B. For example, the electronic device detects a respective gesture directed toward the user interface region. In some embodiments, the electronic device detects the respective gesture on a touch sensitive surface (e.g., at a location of a touch screen of the electronic device that corresponds to a location of the user interface region in the user interface), such as touch screen 504 in FIG. 12B, or other surface. In some embodiments, the respective gesture includes contact with (e.g., touch directed to) the surface, followed by movement of the contact (e.g., movement of a finger or hardware input device (e.g., a stylus) providing the contact) in a respective direction on the surface. In some embodiments, the surface has one or more characteristics of the surface described in method 700. In some embodiments, the first input has one or more characteristics of inputs in methods 700, 900, and/or 1100.

In some embodiments, in response to receiving the first input (1302c), in accordance with a determination that the first input includes movement in a first direction (e.g., a leftward direction as shown in FIG. 12B) and that one or more criteria are satisfied (e.g., if the movement includes scrolling through the plurality of user interface objects, the one or more criteria are satisfied if an amount of the scrolling is below a movement threshold, such as below 0.25, 0.5, 1, 2, 3, 4, 5, or 12 cm), the electronic device scrolls (1302d) the plurality of user interface objects within the user interface region in accordance with (e.g., with a direction based on a direction of the input and/or a magnitude based on a magnitude of the input) the first input while maintaining a location of the user interface region in the user interface, such as scrolling the content entry tools 1208-1 through 1208-4 as shown in FIG. 12C. For example, if the electronic device determines that the first input includes movement of the contact on the user interface region in a first direction and includes scrolling below the movement threshold above, the electronic device scrolls through the plurality of user interface objects in the first direction to reveal additional user interface objects within the user interface region (e.g., additional writing tools and/or controls), such as content entry tools 1208-5 through 1208-8 in FIG. 12C. In some embodiments, the first direction (e.g., substantially or partially) follows an orientation associated with the user interface region. For example, the plurality of user interface objects is arranged in a respective direction (e.g., horizontally) within the user interface region. If the movement in the first direction corresponds to movement in the respective direction and satisfies the one or more criteria, the electronic device optionally scrolls the plurality of user interface objects accordingly. In some embodiments, an amount that the plurality of user interface objects is scrolled is based on a magnitude of the movement. For example, if the first input includes a first amount of movement in the first direction, the electronic device scrolls the plurality of user interface objects by a respective amount based on (e.g., proportional to) the first amount. In some embodiments, a direction in which the plurality of user interface objects is scrolled in the user interface region is based on the direction of the movement relative to the user interface region. For example, detection of the first direction of movement (e.g., rightward or leftward movement relative to the user interface region), which (e.g., substantially or partially) corresponds to the orientation associated with the user interface region, causes the electronic device to scroll the plurality of user interface objects in a respective direction based on the first direction. In some embodiments, the user interface region does not move within the user interface region when the plurality of user interface objects are scrolled, as similarly shown in FIG. 12C.

In some embodiments, in accordance with a determination that the first input includes movement in a second direction, different from the first direction (e.g., and independent of whether the one or more criteria are satisfied), such as movement in a downward direction as shown in FIG. 12I, the electronic device moves (1302e) the user interface region within the user interface in accordance with (e.g., with a direction based on a direction of the input and/or a magnitude based on a magnitude of the input) the first input without scrolling the plurality of user interface objects within the user interface region, such as downward movement of the user interface element 1212 within the user interface 1200 as shown in FIG. 12J. For example, if the electronic device determines that the first input includes movement of the contact on the user interface region in the second direction, the electronic device moves the user interface region in accordance with the first input. In some embodiments, the second direction is orthogonal (e.g., or within 1, 2, 5, 10, 15, 20, 30, or 45 degrees of being orthogonal) to the first direction that causes the plurality of user interface objects to be scrolled within the user interface region. For example, the second direction does not correspond to the orientation associated with the user interface region. In some embodiments, an amount that the user interface region is moved within the user interface is based on a magnitude of the movement. For example, if the first input includes a first amount of movement in the second direction, the electronic device moves the user interface region by a respective amount in the user interface based on (e.g., proportional to) the first amount. In some embodiments, a direction in which the user interface region is moved in the user interface is based on the direction of the movement relative to the user interface region. For example, detection of the second direction of movement (e.g., diagonal movement relative to the user interface region), which (e.g., substantially or partially) does not correspond to the orientation associated with the user interface region, causes the electronic device to move the user interface region in a respective direction based on the second direction. In some embodiments, the plurality of user interface objects are not scrolled within the user interface region when the user interface region is moved. In some embodiments, as described below with reference to steps 1314a-1314b, the electronic device changes an appearance (e.g., size, shape, and/or contents) of the user interface region when the user interface region is moved within the user interface, such as display of content entry palette 1204 as user interface element 1212 in FIG. 12J. Scrolling a plurality of objects within a user interface region or moving the user interface region in a user interface depending on a direction of movement of an input directed toward the user interface region reduces the number of inputs needed to move and/or scroll the objects within the user interface region, thereby improving user-device interaction, and/or enables additional objects to be displayed within the user interface region without increasing a size of the user interface region, thereby improving spatial utilization.

In some embodiments, after scrolling the plurality of user interface objects within the user interface region in accordance with the first input and in accordance with the determination that the first input includes movement in the first direction and that the one or more criteria are satisfied (1304a), the electronic device detects (1304b), via the one or more input devices, a second input directed toward the user interface region, such as user input 1203c directed to the content entry palette 1204 as shown in FIG. 12C. For example, the electronic device detects a respective gesture directed toward the user interface region, as similarly described above with reference to steps 1302a-1302e.

In some embodiments, in response to detecting the second input (1304c), in accordance with a determination that the second input includes movement in the first direction (e.g., leftward movement as shown in FIG. 12C) and that the one or more criteria are not satisfied, including a criterion that is not satisfied when the movement of the second input corresponds to movement past an end of the plurality of user interface objects in the user interface region (e.g., a last user interface object, such as content entry tool 1208-8 in FIG. 12C), the electronic device moves (1304d) the user interface region within the user interface in accordance with the second input, such as movement of the content entry palette 1204 within the user interface 1200 as shown in FIG. 12E. For example, if the electronic device determines that the second input includes movement of the contact on the user interface region in the first direction and includes scrolling past a last user interface object of the plurality of user interface objects, the electronic device moves the user interface region within the user interface in the first direction in accordance with the second input. In some embodiments, the movement in the first direction past the end of the plurality of user interface objects in the user interface region causes the electronic device to move the user interface region irrespective of whether the movement is above or below the movement threshold (e.g., 0.25, 0.5, 1, 2, 3, 4, 5, 10, or 12 cm) described above with reference to steps 1302a-1302e. For example, though movement below the movement threshold satisfies one criterion of the one or more criteria, the movement below the movement threshold is enough to scroll the plurality of user interface objects past the end of the plurality of user interface objects, thus resulting in the movement of the user interface region discussed above. Moving a user interface region after scrolling a plurality of objects within the user interface region in response to detecting an input that includes movement past an end of the plurality of objects facilitates discovery that the end of the plurality of objects has been reached and/or enables the user interface region to be moved after scrolling the plurality of objects within the user interface region automatically, thereby improving user-device interaction.

In some embodiments, before detecting the first input, a first set of user interface objects of the plurality of user interface objects is visible in the user interface region (1306a), such as content entry tools 1208-1 through 1208-4 in FIG. 12A. For example, a first number (e.g., two, three, four, or five) of user interface objects are displayed/visible within the user interface region when the first input is detected.

In some embodiments, scrolling the plurality of user interface objects within the user interface region includes ceasing display of one or more of the first set of user interface objects within the user interface region (1306b), such as ceasing display of the content entry tools 1208-1 through 1208-4 within the content entry palette 1204 as shown in FIG. 12C. For example, when the electronic device scrolls the plurality of user interface objects within the user interface region in accordance with the first input, the electronic device no longer displays one or more of the first set of user interface objects within the user interface region. In some embodiments, the one or more of the first set of user interface objects are no longer displayed in the user interface region because a magnitude of the movement in the first direction causes the electronic device to scroll the one or more of the first set of user interface objects out of view in the user interface region. Ceasing display of one or more objects when scrolling a plurality of the objects within a user interface region in a user interface in accordance with movement directed toward the user interface region enables undesired objects to be scrolled out of view in the user interface region, thereby improving user-device interaction, and/or enables additional objects to be displayed within the user interface region without increasing a size of the user interface region, thereby improving spatial utilization.

In some embodiments, before detecting the first input, a first set of user interface objects of the plurality of user interface objects is visible in the user interface region (e.g., content entry tools 1208-1 through 1208-4 in FIG. 12A) and a second set of user interface objects, different from the first set of user interface objects, of the plurality of user interface objects is not visible in the user interface region (1308a), such as content entry tools 1208-5 through 1208-8 in FIG. 12C. For example, a first number (e.g., two, three, four, or five) of user interface objects are displayed/visible within the user interface region and a second number (e.g., one, two, three, four, or five) of user interface objects are not displayed/visible within the user interface region when the first input is detected.

In some embodiments, scrolling the plurality of user interface objects within the user interface region includes displaying, via the display generation component, one or more of the second set of user interface objects within the user interface region (1308b), such as displaying the content entry tools 1208-5 through 1208-8 within the content entry palette 1204 as shown in FIG. 12C. For example, when the electronic device scrolls the plurality of user interface objects within the user interface region in accordance with the first input, the electronic device reveals one or more of the second set of user interface objects within the user interface region. In some embodiments, one or more of the first set of user interface objects are no longer displayed in the user interface region when the electronic device scrolls the plurality of user interface objects (e.g., because a magnitude of the movement in the first direction causes the electronic device to scroll the one or more of the first set of user interface objects out of view in the user interface region), such as ceasing display of the content entry tools 1208-1 through 1208-4 within the content entry palette 1204 after scrolling as shown in FIG. 12C. In some embodiments, one or more of the first set of user interface objects are concurrently displayed with the one or more of the second set of the user interface objects within the user interface region when the electronic device scrolls the plurality of user interface objects. Revealing one or more objects when scrolling a plurality of the objects within a user interface region in a user interface in accordance with movement directed toward the user interface region enables objects that are not currently displayed to be scrolled into view in the user interface region, thereby improving user-device interaction, and/or enables additional objects to be displayed within the user interface region without increasing a size of the user interface region, thereby improving spatial utilization.

In some embodiments, while detecting the second input (1310a), in accordance with the determination that the second input includes movement in the first direction (e.g., leftward direction in FIG. 12C) and that the one or more criteria are not satisfied (e.g., because the movement of the second input corresponds to movement past an end of the plurality of user interface objects in the user interface region), and before moving the user interface region within the user interface in accordance with the second input, the electronic device moves (1310b) the plurality of user interface objects within the user interface region in accordance with a first portion of the movement in the first direction in the second input, such as movement of the content entry tools 1208-5 through 1208-8 within the content entry palette 1204 as shown in FIG. 12D, wherein moving the user interface region within the user interface is in accordance with a second portion, after the first portion, of the movement in the first direction of the second input, such as movement of the content entry palette 1204 in the user interface 1200 as shown in FIG. 12E. For example, the electronic device moves, without scrolling, the plurality of user interface objects that are displayed in the user interface region in the first direction by a first amount that is less than a second amount that the user interface region is moved in response to detecting the second input (e.g., as described above with reference to steps 1304a-1304d). In some embodiments, the electronic device moves the plurality of user interface objects in the user interface region without scrolling the user interface objects because the end of the plurality of user interface objects has been reached within the user interface region, such as a last user interface object (e.g., content entry tool 1208-8 in FIG. 12C). In some embodiments, the plurality of user interface objects moves the first amount in the user interface region while the object (e.g., finger of the user or input device, such as a stylus) remains in contact with the touch screen. In some embodiments, the electronic device increasingly resists the movement of the plurality of user interface objects in the user interface region as the movement in the first direction in the first portion of the second input progresses (e.g., before transitioning to the second portion of the second input). For example, as the movement in the first direction increases further beyond the end of the plurality of user interface objects and/or the end of the portion of the user interface region that is available for displaying the plurality of user interface objects, the electronic device increasingly (e.g., proportionally to the amount by which the movement is extending beyond the end of the plurality of user interface objects and/or the end of the portion of the user interface region that is available for displaying the plurality of user interface objects) resists the movement of the plurality of user interface objects in the first direction within the user interface region, optionally until the movement of the second input is sufficiently large (e.g., more than 0.05, 0.1, 0.3, 0.5, 1, 3, 5, 10 or 20 cm beyond the end of the plurality of user interface objects and/or the end of the portion of the user interface region that is available for displaying the plurality of user interface objects) to cause the electronic device to move the user interface region in the first direction, such as movement of the content entry palette 1204 leftward in the user interface 1200 in accordance with the input 1203d as shown in FIG. 12E. In some embodiments, after the electronic device moves the plurality of user interface objects by the first amount in the user interface region while detecting the second input, the electronic device moves the user interface region within the user interface by the second amount in accordance with the second input. In some embodiments, if the electronic device detects an end of the second input (e.g., lift-off of the object providing the movement from the surface of the touch screen of the electronic device) while moving the plurality of user interface objects in accordance with the first portion of the movement, the electronic device forgoes moving the user interface region within the user interface. For example, rather than moving the user interface region, the electronic device moves the plurality of user interface objects within the user interface region in a direction (that is optionally opposite the movement in the first direction) until the plurality of user interface objects occupies at least a portion of the user interface region in which the plurality of user interface objects was displayed before the second input was detected. Moving a plurality of objects within a user interface region before moving the user interface region within a user interface in response to detecting an input that includes movement past an end of the plurality of objects facilitates discovery that the end of the plurality of objects has been reached and/or facilitates user input for ceasing the input and preventing the movement of the user interface region within the user interface, thereby improving user-device interaction.

In some embodiments, while moving the user interface region within the user interface in accordance with the first input including movement in the second direction, the electronic device detects (1312a), via the one or more input devices, an end of the first input, such as a release of the movement input 1203e in FIG. 12E. For example, the electronic device detects lift-off of the object (e.g., finger of the user or input device, such as a stylus) providing the contact directed to the user interface region from the touch screen of the electronic device or other surface (e.g., a touch-sensitive surface in communication with the electronic device).

In some embodiments, in response to detecting the end of the first input (1312b), in accordance with a determination that the user interface region is located within a first threshold distance (e.g., 0.1, 0.15, 0.25, 0.5, 0.75, 1, 2, 5, 10, 20, or 30 cm) of a first predetermined portion of the user interface (e.g., an edge of the user interface 1200) when the end of the first input is detected, the electronic device displays (1312c), via the display generation component, the user interface region at the first predetermined portion of the user interface, such as display of the content entry palette 1204 along a top edge of the user interface 1200 as shown in FIG. 12I. For example, if the user interface region is located at a first location that is the first threshold distance of the first predetermined portion of the user interface when the end of the first input is detected, the electronic device displays the user interface region at a location that is based on the second predetermined portion of the user interface. In some embodiments, the first predetermined portion of the user interface includes one or more side regions (e.g., a left side edge or a right side edge) of the user interface and/or top or bottoms regions (e.g., a top edge or a bottom edge) of the user interface (e.g., when the user interface has a top to bottom orientation). Accordingly, the user interface region is displayed along an edge of the user interface region (e.g., top or bottom or side edges) if the electronic device detects the end of the first input at the first location.

In some embodiments, in accordance with a determination that the user interface region is located within the first threshold distance (e.g., 0.1, 0.15, 0.25, 0.5, 0.75, 1, 2, 5, 10, 20 or 30 cm) of a second predetermined portion (e.g., a corner of the user interface 1200), different from the first predetermined portion, of the user interface when the end of the first input is detected, the electronic device displays (1312d) the user interface region at the second predetermined portion of the user interface, such as display of the user interface element 1212 at a top right corner of the user interface 1200 as shown in FIG. 12G. For example, if the user interface region is located at a second location, different from the first location, that is the first threshold distance of the second predetermined portion of the user interface when the end of the first input is detected, the electronic device displays the user interface region at a location that is based on the second predetermined portion of the user interface. In some embodiments, the second predetermined portion of the user interface includes one or more corner regions (e.g., top corners or bottom corners) of the user interface (e.g., when the user interface has a top to bottom orientation). Accordingly, the user interface region is displayed at a corner of the user interface region (e.g., top or bottom corner) if the electronic device detects the end of the first input at the second location. In some embodiments, if the electronic device detects that the user interface region is located outside the first threshold distance of the second predetermined portion, the electronic device displays the user interface region at the first predetermined portion of the user interface. For example, the electronic device displays the user interface region at an edge of the user interface that is closest to the location of the user interface region when the end of the first input is detected, such as display of content entry palette 1204 along the top edge of the user interface 1200 as shown in FIG. 12I. Displaying a user interface region at a portion of a user interface in which the user interface region is displayed that is based on a location at which input directed to the user interface region ends reduces the number of inputs needed to display the user interface region at a particular portion of the user interface and/or enables the user interface region to be displayed at a particular portion of the user interface automatically, thereby improving user-device interaction.

In some embodiments, the user interface region is displayed at a first size in the user interface when the first input is detected (e.g., a first length and/or height in the user interface) (1314a), such as a size of the content entry palette 1204 in the user interface 1200 in FIG. 12I. In some embodiments, while detecting the first input, in accordance with the determination that the first input includes movement in the second direction (e.g., downward direction of input 1203i as shown in FIG. 12I) and that the one or more criteria are satisfied, the user interface region is displayed at a second size, smaller than the first size, in the user interface while the user interface region is moved within the user interface in accordance with the first input (1314b), such as display of user interface element 1212 that is smaller than content entry palette 1204 during the movement as shown in FIG. 12J. For example, the electronic device changes an appearance (e.g., size, shape, and/or contents) of the user interface region when the user interface region is moved within the user interface, as similarly shown in FIG. 12J. In some embodiments, because the user interface region is displayed at the second size, smaller than the first size, during the movement of the user interface region in the user interface, the electronic device alters display of the plurality of objects of the user interface region. For example, the electronic device ceases display of one or more of the plurality of objects in the user interface region and/or one or more of the selectable options in the user interface region, such as ceasing display of the content entry tools 1208-5 through 1208-8 in the user interface element 1212 as shown in FIG. 12J. In some embodiments, during the movement of the user interface region, the electronic device changes a shape of the user interface region to resemble a circular object that includes the user interface object that is currently selected (e.g., when the first input is detected), such as the circular shape of the user interface object 1212 in FIG. 12J. In some embodiments, if the electronic device detects an end of the first input (e.g., detects lift-off of the object providing the first input from the touch screen of the electronic device), the electronic device redisplays the user interface region at the first size. In some embodiments, the electronic device maintains display of the user interface region at the second size (e.g., until a second input is detected directed to the user interface region, such as a tap or touch input directed to the user interface region, which causes the electronic device to redisplay the user interface region at the first size). In some embodiments, as similarly described below with reference to steps 1316a-1316f, the electronic device redisplays the user interface region at the first size or the second size depending on a location at which the end of the movement is detected. Decreasing a size of a user interface region in a user interface during a movement of the user interface region within the user interface enables the user interface region to be easily moved within the user interface and/or avoids unintentional obstruction of content in the user interface by the user interface region during the movement, thereby improving user-device interaction.

In some embodiments, the user interface region is displayed with a first size in the user interface when the first input is detected (e.g., a first length and/or height in the user interface) (1316a), such as a size of the content entry palette 1204 in the user interface 1200 in FIG. 12I. In some embodiments, while moving the user interface region within the user interface in accordance with the first input including movement in the second direction (e.g., downward direction of input 1203i as shown in FIG. 12I) and that the one or more criteria are satisfied (1316b), the electronic device detects (1316c), via the one or more input devices, an end of the first input, such as release of the movement input 1203k as shown in FIG. 12K. For example, the electronic device detects lift-off of the object (e.g., finger of the user or input device, such as a stylus) providing the contact directed to the user interface region from the touch screen of the electronic device or other surface (e.g., a touch-sensitive surface in communication with the electronic device).

In some embodiments, in response to detecting the end of the first input (1316d), in accordance with a determination that the user interface region is located at a first location in the user interface when the end of the first input is detected, the electronic device displays (1316e), via the display generation component, the user interface region with the first size in the user interface, such as display of content entry palette 1204 with the first size in the user interface 1200 as shown in FIG. 12L. For example, if the user interface region is located at the first location in the user interface when the end of the first input is detected, the electronic device displays the user interface region with the first size (e.g., first length and/or height) in the user interface. In some embodiments, the first location is associated with the first size. For example, the first location is a location that is a threshold distance of (e.g., 0.1, 0.15, 0.25, 0.5, 0.75, 1, 2, 5, 10, 20, or 30 cm of) one or more side regions (e.g., a left side edge or a right side edge) of the user interface or is the threshold distance of top or bottoms regions (e.g., a top edge or a bottom edge) of the user interface (e.g., when the user interface has a top to bottom orientation), such as left edge of the user interface 1200 in FIG. 12K. Accordingly, the user interface region is displayed with the first size because the side regions and/or the top or bottom regions of the user interface are associated with the first size.

In some embodiments, in accordance with a determination that the user interface region is located at a second location, different from the first location, in the user interface when the end of the first input is detected, the electronic device displays (13160 the user interface region with a second size, different from the first size, in the user interface, such as display of user interface element 1212 with the second size in the user interface 1200 as shown in FIG. 12H. For example, if the user interface region is located at the second location in the user interface when the end of the first input is detected, the electronic device displays the user interface region with the second size (e.g., second length and/or height), smaller than the first size, in the user interface. In some embodiments, the second location is associated with the second size. For example, the second location is a location that is a threshold distance of (e.g., 0.1, 0.15, 0.25, 0.5, 0.75, 1, 2, 5, 10, 20, or 30 cm of) a corner region (e.g., the top corners and/or the bottom corners) of the user interface (e.g., when the user interface has a top to bottom orientation), such as top right corner of the user interface 1200 in FIG. 12H. Accordingly, the user interface region is displayed with the second size because the top corner regions and/or the bottom corner regions of the user interface are associated with the second size. In some embodiments, if the location of the user interface region when the end of the first input is detected is outside the threshold distance of a corner region of the user interface, the electronic device displays the user interface region at an edge of the user interface that is closest to the location of the user interface region when the end of the first input is detected. For example, the electronic device displays the user interface region at the edge of the user interface with the first size. Displaying a user interface region with a size in a user interface that is based on a location at which input directed to the user interface region ends reduces the number of inputs needed to display the user interface region with a particular size and/or enables the size of the user interface region to be changed automatically, thereby improving user-device interaction.

In some embodiments, the user interface region is displayed with a first orientation relative to the user interface when the first input is detected (e.g., a horizontal orientation or a vertical orientation relative to the user interface) (1318a), such as display of content entry palette 1204 with the first orientation as shown in FIG. 12I. In some embodiments, while moving the user interface region within the user interface in accordance with the first input including movement in the second direction and that the one or more criteria are satisfied (1318b), the electronic device detects (1318c), via the one or more input devices, an end of the first input, such as release of the movement input 1203k as shown in FIG. 12K. For example, the electronic device detects lift-off of the object (e.g., finger of the user or input device, such as a stylus) providing the contact directed to the user interface region from the touch screen of the electronic device or other surface (e.g., a touch-sensitive surface in communication with the electronic device).

In some embodiments, in response to detecting the end of the first input (1318d), in accordance with a determination that the user interface region is located at a first location in the user interface when the end of the first input is detected, the electronic device displays (1318e), via the display generation component, the user interface region with the first orientation relative to the user interface based on (e.g., selected automatically by the electronic device) the first location, such as display of content entry palette 1204 with the first orientation as shown in FIG. 12I. For example, if the first orientation relative to the user interface is a horizontal orientation, and if the user interface region is located at the first location in the user interface when the end of the first input is detected, the electronic device displays the user interface region with the horizontal orientation. In some embodiments, the first location is associated with the horizontal orientation. For example, the first location is a location that is a threshold distance of (e.g., 0.1, 0.15, 0.25, 0.5, 0.75, 1, 1.5, or 2 cm of) a top region (e.g., a top edge, including the top corners) of the user interface or is the threshold distance of a bottom region (e.g., a bottom edge, including the bottom corners) of the user interface (e.g., when the user interface has a top to bottom orientation), such as the top region of the user interface 1200 in FIG. 12H. Accordingly, the user interface region is displayed with the first orientation because the top region and/or the bottom region of the user interface is associated with the first orientation. In some embodiments, while the user interface region is displayed with the first orientation relative to the user interface, the electronic device displays the plurality of user interface objects with the first orientation within the user interface region, such as display of the content entry tools along the horizontal direction within the content entry palette 1204 as shown in FIG. 12I.

In some embodiments, in accordance with a determination that the user interface region is located at a second location, different from the first location, in the user interface when the end of the first input is detected, the electronic device displays (13180 the user interface region with a second orientation, different from the first orientation, relative to the user interface based on (e.g., selected automatically by the electronic device) the second location, such as display of the content entry palette 1204 with the second orientation in the user interface 1200 as shown in FIG. 12L. For example, if the second orientation relative to the user interface is a vertical orientation, and if the user interface region is located at the second location in the user interface when the end of the first input is detected, the electronic device displays the user interface region with the vertical orientation. In some embodiments, the second location is associated with the vertical orientation. For example, the second location is a location that is a threshold distance of (e.g., 0.1, 0.15, 0.25, 0.5, 0.75, 1, 1.5, or 2 cm of) a first side region (e.g., a left side edge) of the user interface or is the threshold distance of a second side region (e.g., a right side edge) of the user interface (e.g., when the user interface has a top to bottom orientation), such as left side region of the user interface 1200 as shown in FIG. 12K. Accordingly, the user interface region is displayed with the second orientation because the first side region and/or the second side region of the user interface is associated with the second orientation. In some embodiments, while the user interface region is displayed with the second orientation relative to the user interface, the electronic device displays the plurality of user interface objects with the second orientation within the user interface region, such as display of the content entry tools along a vertical direction within the content entry palette 1204 as shown in FIG. 12L. Displaying a user interface region with an orientation relative to a user interface in which the user interface region is displayed that is based on a location at which input directed to the user interface region ends reduces the number of inputs needed to display the user interface region with a particular orientation and/or enables the orientation of the user interface region to be changed automatically, thereby improving user-device interaction.

In some embodiments, the user interface region is a content entry palette (e.g., as similarly described above with reference to steps 1302a-1302e) (1320a), such as content entry palette 1204 in FIG. 12A. In some embodiments, the plurality of user interface objects includes a plurality of selectable content entry tools (e.g., as similarly described above with reference to steps 1302a-1302e) (1320b), such as content entry tools 1208-1 through 1208-4 in FIG. 12A. In some embodiments, the plurality of selectable content entry tools is selectable to cause the electronic device to activate a respective content entry mode based on the selected content entry tool. For example, as similarly described below with reference to steps 1322a-1322e, if handwritten input is provided in the user interface while a respective content entry tool is selected, the electronic device displays a representation of the handwritten input based on the respective content entry mode (e.g., pen entry mode, pencil entry mode, marker entry mode, highlighter entry mode, and/or paintbrush entry mode) associated with the selected content entry tool. Additionally, as similarly described above with reference to steps 1302a-1302e, the content entry palette optionally includes selectable options (e.g., options 1210 in FIG. 12A) that are selectable to configure a color of the representation of the handwritten input and/or to perform one or more content editing operations involving content displayed in the user interface. For example, the one or more content editing operations include content insertion (e.g., file insertion or text insertion), text editing operations (e.g., cut, copy, paste), and/or undo/redo operations. Scrolling a plurality of tools within a content entry palette or moving the content entry palette in a user interface depending on a direction of movement of an input directed toward the content entry palette reduces the number of inputs needed to move and/or scroll the tools within the content entry palette, thereby improving user-device interaction, and/or enables additional tools to be displayed within the content entry palette without increasing a size of the content entry palette, thereby improving spatial utilization.

In some embodiments, a first user interface object (e.g., pen entry tool 1208-1 in FIG. 12A) of the plurality of user interface objects (e.g., a first selectable content entry tool) is selected when the first input is detected and after scrolling the plurality of user interface objects within the user interface region in accordance with the first input, the first user interface object is not displayed in the user interface region (e.g., the first selectable content entry tool is scrolled out of view within the user interface region) (1322a), such as ceasing display of pen entry tool 1208-1 after scrolling as shown in FIG. 12C. In some embodiments, after scrolling the plurality of user interface objects within the user interface region in accordance with the first input and while the first user interface object is not displayed in the user interface region, the electronic device detects (1322b), via the one or more input devices, a second input that includes content entry input utilizing a content entry tool corresponding to the first user interface object, such as handwriting input provided by stylus 1205 on touch screen 504 as shown in FIG. 12M. For example, the electronic device detects an object (e.g., a finger or input device, such as a stylus) contact a surface (e.g., a touch screen of the electronic device, a touch-sensitive surface in communication with the electronic device, and/or a physical surface on which the user interface is projected or a simulated surface corresponding to at least a portion of the user interface), and provide handwritten input on the surface. In some embodiments, the first selectable content entry tool corresponds to a drawing tool, such as a pen entry tool, a pencil entry tool, and/or a marker entry tool, as similarly described above with reference to steps 1302a-1302e. In some embodiments, the first user interface object remains selected despite being out of view within the user interface region.

In some embodiments, while detecting the second input (1322c), the electronic device displays (1322d), via the display generation component, a representation of the content entry input in the user interface in accordance with the second input and based on the content entry tool, such as display of representation of the handwritten input 1209 as shown in FIG. 12M. For example, the electronic device displays a representation of the handwritten input provided by the object in the user interface in accordance with the second input. In some embodiments, the representation of the content entry input corresponds to handwritten text (e.g., handwritten letters, numbers, and/or special characters). In some embodiments, the representation of the content entry input corresponds to a drawing (e.g., drawn shapes, images, sketches, and/or diagrams). In some embodiments, a visual appearance (e.g., line thickness, size, and/or color) of the representation of the content entry input is based on the selected content entry tool. For example, if the content entry tool is a pen entry tool, the representation of the content entry input has a visual appearance that corresponding handwriting would have if provided with a physical pen (e.g., on paper). As another example, if the content entry tool is a marker entry tool, the representation of the content entry input has a visual appearance that corresponding handwriting would have if provided with a physical marker.

In some embodiments, the electronic device scrolls (1322e) the plurality of user interface objects within the user interface region such that the first user interface object is displayed in the user interface region, such as scrolling the content entry tools within the content entry palette 1204 to display the pen entry tool 1208-2 within the content entry palette 1204 as shown in FIG. 12M. For example, the electronic device scrolls the plurality of user interface objects to bring the first user interface object back into view in the user interface region. In some embodiments, when the electronic device scrolls the plurality of user interface objects, a spatial and/or chronological arrangement of the plurality of user interface objects is maintained within the user interface region. For example, if the first user interface object is displayed next to a second user interface object and a third user interface object that are also out of view when the second input is detected, when the electronic device scrolls the plurality of user interface objects within the user interface region in response to detecting the second input, the second user interface object and the third user interface object are also displayed (e.g., within view) in the user interface region, such as display of content entry tools 1208-1 and 1208-3 with content entry palette 1204 as shown in FIG. 12M. In some embodiments, scrolling the plurality of user interface objects within the user interface region such that the first user interface object is displayed in the user interface region is in accordance with a determination that the second input was provided utilizing the content entry tool corresponding to the first user interface object when the first user interface object was not visible in the user interface region. In some embodiments, if a different content entry tool corresponding to a second user interface object, different from the first user interface object, is selected when the second input is detected and the second user interface object is not displayed within the user interface region, the electronic device redisplays the second user interface object in the user interface region when the electronic device detects the second input utilizing the different content entry tool corresponding to the second user interface object. For example, as similarly described above, the electronic device scrolls the plurality of user interface objects to bring the second user interface object back into view in the user interface region, while maintaining the spatial and/or chronological arrangement of the plurality of user interface objects within the user interface region. Scrolling a plurality of objects within a user interface region to reveal a first user interface object within the user interface region in response to detecting a content entry input while the first user interface object is active facilitates discovery that the content entry input is utilizing a content entry tool corresponding to the first user interface object and/or facilitates user input for selecting an alternative user interface object for associating a different content entry tool with the content entry input, thereby improving user-device interaction.

In some embodiments, the second direction is within a first threshold (e.g., 0, 1, 5, 10, 15, 20, 25, 30, 35, 45 or 60 degrees) of being orthogonal to the first direction (1324), such as leftward movement of input 1203b in FIG. 12B being orthogonal to downward movement of input 1203i in FIG. 12I. For example, the second direction of movement that causes the electronic device to move the user interface region within the user interface in accordance with the movement is substantially orthogonal/parallel to the first direction of movement that causes the electronic device to scroll the user interface region in accordance with the movement. Scrolling a plurality of objects within a user interface region if a direction of movement of an input directed toward the user interface region is a first direction, and moving the user interface region in a user interface if the direction of movement of the input is in a second direction, substantially orthogonal to the first direction, avoids unintentional scrolling of the plurality of objects by requiring the movement be in the first direction and/or avoids unintentional movement of the user interface region by requiring the movement be in the second direction, thereby improving user-device interaction.

It should be understood that the particular order in which the operations in FIGS. 13A-13F have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 700, 900, and/or 1100) are also applicable in an analogous manner to method 1300 described above with respect to FIGS. 13A-13F. For example, the operation of the electronic device scrolling and moving a content entry palette in a user interface in response to user inputs described above with reference to method 1300 optionally has one or more of the characteristics of entering text into one or more text-entry regions within a document, displaying marks with varying widths, and/or displaying merging and overlapping marks described herein with reference to other methods described herein (e.g., methods 700, 900, and/or 1100). For brevity, these details are not repeated here.

The operations in the information processing methods described above are, optionally, implemented by running one or more functional modules in an information processing apparatus such as general purpose processors (e.g., as described with respect to FIGS. 1A-1B, 3, 5A-5I) or application specific chips. Further, the operations described above with reference to FIGS. 13A-13F are, optionally, implemented by components depicted in FIGS. 1A-1B. For example, displaying operations 1302a, 1312c, 1312d, 1316e, 1316f, 1318e, 1318f, and 1322d, receiving operation 1302b, and detecting operations 1304b, 1312a, 1316c, 1318c, and 1322b are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

As described above, one aspect of the present technology potentially involves the gathering and use of data available from specific and legitimate sources to facilitate the analysis and identification of handwritten inputs. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information, usage history, and/or handwriting styles.

The present disclosure recognizes that the use of such personal information data, in the present technology, can be used to the benefit of users. For example, the personal information data can be used to automatically perform operations with respect to interacting with the electronic device using a stylus (e.g., recognition of handwriting as text). Accordingly, use of such personal information data enables users to enter fewer inputs to perform an action with respect to handwriting inputs. Further, other uses for personal information data that benefit the user are also contemplated by the present disclosure. For instance, handwriting styles may be used to identify valid characters within handwritten content.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the user is able to configure one or more electronic devices to change the discovery or privacy settings of the electronic device. For example, the user can select a setting that only allows an electronic device to access certain of the user's handwriting entry history when analyzing handwritten content.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, handwriting can be recognized based on aggregated non-personal information data or a bare minimum amount of personal information, such as the handwriting being handled only on the user's device or other non-personal information.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method, comprising:
at an electronic device in communication with a display generation component and one or more input devices:
displaying, via the display generation component, a document;
while displaying the document, detecting, via the one or more input devices, a first input directed toward the document; and
in response to detecting the first input:
in accordance with a determination that the first input is directed to a first location that is within a first threshold distance of a first text-entry region in the document while the document is in a respective mode of operation, wherein the first text-entry region does not include a text-entry field, displaying, via the display generation component, a first text-entry field at a respective location in the document based on the first text-entry region, wherein the respective location is located within the first threshold distance of the first text-entry region; and
in accordance with a determination that the first input is directed to a second location, different from the first location, that is within the first threshold distance of the first text-entry region in the document while the document is in the respective mode of operation, displaying the first text-entry field at the respective location in the document.

2. The method of claim 1, further comprising:
in response to detecting the first input:
in accordance with a determination that the first input is directed to a third location, different from the first location and the second location, that is within a second threshold distance of an existing text-entry field, initiating a process to enter text into the existing text-entry field.

3. The method of claim 1, further comprising:
in response to detecting the first input:
in accordance with a determination that the first input is directed to a third location, different from the first location and the second location, that is within the first threshold distance of a second text-entry region, different from the first text-entry region, displaying, via the display generation component, a second text-entry field at a second respective location in the document based on the second text-entry region, wherein the second respective location is located within the first threshold distance of the second text-entry region.

4. The method of claim 3, wherein:
in response to detecting input corresponding to a request to enter text into the first text-entry field, the electronic device displays first text with a respective characteristic having a first value in the first text-entry field; and
in response to detecting input corresponding to a request to enter text into the second text-entry field, the electronic device displays second text with the respective characteristic having the first value in the second text-entry field.

5. The method of claim 1, wherein:
the document is associated with a setting for text corresponding to a respective characteristic having a first value; and
in response to detecting input corresponding to a request to enter text into the first text-entry field, the electronic device displays first text with the respective characteristic having the first value in the first text-entry field.

6. The method of claim 1, wherein the document includes a second text-entry field that includes respective text with a respective characteristic having a first value, the method further comprising:
while displaying the first text-entry field at the respective location in accordance with the first input, detecting, via the one or more input devices, a second input corresponding to a request to enter text into the first text-entry field;
in response to detecting the second input, displaying, via the display generation component, first text with the respective characteristic having the first value in the first text-entry field in accordance with the second input;
while displaying the first text with the respective characteristic having the first value in the first text-entry field, detecting, via the one or more input devices, a third input corresponding to a request to display the first text with the respective characteristic having a second value, different from first value; and
in response to detecting the third input:
displaying, via the display generation component, the first text with the respective characteristic having the second value in the first text-entry field; and
displaying, via the display generation component, the respective text with the respective characteristic having the second value in the second text-entry field.

7. The method of claim 1, wherein the first text-entry region is determined to be a text-entry region based on an evaluation of one or more visual elements of the document.

8. The method of claim 7, wherein:
the one or more visual elements of the document include a first graphical line; and
the first text-entry region is placed, by the electronic device, at a location in the document that has a predetermined spatial relationship to the graphical line in the document.

9. The method of claim 7, wherein:
the evaluation of the one or more visual elements of the document includes a determination of whether the document includes one or more text-entry regions of a first type; and
the first text-entry region is of a second type, different from the first type.

10. The method of claim 7, wherein:
the first text-entry field is displayed with a first size based on a respective size of the first text-entry region.

11. The method of claim 10, wherein:
the respective size of the first text-entry region includes a respective length that is based on available length in the document at a location of the text-entry region in the document;
the first size of the first text-entry field includes a first length; and
the first length is based on the respective length.

12. The method of claim 10, wherein:
the respective size of the first text-entry region includes a respective height that is based on available height in the document at a location of the text-entry region in the document;
the first size of the first text-entry field includes a first height; and
the first height is based on the respective height.

13. The method of claim 10, wherein:
the first size of the first text-entry field includes a first height that is based on a font size setting for text in the first text-entry field.

14. The method of claim 1, wherein the document includes a second text-entry region, the method further comprising:
before detecting the first input and while the document is in the respective mode of operation:
in accordance with a determination that the second text-entry region includes a first type of text-entry field, displaying, via the display generation component, the second text-entry region with a first visual characteristic having a first value; and
in accordance with a determination that the second text-entry region does not include the first type of text-entry field, forgoing displaying the second text-entry region with the first visual characteristic having the first value.

15. The method of claim 14, further comprising:
while displaying the second text-entry region and while the document is in the respective of operation, detecting, via the one or more input devices, an input directed to the second text-entry region; and
in response to detecting the input:
in accordance with the determination that the second text-entry region includes the first type of text-entry field, displaying, via the display generation component, one or more user interface objects that are selectable to enter suggested text into the second text-entry field; and
in accordance with the determination that the second text-entry region does not include the first type of text-entry field, forgoing displaying the one or more user interface objects.

16. The method of claim 1, further comprising:
in response to detecting the first input:
in accordance with a determination that the first input is directed to the first location that is within the first threshold distance of the first text-entry region in the document while the document is not in the respective mode of operation, forgoing displaying the first text-entry field at the respective location in the document; and
in accordance with a determination that the first input is directed to the second location that is within the first threshold distance of the first text-entry region while the document is not in the respective mode of operation, forgoing displaying the first text-entry field at the respective location.

17. The method of claim 1, further comprising:
in response to detecting the first input:
in accordance with a determination that the first input is directed to a third location, different from the first location and the second location, that is not within the first threshold distance of any text-entry region in the document while the document is in the respective mode of operation, displaying, via the display generation component, the first text-entry region at a second respective location in the document, different from the respective location, that is based on the third location and independent of a structure of the document.

18. The method of claim 1, further comprising:
while displaying the first text-entry field at the respective location in accordance with the first input, detecting, via the one or more input devices, a second input corresponding to a request to enter text into the first text-entry field; and
in response to detecting the second input:
in accordance with a determination that the second input includes selection of a first option that is selectable to generate suggested text for entering in the first text-entry field and that the first text-entry field is associated with a first type of text, displaying, via the display generation component, a first user interface object that is selectable to enter first suggested text of the first type into the first text-entry field; and
in accordance with a determination that the second input includes selection of the first option that is selectable to generate suggested text for entering in the first text-entry field and that the first text-entry field is associated with a second type of text, different from the first type of text, displaying, via the display generation component, a second user interface object that is selectable to enter second suggested text of the second type into the first text-entry field, wherein the first suggested text is different from the second suggested text.

19. The method of claim 18, wherein whether the first text-entry field is associated with the first type or the second type of text is based on a context of the first text-entry region within the document.

20. The method of claim 18, wherein the document includes a second text-entry field that shares at least one characteristic with the first text-entry field, the method further comprising:
while displaying the first user interface object in accordance with the second input, detecting, via the one or more input devices, a third input corresponding to selection of the first user interface object; and
in response to detecting the third input:
displaying, via the display generation component, the first suggested text that is associated with the first user interface object in the first text-entry field; and
displaying, via the display generation component, third suggested text that is associated with the first user interface object in the second text-entry field, wherein the third suggested text is related to the first suggested text based on the shared at least one characteristic.

21. The method of claim 1, wherein the document includes a second text-entry field, the method further comprising:
while displaying the first text-entry field at the respective location in accordance with the first input, detecting, via the one or more input devices, a second input corresponding to a request to enter text into the first text-entry field;
in response to detecting the second input, displaying, via the display generation component, first text in the first text-entry field in accordance with the second input; and
after displaying the first text in the first text-entry field, initiating a process to enter text into the second text-entry field without detecting input corresponding to a request to enter text into the second text-entry field.

22. The method of claim 21, wherein initiating the process to enter text into the second text-entry field includes displaying, via the display generation component, one or more user interface objects that are selectable to enter suggested text into the second text-entry field.

23. The method of claim 21, wherein the second text entry field was created in the document in response to user input prior to detecting the first input, and the second text-entry field is spatially subsequent to the first text-entry field in the document.

24. The method of claim 1, further comprising:
while displaying the first text-entry field at the respective location, detecting, via the one or more input devices, handwritten input on a surface, wherein the handwritten input is directed to the first text-entry field; and
in response to detecting the handwritten input, displaying, via the display generation component, first text that is based on the handwritten input in the first text-entry field.

25. The method of claim 1, further comprising:
in response to detecting the first input:
before displaying the first text-entry field at the respective location, displaying, via the one or more input devices, one or more selectable options that are selectable to select a type of the first text-entry field.

26. The method of claim 1, wherein the first text-entry field is displayed with a first size at the respective location in response to detecting the first input, the method further comprising:
while displaying the first text-entry field with the first size at the respective location, detecting, via the one or more input devices, a second input corresponding to a request display the first text-entry field with a second size, different from the first size; and
in response to detecting the second input, displaying, via the display generation component, the first text-entry field with the second size at the respective location.

27. The method of claim 26, wherein the second input is directed to one or more selectable user interface objects displayed with the first text-entry field.

28. The method of claim 1, wherein the first input includes contact between an object and a surface a predefined number of times within a time threshold of one another.

29. An electronic device, comprising:
one or more processors;
memory; and
one or more programs, wherein the one or more programs are stored in the memory and configured to be executed by the one or more processors, the one or more programs including instructions for:
displaying, via a display generation component, a document;
while displaying the document, detecting, via one or more input devices, a first input directed toward the document; and
in response to detecting the first input:
in accordance with a determination that the first input is directed to a first location that is within a first threshold distance of a first text-entry region in the document while the document is in a respective mode of operation, wherein the first text-entry region does not include a text-entry field, displaying, via the display generation component, a first text-entry field at a respective location in the document based on the first text-entry region, wherein the respective location is located within the first threshold distance of the first text-entry region; and
in accordance with a determination that the first input is directed to a second location, different from the first location, that is within the first threshold distance of the first text-entry region in the document while the document is in the respective mode of operation, displaying the first text-entry field at the respective location in the document.

30. A non-transitory computer readable storage medium storing one or more programs, the one or more programs comprising instructions, which when executed by one or more processors of an electronic device, cause the electronic device to perform a method comprising:
displaying, via a display generation component, a document;
while displaying the document, detecting, via one or more input devices, a first input directed toward the document; and
in response to detecting the first input:
in accordance with a determination that the first input is directed to a first location that is within a first threshold distance of a first text-entry region in the document while the document is in a respective mode of operation, wherein the first text-entry region does not include a text-entry field, displaying, via the display generation component, a first text-entry field at a respective location in the document based on the first text-entry region, wherein the respective location is located within the first threshold distance of the first text-entry region; and
in accordance with a determination that the first input is directed to a second location, different from the first location, that is within the first threshold distance of the first text-entry region in the document while the document is in the respective mode of operation, displaying the first text-entry field at the respective location in the document.

31-107. (canceled)
